(19) United States
(12) Patent Application Publication
(10) Pub. No.: US 2013/0080312 A1
(43) Pub. Date: Mar. 28, 2013

(54) MARKET TRADE SUPPORTING APPARATUS AND METHOD OF THE SAME

(71) Applicant: KAWAMURA TRADING SYSTEMS INC., Tokyo (JP)

(72) Inventor: Tetsuhiko KAWAMURA, Tokyo (JP)

(73) Assignee: KAWAMURA TRADING SYSTEMS INC., Tokyo (JP)

(21) Appl. No.: 13/683,350

(22) Filed: Nov. 21, 2012

Related U.S. Application Data
(63) Continuation of application No. PCT/JP2011/002920, filed on May 25, 2011.

(30) Foreign Application Priority Data
May 25, 2010 (JP) 2010-119361
Feb. 1, 2011 (JP) 2011-019739
Feb. 1, 2011 (JP) 2011-019740

(51) Int. Cl. G06Q 40/04

(52) U.S. Cl. CPC G06Q 40/04
USPC 705/37

(57) ABSTRACT

A market trade supporting method and a market trade supporting apparatus that are able to determine the appropriate price of stop order. The sell order price of stop order for loss cut is set based on the lowest price in the period of temporary fall which is until it rises to exceed the level of prior declines after the market price temporary falls when it is on uptrend. The buy order price of stop order for loss cut is set based on the highest price (ceiling price) in the period of temporary rise which is until it calls to exceed the level of prior rises after the market price temporary rises when it is on downtrend.

### TECHNICAL FIELD

This invention relates to an apparatus supporting market trade of stock or foreign exchange, etc.

### BACKGROUND ART

Resent years an environment in which trading of stock and foreign exchange, etc. are performed easily via network is ready by a development of communication represented by an Internet.

Trade using the internet by general investors is carried out flourishingly. Support of the trading various kinds of tools automating are developed using software. A system supporting market trading by a computer is listed in the following patent documents.

### PRIOR ART DOCUMENTS

### Patent Documents

[PATENT DOCUMENTS 1] Japanese Patent No. 4562809
[PATENT DOCUMENTS 2] Japanese Unexamined Patent Application Publication No. 2008-165720

### DISCLOSURE OF INVENTION

### Technical Problem

Generally it is important to set “sell” or “buy” operation at the appropriate timing for getting benefit in market trading. However timing of evening up (loss cut) is also important in view of making loss smaller. Stop order is a method of order in which “sell” order is output when market price becomes higher than a predetermined price and “buy” order is output when market price becomes lower than a predetermined price. The stop order is widely used as a method of automatic loss cut.

A price which becomes trigger for the stop order is set by investor themselves. However in recent years a method of order which is call “trading stop” which corrects automatically the price of stop order in accordance with market price becomes to be used widely among stock company and FX trading company.

FIG. 88 is a figure for explaining a trading stop of buy order. In FIG. 8, solid line indicates a time transition of market price such as stock and exchange rate, etc., and dotted line indicates a price of stop order.

At time t1, a buy order of price “A1” is contracted, and a stop order outputting “sell” order when market price falls lower than “A1-X” is set.

In trading stop, it is automatically corrected so that a price (buy price) for which the stop order output is rounded up in accordance with the rise of the market price when the market price rises in accordance with a time transition.

That is, the stop order is corrected one by one so that a difference between the stop order price and market price does not exceed a predetermined value “X” when the market price rises. The stop order (buy price) will be maintained when the market price drops.

The trading stop of sell order is performed with the above description adversely, the stop order price (buy price) is rounded down in conjunction with this, then the stop order price (buy price) is maintained when the market price rises.

These trading stop can reduce the lost when performing the stop order within a predetermined range because it is possible not to expand a difference between stop order price and market price beyond a predetermined price “X”.

However the trading stop described above has a problem that it is not easy to obtain benefit because the stop order is easy to be performed at “valley floor” and “peak” occurred by change of market price.

Generally a small rise and drop are repeated in short range even when the market price indicates uptrend or downtrend.

For example in FIG. 88 a change of the market price such as a peak (H1), a valley floor (L1), a peak (H2), a valley floor (L2), a peak (H3), . . . are occurred. In the trading stop an upper limit of a difference between stop order price and market price is maintained to a predetermined price “X”. Therefore when change (a difference between peak and valley floor) bigger than the “X” occurs, the stop order is performed even if the prediction of the trend is correct.

The present invention has been made in view of these situations and a purpose thereof is to provide a market trading support apparatus and method of the same which can appropriately determine a price which becomes a trigger of outputting stop order.

### Technical Solution

The present invention is a market trading supporting apparatus for determining a price of a stop order, comprising a data obtaining unit obtaining market data indicating market price of a trade target changing every moment in a market one by one; a bottom price obtaining unit obtaining a bottom price of the market in the temporary decline period during the market price updates a highest price; a ceiling price obtaining unit obtaining a ceiling price of the market in the temporary rise period during the market price updates a lowest price; and a calculating unit calculating a sell price of the stop order based on the obtained bottom price when the bottom price is obtained by the bottom price obtaining unit and calculating a buy price of the stop order based on the obtained ceiling price when the ceiling price is obtained by the ceiling price obtaining unit.

### Effect of Invention

According to the preset invention it is possible to determine appropriately a price which become a trigger of outputting stop order based on a bottom price of market price when market price temporally declines while uptrend or a ceiling price of market price when market price temporally rises while downtrend.

### BRIEF DESCRIPTION OF DRAWINGS

FIG. 1 A drawing showing an example of the overall structure of the market trading system relates to the present invention.

FIG. 2 A drawing showing an example of the hardware structure of the server of order processing.

FIG. 3 A drawing showing an example of the structure of the order processing server relates to the first embodiment.

FIG. 4 A drawing showing an example of the market price data obtained by the market data obtaining unit.

FIG. 5 A drawing showing an example of the structure of the bottom price obtaining unit.

FIG. 6 A drawing showing an example of the structure of the ceiling price obtaining unit.

FIG. 7 A flowchart to explain movement of determining the price of sell order of the stop order for the loss cut mode of long position.

FIG. 8 A flowchart to explain the update process of the bottom price.

FIG. 9 A flowchart to explain the process of updating the price of sell order of the stop order.

FIG. 10 A drawing showing an example of changes in the price of sell order of the stop order determined by the order processing server.

FIG. 11 A drawing to explain an example of determining the price of sell order of the stop order based on the highest and the lowest price of the market price data.

FIG. 12 A flowchart to explain movement of determining the price of buy order of the stop order for the loss cut mode for short position.

FIG. 13 A flowchart to explain the process of updating the ceiling price.

FIG. 14 A flowchart to explain the process of updating the buy order price of stop order.

FIG. 15 A drawing showing an example of changes in the price of sell order of the stop order determined by the order processing server.

FIG. 16 a drawing to explain an example of determining the sell order price of stop order based on the highest and the lowest price of the market price data.

FIG. 17 a flowchart to explain the movement of determining the price of sells order of the stop order for the loss cut mode of long position.

FIG. 18 A drawing showing an example of not updating the sell order price of stop order when the range of drop in the market price is small in the temporary decline period.

FIG. 19 A drawing showing an example of not updating the sell order price of the stop order when the period of temporary decline is short.

FIG. 20 a flowchart to explain movement of determining the price of buy order of the stop order at the order processing server related to the second embodiment.

FIG. 21 A drawing showing an example of not updating the buy order price of the stop order when the range of rise is small in the temporary rise period.

FIG. 22 A drawing an example of not updating the buy order price of stop order when the range of rise in the market price is small in the temporary rise period.

FIG. 23 A drawing showing an example of the structure of the order processing server related to the third embodiment.

FIG. 24 A flowchart to explain the movements of determining the price of buy order of the stop order according to the buy contracted price.

FIG. 25 A flowchart to explain the process in case where the latest market price is increased than a given margin compared to the buy contracted price.

FIG. 26 A drawing showing an example of changes in the sell order price of stop order when the market price is increased than the buy contracted price.

FIG. 27 A flowchart to explain the movement of determining the price of sell order of the stop order according to the sell contracted price.

FIG. 28 A flowchart to explain the process in case where the latest market price is decreased than a given margin compared to the sell contracted price.

FIG. 29 A drawing showing an example of changes in the buy order price of stop order when the market price is decreased than the sell contracted price.

FIG. 30 A flowchart to explain the process of updating the price of sell order of the stop order in the order processing server relate to the forth embodiment.

FIG. 31 A drawing showing an example of transitions in the price of sell order of the stop order and transitions in the amount of long position determined by the order processing server relates to the firth embodiment.

FIG. 32 A flowchart to explain the process of updating the price of buy order of the stop order in the order processing server relate to the forth embodiment.

FIG. 33 A drawing showing an example of transitions in the price of buy order of the stop order and transitions in the amount of short position determined by the order processing server relates to the firth embodiment.

FIG. 34 A drawing showing an example of structure of the order processing server relates to the fifth embodiment.

FIG. 35 A drawing showing an example of the structure of the trend judging unit.

FIG. 36 A first flowchart to explain the processes of judging the trend of the market price and updating the price of stop order.

FIG. 37 A second flowchart to explain the processes of judging the trend of the market price and updating the price of stop order.

FIG. 38 A drawing showing an example of a chart of the market price transitions from downtrend to uptrend.

FIG. 39 A drawing showing an example of chart of the market changes from uptrend to downtrend.

FIG. 40 A drawing showing an example of the structure of the order processing server relates to the sixth embodiment.

FIG. 41 A flowchart to explain movement of the order processing server relates to the sixth embodiment processes the order by deciding automatically favorable conditions of the selling and buying based on the fluctuations of market prices.

FIG. 42 A drawing showing an example of charts of the market price with different time step.

FIG. 43 A flowchart to explain the processes of buy-sell orders.

FIG. 44 a drawing to explain the movement of changing the sell price of stop order at the order processing server relate to the sixth embodiment.

FIG. 45 A drawing to explain the movement of changing the buy price of stop order at the order processing server relate to the sixth embodiment.

FIG. 46 A flowchart to explain the movement of the order processing server relates to the sixth embodiment processes the order by deciding automatically favorable conditions of the selling based on the fluctuations of market prices.

FIG. 47 A drawing showing an example of structure of the order processing server relates to the seventh embodiment.

FIG. 48 A drawing showing an example of the structure of the second trend judging unit.

FIG. 49 A drawing showing an example of the structure of the first change point obtaining unit.

FIG. 50 A drawing showing an example of the structure of the second change point obtaining unit.

FIG. 51 A flowchart to explain the movement of the order processing server relates to the seventh embodiment processes the order by deciding automatically favorable conditions of selling and buying based on the fluctuations of market prices.

FIG. 52 A drawing showing examples of charts (market price and technical index) when the selling order instruction is output in the order processing server relates to the seventh embodiment.

FIG. 53 A drawing showing examples of charts (market price and technical index) when the buying order instruction is output in the order processing server relates to the seventh embodiment.

FIG. 54 A first flowchart to explain the processes of judging the trend of the market price in the second trend judging unit of the order processing server in relates to the seventh embodiment.

FIG. 55 A second flowchart to explain the processes of judging the trend of the market price in the second trend judging unit of the order processing server in relates to the seventh embodiment.

FIG. 56 A drawing showing an example of the chart the technical index (RSI) shows the signs of uptrend of the market price.

FIG. 57 A drawing showing an example of the chart the technical index (RSI) shows the signs of downtrend of the market price.

FIG. 58 A flowchart to explain the movement of the order processing server relates to the eighth embodiment processes the order by deciding automatically favorable conditions of buying and selling based on the fluctuations of market prices.

FIG. 59 A drawing showing examples of charts (market price and technical index) when the selling order instruction is output in the order processing server relates to the eighth embodiment.

FIG. 60 A drawing showing examples of charts (market price and technical index) when the buying order instruction is output in the order processing server relates to the eighth embodiment.

FIG. 61 A flowchart to explain movement of the order processing server relates to the ninth embodiment processes the order by deciding automatically favorable conditions of the selling and buying based on the fluctuations of market prices.

FIG. 62 A drawing showing examples of charts (market price and technical index) when the selling order instruction is output in the order processing server relates to the ninth embodiment.

FIG. 63 A drawing showing examples of charts (market price and technical index) when the buying order instruction is output in the order processing server relates to the ninth embodiment.

FIG. 64 A drawing showing an example of the structure of the order processing server relates to the tenth embodiment.

FIG. 65 A flowchart to explain movement of the order processing server relates to the tenth embodiment processes the order by deciding automatically favorable conditions of the selling and buying based on the fluctuations of market prices.

FIG. 66 A drawing showing examples of charts (market price and technical index) when the selling order instruction is output in the order processing server relates to the tenth embodiment.

FIG. 67 A drawing showing examples of charts (market price and technical index) when the buying order instruction is output in the order processing server relates to the tenth embodiment.

FIG. 68 A drawing showing an example of the structure of the order processing server relates to the eleventh embodiment.

FIG. 69 A first drawing showing examples of the data structure to obtain the bottom price and the ceiling price by each user based on the highest price and lowest price shared by multiple users.

FIG. 70 A second drawing showing examples of the data structure to obtain the bottom price and the ceiling price by each user based on the highest price and lowest price shared by multiple users.

FIG. 71 A drawing to explain a concrete example of update process of highest price when the latest market price is higher than multiple highest prices stored in the highest price storage.

FIG. 72 A drawing to explain a concrete example of the update process of the lowest price when the latest market price is lower than several lowest price stored in the lowest price storage.

FIG. 73 A flowchart to explain update of the price of sell order of the stop order in the order processing server relate to the eleventh embodiment.

FIG. 74 A flowchart to explain the process of updating the sell order price of stop order of the highest price selected for each user.

FIG. 75 A flowchart to explain updating the buy order price of stop order at the order processing server relate to the eleventh embodiment.

FIG. 76 A flowchart to explain the update process of the buy order price of stop order for each user of one highest price selected.

FIG. 77 A drawing showing an example of the trend judging unit in the order processing server related to the twelfth embodiment.

FIG. 78 A drawing showing an example of the structure of the data with each user.

FIG. 79 A first flowchart to explain the process of deciding the trend of the market price and the update process of the price of stop order in the order processing server relate to the twelfth embodiment.

FIG. 80 A second flowchart to explain the process of deciding the trend of the market price and the update process of the price of stop order in the order processing server relate to the twelfth embodiment.

FIG. 81 A third flowchart to explain the process of deciding the trend of the market price and the update process of the price of stop order in the order processing server relate to the twelfth embodiment.

FIG. 82 A flowchart to explain the process of judging uptrend of market price and updating the sell order price of stop order for the highest price selected for each user.

FIG. 83 A flowchart to explain the process of judging downtrend of market price and updating the buy order price of stop order of the lowest price selected for each user.

FIG. 84 A drawing to explain an example of the process storing the latest market price as a new lowest price when uptrend of the market price is judged as ended.

FIG. 85 A drawing to explain an example of the process storing the latest market price as a new highest price when downtrend of the market price is judged as ended.

FIG. 86 A drawing showing an example of the setting screen of terms and conditions at the order processing server related to the sixth embodiment.

FIG. 87 A drawing showing an example of the setting screen of terms and conditions in the order processing server relate to the seventh-tenth embodiments.

FIG. 88 A drawing to explain the trading stop in the buy order.

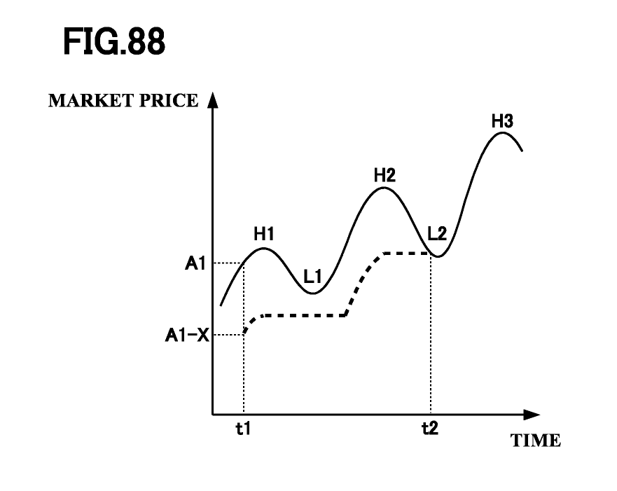

### DETAILED DESCRIPTION OF THE INVENTION

### The First Embodiment

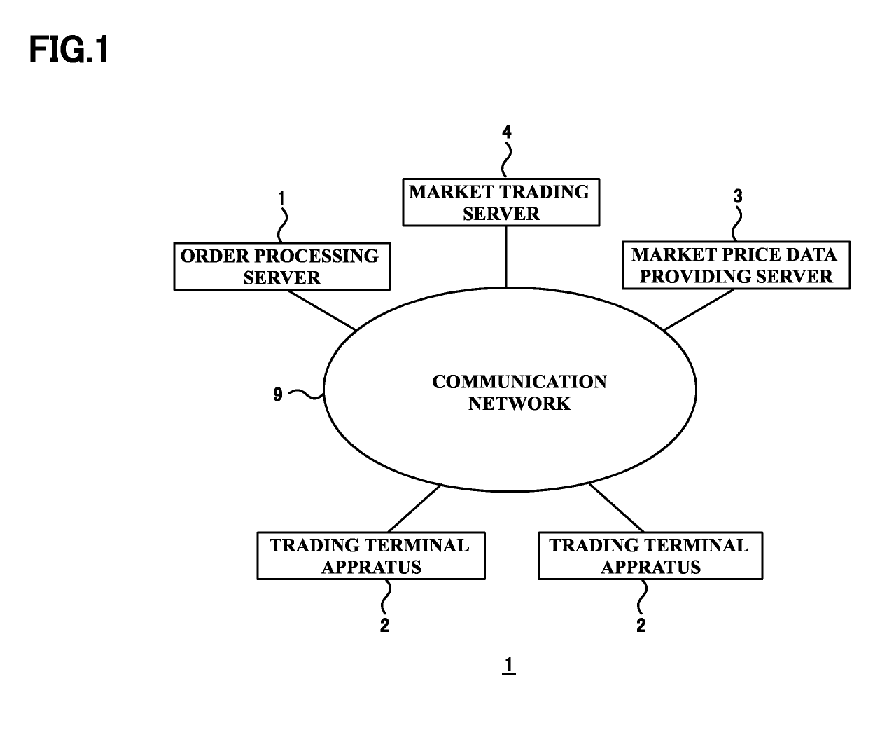

FIG. 1 is a drawing showing an example of the overall structure of the market trading system relates to the present invention.

Trading market system shown in FIG. 1 has the order server 1, the terminal apparatus 2, the market data providing server 3 and the market trading server 4.

The market trading server 4 is the computer system manages trading of stocks, credits and foreign exchanges at securities exchange and the like.

The market trading server 4 executes buying and selling according to the ordering data sent from the order server 1 of the securities company, FX broker and the like, and sends the result of trading as contracted information to the order server 1.

The market data providing server 3 is a computer system provides market information obtained from trading stocks etc. on the market trading server 4 as the market price data. The market data providing server 3, for example, connect to the market trading server 4 through the communication network 9, generate the market price data based on the market information obtained from the market trading server 4 in real time, and provide the generated market price data to the order server 1 and the terminal apparatus 2.

The terminal apparatus 2 is a terminal unit of personal computers and mobile phones operated by users to order to sell or buy stocks etc. The terminal apparatus 2 accesses the order server 1 through the communication network 9 such as internet, and send indications to the order server 1 relates to the order to sell or buy.

The order server 1 is a computer system that processes orders from the terminal apparatus 2 of users. For instance, the order server 1 is managed and controlled by securities companies, FX brokers and the like. The order server 1 creates the ordering data to order buying and selling according to the indication of orders such as limit order, stop order, market order and so on send from the terminal apparatus 2 via the communication network 9, and send the ordering data to the market trading server 4. When the buying and selling corresponding to the ordering data is contracted, the order server 1 accesses the server to manage accounts (not shown) and instructs process of the deposit and payment in the customer account based on the information such as contracted price received from the server.

In addition, the order server 1 has the basic function to order buying and selling to the market trading server 4 according to the demand of the terminal apparatus 2, and also has the function to support automatic trading. For example, the order server 1 performs processes to automatically determine the price of stop order (may be simply stated as ‘price of stop order’ in this specification.) of buying and selling based on the market price data supplied from the market data providing server 3.

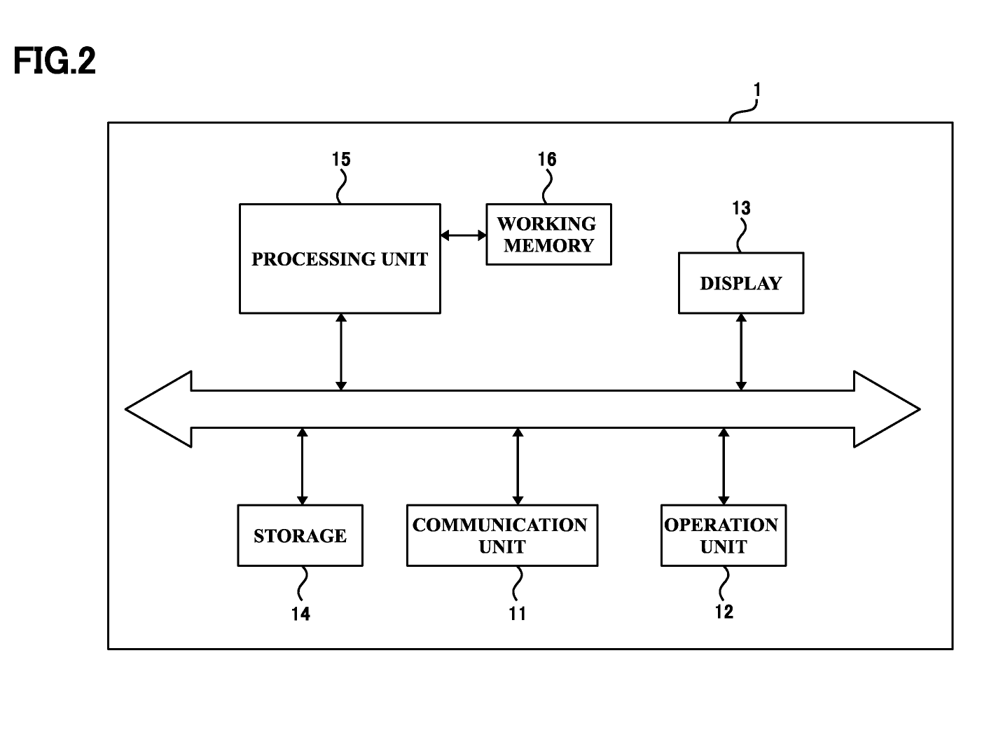

FIG. 2 is a drawing showing an example of hardware structure of the order server 1. The order server 1 shown in FIG. 2 has the communication unit 11, the operation unit 12, the display 13, the storage 14, the processing circuit 15 and the working memory 16. The communication unit 11, the operation unit 12, the display 13, the storage 14 and the processing circuit 15 are connected through an internal bus.

The communication unit 11 sends and receives information such as the order information and the market price data by communicating with the terminal apparatus 2 and the market trading server 3 via the network 9 such as internet.

The operation unit 12 is a user interface to input orders and indications by users composed of the keyboard, mouse, and touch screen for instance. The display 13 displays the screen corresponding to the display signal generated in the processing circuit 15.

The storage 14 is a device to memorize programs and data to run the processes at the processing circuit 15, for example, comprised non-volatile memory such as hard discs and flash ROM and storage with relatively large capacity such as magneto optic disc unit.

The working memory 16 is a device to memorize program codes to be executed in the processing circuit 15 and data to be used temporarily in the course of processing, comprised memory unit with relatively high speed storage such as DRAM and SRAM.

The processing circuit 15 is a circuit to execute processes in accordance with a program in the storage 14 and generally controls the overall operation of the terminal apparatus 2. The processing circuit 15 executes program instructions in order while memorizing properly the raw data and the data to be processed.

The order server 1, for example, is feasible by the computer with hardware mentioned in FIG. 2, also May be implemented by combination with multiple computers.

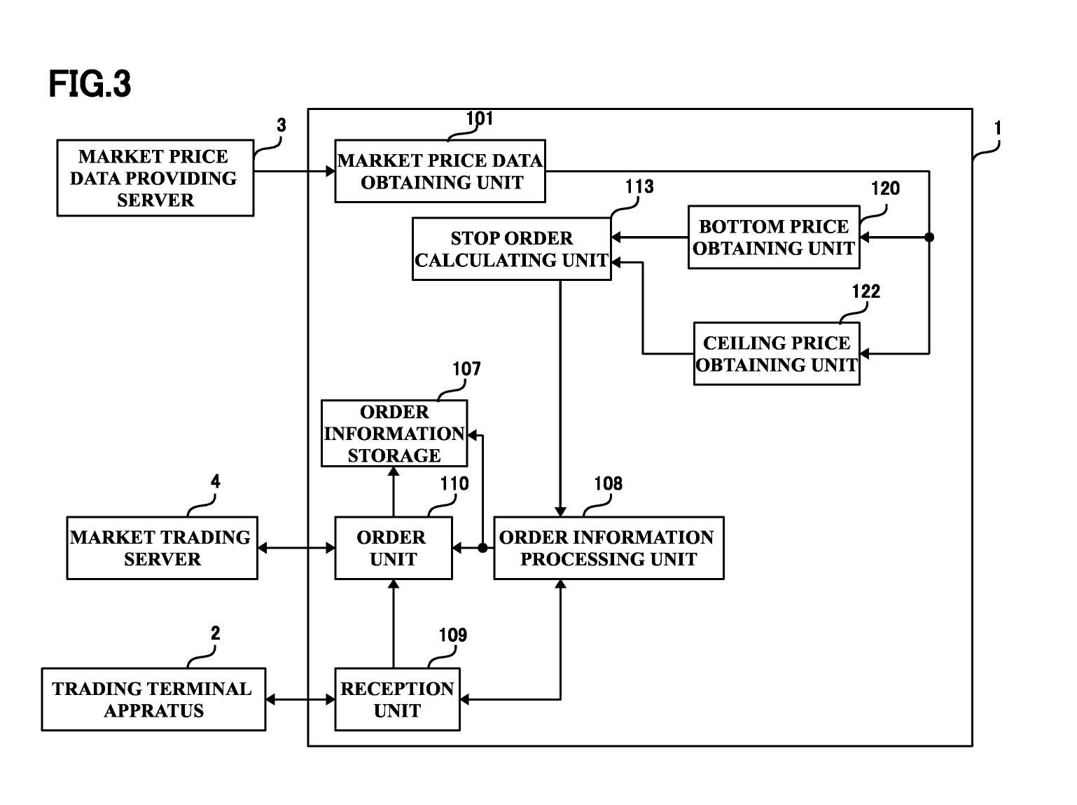

FIG. 3 is a drawing showing an example of structure of the order server 1 can be implemented by cooperating elements of each hardware and programs mentioned in FIG. 2.

The order server 1 shown in FIG. 3 has the market price data obtaining unit 101, the order information storage 107, the order information processing unit 108, the reception unit 109, the order unit 110, the stop order calculating unit 113, the bottom price obtaining unit 120 and the ceiling price obtaining unit 122.

[Market Price Data Obtaining Unit 101]

The market price data obtaining unit 101 accesses the market data providing server 3 through communication network 9, and successively obtains the market price data indicating the rate of stock and exchange constantly changing in the exchange market from the market data providing server 3.

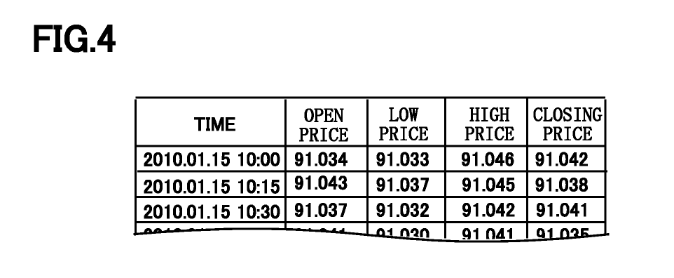

FIG. 4 is a drawing shows an example of the market price data obtained by the market price data obtaining unit 101. In the example of FIG. 4, the one market price data includes the data indicates the prices of the highest, the lowest, the opening and the closing, and the time of its starting point. The market price data obtaining unit 101 obtains the market price data contains the market price information within a given time in predetermined time intervals (15 min in the example of FIG. 4).

Furthermore, the market price data obtaining unit 101 may generate the market price data includes the highest and the lowest prices in predetermined time intervals as shown in the example in FIG. 4 based on the market price data provided from the market data providing server 3 sequentially.

[Bottom Price Obtaining Unit 120]

The bottom price obtaining unit 120 obtains the bottom price of the market price in a period of temporary decline in between updates of the heist price based on the market data obtained sequentially from the market price data obtaining unit 101. In other words, the bottom price obtaining unit 120 obtains the bottom price of the market price in the temporary decline period, when the market price declines temporarily after update of a highest price and again updates the highest price. The bottom price obtaining unit 120 obtains the bottom price of the market price when a temporary decline period finishes and the highest price is updated.

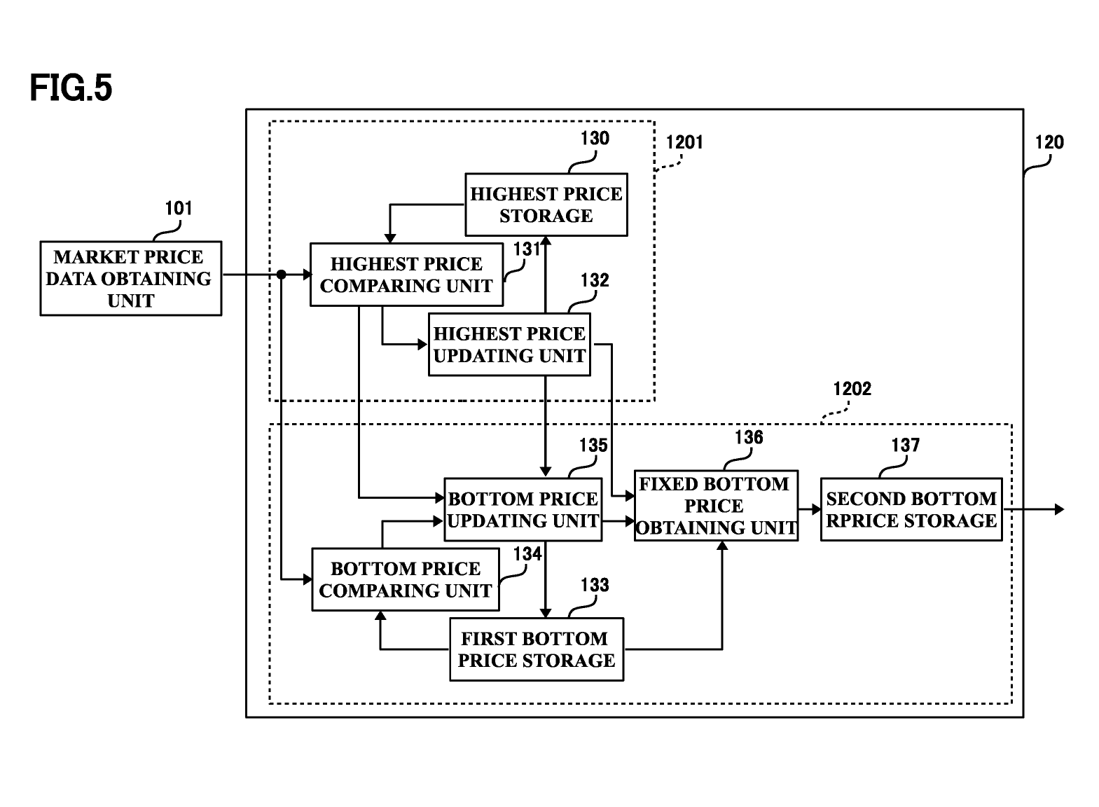

FIG. 5 is a drawing showing an example of the structure of the bottom price obtaining unit 120. The bottom price obtaining unit 120 shown in FIG. 5 includes the highest price processing unit 1201 and the bottom price processing unit 1202.

The highest price processing unit 1201 compares the highest price of the market price previously stored and the latest market price. When the latest market price is higher than the highest price of the market price previously stored, the latest market price is stored as the new highest price.

After a new highest price is stored in the highest price processing unit 1201, and in case where a first market price compared with the new highest price is judged lower than the new stored highest price by the highest price processing unit 1201, the bottom price processing unit 1202 stores the first market price as a provisional bottom price. Then, until the next new highest price is stored in the highest price processing unit 1201, the bottom price processing unit 1202 compares the latest market price shown in the market price data obtained in market price data obtaining unit 101 with the provisional bottom price. The bottom price processing unit 1202 stores the latest market price as a new provisional bottom price when the latest market price is lower than the provisional bottom price. In addition, the bottom price processing unit 1202 judges whether or not the market price shifts from the condition of lower than the highest price to the condition of higher than the highest price based on the result of comparison between the market price and the highest price by the heist price processing unit 1201 (In other words, judgment whether the period of temporary decline is ended or not). The bottom price processing unit 1202 obtains the provisional bottom price as fixed bottom price in the temporary decline period when the market price is judged to shift from the condition of lower than the highest price to the condition of higher than the highest price.

As shown in FIG. 5, the highest price processing unit 1201 comprises the highest price storage 130, the highest price comparing unit 131 and the highest price updating unit 132. The bottom price obtaining unit 120 comprises the first bottom price storage 133, the bottom price comparing unit 134, the bottom price updating unit 135, the fixed bottom price obtaining unit 136 and the second bottom price storage 137.

The highest price storage 130 stores the highest price shown in the market price data obtained from the market price data obtaining unit 101.

The highest price comparing unit 131 compares the latest market price shown in the market price data obtained from the market price data obtaining unit 101 and the highest price of the highest price storage 130. For example, the highest price comparing unit 131 compares the highest market price (FIG. 4) included in the latest market price data and the highest price of the highest price storage 130.

In addition, the highest price comparing unit 131 holds the Flag f1 indicating whether or not the market price is cheaper than the highest. In other words, the highest price comparing unit 131 set the Flag f1 to [1] when the latest market price is lower than the highest price of the highest price storage 130, the Flag f1 is reset to [0] when the latest market price is higher than the highest price of the highest price storage 130. Consequently, temporary decline in the period between the update of the highest price, the Flag f1 is set to [1].

The highest price updating unit 132 stores the latest market price as a new highest price to the highest price storage 130, when the latest market price is judged by the highest price comparing unit 131 as higher than the highest price of the highest price storage 130. For instance, the highest price updating unit 132 stores the highest price of the relevant latest market price as a new highest price to the highest price storage 130 when the highest price of the latest market price in the market price data (FIG. 4) is judged by highest price comparing unit 131 as higher than the highest price of the highest price storage 130.

The first bottom price storage 133 and the second bottom price storage 137 stores the bottom price of the market price shown in market data obtained by the market price data obtaining unit 101 during updating the highest price by the highest price updating unit 132 (the period of temporary a decline).

The first bottom price storage 133 temporarily stores the bottom price in the temporary decline period during updating the highest price. The second bottom price storage 137 stores the bottom price determined at the end of the period of temporary decline.

The bottom price comparing unit 134 compares the latest market price shown in the market price data obtained from the market price data obtaining unit 101 and the lowest price (provisional lowest price) of the first bottom price storage 133. For instance, the bottom price comparing unit 134 compares the lowest market price (FIG. 4) included in the latest market price data and the lowest price of the first bottom price storage 133.

The bottom price updating unit 135 stores the lowest price (the bottom price) of the market price data obtained from the market price data obtaining unit 101, between the update of the highest price by the highest price updating unit 132, to the first bottom price storage 133.

In other words, the bottom price updating unit 135 stores the first market price as a provisional bottom price to the first bottom price storage 133 in case where the first market price compared after the update of the he highest price by the highest price updating unit 132 is judged cheaper than the highest price of the highest price storage 130 by the highest price comparing unit 131. Namely, the initial value of the market price in the temporary decline period is stored. Then, in case where the latest market price shown in the market price data obtained in the market price data obtaining unit 101 is judged lower than the bottom price of the first bottom price storage 133 by the bottom price comparing unit 134, until the highest price is updated by the highest price updating unit 132 again, the bottom price updating unit 135 stores the latest market price as a provisional bottom price to the first bottom price storage 133.

For example, the bottom price updating unit 135 stores the first lowest market price (FIG. 4) as a provisional bottom price to the first bottom price storage 133 in case where the first highest market price (FIG. 4) compared after the update of the highest price by the highest price updating unit 132 is judged lower than the highest price of the highest price storage 130. Moreover, in case where the latest lowest market price shown in the market price data (FIG. 4) obtained in the market price data obtaining unit 101 is judged lower than the bottom price of the first bottom price storage 133 by the bottom price comparing unit 134, until the highest price is updated by the highest price updating unit 132 again, the bottom price updating unit 135 stores the latest lowest market price as a provisional bottom price to the first bottom price storage 133.

The fixed bottom price obtaining unit 136 judges the change of the market price for the highest price based on the result of the highest price comparing unit 131. For instance, the fixed bottom price obtaining unit 136 judges whether the market price is shifted from the condition of lower than the highest price to the condition of higher than the highest price based on the flag f1 maintained in the highest price comparing unit 131. The fixed bottom price obtaining unit 136 stores the provisional bottom price stored in the first bottom price storage 133 as the bottom price determined in the temporary decline period to the second bottom price storage 137 when the market price is determined that shifted from the condition of lower than the highest price to the condition of higher than the highest price (Flag f1 is changed from [1] to [0]).

Hereinbefore, the bottom price obtaining unit 120 is explained in detail.

[Ceiling Price Obtaining Unit 122]

Return to FIG. 3.

The ceiling price obtaining unit 122 obtains the ceiling price of the market price in a period of temporary rise in between updates of lowest price based on the market data obtained sequentially from the market price data obtaining unit 101. In other words, the ceiling price obtaining unit 122 obtains the ceiling price of the market price in the temporary rise period, when the market price rises temporarily after update of a lowest price and again updates the lowest price. The ceiling price obtaining unit 122 obtains the ceiling price of the market price when a temporary rise period finishes and the lowest price is updated.

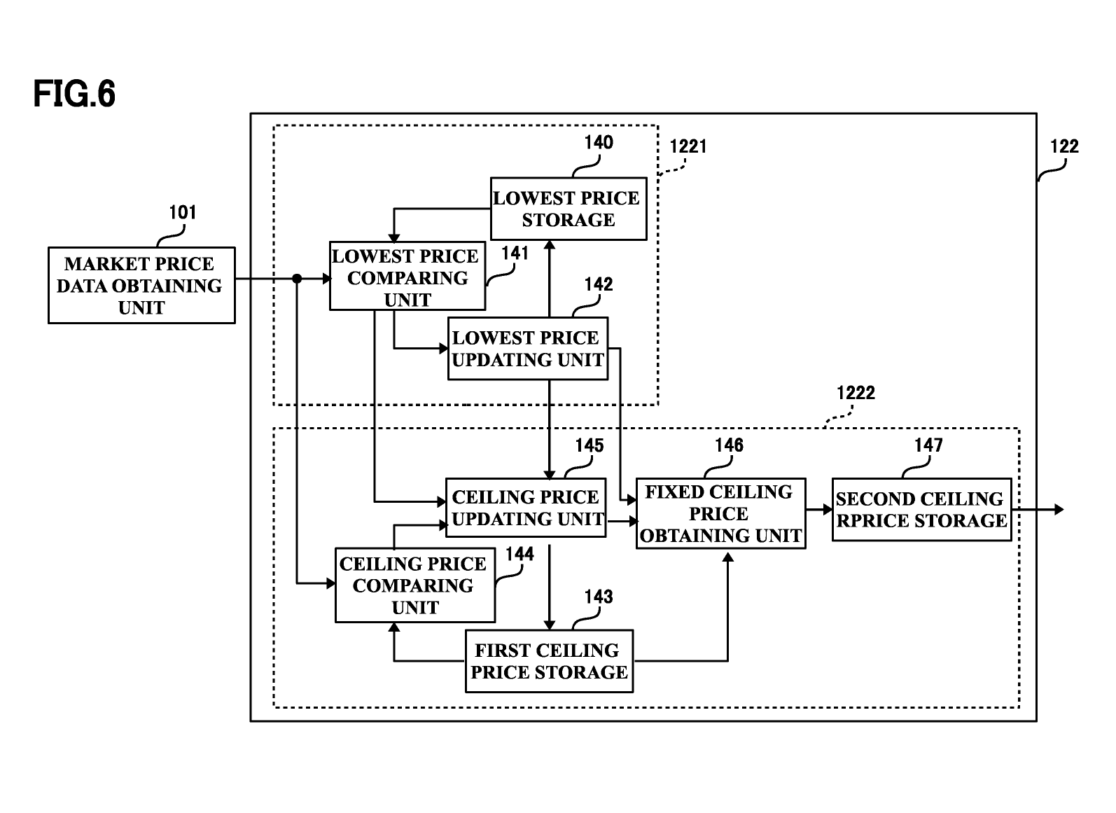

FIG. 6 is a drawing showing an example of the structure of the ceiling price obtaining unit 122. The ceiling price obtaining unit 122 shown in FIG. 6 includes the lowest price processing unit 1221 and the ceiling price processing unit 1222.

The lowest price processing unit 1221 compares the lowest price of the market price previously stored and the latest market price. When the latest market price is lower than the lowest price of the market price previously stored, the latest market price is stored as the new lowest price.

After a new lowest price is stored in the lowest price processing unit 1221, and in case where a first market price compared with the new highest price is judged higher than the new stored lowest price by the lowest price processing unit 1221, the ceiling price processing unit 1222 stores the first market price as a provisional ceiling price. Then, until the next new lowest price is stored in the lowest price processing unit 1221, the ceiling price processing unit 1222 compares the latest market price shown in the market price data obtained in market price data obtaining unit 101 with the provisional bottom price. In addition, the ceiling price processing unit 1222 judges whether or not the market price shifts from the condition of lower than the lowest price to the condition of higher than the lowest price based on the result of comparison between the market price and the highest price by the lowest price processing unit 1221 (In other words, judgment whether the period of temporary rise is ended or not). The ceiling price processing unit 1222 obtains the provisional ceiling price as fixed ceiling price in the temporary rise period when the market price is judged to shift from the condition of higher than the lowest price to the condition of lower than the lowest price.

The lowest price processing unit 1221 in the example of FIG. 5 has the lowest price storage 140, the lowest price comparing unit 141 and the lowest price updating unit 142. Moreover, the ceiling price processing unit 1222 has the first ceiling price storage 143, the ceiling price comparing unit 144, the ceiling price updating unit 145, the fixed ceiling price obtaining unit 146 and the second ceiling price storage 147.

The lowest price storage 140 stores the lowest price shown in the market price data obtained from the market price data obtaining unit 101.

The lowest price comparing unit 141 compares the latest market price shown in the market price data obtained from the market price data obtaining unit 101 and the lowest price of the lowest price storage 140. For example, the lowest price comparing unit 141 compares the lowest market price (FIG. 4) included in the latest market price data and the lowest price of the lowest price storage 140.

Moreover, the lowest price comparing unit 141 has the flag f2 indicating whether or not the market price is higher than the lowest. In other words, the lowest price comparing unit 141 set the flag 12 to [1] when the latest market price is higher than the lowest price of the lowest price storage 140, the flag f2 is reset to [0] when the latest market price is lower than the lowest price of the lowest price storage 140. Consequently, temporary rise in the period in between the market price update the lowest price, the flag f2 is set to [1].

The lowest price updating unit 142 stores the latest market price as a new lowest price to the lowest price storage 140, when the latest market price is judged by the lowest price comparing unit 141 as lower than the lowest price of the lowest price storage 140. For instance, the lowest price updating unit 142 stores the lowest price of the relevant latest market price as a new lowest price to the lowest price storage 140 when the lowest price of the latest market price in the market price data (FIG. 4) is judged by lowest price comparing unit 141 as lower than the lowest price of the lowest price storage 140.

The first ceiling price storage 143 and the second ceiling price storage 147 stores the ceiling price of the market price shown in market data obtained by the market price data obtaining unit 101 during updating the lowest price by the lowest price updating unit 142 (the period of temporary rise).

The first ceiling price storage 143 temporarily stores the ceiling price in the temporary rise period during updating the lowest price. The second ceiling price storage 147 stores the ceiling price determined at the end of the period of temporary rise.

The ceiling price comparing unit 144 compares the latest market price shown in the market price data obtained from the market price data obtaining unit 101 and the ceiling price of the first ceiling price storage 143 (provisional ceiling price). For example, the ceiling price comparing unit 144 compares the highest market price (FIG. 4) included in the latest market price data and the ceiling price of the first ceiling price storage 143.

The ceiling price updating unit 145 stores the highest price (the ceiling price) of the market price data obtained from the market price data obtaining unit 101, between the update of the highest price by the lowest price updating unit 142, to the first ceiling price storage 143.

In other word, the ceiling price updating unit 145 stores the first market price as a provisional ceiling price to the first ceiling price storage 143 in case where the first market price compared after the update of the lowest price updating unit 142 is judged higher than the lowest price of the lowest price storage 140 by the lowest price comparing unit 141. Namely, the initial value of the market price in the temporary rise period is stored. Then, in case where the latest market price shown in the market price data obtained in the market price data obtaining unit 101 is judged higher than the ceiling price of the first ceiling price storage 143 by the ceiling price comparing unit 144, until the lowest price is updated by the lowest price updating unit 142 again, the ceiling price updating unit 145 stores the latest market price as a provisional ceiling price to the first ceiling price storage 143.

For example, the ceiling price updating unit 145 stores the first highest market price (FIG. 4) as a provisional ceiling price to the first ceiling price storage 143 in case where the first lowest market price (FIG. 4) compared after the update of the highest price by the lowest price updating unit 142 is judged higher than the lowest price of the lowest price storage 140. Moreover, in case where the latest highest market price shown in the market price data (FIG. 4) obtained in the market price data obtaining unit 101 is judged higher than the ceiling price of the first ceiling price storage 143 by the ceiling price comparing unit 144, until the lowest price is updated by the lowest price updating unit 142 again, the ceiling price updating unit 145 stores the latest highest market price as a provisional ceiling price to the first ceiling price storage 143.

The fixed ceiling price obtaining unit 146 judges the change of the market price for the lowest price based on the result of the lowest price comparing unit 141. For instance, the fixed ceiling price obtaining unit 146 judges whether the market price is shifted from the condition of higher than the lowest price to the condition of lower than the lowest price based on the flag f2 maintained in the lowest price comparing unit 141. The fixed bottom price obtaining unit 136 stores the provisional ceiling price stored in the first ceiling price storage 143 as the ceiling price determined in the temporary rise period to the second ceiling price storage 147 when the market price is determined that shifted from the condition of higher than the lowest price to the condition of lower than the lowest price (Flag f2 is changed from [1] to [0]).

Hereinbefore, the bottom price obtaining unit 120 is explained in detail.

[Stop Order Calculating Unit 113]

Return to FIG. 3.

The stop order calculating unit 113 calculates the selling price in order to make a stop order (may be simply stated as [sell order price of stop order] in this specification), and the buying price in order to make a stop order (may be simply stated as [buy order price of stop order] in this specification).

For instance, the stop order calculating unit 113 calculates the sell order price of stop order in the mode of calculate the price of the stop order set in order to cut loss of short position (Loss cut mode of short position). Also, the stop order calculating unit 113 calculates the buy order price of stop order in the mode of calculate the price of the stop order set in order to cut loss of long position (Loss cut mode of long position).

The mode of processing in the stop order calculating unit 113 in the present embodiment may be selected optionally according to the instruction from the user of the terminal apparatus 2.

For example, when the order server 1 receives an instruction from the terminal apparatus 2 of users with the long positions to select the loss cut mode of short position, move the stop order calculating unit 113 as a loss cut mode of short position. When the order server 1 receives an instruction from the terminal apparatus 2 of users with the short positions to select the loss cut mode of long position, move the stop order calculating unit 113 as a Loss cut mode of long position.

When the stop order calculating unit 113 operates in loss cut mode of short position, the stop order calculating unit 113 calculates the sell order price of the stop order based on the fixed bottom price in the temporary decline period obtained in the bottom price obtaining unit 120. For instance, the stop order calculating unit 113 calculates the price cheaper by a given price than the prefixed bottom price as sell order price of stop order. In other examples, the stop order calculating unit 113 may calculate the price cheaper by a given percentage than the prefixed bottom price as a sell order price of stop order.

On the other hand, the stop order calculating unit 113 operates in loss cut mode of long position, the stop order calculating unit 113 calculates the buy order price of the stop order based on the fixed ceiling price in the temporary rise period obtained in the ceiling price obtaining unit 122. For instance, the stop order calculating unit 113 calculates the price higher by a given price than the prefixed ceiling price as buy order price of stop order. In other examples, the stop order calculating unit 113 may calculate the price higher by a given percentage than the prefixed ceiling price as buy order price of stop order.

Moreover, in loss cut mode of short position, ‘given price’ the stop order calculating unit 113 subtracts from the bottom price and ‘given percentage’ determine the percentage of the reduction from the bottom price may be fixed for all users or customized freely by each user.

[Order Information Storage 107]

The 107 stores the information about buy-sell orders confirmed at the order server 1. The information about the buy-sell orders confirmed includes the information about stop order mentioned above, and the information of buying and selling completed (contracted).

[Order Information Processing Unit 108]

The order information processing unit 108 generates the order information indicates contents of the order to order to the market trading server 4 in response to an output from the terminal apparatus 2 of users received in reception unit 109. And the order information processing unit 108 stores the information to the order information storage 107. The order information includes the identification number of the users, type of order (sell/buy, market order, limit order, stop order and so on), the price of buying and selling should be enforced, and the price and the number of buying and selling.

In addition, the order information processing unit 108 changes the price of the stop order in the information stored in the order information storage 107 to the calculated price after the price of the stop order is calculated in the stop order calculating unit 113.

However, the order information processing unit 108 does not change the sell order price calculated in stop order calculating unit 113 from the selling price if the sell order price of the stop order calculated in the stop order calculating unit 113 is lower than the sell order price of the stop order stored in the order information storage 107.

Moreover, also the order information processing unit 108 do not change the buy order price calculated in stop order calculating unit 113 from the buying price if the buy order price of the stop order calculated in the stop order calculating unit 113 is higher than the buy order price of the stop order stored in the order information storage 107.

In other words, the order information processing unit 108 prohibit to reduce the sell order price of stop order than present price or to raise the buy order price of stop order than present price. Increase in losses is prevented when the stop order is executed.

[Reception Unit 109]

The reception unit 109 communicates with the terminal apparatus 2 of users via the communication network 9. For instance, the reception unit 109 has the function as a web server, communicates the data of webpages, such as HTML data, by using predetermined protocol such as web browser and HTTP of the terminal apparatus. In other words, the reception unit 109 generates screen display data such as HTML data and sends to the terminal apparatus 2 to display screens related to the various transactions at display of the terminal apparatus 2. For example, the screen to enter authentication information for users to log into the system, the screen to display charts of the market price, the screen to set the terms and conditions, and the screen to display order history and contracted history in the past. The reception unit 109 receives information entered in these screens from the terminal apparatus 2.

[Order Unit 110]

The order unit 110 send the ordering data to place buy-sell orders to the market trading server 4, and receive the information about the result of buying and selling executed in accordance with the ordering data (contracted information) from the market trading server 4 based on the ordering data stored in the order information storage 107. The contracted information includes information such as identification code of the users, identification code for orders, results of order acceptance (notification of whether acceptance is confirmed), and the execution result of order (contract price, date, amount and so on). The order unit 110 adds aforementioned information to the ordering information of the order information storage 107.

Specifically, the order unit 110 generates the ordering data of stop order to buy or sell, and send the ordering data to the market trading server 4 in case where the latest market price shown in the market price data reaches the price of stop order specified in the information stored in the order information storage 107. In other words, the order unit 110 generates the ordering data to sell in case where the latest market price shown in the market price data gets lower than sell order price of the stop order specified in memory information in the order information storage 107. Moreover, the order unit 110 generates the ordering data to buy in case where the latest market price shown in the market price data gets higher than buy order price of the stop order specified in memory information in the order information storage 107.

Hereinafter, Movement for determining the price of the stop order in the order server 1 in aforementioned market trading system will be described. Loss cut mode of short position and loss cut mode of long position will be explained separately.

(Loss Cut Mode of Long Position)

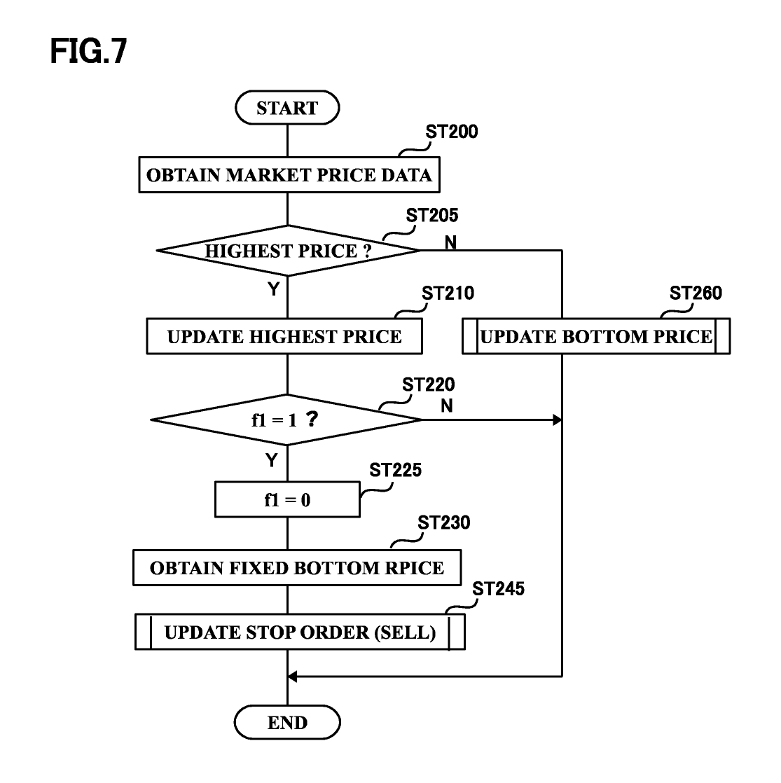

FIG. 7 is a flowchart to explain movement of determining the price of sell order of the stop order for the loss cut mode of long position.

After the market price data obtained in the market price data obtaining unit 101 (ST200), the highest price comparing unit 131 compares the previous highest price stored in the highest price storage 130 and the latest market price in the market price data (ST205). If the latest market price is higher than the highest price, the highest price updating unit 132 stores the market price as a new highest price to the highest price storage 130 (ST210).

On the other hand, in case where the latest market price is lower than the highest price, the process of updating the bottom price stored in the first bottom price storage 133(ST260) is executed due to the period of temporary decline in the market price.

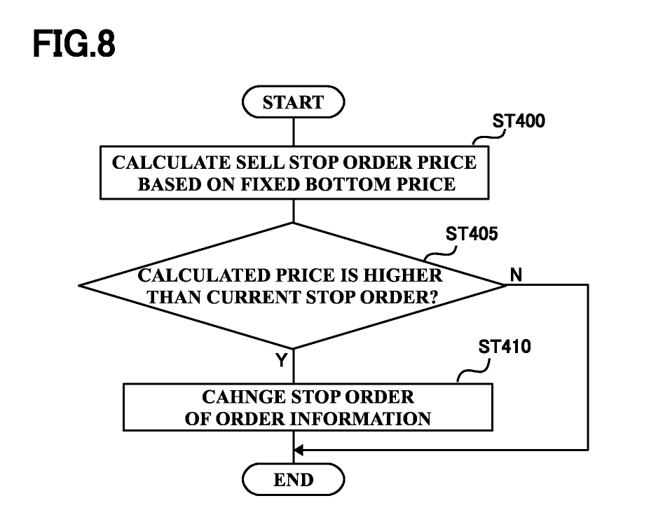

FIG. 8 is a flowchart to explain the update process of the bottom price (ST260: FIG. 7).

In case where the flag F1, indicates the period of temporary decline, is set to [0] (ST420), the bottom price updating unit 135 set the flag f1 to [1] (ST425) and stores the latest market price to the first bottom price storage 133 as an initial value of provisional bottom price. On the other hand, in case where the flag f1 is set to [1], the bottom price comparing unit 134 compares the bottom price of the first bottom price storage 133 and the latest market price (ST435). In the result of comparison, when the latest market price is lower than the current bottom price, the bottom price updating unit 135 stores the latest market price to the first bottom price storage 133 as an initial value of provisional bottom price (ST430).

Return to FIG. 7. In case where the new highest price is stored in the highest price storage 130 by the highest price updating unit 132 (ST210), the fixed bottom price obtaining unit 136 refers to the flag f1 indicating whether or not the market price is cheaper than the highest price (ST220). In case where the Flag 11 is set to [1], the market price is deemed to be shifted from the condition of lower than the highest price to the condition of higher than the highest price (the period of temporary decline has ended), therefore the fixed bottom price obtaining unit 136 obtains the bottom price stored in the first bottom price storage 133 as a the prefixed bottom price of the period of temporary decline, and stores to the second bottom price storage 137 (ST230). Furthermore, the highest price comparing unit 131 reset the flag f1 to [0] as the condition of the market price shifts higher than the highest price (ST225).

When the bottom price is obtained in the fixed bottom price obtaining unit 136, the stop order calculating unit 113 calculates sell order price of stop order based on the obtained bottom price. The order information processing unit 108 updates the price of stop order calculated by stop order calculating unit 113 from the price stored in the order information storage 107 (ST25).

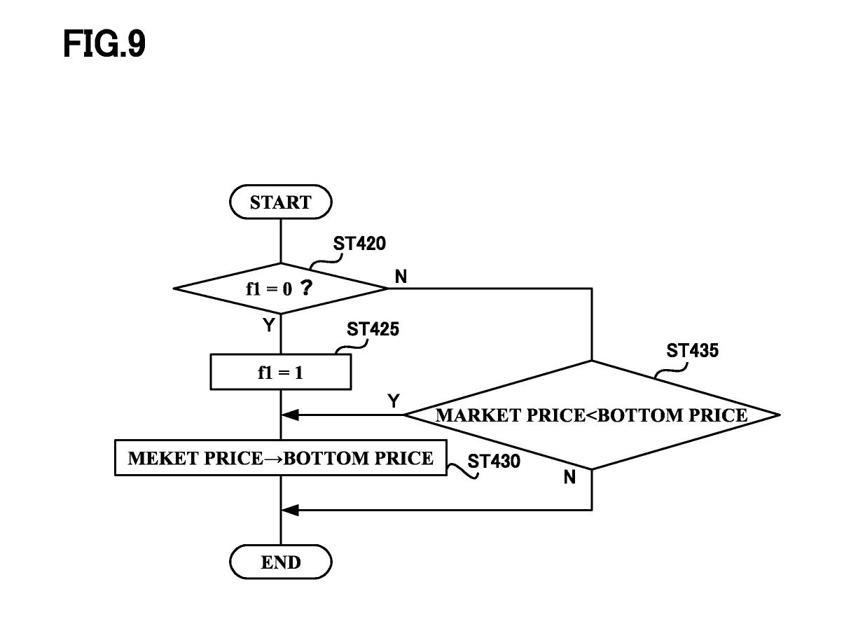

FIG. 9 is a flowchart to explain the process of updating the price of sell order of the stop order (ST245:FIG. 7).

The stop order calculating unit 113 calculates sell order price of stop order based on the fixed bottom price stored in the second bottom price storage 137 (ST400). For instance, the stop order calculating unit 113 calculates the result of subtracting a given price from the bottom price as sell order price of stop order.

Then, the order information processing unit 108 compares the price of stop order calculated by the stop order calculating unit 113 and the price of stop order of memory information in the order information storage 107 (ST405).When the sell order price of stop order calculated is higher than the sell order price of stop order decided, the order information processing unit 108 changes the price of stop order of memory information in the order information storage 107 to the price of stop order calculated (ST410). On the other hand, when the sell order price of stop order calculated is lower than the sell order price of stop order decided, the order information processing unit 108 does not update the price of stop order. As for the reason, the amount of loss increases when the stop order is placed if the sell order price of stop order set cheaper.

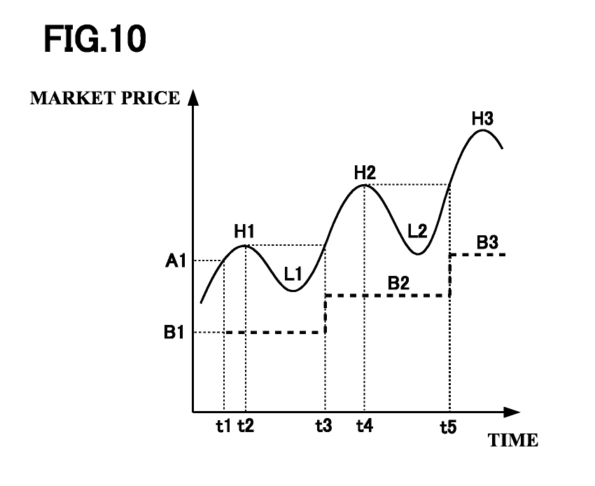

FIG. 10 is a drawing showing an example of changes in the price of sell order of the stop order determined by the order server 1.

In the example of FIG. 10, the buy order of the price A1 is contracted at the time t1, and the sell order price of stop order is set at the price B1 cheaper than the price A1. The market price shows an uptrend as a whole, the market price repeats a transition of peak and valley floor (H1, L1, H2, L2, H3 . . . ) in the shorter period.

Hereinafter, the market price changes from the highest price to the temporary decline price such as [H1], [H2] and [H3] is called [the peak price] on uptrend.

The bottom price obtaining unit 120 stores the lowest price after time t2 as a provisional bottom price when the market price declines temporary after reaches the peak price H1. The lowest price L1 is determined in the period of time t2 to time t3 when the market price exceeds the peak price at the time t3. The lowest price L1 is equal to the prefixed bottom price obtained in bottom price obtaining unit 120 at the time t3. The stop order calculating unit 113 calculates new sell order price of stop order B2 based on the prefixed bottom price (the lowest price L1 within the t2-t3 period of time). In the example of the drawing, the sell order price of stop order B2 is set slightly low price than lowest price L1.

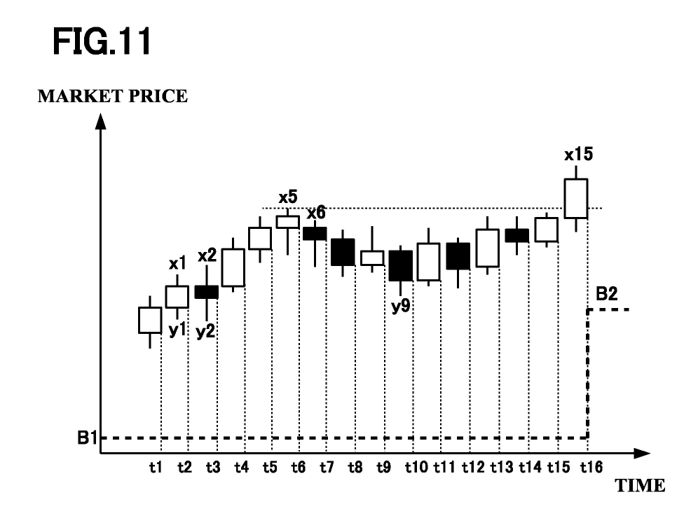

FIG. 11 is a drawing to explain an example of determining the price of sell order of the stop order based on the highest and the lowest price of the market price data.

In FIG. 11, the symbol called “candlestick” expresses the highest, the lowest, the opening and the closing price within a certain period. In the white rectangle, the bottom side indicates the opening price, and the upper side indicates the closing price. In the black rectangle, the upper side indicates the opening price, and the bottom side indicates the closing price. The top end of the line thrust out upward from the upper side indicates the highest price, and the bottom end of line thrust out downward from the bottom side indicates the lowest price.

In the example of FIG. 11, the low price at the time t3 is declined compared to the low price 1 at the time t2. However, because of the high price x2 at the time t3 is higher than the high price x1 at the time t2, the low price y2 is not stored as the bottom price, therefore the price of stop order is not changed.

After the highest price x5 is priced at the time t6, the high price of the market price data is lower than the highest price x5 between the time t7 to the time t15, and the high price x15 of the market price data is higher than the high price x5 at the time t16. Therefore, from the time t7 to the time t15 is aforementioned the period of temporary decline. The lowest price (bottom price) in the temporary decline period is the low price y9 at the time t10. The bottom price obtaining unit 120 obtains y9 as a fixed bottom price. After the highest price is updated from x5 to x15 at the time t16, the sell price of stop order B2 is determined based on the bottom price y9 in the temporary decline period (t7-t15)

(Loss Cut Mode of Short Position)

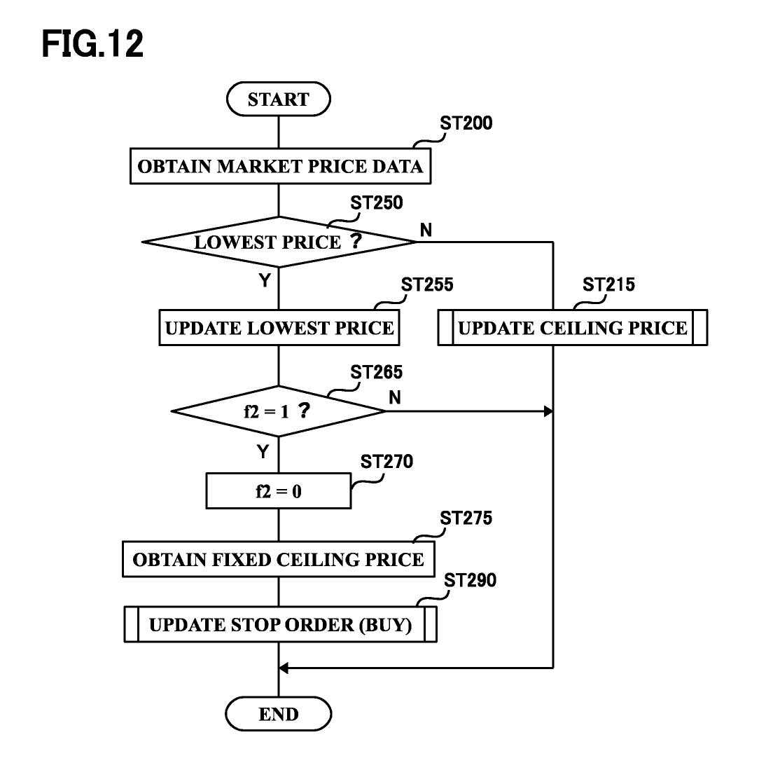

FIG. 12 is a flowchart to explain movement of determining the price of buy order of the stop order for the loss cut mode for short position.

After the market price data obtained in the market price data obtaining unit 101 (ST200), the lowest price comparing unit 141 compares the highest price stored in the lowest price storage 140 and the latest market price in the market price data (ST250). If the latest market price is lower than the lowest price, the lowest price updating unit 142 stores the market price as a new lowest price to the lowest price storage 140 (ST255).

On the other hand, when the latest market price is higher than the lowest price, the market price is in the temporary rise period, the update process of the ceiling price (ST215) stored in the first ceiling price storage 143 is performed.

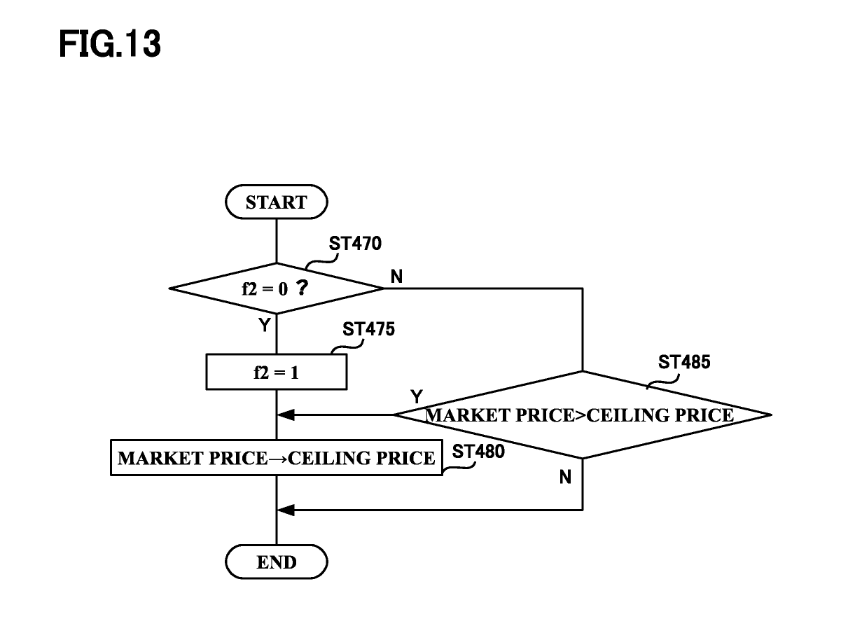

FIG. 13 is a flowchart to explain the process of updating the ceiling price (ST215: FIG. 12).

In case where the flag F2, indicates the period of temporary rise, is set to [0] (ST470), the ceiling price updating unit 145 set the flag f2 to [1] (ST475) and stores the latest market price to the first ceiling price storage 143 as an initial value of provisional ceiling price. On the other hand, in case where the flag F2 is set to [1], the ceiling price comparing unit 144 compares the ceiling price of the first ceiling price storage 143 and the latest market price (ST485). In the result of comparison, when the latest market price is higher than the current ceiling price, the ceiling price updating unit 145 stores the latest market price to the first ceiling price storage 143 as an initial value of provisional ceiling price (ST480).

Return to FIG. 12. In case where the new lowest price is stored in the lowest price storage 140 by the lowest price updating unit 142 (ST255), the fixed ceiling price obtaining unit 146 refers to the flag f2 indicating whether or not the market price is higher than the lowest price (ST265). In case where the Flag f2 is set to [1], the market price is deemed to be shifted from the condition of higher than the lowest price to the condition of lower than the lowest price (the period of temporary rise has ended), therefore the fixed ceiling price obtaining unit 146 obtains the bottom price stored in the first ceiling price storage 143 as a provisional ceiling price of the period of temporary rise, and stores to the second ceiling price storage 147 (ST275). Furthermore, the lowest price comparing unit 141 reset the flag f2 to [0] as the condition of the market price shifts lower than the lowest price (ST270).

When the ceiling price is obtained in the fixed ceiling price obtaining unit 146, the stop order calculating unit 113 calculates buy order price of stop order based on the obtained ceiling price. The order information processing unit 108 updates the price of stop order calculated by stop order calculating unit 113 from the price stored in the order information storage 107 (ST290).

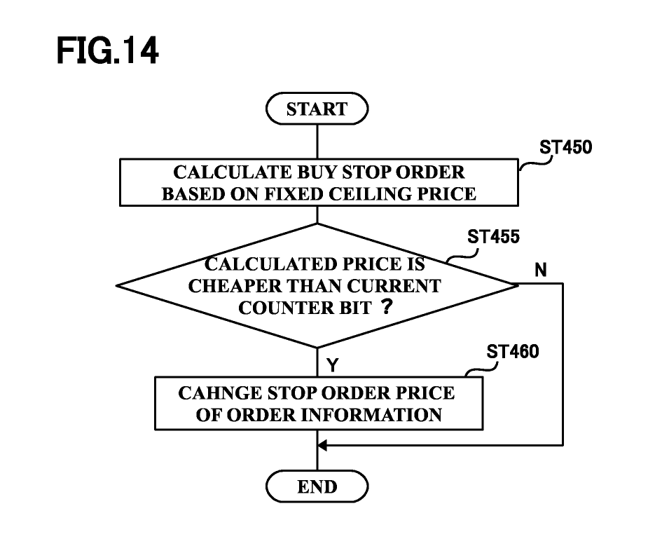

FIG. 14 is a flowchart to explain the process of updating the buy order price of stop order (ST290:FIG. 12).

The stop order calculating unit 113 calculates buy order price of stop order based on the fixed ceiling price stored in the second ceiling price storage 147 (ST450). For instance, the stop order calculating unit 113 calculates the result of adding a given price to the ceiling price as buy order price of stop order.

Then, the order information processing unit 108 compares the price of stop order calculated by the stop order calculating unit 113 and the price of stop order of memory information in the order information storage 107 (ST455). When the buy order price of stop order calculated is lower than the buy order price of stop order decided, the order information processing unit 108 changes the price of stop order of memory information in the order information storage 107 to the price of stop order calculated (ST460). On the other hand, when the buy order price of stop order calculated is higher than the buy order price of stop order decided, the order information processing unit 108 do not update the price of stop order. As for the reason, the amount of loss increases when the stop order is placed if the buy order price of stop order set higher.

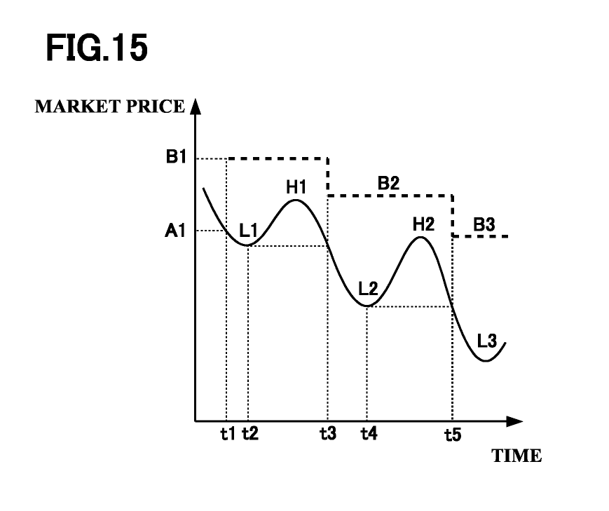

FIG. 15 is a drawing showing an example of changes in the price of sell order of the stop order determined by the order server 1.

In the example of FIG. 15, the sell order of the price A1 is contracted at the time t1, and the buy order price of stop order is set at the price B1 cheaper than the price A1. The market price shows a downtrend as a whole, the market price repeats a transition of peak and valley floor (H1, L1, H2, L2, H3 . . . ) in the shorter period. Hereinafter, the market price changes from the lowest price to the temporary rise price such as [L1], [L2] and [L3] is called [the valley floor price] on downtrend.

When the market price temporary declines after reaches the valley floor price L1 at the time t2, the ceiling price obtaining unit 122 stores the highest price after the time t2 as a provisional ceiling price. The highest price H1 within the time t2-t3 period of time (in the temporary rise period) is determined when the market price becomes lower than the valley floor price H1 at the time t3. The highest price H1 is equal to the prefixed ceiling price obtained in ceiling price obtaining unit 122 at the time t3. The stop order calculating unit 113 calculates new sell order price of stop order B2 based on the prefixed ceiling price (the highest price H1 within the time t2-t3). In the example of the drawing, the sell order price of stop order B2 is set slightly higher than the highest price H1.

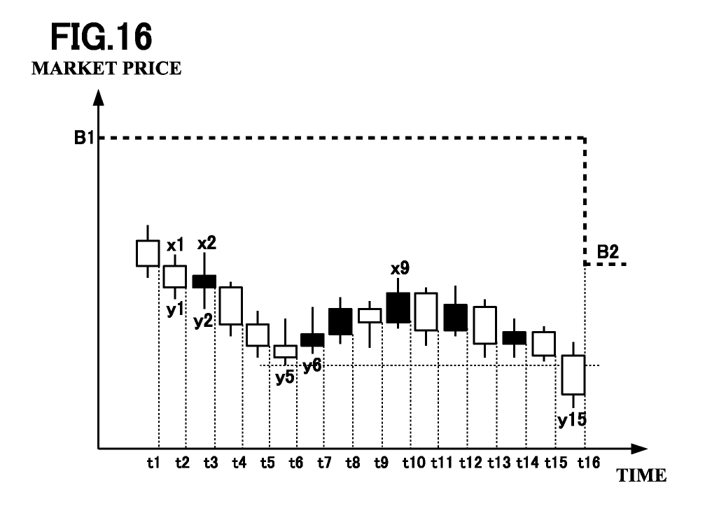

FIG. 16 is a drawing to explain an example of determining the sell order price of stop order based on the highest and the lowest price of the market price data. In FIG. 16, the fluctuations of market prices is indicated by using the candlestick same as FIG. 11.

In the example of FIG. 16, the high price X2 at the time t3 is increased compared to the high price at the time t2. However, because of the low price y2 at the time t3 is lower than the low price y1 at the time t1, the high price x2 is not stored as the ceiling price, therefore the price of stop order is unchanged.

After the lowest price y5 is priced at the time t6, the low price of the market price data is higher than the lowest price y5 between the time t7 to the time t15, and the low price y15 of the market price data is lower than the low price y5 at the time t16. Therefore, from the time t7 to the time t15 is aforementioned the period of temporary rising. The highest price (ceiling price) in the temporary rise period is the high price x9 at the time t10. The ceiling price obtaining unit 122 obtains x9 as a fixed ceiling price. After the lowest price is updated from y5 to y15 at the time t16, the buy price of stop order B2 is determined based on the ceiling price x9 in the temporary rise period (t7-t15).

As explained above, according to the present embodiment, the sell order price of stop order is set based on the lowest price (bottom price) in the temporary decline period when the market price declined from the peak price on uptrend rises again and exceeds to the peak price (FIG. 10). Also, according to the present embodiment, the buy order price of stop order is set based on the highest price (ceiling price) in the temporary rise period when the market price rose to the valley floor price on downtrend declines again and exceeds to the valley floor price (FIG. 14).

Generally, the bottom price in the temporary decline period tends to go up on uptrend market. By setting the sell order price of the stop order based on the bottom price, a wasteful execution case of a sell order at the stop order can be reduced in the temporary declining phase on uptrend.

Furthermore, the ceiling price in the temporary rise period tends to go down on downtrend market. By setting the buy order price of the stop order based on the ceiling price, a wasteful execution case of a buy order at the stop order can be reduced in the temporary rising phase on downtrend.

In this manner, in the present embodiment, compare to conventional trading stop method, the stop order for the loss cut is less likely to executed wastefully, therefore the loss by execution of the order can be reduced.

### The Second Embodiment

Next, the second embodiment of the present invention will be explained.

The order server 1 relate to the present embodiment, in either case of temporary decline in the market price at loss cut mode of long position and temporary boost in the market price at the loss cut mode of short position, do not update of the price of the stop order based on the lowest or highest price if the prescribed condition is not fulfilled.

In other words, the order server 1 relate to the present embodiment do not update the price of the stop order in cases of the range of drop of the market price is smaller than the predetermined value in the temporary decline period. Also, the order server 1 relate to the present embodiment do not update the price of the stop order in cases of the rage of rise of the market price is smaller than the predetermined value in the temporary rise period.

For instance, the bottom price obtaining unit 120 do not obtain the bottom price in the temporary decline period when the calculated range of drop in the temporary decline period is smaller than the predetermined value.

Specifically, when the highest price stored in the highest price processing unit 1201 is updated, the bottom price processing unit 1202 (FIG. 5) calculates range of drop in the temporary decline period of the market price according to the ratio or the differences between the highest price just before the update and the bottom price currently stored. The bottom price processing unit 1202 does not obtain the bottom price in the temporary decline period when the calculated range of drop in the temporary decline period is smaller than the predetermined value.

More specifically, when the highest price is updated in highest price updating unit 132, the fixed bottom price obtaining unit 136 calculates range of drop in the temporary decline period of the market price according to the ratio or the differences between the highest price just before the update and the bottom price stored in the first bottom price storage 133. The fixed bottom price obtaining unit 136 do not store the bottom price of the first bottom price storage 133 to the second bottom price storage 137 as the fixed bottom price when the calculated range of drop in the temporary decline period is smaller than the predetermined value.

In contrast, the ceiling price obtaining unit 122 do not obtain the ceiling price in the temporary rise period when the calculated range of rise in the temporary rise period is smaller than the predetermined value.

Specifically, when the lowest price stored in the lowest price processing unit 1221 is updated, the ceiling price processing unit 1222 (FIG. 6) calculates range of rise in the temporary rise period of the market price according to the ratio or the differences between the lowest price just before the update and the ceiling price currently stored. The ceiling price processing unit 1222 does not obtain the ceiling price in the temporary rise period when the calculated range of rise in the temporary rise period is smaller than the predetermined value.

More specifically, when the lowest price is updated in lowest price updating unit 142, the fixed ceiling price obtaining unit 146 calculates range of rise in the temporary rise period of the market price according to the ratio or the differences between the lowest price just before the update and the ceiling price stored in the first ceiling price storage 143. The fixed ceiling price obtaining unit 146 do not store the bottom price of the first ceiling price storage 143 to the second ceiling price storage 147 as the fixed ceiling price when the calculated range of rise in the temporary rise period is smaller than the predetermined value.

Secondly, the order server 1 relate to the present embodiment do not update the price of the stop order when the duration period of temporary decline and the period of temporary rise are shorter than predetermined time.

For instance, bottom price obtaining unit 120 do not obtain the bottom price in the temporary decline period when the calculated range of drop in the temporary decline period based on the time information included in the market price data is smaller than the predetermined value.

Specifically, the highest price processing unit 1201 stores time information of the market price linked to the highest price. When the highest price stored in the highest price processing unit 1201 is updated, the bottom price processing unit 1202 calculates elapsed time from the time of the highest price before update to the time of the highest price after update based on the time information of the market price data. When elapsed time is shorter than the predetermined time, the bottom price processing unit 1202 does not obtain the bottom price in the temporary decline period.

More specifically, when the highest price stored is updated by the highest price updating unit 132, the fixed ceiling price obtaining unit 146 calculates elapsed time from the time of the highest price before update to the time of the highest price after update based on the time information of the market price data. When elapsed time calculated is shorter than the predetermined time, the fixed ceiling price obtaining unit 146 do not obtain the bottom price in the temporary decline period.

On the other hand, the ceiling price obtaining unit 122 calculates the time in the temporary rise period based on the time information of the market price data. When elapsed time calculated is shorter than the predetermined time, the ceiling price obtaining unit 122 do not obtain the ceiling price in the temporary rise period.

In concrete terms, the lowest price processing unit 1221 stores time information of the market price linked to the lowest price. When the lowest price stored in the lowest price processing unit 1221 is updated, the ceiling price processing unit 1222 calculates elapsed time from the time of the lowest price before update to the time of the lowest price after update based on the time information of market price data. When elapsed time is shorter than the predetermined time, the bottom price processing unit 1202 does not obtain the ceiling price in the temporary rise period.

More specifically, when the lowest price stored is updated by the lowest price updating unit 142, the fixed ceiling price obtaining unit 146 calculates elapsed time from the time of the lowest price before update to the time of the lowest price after update based on the time information. When elapsed time calculated is shorter than the predetermined time, the fixed ceiling price obtaining unit 146 do not obtain the bottom price in the temporary rise period.

Hereinafter, processes of the present embodiment differ from the aforementioned embodiment will be explained. Loss cut mode of short position and loss cut mode of long position will be explained separately.

(Loss Cut Mode of Long Position)

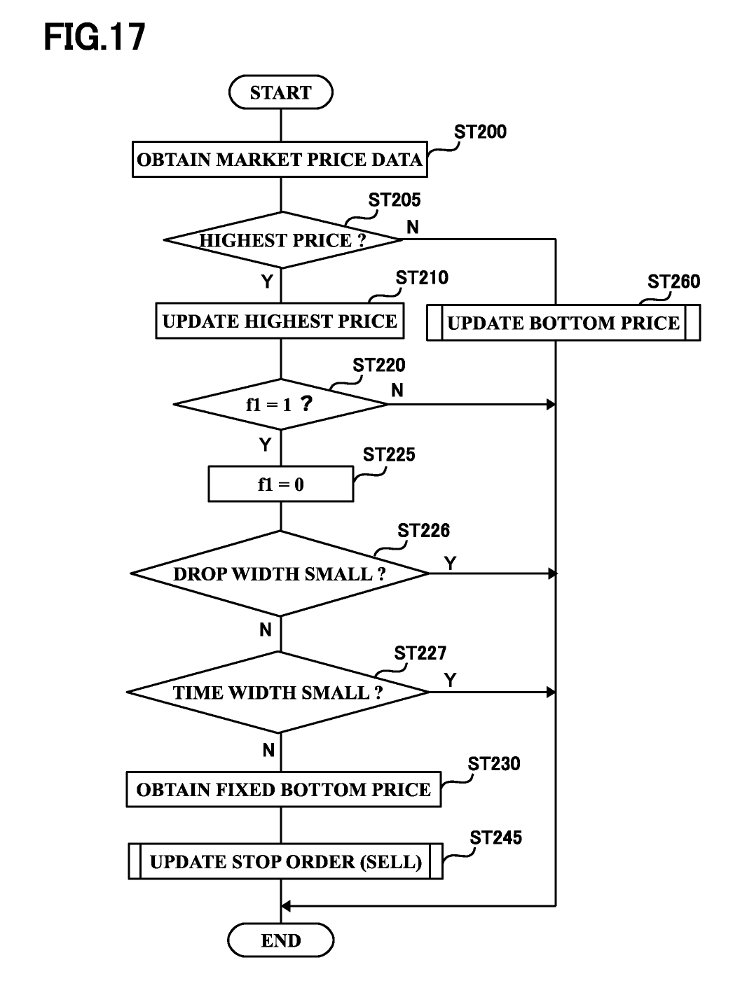

FIG. 17 is a flowchart to explain the movement of determining the price of sells order of the stop order for the loss cut mode of long position.

In comparison with the flowchart of FIG. 7 and FIG. 17, step ST226 and ST227, which flowcharts in aforementioned embodiment do not comprise, were added to the flowchart of the present embodiment.

StepST226:

The fixed bottom price obtaining unit 136 calculates the differences between the bottom price stored in the first bottom price storage 133 and the highest price at a previous time (the highest price just before update in ST210) in case where the highest price is updated by the highest price updating unit 132 (ST210) and the period of temporary decline has finished (Flag f1 is set to [1] in step ST220).

For instance, the highest price updating unit 132 stores the highest price to another storage area in the storage 14 just before the update when the highest price of the highest price storage 130 is updated. The fixed bottom price obtaining unit 136 read the highest price before update from aforementioned storage area, and calculates range of drop by subtracting the bottom price in the first bottom price storage 133 from the highest price read. The fixed bottom price obtaining unit 136 judges whether range of drop is smaller than the predetermined value, the bottom price of the first bottom price storage 133 is not stored to the second bottom price storage 137 as fixed bottom price when range of drop is smaller than the predetermined value. Herewith, the sell order price of stop order stored in the order information storage 107 is unchanged and maintained.

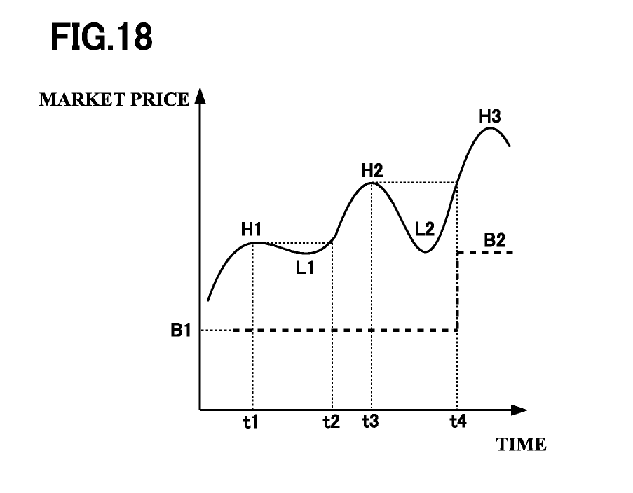

FIG. 18 is a drawing showing an example of not updating the sell order price of stop order when the range of drop in the market price is small in the temporary decline period. In the example of FIG. 18, range of drop from the peak price H1 to the valley floor price L1 at the time t1 is small, the market price shifts almost flatly. At the time t2, the bottom price obtaining unit 120 judges that H1-L1 is smaller than the predetermined range of drop, and discontinues acquiring the valley floor price L1 as fixed ceiling price. Herewith, the sell price of stop order is not calculated, therefore the price of stop orders at the time t2 is maintained.

StepST227:

The fixed bottom price obtaining unit 136 calculates the elapse time from the time highest price previously priced to the time highest price currently priced (the length in the temporary decline period) based on the time information of the market price data in case where the highest price is updated by the highest price updating unit 132 (ST210) and the period of temporary decline has finished (Flag f1 is set to [1] in step ST220).

For instance, the highest price updating unit 132 stores the highest price and the time information together to another storage area in the storage 14 just before the update when the highest price of the highest price storage 130 is updated.

The fixed bottom price obtaining unit 136 read the highest price before update from aforementioned storage area, and calculates the length of the period of temporary decline based on the time information of the highest price read and the time information of highest price of the highest price storage 130. The fixed bottom price obtaining unit 136 judges whether length of the period of temporary decline calculated is shorter than the predetermined value, the bottom price of the first bottom price storage 133 is not stored to the second bottom price storage 137 as fixed bottom price when length of the period of temporary decline is shorter than the predetermined value. Herewith, the sell order price of stop order stored in the order information storage 107 is unchanged and maintained.

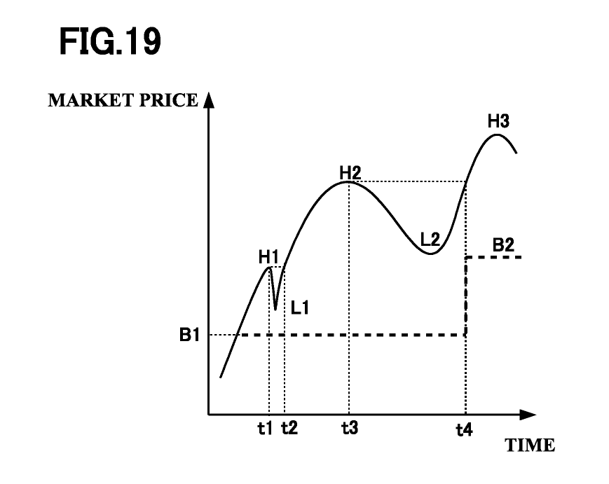

FIG. 19 is a drawing showing an example of not updating the sell order price of the stop order when the period of temporary decline is short.

The market price priced the peak price H1 at the time t1 temporary declined and increased again, and exceeded the peak price H1 at the time t2. However the period of temporary decline from the time t1 to the time t2 becomes exceedingly short. At the time t2, the bottom price obtaining unit 120 judges that t1-t1 is shorter than the predetermined length of time, and discontinues acquiring the valley floor price L1 as fixed bottom price. Herewith, the sell price of stop order is not calculated, therefore the price of stop orders at the time t2 is maintained.

In case where the range of drop is determined as greater than the predetermined value in step ST226 and the duration of the period of temporary decline is determined as longer than the predetermined time in step ST227, the bottom price obtaining unit 120 obtains the fixed bottom price in the temporary decline period (ST230).

(Loss Cut Mode of Short Position)

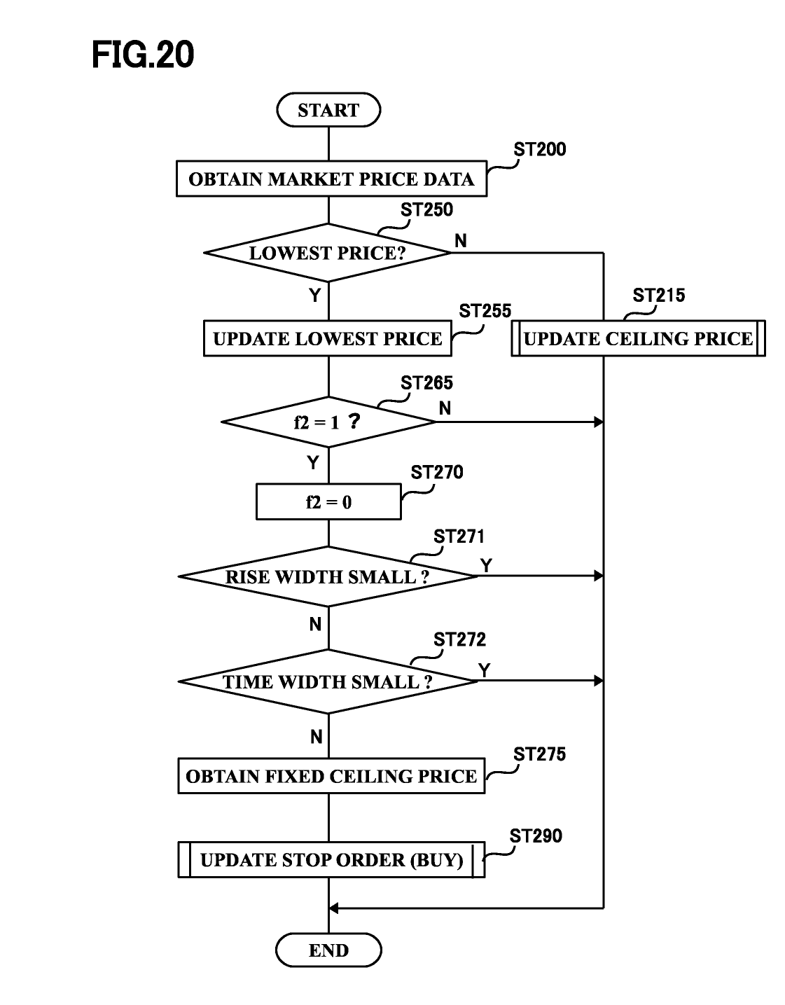

FIG. 20 is a flowchart to explain movement of determining the price of buy order of the stop order at the order server 1 related to the second embodiment.

In comparison with the flowchart of FIG. 12 and FIG. 20, step ST271 and ST272, which flowcharts in aforementioned embodiment do not comproses, were added to the flowchart of the present embodiment.

Step ST271:

The fixed ceiling price obtaining unit 146 calculates the differences between the ceiling price stored in the first ceiling price storage 143 and the lowest price at a previous time (the lowest price just before update in ST255) in case where the lowest price is updated by the lowest price updating unit 142 (ST255) and the period of temporary rising has finished (Flag f2 is set to [1] in step ST265).

For instance, the lowest price updating unit 142 stores the lowest price to another storage area in the storage 14 just before the update when the lowest price of the lowest price storage 140 is updated. The fixed ceiling price obtaining unit 146 read the lowest price before update from aforementioned storage area, and calculates range of rises by subtracting the ceiling price in the first ceiling price storage 143 from the lowest price read. The fixed ceiling price obtaining unit 146 judges whether range of rises is smaller than the predetermined value, the ceiling price of the first ceiling price storage 143 is not stored to the second ceiling price storage 147 as fixed ceiling price when range of rise is smaller than the predetermined value. Herewith, the buy order price of stop order stored in the order information storage 107 is unchanged and maintained.

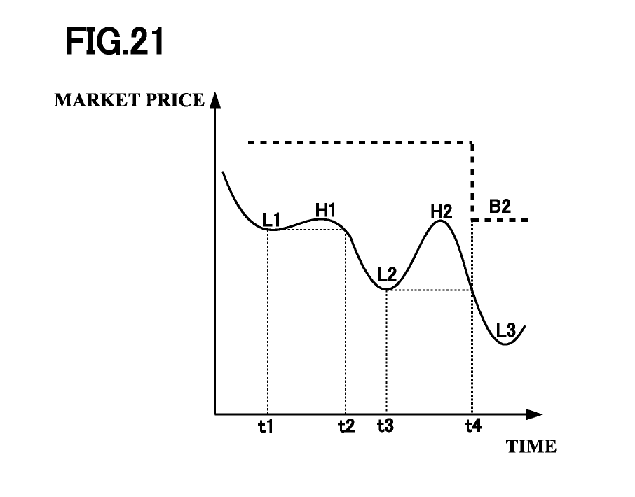

FIG. 21 is a drawing showing an example of not updating the buy order price of the stop order when range of rise is small in the temporary rise period. In the example of FIG. 21, range of rise from the valley floor price L1 to the ceiling price H1 at the time t1 is small, the market price shifts almost flatly. At the time t2, the ceiling price obtaining unit 122 judges that H1-L1 is smaller than the predetermined range of rises, and discontinues acquiring the peak price H1 as fixed ceiling price. Herewith, the buy price of stop order is not calculated, therefore the price of stop orders at the time t2 is maintained.

StepST272:

The fixed ceiling price obtaining unit 146 calculates elapsed time from the time of the lowest price priced and the time of the lowest price priced at a previous time (length in the temporary rise period) in case where the lowest price is updated by the lowest price updating unit 142 (ST255) and the period of temporary rising has finished (Flag f2 is set to [1] in step ST265).

For instance, the lowest price updating unit 142 stores the lowest price and the time information together to another storage area in the storage 14 before the update when the lowest price of the lowest price storage 140 is updated. The fixed ceiling price obtaining unit 146 read the time information of the lowest price before update from aforementioned storage area, and calculates the length in the temporary rise period based on the time information of the lowest price read and the time information of lowest price of the lowest price storage 140. The fixed ceiling price obtaining unit 146 judges whether length of the period of temporary rising calculated is shorter than the predetermined value, the ceiling price of the first ceiling price storage 143 is not stored to the second ceiling price storage 147 as fixed ceiling price when length of the period of temporary rising is shorter than the predetermined value. Herewith, the buy order price of stop order stored in the order information storage 107 is unchanged and maintained.

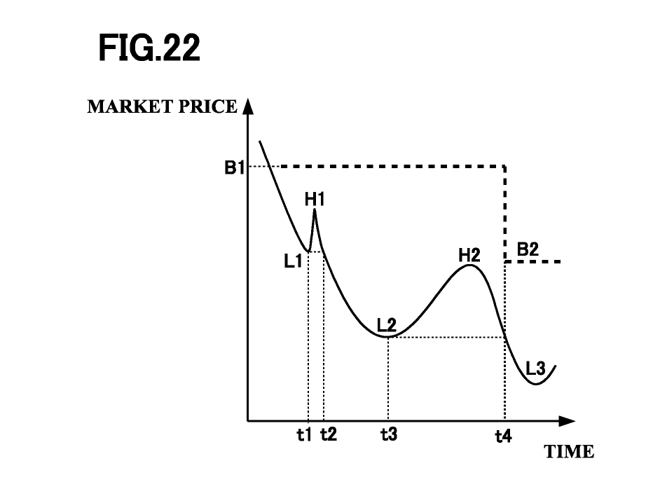

FIG. 22 is a drawing an example of not updating the buy order price of stop order when the range of rise in the market price is small in the temporary rise period.

The market price priced the valley floor price L1 at the time t1 temporary increased and declined again, and became lower than the valley floor price L1 at the time t2. However the period of temporary rise from the time t1 to the time t2 becomes exceedingly short. At the time t2, the ceiling price obtaining unit 122 judges that t2-t1 is shorter than the predetermined length of time, and discontinues acquiring the peak price H1 as fixed ceiling price. Herewith, the buy price of stop order is not calculated, therefore the price of stop orders at the time t2 is maintained.

In case where the range of drop is determined as greater than the predetermined value in step ST226 and the duration of the period of temporary decline is determined as longer than the predetermined time in step ST227, the bottom price obtaining unit 120 obtains the fixed bottom price in the temporary decline period (ST230).

As explained above, according to the present embodiment, the bottom price of the bottom price obtaining unit 120 and the ceiling price of the ceiling price obtaining unit 122 are not obtained and current price of stop order is maintained when range of drop in the temporary decline period is smaller than the predetermined value in the loss cut mode of short position or range of rise in the temporary rise period is smaller than the predetermined value in the loss cut mode of long position.

Therefore, it can be prevent update of the price of stop order because of a small variation of the market prices may be negligible compared to the average value of the fluctuation in the market price.

Also, according to the present embodiment, the bottom price of the bottom price obtaining unit 120 and the ceiling price of the ceiling price obtaining unit 122 are not obtained and current price of stop order is maintained when the period of temporary rising is smaller than the predetermined value in the loss cut mode of short position or the period of temporary rising is smaller than the predetermined value in the loss cut mode of long position.

Therefore, it can be prevent update of the price of stop order because of a small variation of the market prices by the way of noise in short term compared to the average cycle of the fluctuation repeat the peak and valley floor in the market price.

Furthermore, the criteria of the smallest duration whether to change the stop order price may be defined as the number of candlesticks described above. In other words, in a situation such as the number of candlestick in the temporary decline period in loss cut mode of short position, or the number of candlestick in the temporary rise period in loss cut mode of long position is less than predetermined minimum number, the bottom price obtaining unit 120 do not obtain the ceiling price and the ceiling price obtaining unit 122 do not obtain the bottom price and the current price of stop order is maintained.

Next, the examples of the modification of the present invention will be explained.

In aforementioned examples, the price of the stop order is not updated by preventing obtain the bottom price by the bottom price obtaining unit 120 as well as the ceiling price by the ceiling price obtaining unit 122 when the transition of the market price do not meet requirements.

In contrast, in the examples of the modification of the present invention will be explain below, the price of the stop order is not updated by not calculating stop order by first bottom price 133 or generating signals showing the price of stop order calculated is invalid when the transition of the market price do not meet requirements.

(An Example of the First Modification of the Second Embodiment)

When the range of drop in the temporary decline period is smaller than the predetermined value or the range of rise in the temporary rise period is smaller than the predetermined value, The order server 1 related to an example of the first modification do not calculate the price of stop order in the first bottom price storage 133, or the order server 1 generates signals showing that the price calculated in the first bottom price storage 133 is invalid.

For instance, in loss cut mode of short position, the stop order calculating unit 113 related to an example of first modification calculates range of drop in the temporary decline period. If range of drop is smaller than the predetermined value, the stop order calculating unit 113 do not calculate sell order price of stop order, or the stop order calculating unit 113 generates the signals showing that the price calculated is invalid.

In other words, when the highest price stored in the highest price processing unit 1201 (FIG. 5) is updated, the stop order calculating unit 113 calculates range of drop in the temporary decline period according to the ratio or the differences between the highest price just before the update and the bottom price currently stored. Specifically, when the highest price updated by the highest price updating unit 132, the stop order calculating unit 113 calculates range of drop in the temporary decline period according to the ratio or the differences between the highest price just before the update and the bottom price stored in the first bottom price storage 133. When the range of drop calculated is smaller than the predetermined value, the stop order calculating unit 113 does not calculate the sell order price of stop order, or the stop order calculating unit 113 generates signals showing that the price calculated is invalid.

For instance, the stop order calculating unit 113 related to an example of first modification calculates range of drop in the temporary decline period according to the ratio or the differences between the highest price just before the update and the bottom price stored in the first bottom price storage 133, before it calculates the sell order price of stop order in the step ST400 shown in flowchart in FIG. 9.

When the range of drop calculated is smaller than the predetermined value, the stop order calculating unit 113 discontinues calculating the sell order price of stop order in the step ST400.

In addition, for example, the stop order calculating unit 113 relate to an example of the first modification calculates range of drop in the temporary decline period according to the ratio or the differences between the highest price just before the update and the bottom price stored in the first bottom price storage 133, before the sell order price of stop order in the step ST400 shown in flowchart in FIG. 9 is updated. When the range of drop calculated is smaller than the predetermined value, the stop order calculating unit 113 generates signals showing that the price calculated in step ST400 is invalid. When the signal shows invalidity is generated, the order information processing unit 108 does not update the sell order price of stop order in step ST410.

On the other hand, in loss cut mode of long position, the stop order calculating unit 113 related to an example of first modification calculates range of rise in the temporary rise period. If range of rise is smaller than the predetermined value, the stop order calculating unit 113 do not calculate buy order price of stop order, or the stop order calculating unit 113 generates the signals showing that the price calculated is invalid.

In other words, when the lowest price stored in the lowest price processing unit 1221 (FIG. 6) is updated, the stop order calculating unit 113 calculates range of rise in the temporary rise period according to the ratio or the differences between the lowest price just before the update and the ceiling price currently stored. Specifically, when the lowest price updated by the lowest price updating unit 142, the stop order calculating unit 113 calculates range of rise in the temporary rise period according to the ratio or the differences between the lowest price just before the update and the ceiling price stored in the first bottom price storage 133. When the range of rise calculated is smaller than the predetermined value, the stop order calculating unit 113 does not calculate the buy order price of stop order, or the stop order calculating unit 113 generates signals showing that the price calculated is invalid.

For instance, the stop order calculating unit 113 related to an example of first modification calculates range of rise in the temporary rise period according to the ratio or the differences between the lowest price just before the update and the ceiling price stored in the first ceiling price storage 143, before it calculates the buy order price of stop order in the step ST450 shown in flowchart in FIG. 14. When the range of rise calculated is smaller than the predetermined value, the stop order calculating unit 113 discontinues calculating the buy order price of stop order in the step ST450.

In addition, for example, the stop order calculating unit 113 relate to an example of the first modification calculates range of rise in the temporary rise period according to the ratio or the differences between the lowest price just before the update and the ceiling price stored in the first ceiling price storage 143, before the buy order price of stop order in the step ST460 shown in flowchart in FIG. 14 is updated. When the range of rise calculated is smaller than the predetermined value, the stop order calculating unit 113 generates signals showing that the price calculated in step ST450 is invalid. When the signal shows invalidity is generated, the order information processing unit 108 does not update the buy order price of stop order in step ST460.

(An Example of the Second Modification of the Second Embodiment)

When the duration period of temporary decline and the period of temporary rise are shorter than predetermined time, the order server 1 related to an example of the second modification do not calculate the price of stop order in the first bottom price storage 133, or the order server 1 generates signals showing that the price calculated in the first bottom price storage 133 is invalid.

On the other hand, in loss cut mode of short position, the stop order calculating unit 113 related to an example of second modification calculates the duration period of temporary decline based on the time information included in market price data is smaller than the predetermined value, the stop order calculating unit 113 do not calculate sell order price of stop order, or the stop order calculating unit 113 generates the signals showing that the price calculated is invalid.

In other words, when the highest price stored in the highest price processing unit 1201 (FIG. 5) is updated, the stop order calculating unit 113 calculates elapsed time from the time of the highest price before update to the time of the highest price after update based on the time information of market price data. Specifically, when the highest price stored is updated by the highest price updating unit 132, the stop order calculating unit 113 calculates elapsed time from the time of the highest price before update to the time of the highest price after update based on the time information. When the elapsed time calculated is shorter than the predetermined value, the stop order calculating unit 113 does not calculate the sell order price of stop order, or the stop order calculating unit 113 generates signals showing that the price calculated is invalid.

For instance, the stop order calculating unit 113 related to an example of second modification calculates elapsed time from the time of the highest price before update by the highest price updating unit 132 to the time of the highest price after update based on the time information in the market price data, before it calculates the sell order price of stop order in the step ST400 shown in flowchart in FIG. 9. When the elapsed time calculated is shorter than the predetermined value, the stop order calculating unit 113 discontinues calculating the buy order price of stop order in the step ST400.

In addition, for example, the stop order calculating unit 113 relate to an example of the second modification calculates elapsed time from the time of the highest price before update by the highest price updating unit 132 to the time of the highest price after update based on the time information in the market price data, before the sell order price of stop order in the step ST410 shown in flowchart in FIG. 9 is updated. When elapsed time calculated is shorter than the predetermined value, the stop order calculating unit 113 generates signals showing that the price calculated in step ST400 is invalid. When the signal shows invalidity is generated, the order information processing unit 108 does not update the sell order price of stop order in step ST410.

On the other hand, in loss cut mode of long position, the stop order calculating unit 113 related to an example of second modification calculates the time in the temporary rise period based on the time information of the market price data. When elapsed time calculated is shorter than the predetermined time, the stop order calculating unit 113 do not do not calculate sell order price of stop order, or the stop order calculating unit 113 generates the signals showing that the price calculated is invalid. In other words, when the lowest price stored in the lowest price processing unit 1221 (FIG. 6) is updated, the stop order calculating unit 113 calculates elapsed time from the time of the lowest price before update to the time of the lowest price after update based on the time information in the market price data. Specifically, when the lowest price updated by the lowest price updating unit 142, the stop order calculating unit 113 calculates elapsed time from the time of the lowest price before update to the time of the lowest price after update based on the time information in the market price data. When elapsed time calculated is shorter than the predetermined value, the stop order calculating units 113 do not calculate the buy order price of stop order, or the stop order calculating unit 113 generates signals showing that the price calculated is invalid.

For instance, the stop order calculating unit 113 related to an example of second modification calculates elapsed time from the time of the lowest price before update by the lowest price updating unit 142 to the time of the lowest price after update based on the time information in the market price data, before it calculates the buy order price of stop order in the step ST450 shown in flowchart in FIG. 14. When the elapsed time calculated is shorter than the predetermined value, the stop order calculating unit 113 discontinues calculating the buy order price of stop order in the step ST450.

In addition, for example, the stop order calculating unit 113 relate to an example of the second modification calculates elapsed time from the time of the lowest price before update by the lowest price updating unit 142 to the time of the lowest price after update based on the time information in the market price data, before the buy order price of stop order in the step ST460 shown in flowchart in FIG. 14 is updated. When elapsed time calculated is shorter than the predetermined value, the stop order calculating unit 113 generates signals showing that the price calculated in step ST450 is invalid. When the signal shows invalidity is generated, the order information processing unit 108 does not update the sell order price of stop order in step ST460.

### Third Embodiment

Next, the third embodiment of the present invention will be explained. In the present embodiment, occurrence of loss is prevented by setting the price of stop order for loss cut mode corresponding to the contracted price of buying and selling.

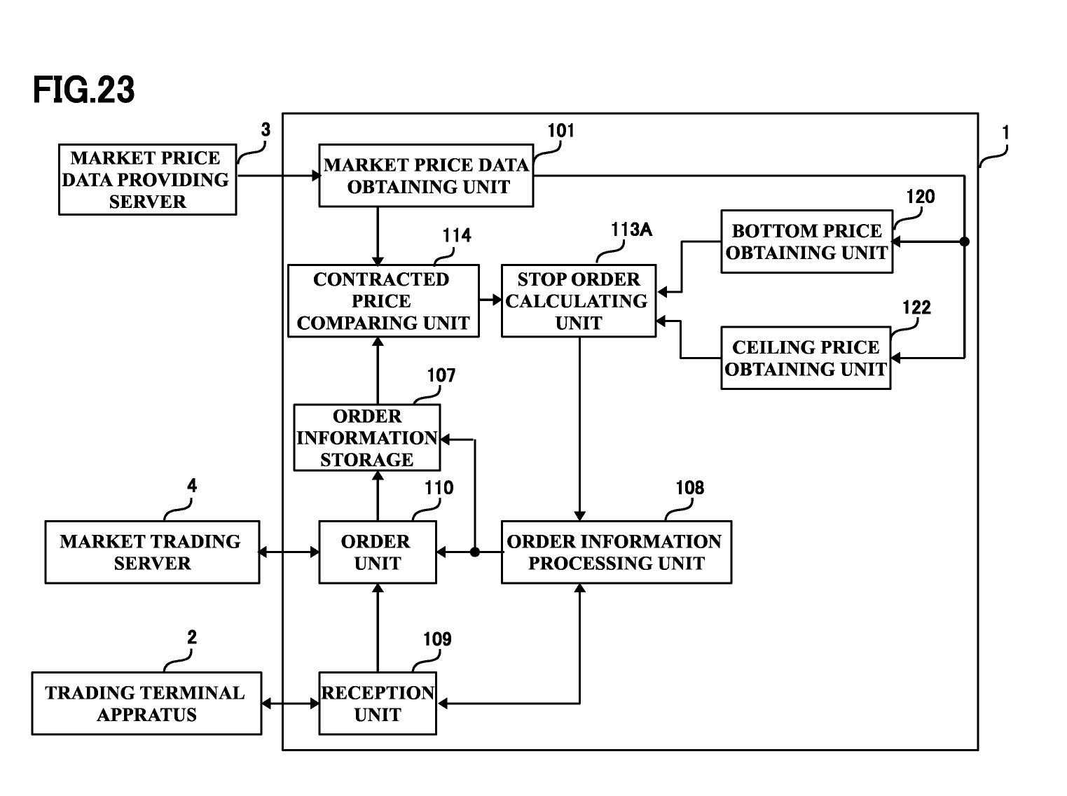

FIG. 23 is a drawing showing an example of the structure of the order server 1 related to the third embodiment.

The order server 1 shown in FIG. 23 is added the contracted price comparing unit 114 to the order server 1 shown in FIG. 3 and change the stop order calculating unit 113 into the stop order price calculating unit 113A.

The contracted price comparing unit 114 compares the latest rate shown in the market price data obtained from the market price data obtaining unit 101 and the buy and sell contracted price stored in the order information storage 107. For example, the contracted price comparing unit 114 in the loss cut mode of short position judges whether the market price shown in the market price data is increased a given margin alpha(alpha>0) than the buy contracted price stored in the order information storage 107. In contrast, the contracted price comparing unit 114 in the loss cut mode of long position judges whether the market price shown in the market price data is decreased a given margin alpha than the sell contracted price stored in the order information storage 107.

The stop order price calculating unit 113A calculates the price of stop order based on the bottom price and the ceiling price likewise aforementioned the stop order calculating unit 113. Also, the stop order price calculating unit 113A calculates the price of stop order based on the buy contracted price and selling stored in the order information storage 107.

Specifically, in loss cut mode of short position, the latest market price is judged as higher than the buy contracted price (for instance, the market price is increased than a given margin alpha compared to the buy contracted price) and the current selling price of stop order stored in the order information storage 107 is higher than the buy contracted price, the stop order price calculating unit 113A calculates sell order price of stop order based on the buy contracted price (ST400). For example, the stop order price calculating unit 113A sets the sell order price of stop order equal to the buy contracted price, or sets the sell order price of stop order margin beta (alpha>beta>0) higher than the buy contracted price.

In contrast, in loss cut mode of long position, the latest market price is judged by the contracted price comparing unit 114 as lower than the sell contracted price (for instance, the market price is decreased than a given margin alpha compared to the sell contracted price) and the current buying price of stop order stored in the order information storage 107 is higher than the sell contracted price, the stop order price calculating unit 113A calculates buy order price of stop order based on the sell contracted price (ST400). For example, the stop order price calculating unit 113A sets the buy order price of stop order equal to the sell contracted price, or set the buy order price of stop order margin beta(alpha>beta>0) lower than the sell contracted price.

Specifically, in loss cut mode of short position, the latest market price is judged by the contracted price comparing unit 114 as higher than the buy contracted price (for instance, the market price is increased than a given margin alpha compared to the buy contracted price) and the current selling price of stop order stored in the order information storage 107 is lower than the buy contracted price, the stop order price calculating unit 113A calculates sell order price of stop order based on the buy contracted price. For example, the stop order price calculating unit 113A sets the sell order price of stop order equal to the buy contracted price, or set the sell order price of stop order margin beta(alpha>beta>0) higher than the buy contracted price.

Hereinafter, the processes of determining the price of the stop order in the present embodiment will be explained separately as loss cut mode of short position and loss cut mode of long position.

(Loss Cut Mode of Short Position)

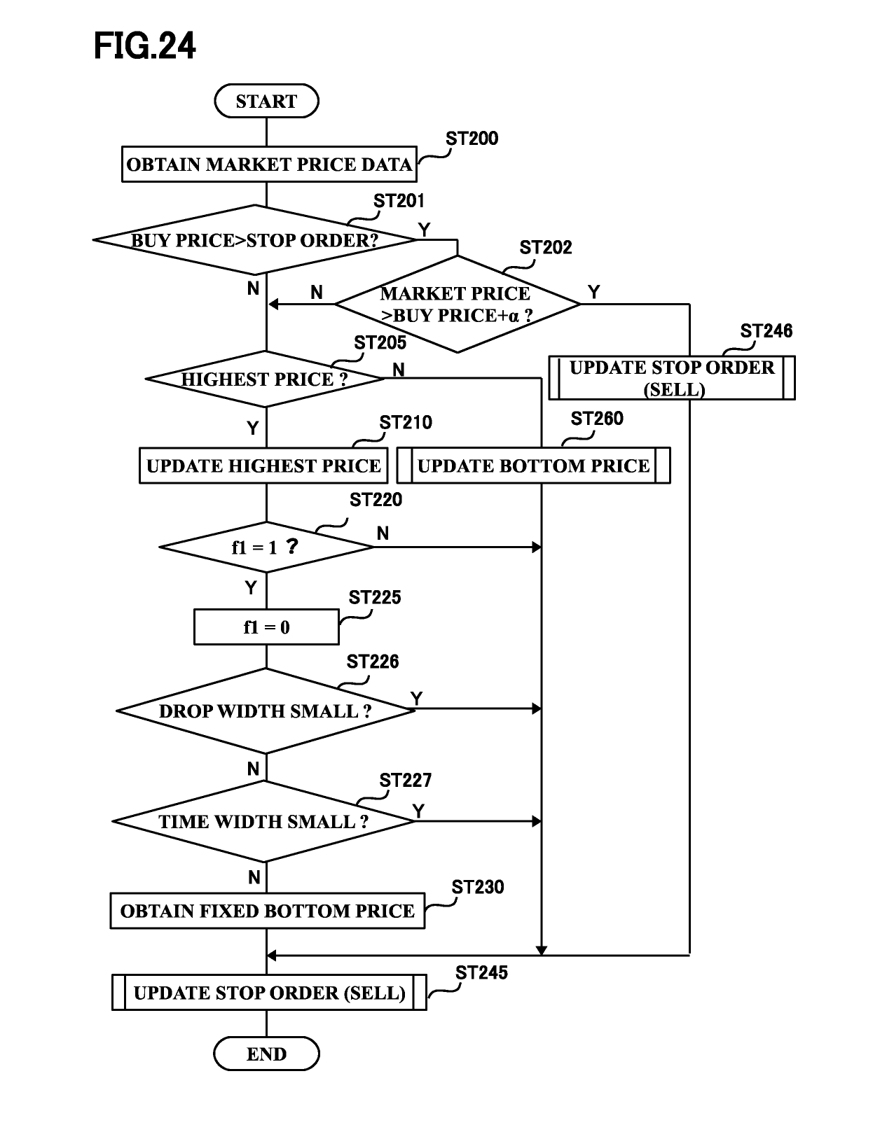

FIG. 24 is a flowchart to explain the movements of determining the price of buy order of the stop order according to the buy contracted price.

When compare the flowchart of FIG. 17 and FIG. 24, the flowchart of FIG. 24 is added step ST201, ST202 and ST246. Hereinafter, movements, mainly the added processes, will be explained.

After the market price data obtained in the market price data obtaining unit 101 (ST200), the stop order price calculating unit 113A judges whether the current sell order price of stop order stored in the order information storage 107 is lower than the buy contracted price (ST201). When the current sell order price of stop order stored in the order information storage 107 is lower than the buy contracted price, the stop order price calculating unit 113A refers to the result of judgment by the contracted price comparing unit 114 (ST202). In the contracted price comparing unit 114, the stop order price calculating unit 113A performs process of updating the sell order price of stop order based on the buy contracted price when the latest market price is judged that it is increased than a given margin alpha compare to the buy contracted price (ST246).

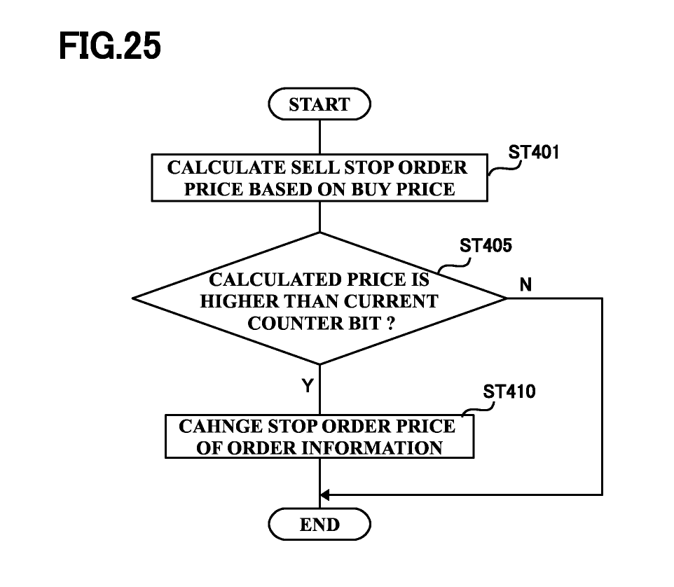

FIG. 25 is a flowchart to explain the process (ST246: FIG. 24) in case where the latest market price is increased than a given margin alpha compared to the buy contracted price.

In this case, the stop order price calculating unit 113A calculates the sell order price of stop order based on the buy contracted price (ST401). For instance, the stop order price calculating unit 113A set the sell order price of stop order equal to the buy contracted price. Or, the stop order price calculating unit 113A set the sell order price of stop order as higher than the buy contracted price and lower than the current market price. Next, the order information processing unit 108 compares the price of stop order calculated in the stop order price calculating unit 113A and the price of stop order stored in the information memory in the order information storage 107 (ST405). The sell order price of stop order calculated is higher than the sell order price of stop order defined, the order information processing unit 108 changes the price of stop order stored in the order information storage 107 to the price calculated in the stop order price calculating unit 113A (ST410). On the other hand, the sell order price of stop order calculated is lower than the sell order price of stop order defined, the order information processing unit 108 do not update the price of stop order.

Return to FIG. 24. In case where the buy order price of stop order is higher than the buy contracted price (ST210), or in case were the market price is not increased than the margin alpha compared to the buy contracted price (ST202), the stop order price calculating unit 113A does not perform aforementioned step ST246, and performs subsequent process after step ST205 same as FIG. 17 (updating the price of stop order corresponding to the bottom price).

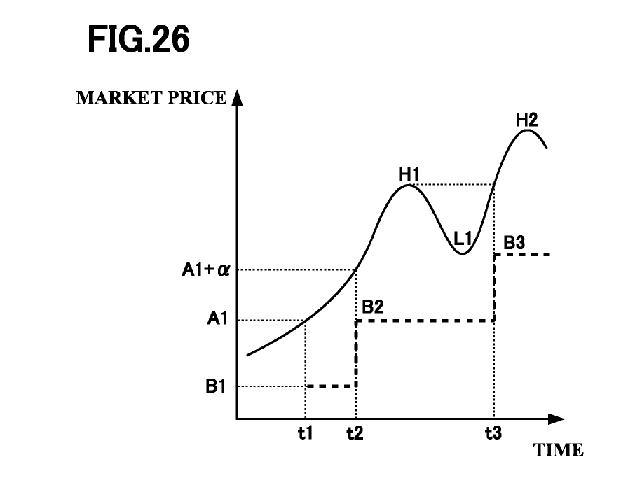

FIG. 26 is a drawing showing an example of changes in the sell order price of stop order when the market price is increased than the buy contracted price.

When the buy order of the price A1 is contracted at the time t1 and is decreased until the price B1 (B1<A1), the stop order to place the sell order for loss cut is set. The market price rises further after the time t1, and increases the margin alpha than the price A1 at the time t2. When market price reaches (A1+alpha), the stop order price calculating unit 113A calculates the sell order price of stop order B2 based on the price A1. For instance, the stop order price calculating unit 113A sets the sell order price of stop order B2 the same as the price A1 or the price (A1+beta). The price (A1+beta) is higher than the contracted price A1 and lower than the current market price (A1+alpha).

(Loss Cut Mode of Long Position)

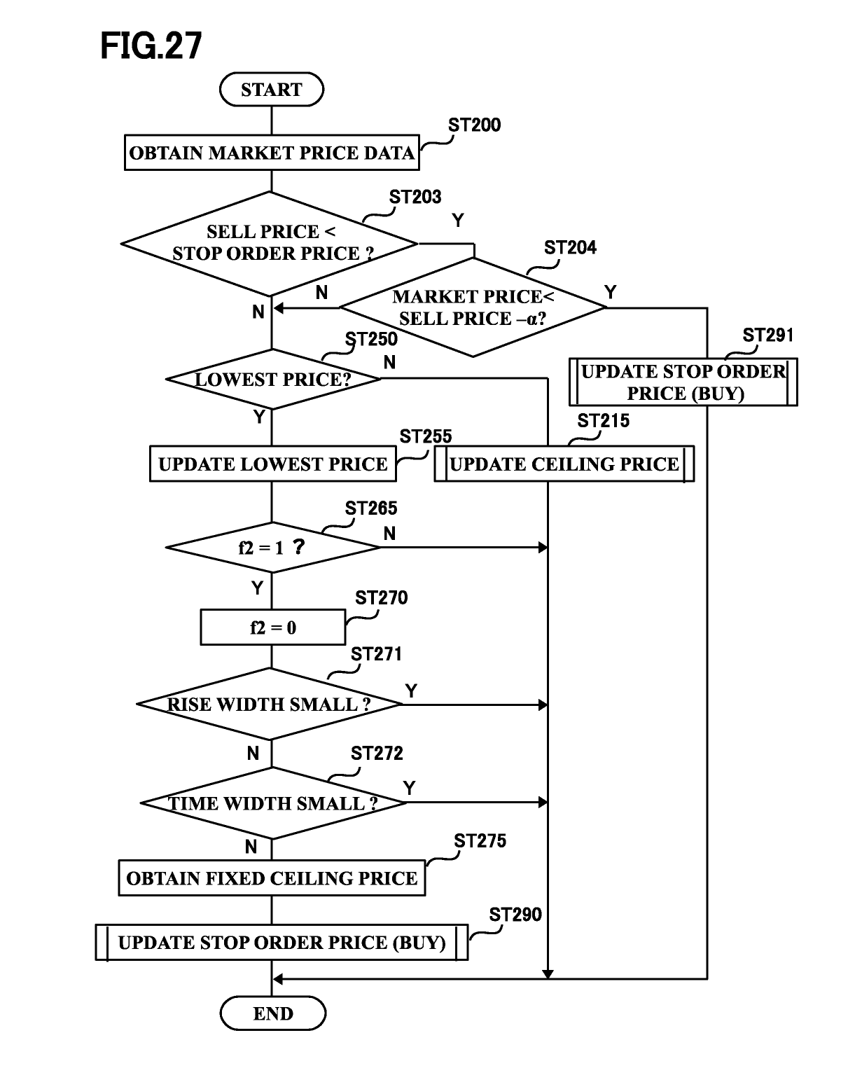

FIG. 27 is a flowchart to explain the movement of determining the price of sell order of the stop order according to the sell contracted price.

When compare the flowchart of FIG. 20 and FIG. 27, the flowchart of FIG. 27 is added step ST203, ST204 and ST291. Hereinafter, movements, mainly the added processes, will be explained.

After the market price data obtained in the market price data obtaining unit 101 (ST200), the stop order price calculating unit 113A judges whether the current buy order price of stop order stored in the order information storage 107 is higher than the sell contracted price (ST203). When the current buy order price of stop order stored in the order information storage 107 is higher than the sell contracted price, the stop order price calculating unit 113A refers to the result of judgment by the contracted price comparing unit 114 (ST204). In the contracted price comparing unit 114, the stop order price calculating unit 113A performs process of updating the buy order price of stop order based on the sell contracted price when the latest market price is judged that it is decreased than a given margin alpha compare to the sell contracted price (ST291).

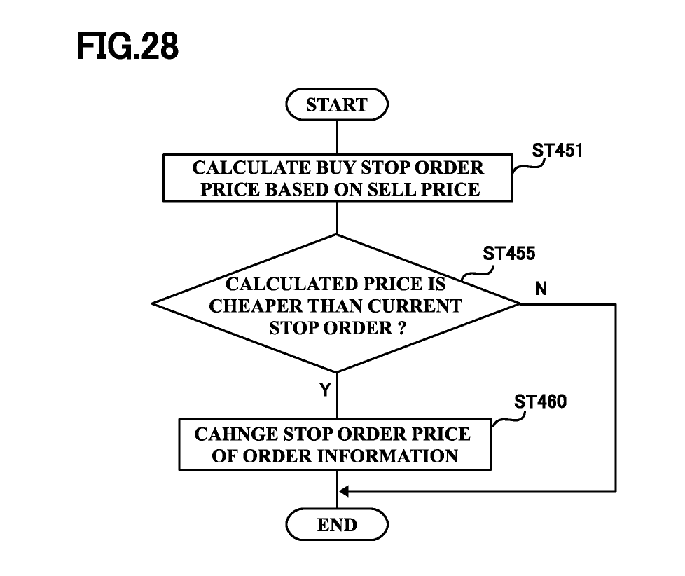

FIG. 28 is a flowchart to explain the process (ST291: FIG. 27) in case where the latest market price is decreased than a given margin alpha compared to the sell contracted price.

In this case, the stop order price calculating unit 113A calculates the buy order price of stop order based on the sell contracted price (ST451). For instance, the stop order price calculating unit 113A set the buy order price of stop order equal to the sell contracted price. Or, the stop order price calculating unit 113A set the buy order price of stop order as lower than the sell contracted price and higher than the current market price. Next, the order information processing unit 108 compares the price of stop order calculated in the stop order price calculating unit 113A and the price of stop order stored in the information memory in the order information storage 107 (ST455). The buy order price of stop order calculated is lower than the buy order price of stop order defined, the order information processing unit 108 changes the price of stop order stored in the order information storage 107 to the price calculated in the stop order price calculating unit 113A (ST460). On the other hand, the buy order price of stop order calculated is higher than the sell order price of stop order defined, the order information processing unit 108 do not update the price of stop order.

Return to FIG. 27. In case where the sell order price of stop order is lower than the sell contracted price (ST203), or in case where the market price is not decreased than the margin alpha compared to the sell contracted price (ST204), the stop order price calculating unit 113A does not perform aforementioned step ST291, and performs subsequent process after step ST250 same as FIG. 20 (updating the price of stop order corresponding to the ceiling price).

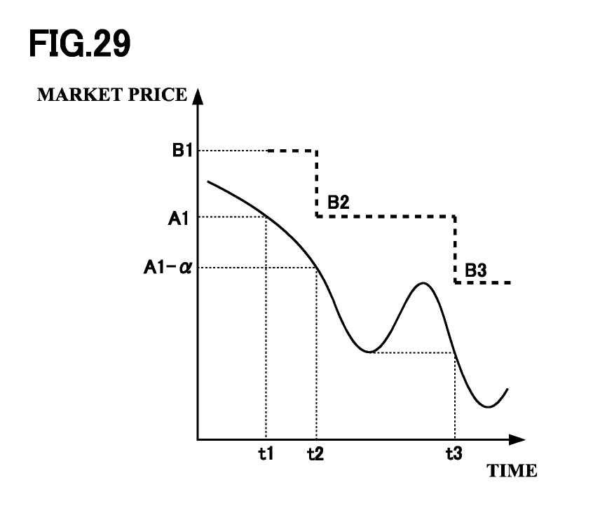

FIG. 29 is a drawing showing an example of changes in the buy order price of stop order when the market price is decreased than the sell contracted price.

When the sell order of the price A1 is contracted at the time t1 and is increased until the price B1 (B1>A1), the stop order to place the buy order for loss cut is set. The market price declined further after the time t1, and decreases the margin alpha than the price A1 at the time t2. When market price reaches (A1−alpha), the stop order price calculating unit 113A calculates the buy order price of stop order B2 based on the price A1. For instance, the stop order price calculating unit 113A sets the buy order price of stop order B2 the same as the price A1 or the price (A1−beta). The price (A1−beta) is lower than the contracted price A1 and higher than the current market price (A1−alpha).

As stated above, according to the present embodiment, when the market price is increased compared to the buy contracted price, the sell order price of stop order is set on equal to the contracted price or higher than the contracted price. Also, when the market price is decreased compared to the sell contracted price, the buy order price of stop order is set on equal to the contracted price or lower than the contracted price. That is to say, when the market price is moved to the expected direction only a given margin alpha, the price of stop order is automatically changed to the price do not cause losses near the contracted price after buying and selling are executed. Consequently, it can effectively reduce the occurrence of losses related to the contracted of stop order.

### The Forth Embodiment

Next, the forth embodiment will be explained.

In the order server 1 relate to the present embodiment, when market prices shift as expected, add a new buying order on uptrend and add a new selling order on downtrend to change the price of the stop order.

Namely, as the stop order calculating unit 113 stop order price calculating unit 113A in the loss cut mode of short position calculates the sell order price of stop order, the order information processing unit 108 generates the order information to output new buying orders, and stores the information to the order information storage 107. From this, the order unit 110 sends the new ordering data of buying to the market trading server 4.

In this case, the order information processing unit 108 replaces the determined selling price of stop order in memory information of the order information storage 107 to the calculated price, and changes the quantity of selling. In other words, the order information processing unit 108 modifies the quantity of selling of stop order to increase the new amount of the quantity of buying order at order information stored in the order information storage 107. From this, the stop order of loss cut correspond to entire short positions includes newly added is set.

On the other hand, as the stop order calculating unit 113 stop order price calculating unit 113A in the loss cut mode of long position calculates the buy order price of stop order, the order information processing unit 108 generates the order information to output new selling orders, and stores the information to the order information storage 107. From this, the order unit 110 sends the new ordering data of selling to the market trading server 4.

In this case, the order information processing unit 108 replaces the defined buying price of stop order in memory information of the order information storage 107 to the calculated price, and changes the quantity of selling. In other words, the order information processing unit 108 modifies the quantity of buying of stop order to increase the new amount of the quantity of selling order at order information stored in the order information storage 107. From this, the stop order of loss cut correspond to entire long positions includes newly added is set.

Hereinafter, focusing on the differences from aforementioned embodiment, the adding behavior of the new position will be explained by stating the case of loss cut mode of long position and loss cut mode of short position separately.

(Loss Cut Mode of Short Position)

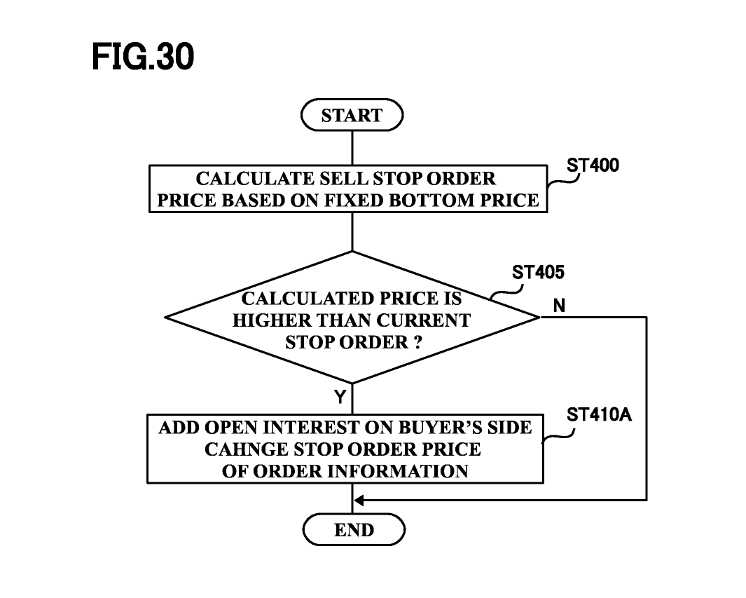

FIG. 30 is a flowchart to explain the process of updating the price of sell order of the stop order in the order server 1 relate to the forth embodiment (ST245: FIG. 7, FIG. 17, and FIG. 24).

In comparison with the flowchart of FIG. 9 and FIG. 30, Step ST410 in flowchart of FIG. 9 is changed to the ST410A in flowchart of FIG. 30.

When the calculation result of the sell order price of stop order in the stop order calculating unit 113 stop order price calculating unit 113A is judged as higher than the sell order price of stop order defined at the present moment (ST405), the order information processing unit 108 generates the order information (the first order information) to output new buying order and stores to the order information storage 107 (ST410A). The buying order can be the market order without specifying the buying price, or the limit order with the buying price a given offset value (for example, value arbitrarily set by the user) higher than the latest market price obtained in the market price data obtaining unit 101. The order unit 110 send the ordering data of buying based on the first order information stored in the order information storage 107 to the market trading server 4, and stores the response (such as information of the buy contracted price) from the market trading server 4 to the order information storage 107. Expanding the amount of profit on uptrend became possible by adding new short positions.

In addition, the order information processing unit 108 change the sell order price of stop order defined at the present moment stored in the order information storage 107 to the price calculated in the stop order calculating unit 113 stop order price calculating unit 113A, increase the quantity of selling of stop order for the amount of buying of the first order information (ST410A). From this, loss cut works effectively near bottom price in the short position of the new buying order (the first order information).

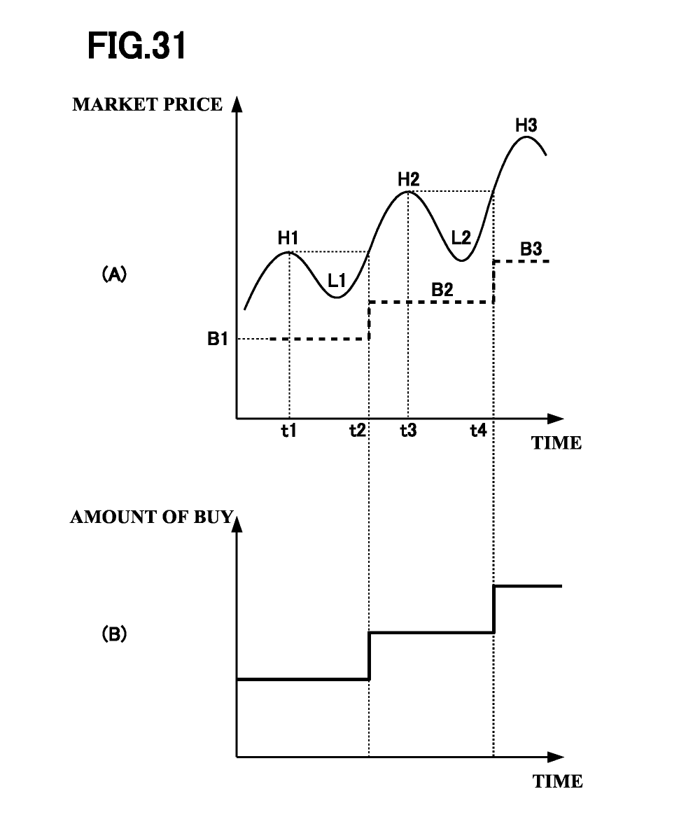

FIG. 31 is a drawing showing an example of transitions in the price of sell order of the stop order (A) and transitions in the amount of long position (B) determined by the order server 1 relates to the firth embodiment.

As shown in FIG. 31, the amount of long position increases when the new orders are issued each time the sell order price of stop order is changed on an uptrend in the market price.

(Loss Cut Mode of Long Position)

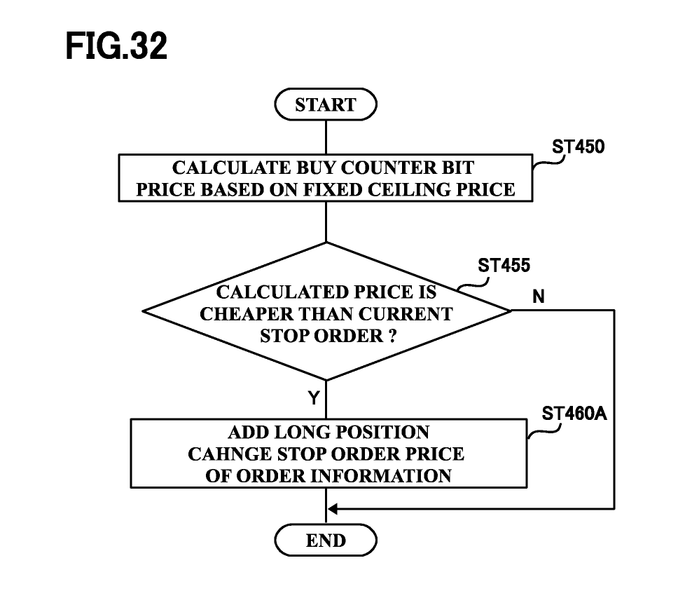

FIG. 32 is a flowchart to explain the process of updating the price of buy order of the stop order in the order server 1 relate to the forth embodiment (ST290: FIG. 12, FIG. 20, and FIG. 27).

In comparison with the flowchart of FIG. 14 and FIG. 32, Step ST460 in flowchart of FIG. 14 is changed to the ST460A in flowchart of FIG. 32.

When the calculation result of the buy order price of stop order in the stop order calculating unit 113 stop order price calculating unit 113A is judged as lower than the buy order price of stop order defined at the present moment (ST455), the order information processing unit 108 generates the order information (the second order information) to output new selling order and stores to the order information storage 107 (ST460A). The selling order can be the market order without specifying the selling price, or the limit order with the selling price a given offset value (for example, value arbitrarily set by the user) lower than the latest market price obtained in the market price data obtaining unit 101. The order unit 110 send the ordering data of selling based on the second order information stored in the order information storage 107 to the market trading server 4, and stores the response (such as information of the sell contracted price) from the market trading server 4 to the order information storage 107. Expanding the amount of profit on downtrend became possible by adding new long positions.

In addition, the order information processing unit 108 change the buy order price of stop order defined at the present moment stored in the order information storage 107 to the price calculated in the stop order calculating unit 113 stop order price calculating unit 113A, increase the quantity of buying of stop order for the amount of selling of the first order information (ST410A). From this, loss cut works effectively near bottom price in the long position of the new selling order (the second order information).

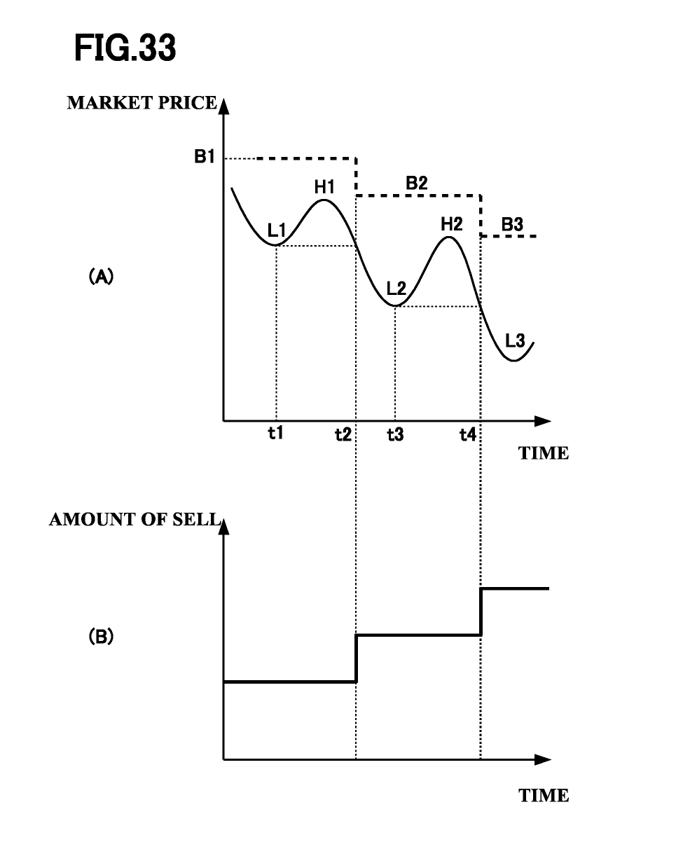

FIG. 33 is a drawing showing an example of transitions in the price of buy order of the stop order (A) and transitions in the amount of short position (B) determined by the order server 1 relates to the firth embodiment.

As shown in FIG. 33, the amount of short position increases when the new orders are issued each time the buy order price of stop order is changed on a downtrend in the market price.

As stated above, according to the present embodiment, after the market price shifted as an expectation of trends and in case of changing the price of stop order, expanding aggressively the amount of profit can be done while reducing the loss due to the execution of stop order by adding buy orders on uptrend or by adding sell orders on downtrend.

### The Fifth Embodiment

Next, the fifth embodiment will be explained.

The order server 1 relates to the present embodiment judges the market price is either uptrend or downtrend based on the pattern of change in market price. The results will be notified to the user.

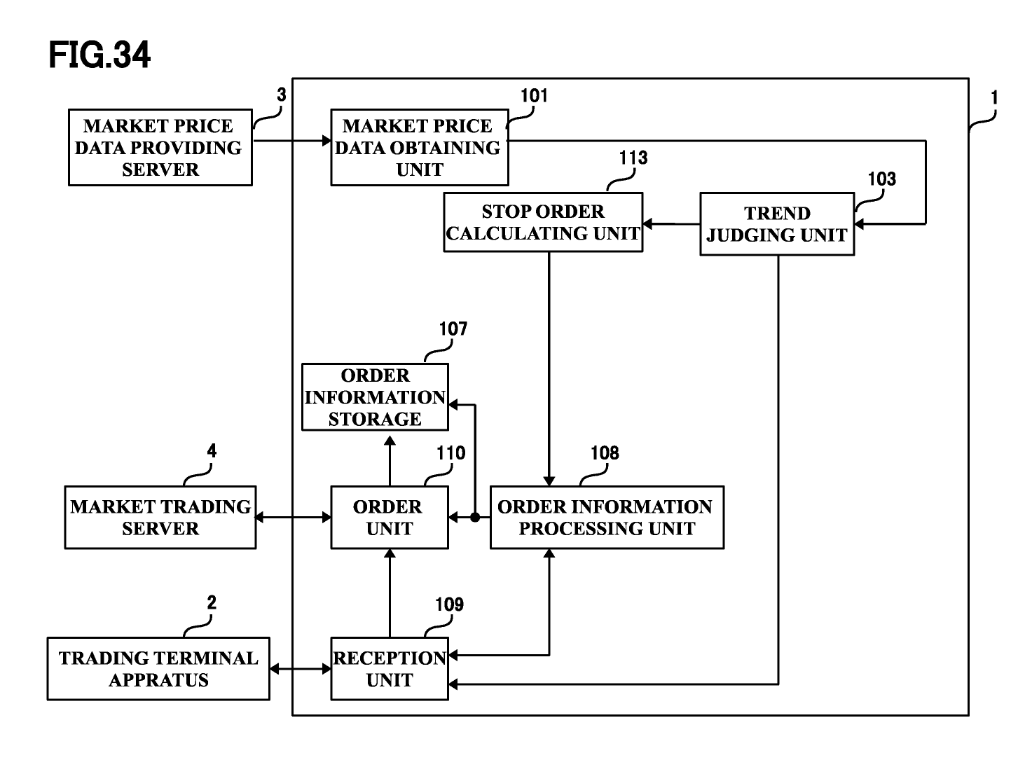

FIG. 34 is a drawing showing an example of structure of the order server 1 relates to the fifth embodiment. Instead of the bottom price obtaining unit 120 and the ceiling price obtaining unit 122 in the order server 1 shown in FIG. 3, the order server 1 shown in FIG. 34 has the trend judging unit 103 contains these units.

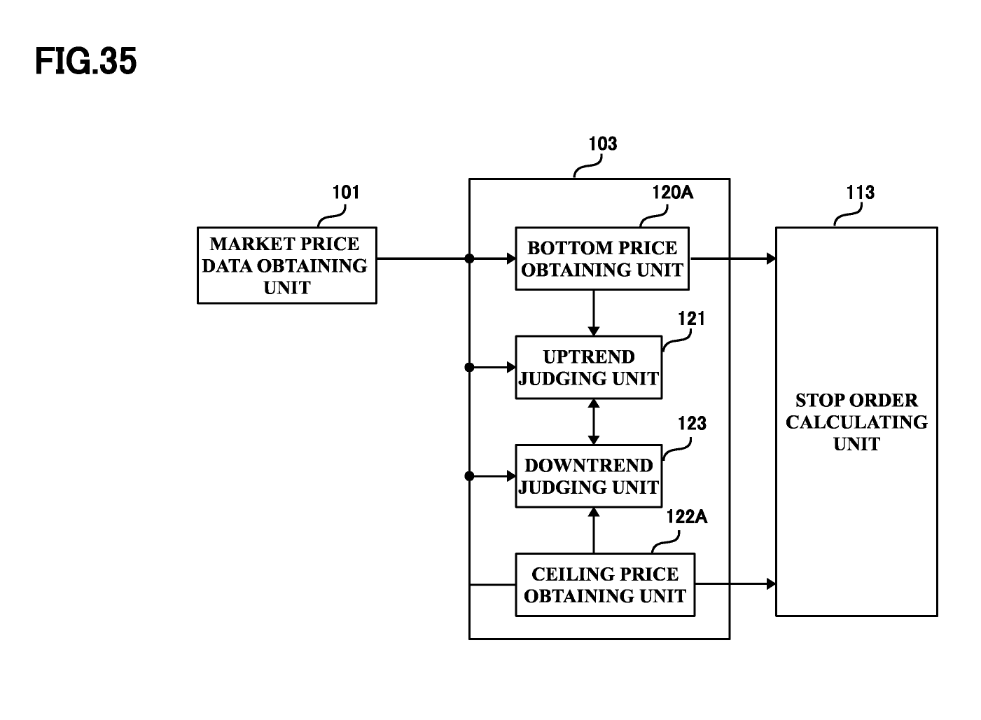

FIG. 35 is a drawing showing an example of the structure of the trend judging unit 103. The trend judging unit 103 shown in FIG. 35 has the bottom price obtaining unit 120A, the uptrend judging unit 121, the ceiling price obtaining unit 122A and the downtrend judging unit 123.

The bottom price obtaining unit 120A has the same elements of the bottom price obtaining unit 120 in FIG. 3, and execute the same processes. In addition, when the market price is judged in the downtrend judging unit 123 that the downtrend has ended, the bottom price obtaining unit 120A obtains the bottom price as the highest price after the latest market price shown in the market price data obtained in market price data obtaining unit 101. In concrete terms, when the highest price updating unit 132 (FIG. 6) is judged that the downtrend of the market price has ended in the downtrend judging unit 123, the highest price updating unit 132 stores the latest market price shown in the market price data obtained in the market price data obtaining unit 101 as a new highest price to the highest price storage 130. When downtrend shifts to uptrend, it is able to obtain the bottom price need to judge uptrend properly by initializing the highest price at the time of determining the end of downtrend.

The ceiling price obtaining unit 122A has the same elements of the ceiling price obtaining unit 122 in FIG. 3, and executes the same processes. In addition, when the market price is judged in the uptrend judging unit 121 that the uptrend has ended, the ceiling price obtaining unit 122A obtains the ceiling price as the lowest price after the latest market price shown in the market price data obtained in market price data obtaining unit 101. In concrete terms, when the lowest price updating unit 142 (FIG. 7) is judged that the uptrend of the market price has ended in the uptrend judging unit 121, the lowest price updating unit 142 stores the latest market price shown in the market price data obtained in the market price data obtaining unit 101 as a new lowest price to the lowest price storage 140. When uptrend shifts to downtrend, it is able to obtain the ceiling price need to judge uptrend properly by initializing the lowest price at the time of determining the end of uptrend.

The uptrend judging unit 121 judges the market price is on uptrend when the bottom price obtained in the bottom price obtaining unit 120A continue to rise. In contrast, the uptrend judging unit 121 judges that uptrend has finished when the condition is not fulfilled.

In other words, the uptrend judging unit 121 judges that the market price is on uptrend in case where the bottom price obtained in the bottom price obtaining unit 120A rises once or several times in succession. After the market price data is judged as uptrend, when the latest market price shown in the market price data (For example, the low price of the market price) gets lower than the latest bottom price obtained in the bottom price obtaining unit 120, the uptrend judging unit 121 judges that the uptrend of market price has finished.

For example, the uptrend judging unit 121 compares the latest bottom price and the previous bottom price every time the bottom price is obtained in the highest price processing unit 1201 (FIG. 5). Specifically, the uptrend judging unit 121 compares the latest fixed bottom price and the previous fixed bottom price each time the bottom price determined in the fixed ceiling price obtaining unit 146 is stored to the second bottom price storage 137.

The uptrend judging unit 121 judges that the market price is on uptrend in case where the result of comparison shows that the latest fixed bottom price is higher than the previous fixed bottom price once, or several times in succession.

After the market price data is judged as uptrend, the uptrend judging unit 121 compares the latest market data shown in the market price data (For example, the low price of the market price) and the latest fixed bottom price. When the latest market price is lower than the latest fixed bottom price, the uptrend judging unit 121 judges that the uptrend of market price has finished.

The downtrend judging unit 123 judges the market price is on downtrend when the ceiling price obtained in the ceiling price obtaining unit 122A continues to decline. In contrast, the downtrend judging unit 123 judges that downtrend has finished when the condition is not fulfilled.

In other words, the downtrend judging unit 123 judges that the market price is on downtrend when the ceiling price obtained in the ceiling price obtaining unit 122A decreases once or several times in succession. After the market price data is judged as downtrend, when the latest market price shown in the market price data (For example, the high price of the market price) gets higher than the latest ceiling price obtained in the ceiling price obtaining unit 122, the downtrend judging unit 123 judges that the downtrend of market price has finished.

For example, the downtrend judging unit 123 compares the latest ceiling price and the previous ceiling price every time the ceiling price is obtained in the ceiling price processing unit 1222 (FIG. 6). Specifically, the downtrend judging unit 123 compares the latest fixed ceiling price and the previous fixed ceiling price each time the ceiling price determined in the fixed ceiling price obtaining unit 146 is stored to the second ceiling price storage 147.

The downtrend judging unit 123 judges that the market price is on downtrend in case where the result of comparison shows that the latest fixed ceiling price is lower than the previous fixed ceiling price once, or several times in succession.

After the market price data is judged as downtrend, the downtrend judging unit 123 compares the latest market data shown in the market price data (For example, the high price of the market price) and the latest fixed ceiling price. When the latest market price is higher than the latest determined ceiling price, the downtrend judging unit 123 judges that the downtrend of market price has finished.

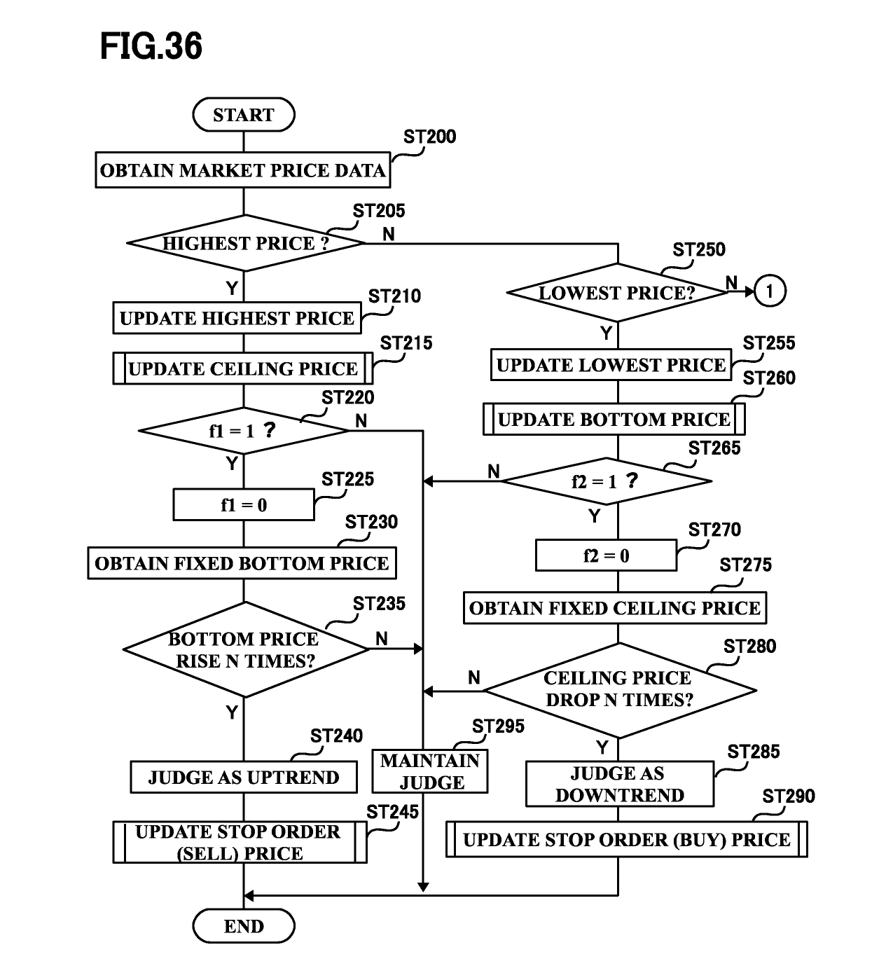

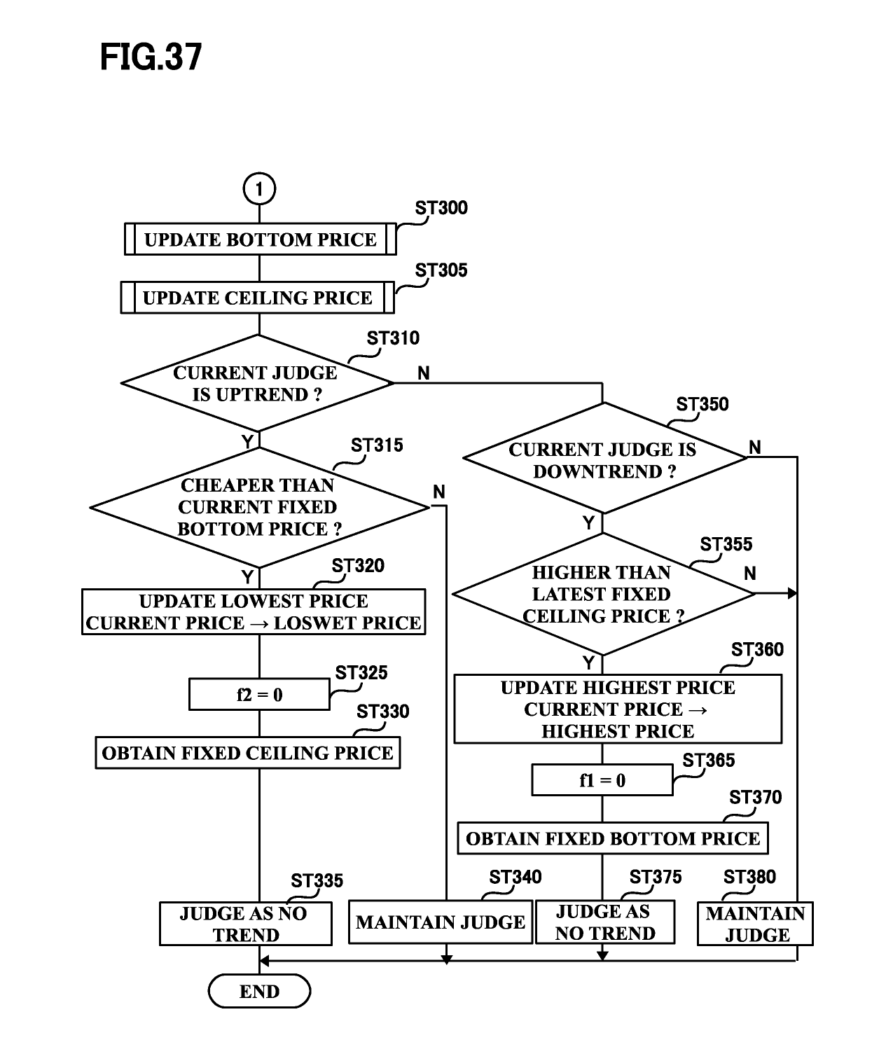

FIG. 36 and FIG. 37 are flowcharts to explain the processes of judging the trend of the market price and updating the price of stop order.

After the market price data obtained in the market price data obtaining unit 101 (ST200), the highest price comparing unit 131 compares the previous highest price stored in the highest price storage 130 and the latest market price in the market price data (ST205). If the latest market price is higher than the highest price, the highest price updating unit 132 stores the market price as a new highest price to the highest price storage 130 (ST210). In this case, perform the update process of the ceiling price accompanied by increasing market price. (ST215, See FIG. 13).

Next, the fixed bottom price obtaining unit 136 refers to the flag f1 indicating whether or not the market price is cheaper than the highest (ST220). In case where the Flag f1 is set to [1], the market price is deemed to be shifted from the condition of lower than the highest price to the condition of higher than the highest price (the period of temporary decline has ended), therefore the fixed bottom price obtaining unit 136 obtains the bottom price stored in the first bottom price storage 133 as a the prefixed bottom price of the period of temporary decline, and stores to the second bottom price storage 137 (ST230). The highest price comparing unit 131 resets the flag f1 to [0] as the market price became higher than the highest price (ST225).

Once the new fixed bottom price is stored to the second bottom price storage 137, the uptrend judging unit 121 judges whether the fixed bottom price increased predetermined times in succession (ST235), when the market price tend to rise, the market price is determined as uptrend (ST240).

When the bottom price is obtained in the fixed bottom price obtaining unit 136, the stop order calculating unit 113 calculates sell order price of stop order based on the obtained bottom price. The order information processing unit 108 updates the price of stop order calculated by stop order calculating unit 113 from the price of stop order stored in the order information storage 107 (ST245, see FIG. 5).

In the example of the flowchart shown in FIG. 36, the price of stop order is calculated (ST245) when the market price is judged as uptrend by the uptrend judging unit 121 (ST245). In the example of the other embodiment of present embodiment, notwithstanding the result of judgment by the uptrend judging unit 121, the price of stop order may be calculated when the bottom price is obtained in the fixed bottom price obtaining unit 136 (ST230).

When the flag f1 is set to [0] in step ST220, the period of temporary decline do not exist, and the market price rises monotonously. In this case, the trend judging unit 103 maintains the previous result of judgment. Furthermore, the trend judging unit 103 maintains the previous results of judgment (ST295) when there was no conceptive rise of the bottom price at step ST235.

In addition, when the market price is cheaper than the highest price, the lowest price comparing unit 141 compares the previous highest price stored in the lowest price storage 140 and the latest market price in the market price data (ST250). When the latest market price is lower than the lowest price, the lowest price updating unit 142 stores the latest market price as new lowest price to the lowest price storage 140. In this case, the update process due to the decline of market price is performed (ST260, See FIG. 8).

Next, when a new lowest price is stored to the lowest price storage 140 by the lowest price updating unit 142, the fixed ceiling price obtaining unit 146 refers to the flag f2 indicates whether the market price is higher than the lowest price (ST265). In case where the flag f2 is set to [1], the market price is deemed to be shifted from the condition of higher than the lowest price to the condition of lower than the lowest price (the period of temporary rise has ended), therefore the fixed ceiling price obtaining unit 146 obtains the ceiling price stored in the first ceiling price storage 143 as a the prefixed ceiling price of the period of temporary rise, and stores to the second ceiling price storage 147 (ST275). The lowest price comparing unit 141 resets the flag f2 to [0] (ST270) as the market price became cheaper than the lowest price.

Once the new fixed ceiling price is stored to the second ceiling price storage 147, the downtrend judging unit 123 judges whether the fixed ceiling price declined predetermined times in succession (ST280), when the market price tend to decline, the market price is determined as downtrend (ST285).

When the ceiling price is obtained in the fixed ceiling price obtaining unit 146, the stop order calculating unit 113 calculates buy order price of stop order based on the obtained ceiling price. The order information processing unit 108 updates the price of stop order calculated by stop order calculating unit 113 from the price of stop order stored in the order information storage 107 (ST290, see FIG. 14).

In the example of the flowchart shown in FIG. 36, the price of stop order is calculated (ST290) when the market price is judged as downtrend by the downtrend judging unit 123 (ST285). In the example of the other embodiment of present embodiment, notwithstanding the result of judgment by the downtrend judging unit 123, the price of stop order may calculate when the bottom price is obtained in the fixed ceiling price obtaining unit 146 (ST275).

When the flag f2 is set to [0] in step ST220, the period of temporary rise do not exist, and the market price decreases monotonously. In this case, the trend judging unit 103 maintains the previous result of judgment. Moreover, the trend judging unit 103 maintains the previous results of judgment (ST295) when there was no conceptive rise of the ceiling price at step ST280.

When the latest market price is lower than highest price and higher than the lowest price, update process of the bottom price (ST300) and the ceiling price (ST305) are performed. The update process of the bottom price in the step ST300 is same as the step ST260 (a flowchart in FIG. 8), and the update process of the ceiling price in the step ST305 is same as the step ST215 (a flowchart in FIG. 13).

The latest market price is in between the highest price and lowest price, and the market price is judged as on uptrend (ST310), the trend judging unit 103 judges whether uptrend of the market price has finished.

In other word, when the market price is judged as uptrend (ST310) and the latest market price is lower than the latest fixed bottom price (ST315), the uptrend judging unit 121 judges that uptrend of the market price has finished and become no trend state (Not uptrend or downtrend) (ST335).

In this case, the lowest price updating unit 142 stores the latest market price to the lowest price storage 140 as new lowest price (ST320). From this, acquiring the ceiling price by ceiling price obtaining unit 122A and judging downtrend by downtrend judging unit 123 become feasible by using the latest market price as the standard initial value of the lowest price. Moreover, the lowest price comparing unit 141 resets flag f2 to [0] to finish the period of temporary rise from the previous lowest price (ST325), and the fixed ceiling price obtaining unit 146 stores the ceiling price stored in the first ceiling price storage 143 as the fixed ceiling price to the second ceiling price storage 147 (ST330). The ceiling price determined at this time corresponds to the highest price in the rise period that ended.

When the latest market price is higher than the fixed bottom price (ST315), the uptrend judging unit 121 maintains the result of uptrend (ST340).

On the other hand, the latest market price is in between the highest price and lowest price, and the market price is judged as on downtrend (ST350), the trend judging unit 103 judges whether downtrend of the market price has finished.

In other word, when the market price is judged as downtrend (ST350) and the latest market price is higher than the latest fixed ceiling price (ST355), the downtrend judging unit 123 judges that downtrend of the market price has finished and become no trend state (Not uptrend or downtrend) (ST375).

In this case, the highest price updating unit 132 stores the latest market price as a new highest price to the highest price storage 130 (ST360). From this, acquiring the bottom price by bottom price obtaining unit 120A and judging uptrend by uptrend judging unit 121 becomes feasible by using the latest market price as the standard of the standard initial value of the lowest price. Moreover, the highest price comparing unit 131 resets flag f1 to [0] to finish the period of temporary decline from the previous highest price, and the fixed bottom price obtaining unit 136 stores the bottom price stored in the first bottom price storage 133 as the fixed bottom price the second bottom price storage 137 (ST370). The bottom price determined at this time corresponds to the lowest price in the decline period that ended.

When the latest market price is lower than the fixed ceiling price (ST355), the downtrend judging unit 123 maintains the result of downtrend (ST380).

When the latest market price is in between the highest and the lowest price, and the market price is judged as no trend state at that time, the trend judging unit 103 maintains the judgment of no trend state (ST380).

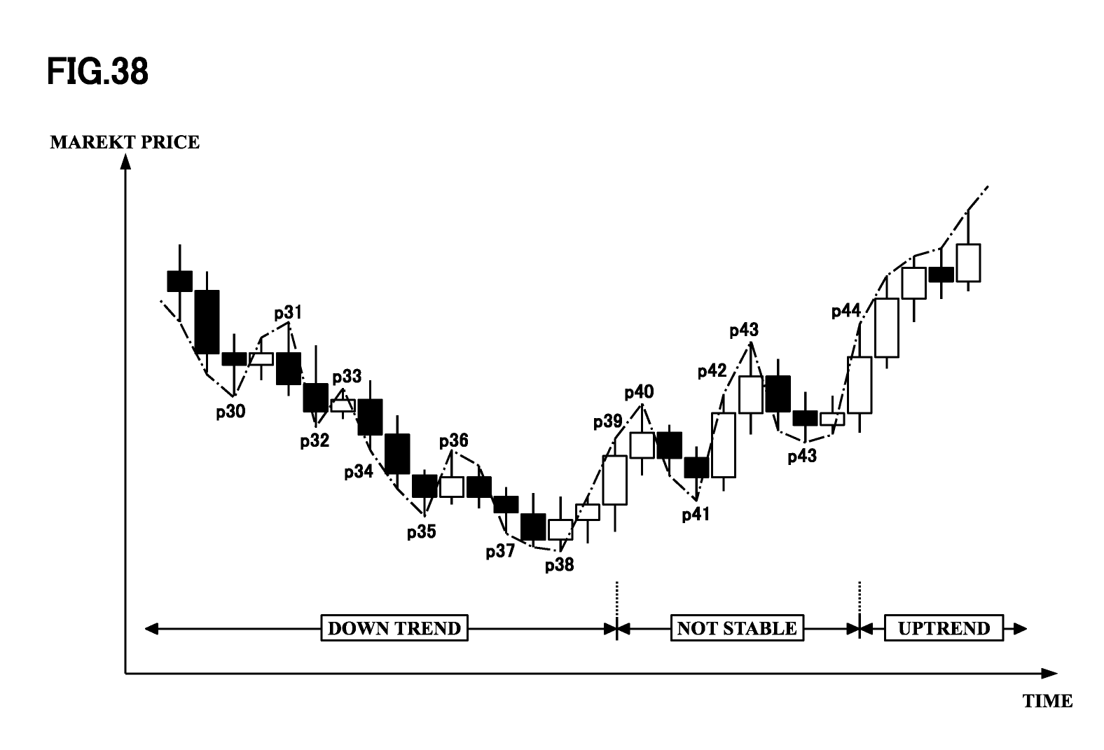

FIG. 38 is a drawing showing an example of a chart of the market price transitions from downtrend to uptrend.

In the example of the FIG. 38, the high price of the market price [p31], [p33] and [p36] are the ceiling price in the temporary rise period generated during the update of the lowest price, these series of the ceiling price has declined as time passes. In the period of the ceiling price declines, the trend judging unit 103 judges that the market price is downtrend.

The market price declines from the ceiling price of [p36], and become the lowest price [p38], then reverses and increases until the high price [p39], and the market price reaches higher than the previous ceiling price [p36], the trend judging unit 103 judges that the downtrend of the market price has ended. In this case, the high price of the [p39] is stored to the highest price storage 130 as a new highest price. Also, the low price of the [p38] stored in the first bottom price storage 133 is stored to the second bottom price storage 137 as a latest fixed bottom price.

After downward trend has ended and become no trend state, the market price updates the highest price and rises. After the market price declines from the highest price updated in [p40], the market price update the highest price in [p42] again, and the low price of [p41] is stored to the second bottom price storage 137 as the fixed bottom price. The bottom price of the [p41] is higher than the bottom price of the [p38]. The market price rises to the high price of [p43], and through the period of temporary decline, then increases until the high price [p44] higher than the [p43], the low price of the [p43] is stored to the second bottom price storage 137 as fixed bottom price. The bottom price of the p43 becomes higher than the bottom price of the p41. At this point, the bottom price is increased for twice in succession, the uptrend judging unit 121 judges that the market price become on uptrend.

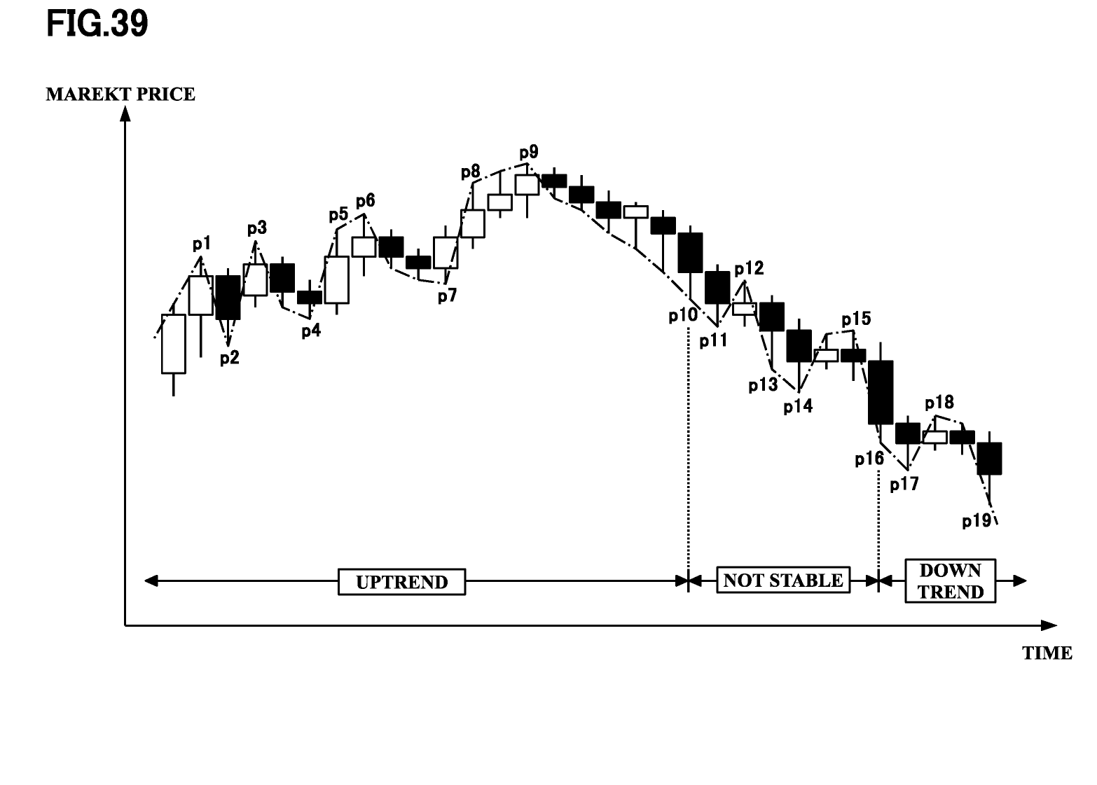

FIG. 39 is a drawing showing an example of chart of the market changes from uptrend to downtrend.

In the example of the FIG. 39, the high price of the market price [p2], [p4] and [p7] are the bottom price in the temporary decline period generated between the update of the highest price, these series of the bottom price has risen as time passes. In the period of the bottom price rises, the trend judging unit 103 judges that the market price is uptrend.

The market price rises from the bottom price of [p7], and become the highest price [p9], then reverses and decreases until the low price [p10], the market price reaches lower than the previous bottom price [p7], the trend judging unit 103 judges that the uptrend of the market price has ended. In this case, the low price of the [p10] is stored to the lowest price storage 140 as a new lowest price. Also, the high price of the [p9] stored in the first ceiling price storage 143 is stored to the first ceiling price storage 143 as a latest fixed ceiling price. After upward trend has ended and become no trend state, the market price updates the lowest price and decline. After the market price rises from the highest price updated in [p11], the market price update the lowest price in [p13] again, and the high price of [p12] is stored to the second ceiling price storage 147 as the fixed ceiling price.

The ceiling price of the [p12] is lower than the ceiling price of the p9. The market price declines to the low price of [p14], and through the period of temporary rise, then decreases until the low price [p16] low than the [p14], the high price of the [p415] is stored to the second ceiling price storage 147 as fixed ceiling price. The ceiling price of the [p43] becomes lower than the ceiling price of the [p41]. At this point, the ceiling price is decreased for twice in succession, the downtrend judging unit 123 judges that the market price become on downtrend.

Hereinbefore, the trend judging unit 103 is explained in detail.

The reception unit 109 notifies the result of judgment by the trend judging unit 103 to the terminal apparatus 2. For instance, the reception unit 109 generates the screen display data such as HTML data and sends to the terminal apparatus 2 to display comprehensible visually the result of judgment by the trend judging unit 103 (uptrend, downtrend and no trend state) on the display screen of the terminal apparatus 2.

According to the order server 1 relate to the present embodiment, the order server 1 is capable of strong support the decision of the user's transaction by automatically deciding and notifying whether the trend of market price is rise or declining.

### The Sixth Embodiment

Next, the sixth embodiment will be explained.

The order server 1 relate to the present embodiment judges the market trend (uptrend, downtrend, no trend state) in each time scale based on several market price data obtained periodically at different time scales, and outputs appropriate timing of order by the result of Judgments.

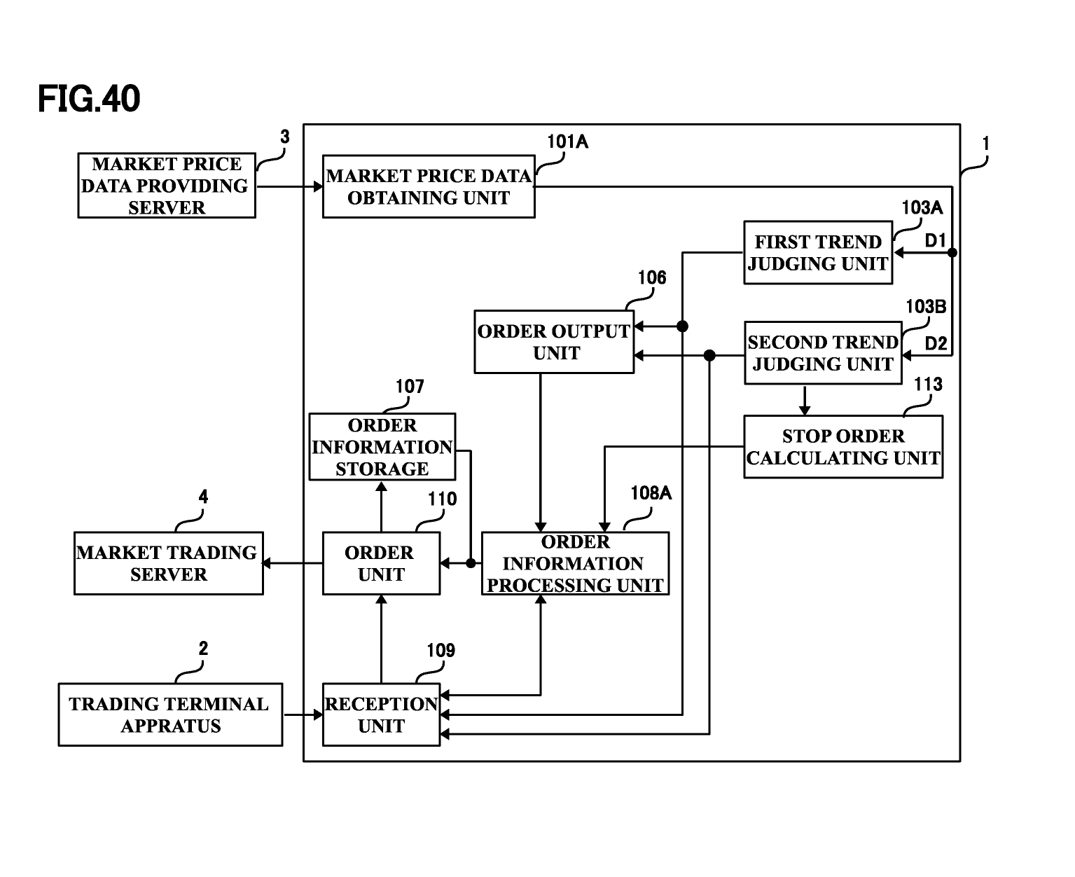

FIG. 40 is a drawing showing an example of the structure of the order server 1 relates to the sixth embodiment. The order server 1 shown in FIG. 40 has same elements as the order server 1 relates to aforementioned embodiment, such as the order information storage 107, the reception unit 109, the order unit 110 and the stop order calculating unit 113. Moreover, the order server 1 shown in FIG. 40 has the market price data obtaining unit 101A, the first trend judging unit 103A, the second trend judging unit 103B, the order outputting unit 106 and the order information processing unit 108A.

[Market Price Data Obtaining Unit 101A]

The market price data obtaining unit 101A successively obtains the market price data likewise the market price data obtaining unit 101 in FIG. 3. However, the market price data obtaining unit 101A obtains multiple market price data contains the market price data with different time scale. For example, the market price data obtaining unit 101 obtains the market price data D1 includes information of the market price (highest, lowest price and so on) in the time T1 within long time scale comparatively every time the time T1 passes, and obtains the market price data D2 includes information of the market price within the time T2 (T2<T1) with short time scale comparatively every time the time T2 passes. The market price data obtaining unit 101A may generate the market price data includes the highest and the lowest prices in predetermined time intervals as shown in the example in FIG. 4 based on the market price data provided from the market data providing server 3 sequentially.

[First Trend Judging Unit 103A and Second Trend Judging Unit 103B]

The first trend judging unit 103A judges the market price is either uptrend or downtrend based on the market price data D1 with long time scale comparatively. On the other hand, the second trend judging unit 103B judges the market price is either uptrend or downtrend based on he market price data D1 with short time scale comparatively.

The market data to be processed of the first trend judging unit 103A and second trend judging unit 103B is different (D1 and D2), however the processing details are same as trend judging unit 103 shown in FIG. 34 and FIG. 35.

[Order Outputting Unit 106]

The order outputting unit 106 places the buy order when the market price is judged as uptrend in the both the first trend judging unit 103A and the second trend judging unit 103B, and places the sell order when the market price is judged as downtrend in the both first trend judging unit 103A and the second trend judging unit 103B.

For instance, from the condition of one of the first trend judging unit 103A and second trend judging unit 103B in the market price is not on uptrend (on downtrend or no trend state) to the condition of both the first trend judging unit 103A and second trend judging unit 103B in the market price are on uptrend, the order outputting unit 106 outputs the buy order. Specifically, the order outputting unit 106 outputs the buy order when the judgment of uptrend has continued in the first trend judging unit 103A with long time scale, and the judgment of the uptrend has begun in the second trend judging unit 103B with short time scale (shifted from non-uptrend to uptrend).

For instance, from the condition of one of the first trend judging unit 103A and second trend judging unit 103B in the market price is not on downtrend (on uptrend or no trend state) to the condition of both the first trend judging unit 103A and second trend judging unit 103B in the market price are on downtrend, the order outputting unit 106 outputs the buy order. Specifically, the order outputting unit 106 outputs the buy order when the judgment of downtrend has continued in the first trend judging unit 103A with long time scale, and the judgment of the downtrend has begun in the second trend judging unit 103B with short time scale (shifted from non-downtrend to downtrend).

In other words, the order outputting unit 106 outputs buy-sell orders when the market trend is judged based on the market price data with short time scale, and the market trend is judged based on the market price data with long time scale are start to correspond.

[Order Information Processing Unit 108A]

The order information processing unit 108A performs the same process of the order information processing unit 108 in the FIG. 3, and generates the order information after receives buy-sell orders from the order outputting unit 106 and stores the information to the order information storage 107.

In other words, when the order information processing unit 108A receives the indication of buy order from the order outputting unit 106, generate the order information to output the new buy order and the order information to output buy orders for settlement of the contracted sell order (long position) shown in information stored in the order information storage 107. Moreover, when the order information processing unit 108A receives the indication of sell order from the order outputting unit 106, generate the order information to output the new sell order and the order information to output buy orders for settlement of the contracted buy order (short position) shown in information stored in the order information storage 107.

When order information is generated automatically, the order information processing unit 108 may not store the order information to the order information storage 107 until order permission obtained from terminal apparatus 2. In other words, when the reception unit 109 receives response from the terminal apparatus 2 that permits an order relate to the order information automatically generated, the order information is stored to the order information storage 107.

For instance, the reception unit 109 send the notification relate to order information shown in order information to the terminal apparatus 2 when the order information is automatically generated according to the order instruction of the order outputting unit 106 in the order information processing unit 108A. Specifically, the reception unit 109 has the function of sending and receiving email, and sends the email to users' email address with the URL to the web page for confirming order of the reception unit 109. When user of the terminal apparatus 2 accesses the aforementioned URL written in the email, the reception unit 109 send the screen data to confirm user that permission or not-permission the order relate to the order information automatically generated. The reception unit 109 received the response of permission or non-permission that the user entered in the confirmation screen from terminal apparatus 2, and transfer to the order information processing unit 108A.

[Stop Order Calculating Unit 113]

Between two trend judging unit (103A, 103B), The stop order calculating unit 113 calculates the price of stop order based on the bottom price and ceiling price obtained in the bottom price obtaining unit 120A of the second trend judging unit 103B with short time scale and the ceiling price obtaining unit 122A (FIG. 35).

Hereafter, the order server 1 with aforementioned component related to the present embodiment will be explained in detail.

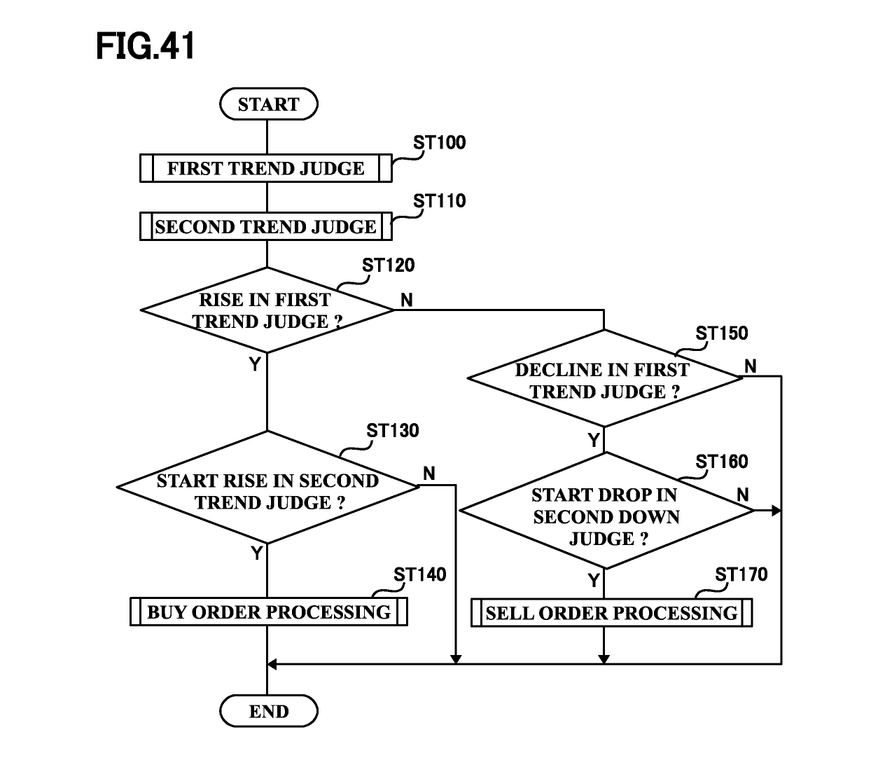

FIG. 41 is a flowchart to explain movement of the order server 1 processes the order by deciding automatically favorable conditions of buying and selling based on the fluctuations of market prices. The order server 1 repeatedly performs the process shown in FIG. 41.

The first trend judging unit 103A judges the market price is either uptrend or downtrend based on the market price data D1 obtained in the market price data obtaining unit 101 with long time scale comparatively (ST100). Moreover, the second trend judging unit 103B judges the market price is either uptrend or downtrend based on the market price data D1 obtained in the market price data obtaining unit 101 with short time scale comparatively (ST110).

Each trend judging unit (103A, 103B) obtains the bottom price in the temporary decline period during updating the highest price. The bottom price increased once, or several times in succession, each trend judging unit (103A, 103B) judges that the market price is on uptrend. Each trend judging unit (103A, 103B) obtains the ceiling price in the temporary rise period during updating the lowest price. The ceiling price decreased once, or several times in succession, each trend judging unit (103A, 103B) judges that the market price is on downtrend. The processes, for example explained in FIG. 36 and FIG. 37, are performed in step ST100 and ST110.

The market price is judged as uptrend by the first trend judging unit 103A (ST120), and the second trend judging unit 103B judged that the uptrend on the market price has begun (ST130), the order outputting unit 106 outputs the buy order. From this, the order information processing unit 108 automatically generates the order information of buy order (ST140).

The market price is judged as downtrend by the first trend judging unit 103A (ST150), and the second trend judging unit 103B judged that the downtrend on the market price has begun (ST160), the order outputting unit 106 outputs the buy order. From this, the order information processing unit 108A generates the order information of sell order (ST170).

The order information is not generated as the order instruction is not output from the order outputting unit 106 when the result of judgment from first trend judging unit 103A and second trend judging unit 103B are opposite (one is judged as uptrend and another is judged as downtrend) and the result of judgment from first trend judging unit 103A and second trend judging unit 103B is no trend state (not uptrend or downtrend).

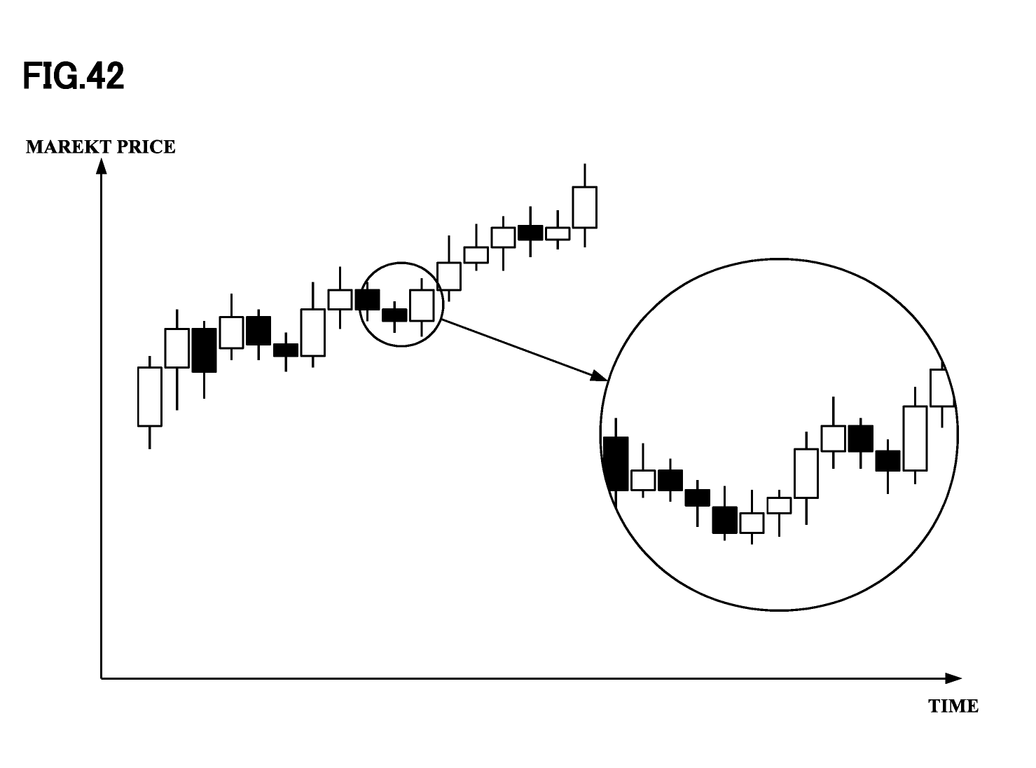

FIG. 42 is a drawing showing an example of charts of the market price with different time step.

In FIG. 42, the right side indicates the candlestick chart with short time scale, the left side indicates the candlestick chart with longtime scale. As shown in Figure, one candlestick with long time scale corresponds to several candlesticks with short time scale. For example, one candlestick for a day corresponds to 12 candlesticks for an hour.

For instance, each market price data obtained by the market price data obtaining unit 101 corresponds to each candle stick shown in FIG. 42. Then, The first trend judging unit 103A judges the market trend in the candlestick chart with long time scale on the left side of Figure, and the second trend judging unit 103B judges the market trend in the candlestick chart with short time scale on the right side of Figure.

For instance, the market price is judged as uptrend by the first trend judging unit 103A with the long time scale shown in the left side of the drawing, the order outputting unit 106 outputs the buy order when the market price is judged as uptrend by the second trend judging unit 103B with the short time scale shown in the right side of the drawing.

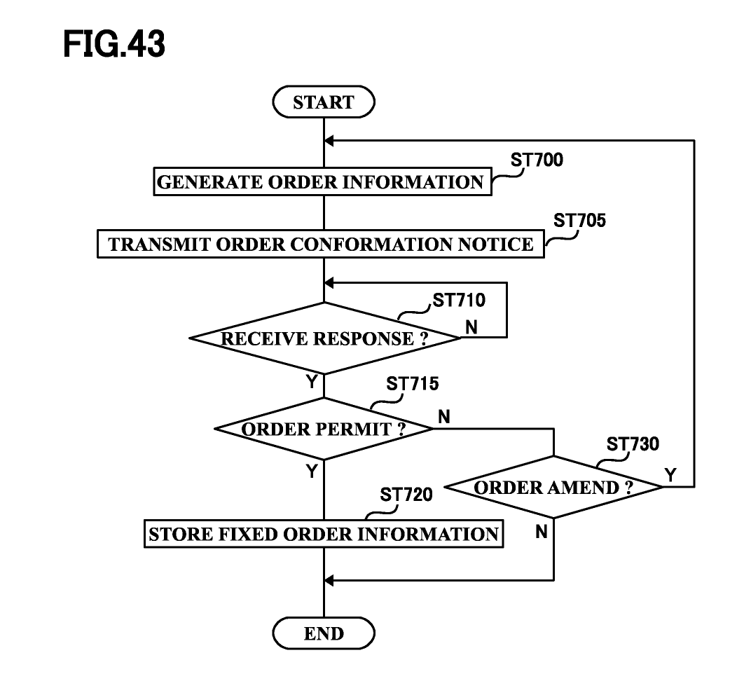

FIG. 43 is a flowchart to explain the processes of buy-sell orders (ST 140, 170: FIG. 41).

Once the buy-sell orders are output, the order information processing unit 108A generates order information to output new buy-sell orders or order information to output settlement of the contracted position. When the order information is generated in the order information processing unit 108A, the reception unit 109 sends the notification to request confirm the order information shown in the order information generated to the terminal apparatus 2, and waits the response from the terminal apparatus 2 (ST710). When the reception unit 109 receives response of the permission of the order (ST715), the order information processing unit 108A stores the order information generated in step ST700 to the order information storage 107 (ST720). The order unit 110 sends the ordering data to the market trading server 4 according to the determined order information stored in the order information storage 107.

On the other hand, when the response from the terminal apparatus 2 is to request the modification of the order information (ST730), the order information processing unit 108A generate the ordering data modified according to the request (ST700), and the reception unit 109 sends again the notification to confirm the ordering data modified to the terminal apparatus 2 (ST710). In addition, when the response from the terminal apparatus 2 indicates non-permission of the order, the order information processing unit 108A destroys the order information generated instead of storing to the order information storage 107.

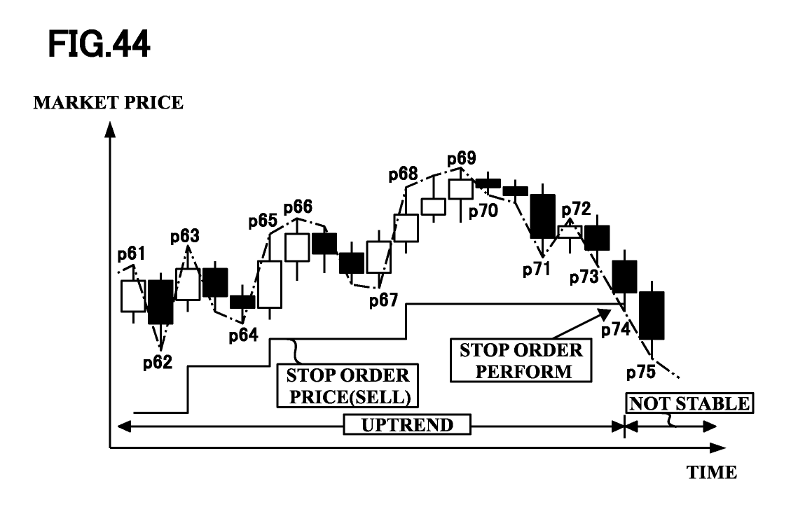

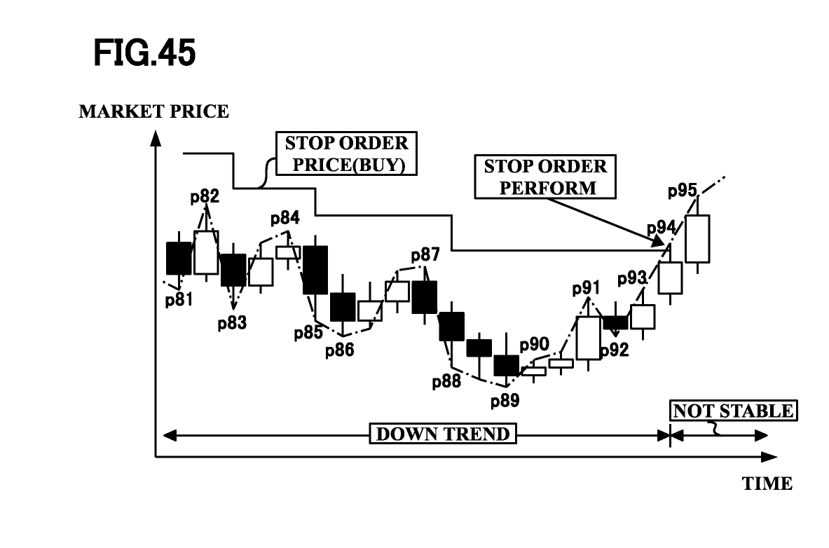

FIG. 44 and FIG. 45 are drawings to explain the movement of changing the price of stop order at the order server 1 relate to the sixth embodiment. FIG. 44 indicates an example of changing the sell order price of stop order, and FIG. 45 indicates an example of changing the buy order price of stop order. In each figure, the stepwise graph shown with candlestick chart indicates transition in the price of the stop order.

In the example of FIG. 44, short position is held in the condition of uptrend of market price, and the sell order of stop order is placed to cut losses due to a decline in the market price. Stop order is updated at the timing [p63], [p65] and [p68] the bottom price [p62], [p64] and [p67] are determined. Stop order is set a given offset value (or a given percentage) lower than the bottom price. After this, when market price become lower than the price of stop order at the timing of [p74], the order unit 110 sends the ordering data of sell stop order to the market trading server 4, and short position is settled.

In the example of FIG. 45, long position is held in the condition of downtrend of market price, the buy order of stop order is set to cut losses due to a rise in the market price.

Stop order is updated at the timing [p83], [p85] and [p88] the ceiling price [p82], [p84] and [p87] are determined. Stop order is set a given offset value (or a given percentage) higher than the ceiling price. After this, when market price become lower than the price of stop order at the timing of [p94], the order unit 110 sends the ordering data of buying of stop order to the market trading server 4, and long position is settled.

Furthermore, an order of stop order in the present embodiment can be placed according to the indication from the terminal apparatus 2. Also an order of stop order in the present embodiment can be placed automatically according to the indication from the order outputting unit 106. For instance, when the order information processing unit 108A receives a new buy-sell orders from the order outputting unit 106, generates the new buy-sell orders information. And the order information processing unit 108A may automatically generates the order information relate to stop order for loss cut and stores information to the order information storage 107.

As stated above, according to the order server 1 relate to the present embodiment, the market trend is judged based on the market price data D1 and D2 obtained cyclically with different time scale, and the buy-sell orders are output when the trend of market price judged based on the market price data D2 with short time scale coincide with the trend of market price judged based on the market price data D1 with long time scale.

Generally, the constant trend is continued in long time span, the trend with same direction as long time span is predominate in short time span. Therefore, as stated above, the trading with high rate of success can be done by ordering buy-sell orders at the timing of the trend of short time span begin to agree with the trend of long time span.

Also, according to the order server 1 relate to the present embodiment, when the buy-sell order is executed based on the result of judgment of the trend of the market price, the notification to confirm the order is sent to the terminal apparatus 2 of the user, then the order is determined in case where the response of the notification that allows order from the terminal apparatus 2 is received.

In other words, when the order server 1 determines the buy-sell orders based on the result of judgment of the trend, permission of the user is needed. Therefore, reduce the risk of occurrence of the losses due to transaction carried out automatically in adverse condition user do not desire.

Next, the example of modification of the sixth embodiment will be explained.

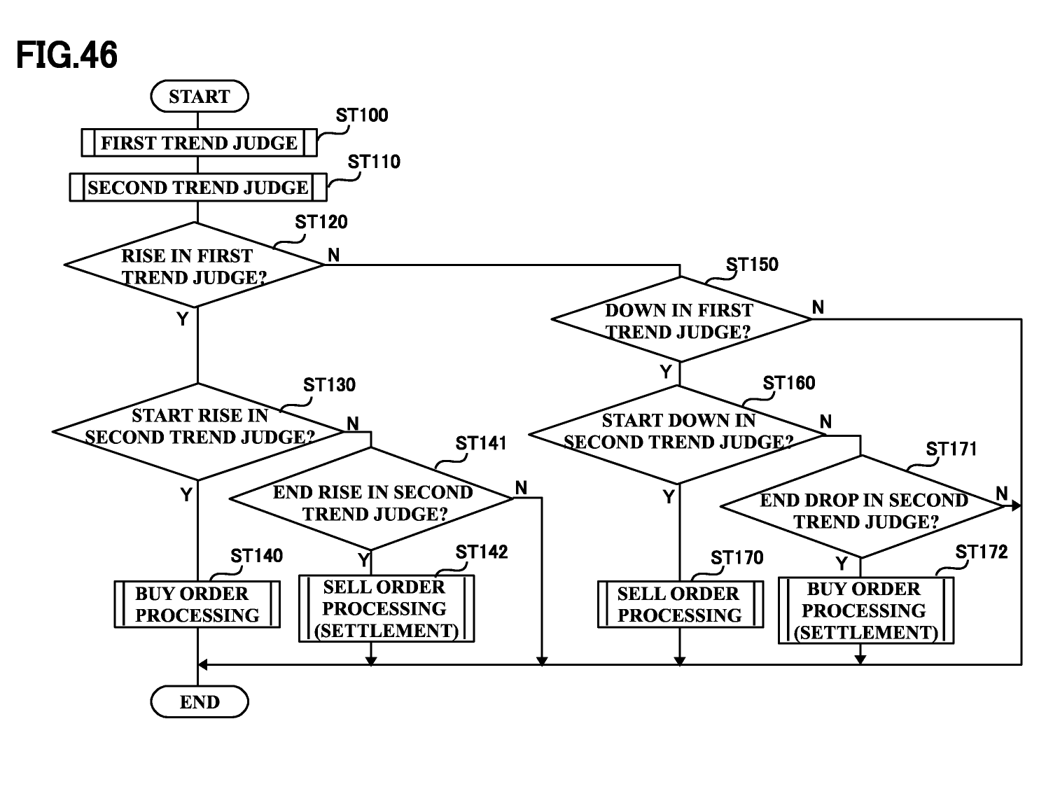

FIG. 46 is a flowchart to explain the movement to execute buy and sell orders in the order server 1 relate to a variant of the sixth embodiment.

Compare to the flowchart shown in FIG. 41, the flowchart shown in FIG. 46 is added step ST141, ST142, ST171 and ST172.

The market price is judged as on uptrend in the first trend judging unit 103A (ST120), and the market price is judged that the period of temporary rise has ended in the second trend judging unit 103B (ST141), the order outputting unit 106 outputs the sell order to settle the contracted buy order (short position) stored in the order information of the order information storage 107. The order information processing unit 108A received this instruction automatically generates the order information of the sell order for settle the short position (ST142).

On the other hand, the market price is judged as on downtrend in the first trend judging unit 103A (ST150) and the market price is judged that the period of temporary decline has ended in the second trend judging unit 103B (ST171), the order outputting unit 106 outputs the buy order to settle the contracted sell order (long position).

The order information processing unit 108A received this instruction automatically generates the order information of the buy order for settle the long position (ST172).

The order processing in step ST142 and ST172 are same as the order processing explained in the flowchart of FIG. 43, and the order is determined when user permits the order information.

As stated above, according to order server 1 relate to the example of modification of the present embodiment, the new buy-sell order is output when the trend with short time span coincide with the trend with long time span. The settlement of the contracted order (position) is output when the trend with short time spans starts becoming to opposite to the trend with long time span. Generally, the trend with same direction as long time span is expected as predominate in short time span. Therefore, executes buying and selling by focusing on the period that short time span and long time span has a trend in same direction, the possibility of the expected market price deviates can be reduced and the trading with high stability can be done.

### The Seventh Embodiment

Next, the seventh embodiment will be explained.

The order server 1 judges the market trend based on the time shift of the bottom price and ceiling price of the market price as well as based on the transition of the technical index. And, buy or sell order is placed when the result of judgment of the trend based on the technical index is opposite to the result of judgment of the trend based on the bottom price and ceiling price of the market price are opposite (one is judged as uptrend and another is judged as downtrend).

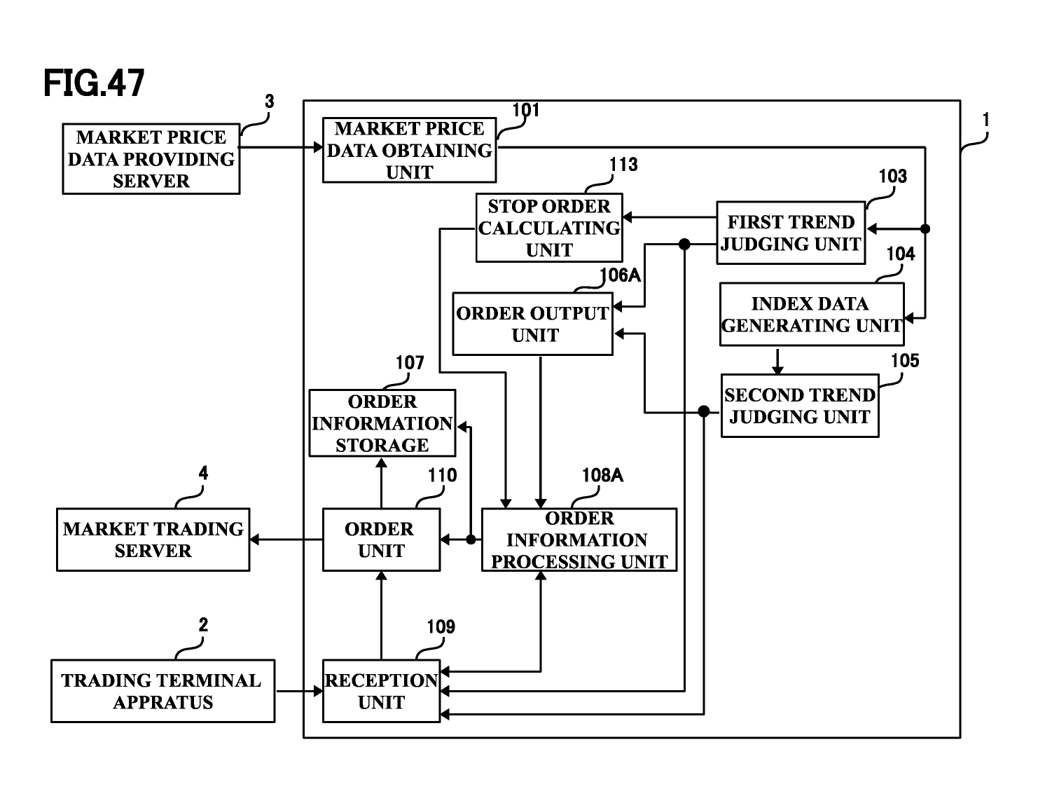

FIG. 47 is a drawing showing an example of structure of the order server 1 relates to the seventh embodiment. The order server 1 shown in FIG. 47 has same elements as the order server 1 shown in FIG. 3 such as the market price data obtaining unit 101, the order information storage 107, the reception unit 109, the order unit 110 and the stop order calculating unit 113. The order server 1 shown in FIG. 47 also has same elements as the order server 1 shown in FIG. 40 such as the order information processing unit 108A, and the first trend judging unit 103, the index data generating unit 104, the second trend judging unit and the order outputting unit 106A.

[First Trend Judging Unit 103]

The first trend judging unit 103 has same elements as the trend judging unit 103 (FIG. 3), and execute same processes. In the explanation of the present embodiments, it is called the first trend judging unit 103 instead of the trend judging unit 103 to clearly distinguish from the second trend judging unit.

[Index Data Generating Unit 104]

The index data generating unit 104 sequentially generated the given technical index data showing the trend of the market price, such as RSI (relative strength index), based on the market data obtained in the market price data obtaining unit 101. The technical index data shown in the index data indicates the market price is either uptrend or downtrend based on the change in direction of the certain price.

[Second Trend Judging Unit]

The second trend judging unit judges the market price is either uptrend or downtrend based on the technical index data generated in the index data generating unit 104. In other words, the second trend judging unit judges the market price is either uptrend or downtrend depend on whether the changes of the index data satisfies the predetermined conditions.

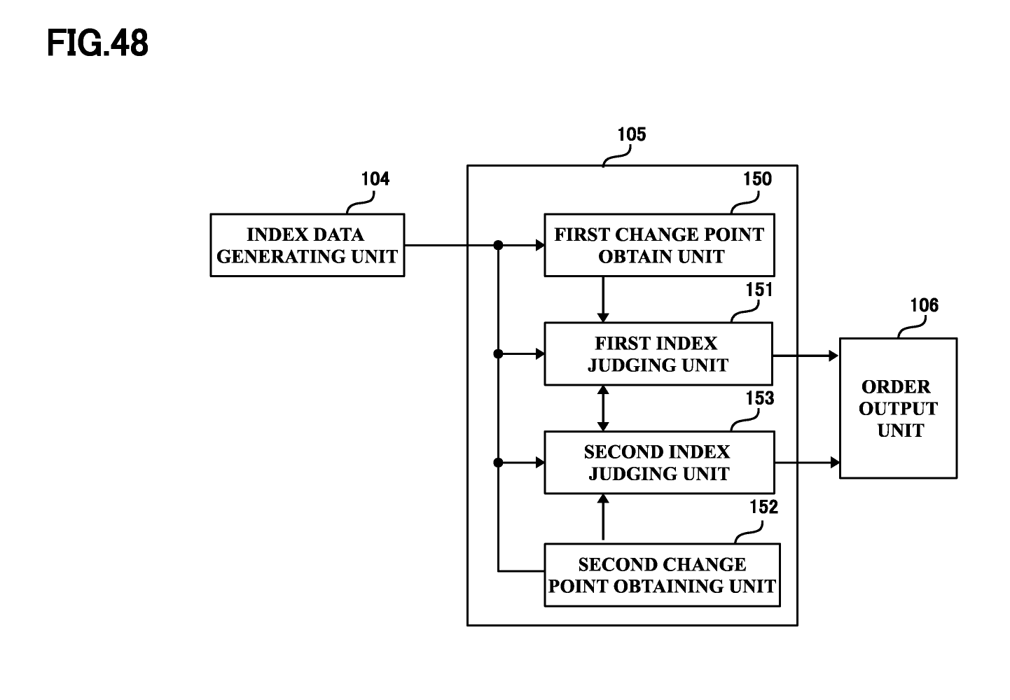

FIG. 48 is a drawing showing an example of the structure of the second trend judging unit.

The second trend judging unit shown in FIG. 48 has the first change point obtaining unit 150, the first index judging unit 151, the second change point obtaining unit 152 and the second index judging unit 153.

The first change point obtaining unit 150 obtains the technical index at the beginning change point when the technical index shifts the direction to the downtrend of the market price. For instance, the first change point obtaining unit 150 obtains technical index at the beginning change point as a turning point when the technical index shifts certain price or percentage towards the direction indicates downtrend of the market price.

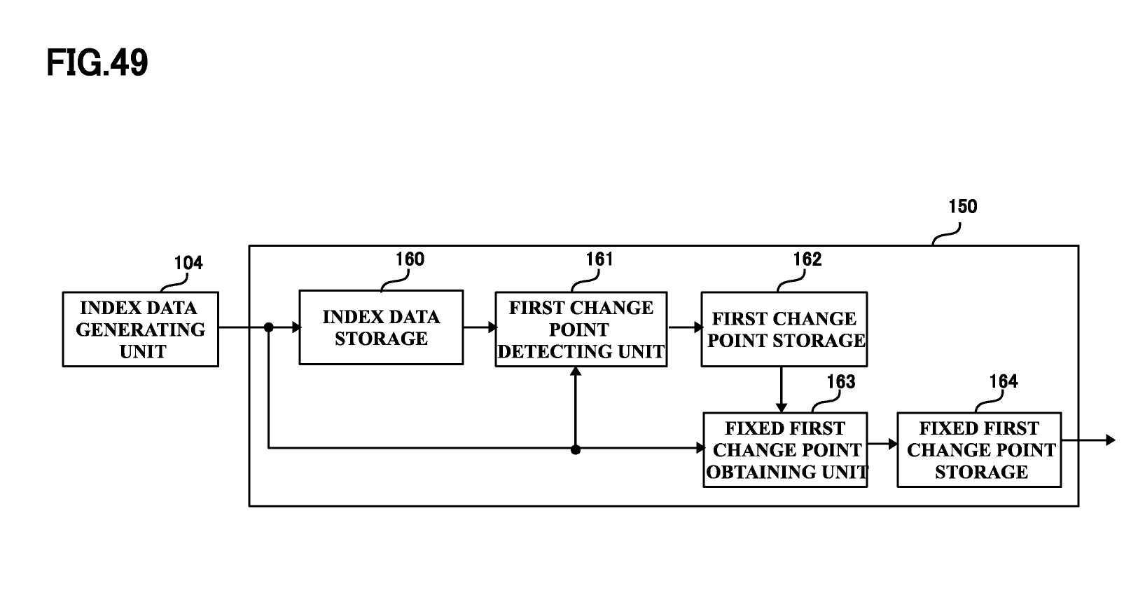

FIG. 49 is a drawing showing an example of the structure of the first change point obtaining unit 150.

The first change point obtaining unit 150 shown in FIG. 49 has the index data storage 160, the first change point detecting unit 161, the first change point storage unit 162, the fixed first change point obtaining unit 163 and the fixed first change point storage 164.

The index data storage 160 stores the technical index data generated sequentially at the index data generating unit 104.

The first change point detecting unit 161 compares the latest technical index data generated in the index data generating unit 104 and the previous technical index data stored in the index data storage 160, and detects whether the previous technical index is shifted towards downtrend than the latest technical index. For instance, in case where technical index is RSI, the first change point detecting unit 161 detects that technical index shifts towards downwards when the previous technical index is lower than the latest technical index.

When the first change point detecting unit 161 detects shifts of the technical index towards downtrend of the market price (Reduction of RSI), the first change point detecting unit 161 sets the flag f3 to [1] and resets the flag f4 to [0].

When the first change point detecting unit 161 changes the flag f3 to [1] from [0] according to the result of comparison of the previous technical index and the latest technical index, the first change point detecting unit 161 stores the information related to the previous technical index as a change point to the first change point storage unit 162. For instance, the first change point detecting unit 161 stores the technical index at the change point and information related to the time to the first change point storage unit 162.

The fixed first change point obtaining unit 163 compares the technical index data generated in the index data generating unit 104 and technical index data of recent change point stored in the first change point storage unit 162. The fixed first change point obtaining unit 163 stores the technical index data of recent change point as a determined change point to the fixed first change point storage 164 when the latest technical index shifts a given value or percentage towards the direction indicates downtrend of the market price compare to the technical index at the recent change point.

Hereinbefore, the first change point obtaining unit 150 is explained in detail.

Return to FIG. 48.

The second change point obtaining unit 152 obtains the technical index on the change point where the variation starts when the technical index shifts towards the direction indicates uptrend of the market price. For example, the second change point obtaining unit 152 obtains technical index at the beginning change point as a turning point when the technical index shifts certain price or percentage towards the direction indicates uptrend of the market price.

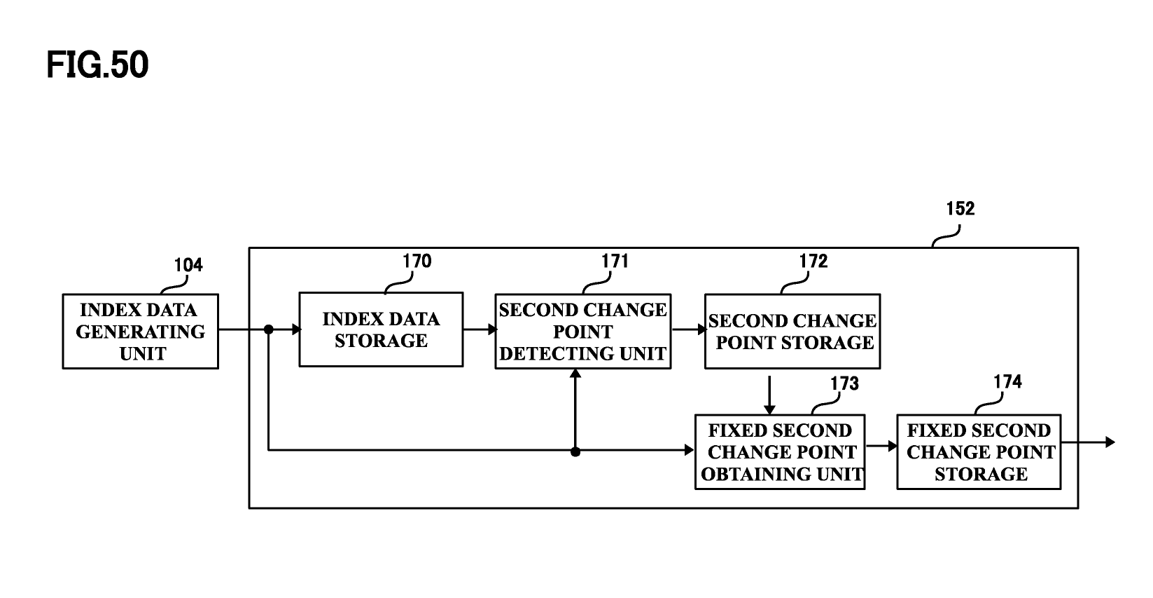

FIG. 50 is a drawing showing an example of the structure of the second change point obtaining unit 152.

The second change point obtaining unit 152 shown in FIG. 50 has the index data storage 170, the second change point detecting unit 171, the second change point storage 172, the fixed second change point obtaining unit 173 and the fixed second change point storage 174.

The index data storage 170 stores the technical index data generated sequentially at the index data generating unit 104. The index data storage 170 and the index data storage 160 (FIG. 49) may be collaborated.

The second change point detecting unit 171 compares the latest technical index data generated in the index data generating unit 104 and the previous technical index data stored in the index data storage 170, and detects whether the previous technical index is shifted towards uptrend than the latest technical index. For instance, in case where technical index is RSI, the second change point detecting unit 171 detects that technical index shifts toward upward when the previous technical index is higher than the latest technical index.

When the second change point detecting unit 171 detects the shifts of technical index toward uptrend of the market price (rise of RSI), sets the flag f4 to [1] and resets the flag f3 to [0].

When the second change point detecting unit 171 changes the flag f4 to [1] from [0] according to the result of comparison of the previous technical index and the latest technical index, the second change point detecting unit 171 stores the information relate to the previous technical index as a change point to the second change point storage 172, stores the information related to the previous technical index as a change point to the second change point storage 172. For instance, the second change point detecting unit 171 stores the technical index at the change point and information related to the time to the second change point storage 172.

The fixed second change point obtaining unit 173 compares the technical index data generated in the index data generating unit 104 and technical index data of recent point of change point stored in the second change point storage 172. The fixed second change point obtaining unit 173 stores the technical index data of recent change point as a determined change point to the fixed second change point storage 174 when the latest technical index shifts certain price or percentage towards the direction indicates uptrend of the market price compare to the technical index at the recent change point.

Hereinbefore, the second change point obtaining unit 152 is explained in detail.

Return to FIG. 48.

The first index judging unit 151 judges that the downtrend of the market price has begun when the technical index, at the change point obtained in the first change point obtaining unit 150, shifts towards the direction indicated downtrend once or several times in succession. For instance, in case where technical index is RSI, when RSI is placed in the area shows ‘overbought’ (higher than the 75% for instance), and the change point declines once or several times in succession, the first index judging unit 151 judges that the downtrend of the market price has begun.

The second index judging unit 153 judges that the uptrend of the market price has begun when the technical index, at the change point obtained in the second change point obtaining unit 152, shifts towards the direction indicated uptrend once or several times in succession. For instance, in case where technical index is RSI, when RSI is placed in the area shows ‘oversold’ (lower than the 25% for instance), and the change point rises once or several times in succession, the second index judging unit 153 judges that the uptrend of the market price has begun.

[Order Outputting Unit 106A]

Return to FIG. 47.

The order outputting unit 106A outputs the sell order when the market price is judged as on uptrend in the first trend judging unit 103 and the market price is judged that downtrend of the market price has begun by the second trend judging unit. Furthermore, the order outputting unit 106A outputs the buy order when the market price is judged as on downtrend in the first trend judging unit 103 and the market price is judged that uptrend of the market price has begun by the second trend judging unit.

Hereafter, the order server 1 with aforementioned component related to the present embodiment will be explained in detail.

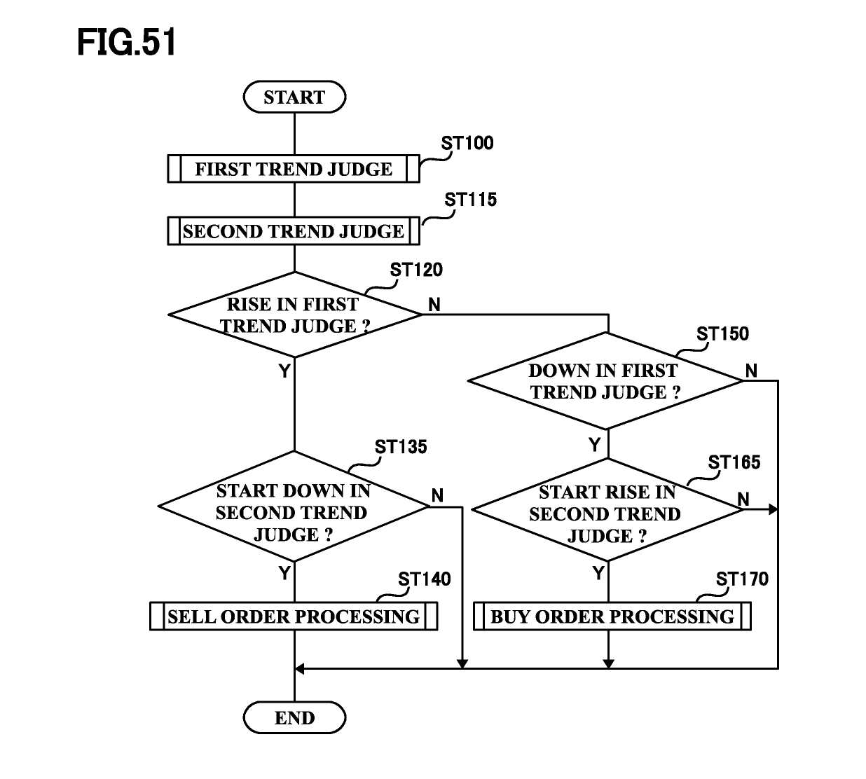

FIG. 41 is a flowchart to explain movement of the order server 1 processes the order by deciding automatically favorable conditions of buying and selling based on the fluctuations of market prices. The order server 1 repeatedly performs the process shown in FIG. 51.

The first trend judging unit 103 judges the market price is either uptrend or downtrend based on the market price data obtained sequentially from the market price data obtaining unit 101 (ST100: FIG. 36, 37). In other words, the first trend judging unit 103 obtains the bottom price in the temporary decline period during updating the highest price, the bottom price increased once, or several times in succession, first trend judging unit 103 judges that the market price is on uptrend. Also, the first trend judging unit 103 obtains the ceiling price in the temporary rise period during updating the lowest price, the ceiling price declined once, or several times in succession, first trend judging unit 103 judges that the market price is on downtrend.

On the other hand, the second trend judging unit judges the market price is either uptrend or downtrend based on the technical index data generated sequentially from the index data generating unit 104 (ST115). For instance, in case where technical index is RSI, the second trend judging unit obtains the change point that starts to decline the value of RSI, when the change point declines once or several times, the market price is judged as on downtrend. The second trend judging unit obtains the change point that starts to increase the value of RSI, the change point rise once or several times, the market price is judged as on uptrend.

When the market price is judged as uptrend in the first trend judging unit 103 (ST120), it is judged that the downtrend of the market price has begun in the second trend judging unit, the order outputting unit 106A outputs the sell order. From this, the order information processing unit 108A automatically generates the order information of the sell order (ST140: FIG. 42).

When the market price is judged as downtrend in the first trend judging unit 103 (ST150), it is judged that the uptrend of the market price has begun in the second trend judging unit 105, the order outputting unit 106A outputs the buy order. From this, the order information processing unit 108A automatically generates the order information of the buy order (ST170: FIG. 43).

The order information is not generated as the order instruction is not output from the order outputting unit 106 when the result of judgment of the first trend judging unit 103 and second trend judging unit are on same trend, or the result of judgment of one of the first trend judging unit 103 and second trend judging unit is no trend state (Not uptrend or downtrend).

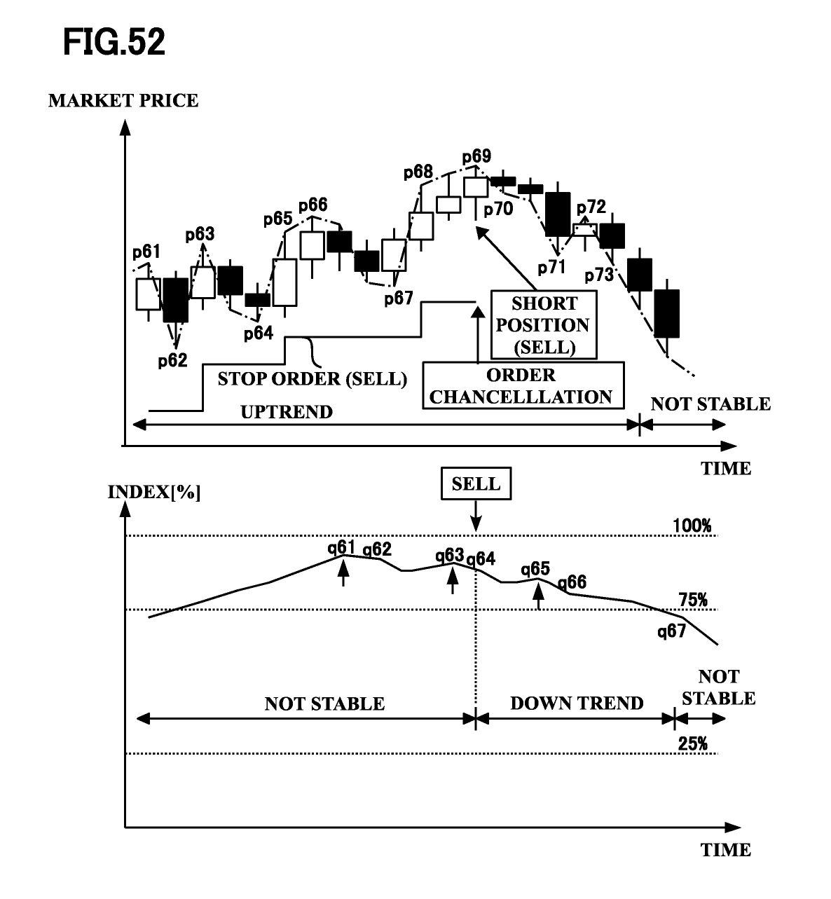

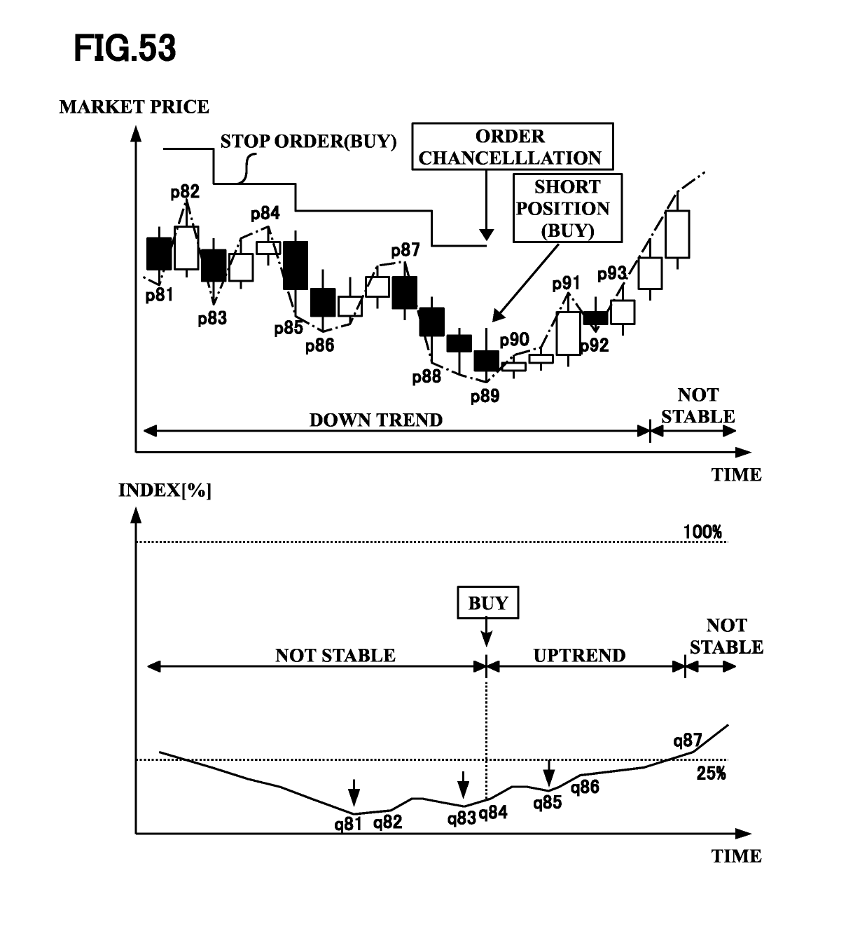

FIG. 52 and FIG. 53 are drawings showing examples of chart of market price and technical index. FIG. 52 indicates the chart a case of the selling order instruction is output, and FIG. 53 indicates the chart a case of the buying order instruction is output.

The upper side of FIG. 52 and FIG. 53 shows the candlestick chart of the market price. The dashed line shown on piles of the candlestick chart indicates the highest price storage 130 refer to judge transition in the market price. In particular, the dashed line is tied with the high price in the candlestick chart when the highest price is updated in the highest price updating unit 132, the low price in the candlestick chart when the bottom price is updated in the bottom price updating unit 135, the low price in the candlestick chart when the lowest price is updated in the lowest price updating unit 142 and the high price in the candlestick chart when the ceiling price is updated in the ceiling price updating unit 145.

On the other hand, the underside of FIG. 52 and FIG. 53 indicates RSI chart. RSI is an indicator called as oscillator, varies in the range of 0-100% as shown in Figure. The second trend judging unit decides the trend of the market price based on change point of RSI in the range of 75-100% indicates “overbought” and in the range of 0-25% indicates “oversold”.

In the example of the FIG. 52, the first trend judging unit 103 judges that uptrend from [p61] to [p73] in the market price data. In contrast, the second trend judging unit judges that downtrend begins in the index data (RSI) of [p64]. The second trend judging unit starts to judge on downtrend, the judgment of the first trend judging unit 103 is the opposite of the result as [uptrend]. Therefore the order outputting unit 106 outputs the sell order at the timing of the index data of [p64] shown in the FIG. 52.

The order information processing unit 108A generates the order information to order new sell orders when received the instruction of sell orders. In this case, the order information of sell orders to settle an account can be generated when long position is held. Moreover, the order information can be generated to cancel stop order when stop order for the loss cut of short position is set.

On the other hand, in the example of the FIG. 53, the first trend judging unit 103 judges that downtrend from [p81] to [p93] in the market price data. In contrast, the second trend judging unit judges that downtrend begins in the index data (RSI) of [p84]. The second trend judging unit starts to judge on uptrend, the judgment of the first trend judging unit 103 is the opposite of the result as [downtrend]. Therefore the order outputting unit 106 outputs the buy order at the timing of the index data of [p84] shown in the FIG. 53.

The order information processing unit 108A generates the order information to order new buy orders when received the instruction of buy orders. In this case, the order information of buy orders to settle an account can be generated when short position is held. Moreover, the order information can be generated to cancel stop order when stop order for the loss cut mode of long position is set.

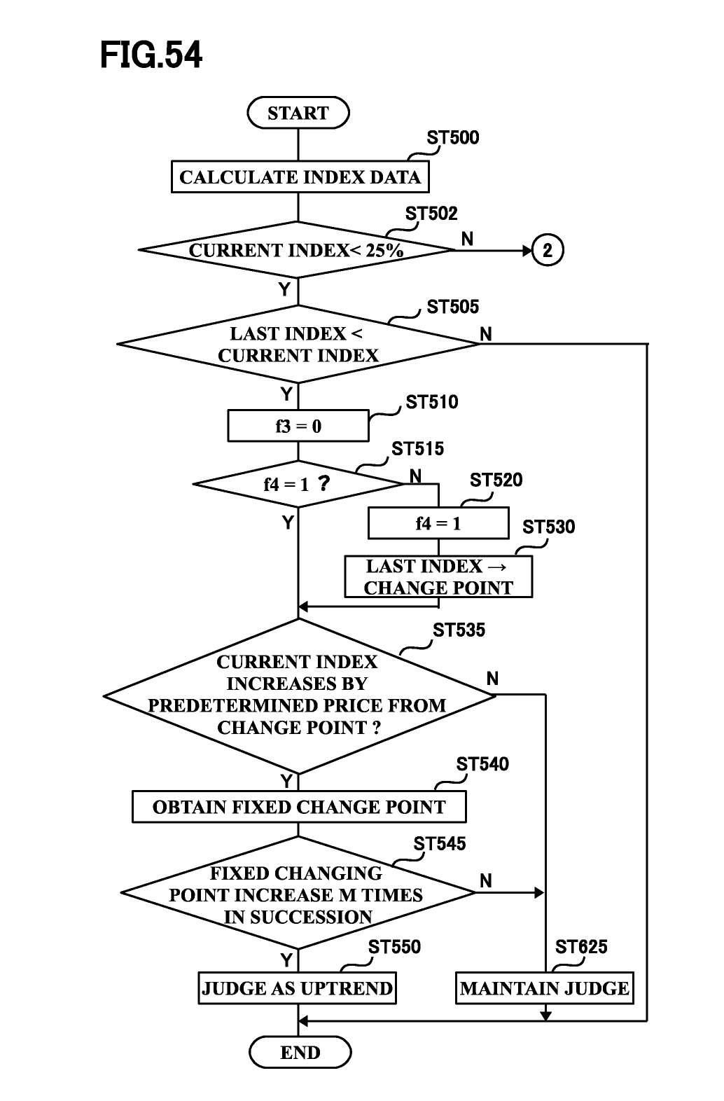

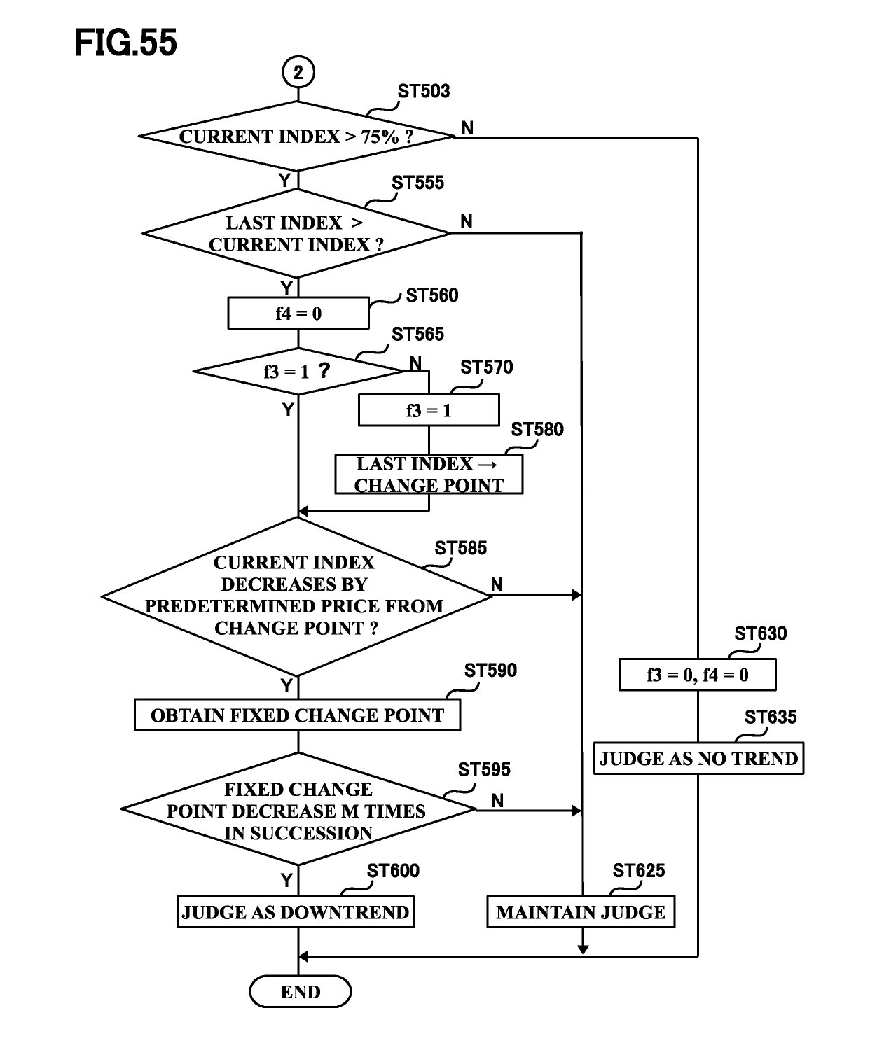

Next, the determination process based on the technical index at the second trend judging unit will be explained by referencing the flowcharts of FIG. 54 and FIG. 55.

For example, the index data generating unit 104 calculates RSI as the technical index (ST500). The second trend judging unit judges whether the current technical index calculated by the index data generating unit 104 is lower than 25%. Technical index is lower than 25% indicates that signs of ‘oversold’ become apparent in the market.

When the latest technical index is lower than 25% (ST502), the second change point detecting unit 171 compares the latest technical index calculated in the index data generating unit 104 and the previous technical index before stored in the order outputting unit 106. As a result of comparison, the latest technical index is higher than the previous technical index, the second change point detecting unit 171 resets the flag f3 to [0] indicates decline of the technical index. In this case, the second change point detecting unit 171 confirm the value of the flag f4 indicates a rise of technical index (ST515), when the flag f4 is set to [0], the second change point detecting unit 171 sets the flag f4 to [1] (ST520), and stores the information relate to the previous technical index (for example, the technical index and its time) as a change point to the second change point storage 172 (ST530).

The latest technical index is higher than the previous technical index (ST505), the fixed second change point obtaining unit 173 compares the recent change point stored in the second change point detecting unit 171 and latest technical index (ST535). When the latest technical index become a given price (or a given percentage) higher than the recent change point, the fixed second change point obtaining unit 173 stores the recent change point as a determined change point to the fixed second change point storage 174 (ST540).

When a new change point is stored to the fixed second change point storage 174 (ST540), the second index judging unit 153 compares the new change point and the previous change point, and judges whether the change point is increased based on the result of comparison (ST545). The change point rises a predetermined number of times (M times) in succession, the second index judging unit 153 judges that the market price is uptrend (ST550).

When the latest technical index is lower than 25% (ST502), the latest technical index is lower than the previous technical index (ST505), the latest technical index do not rise more than a given value (or given percentage) compared to the recent change point (ST535), the change point do not rise a predetermined number of times in succession (ST545), the second trend judging unit maintains the current result of judgment.

On the other hand, when the current technical index is higher than 25% (ST 503), the second trend judging unit judges whether the current technical index is higher than 75%. Technical index is higher than 75% indicates that signs of ‘overbought’ become apparent in the market.

The latest technical index is higher than 75% (ST503), the first change point detecting unit 161 (FIG. 49) compares the latest technical index and the previous technical index (ST555), when the latest technical index is lower than the previous technical index, reset the flag f4 shows rise of technical index to [0] (ST560). In this case, the first change point detecting unit 161 confirm the value of the flag f3 shows decline of technical index (ST565), when the flag f3 is set to [0], set the flag f3 to [1] (ST570) and stores the information relate to the previous technical index (for example the technical index and its time) as a change point to the first change point storage unit 162 (ST580).

The latest technical index is higher than the previous technical index (ST555), the fixed first change point obtaining unit 163 compares the recent change point stored in the first change point detecting unit 161 and latest technical index (ST585).

When the latest technical index become a given price (or a given percentage) decline than the recent change point, the fixed first change point obtaining unit 163 stores the recent change point as a determined change point to the fixed first change point storage 164 (ST590).

When a new change point is stored to the fixed first change point storage 164, the first index judging unit 151 compares the new change point and the previous change point, and judges whether the change point is declined based on the result of comparison (ST595). The change point declines a given number of times (M times) in succession, the first index judging unit 151 judges that the market price is downtrend (ST600).

In the current technical index is higher than 75% (ST 503), when the latest technical index is higher than the previous technical index (ST565), and when the latest technical index is not declined a given price (or a given percentage) compare to the recent change point (ST585), and the change point is not declined as a given number of times in succession (ST585), the second trend judging unit maintains the current result of judgment.

The latest technical index is in between 25-75%, the second trend judging unit resets the flag f3 and f4 to [0], and resets the count of the change point shifted stored in the first index judging unit 151 and second index judging unit 153 to [0] (ST630). In this case, the second trend judging unit judges the market price as no trend state (ST635).

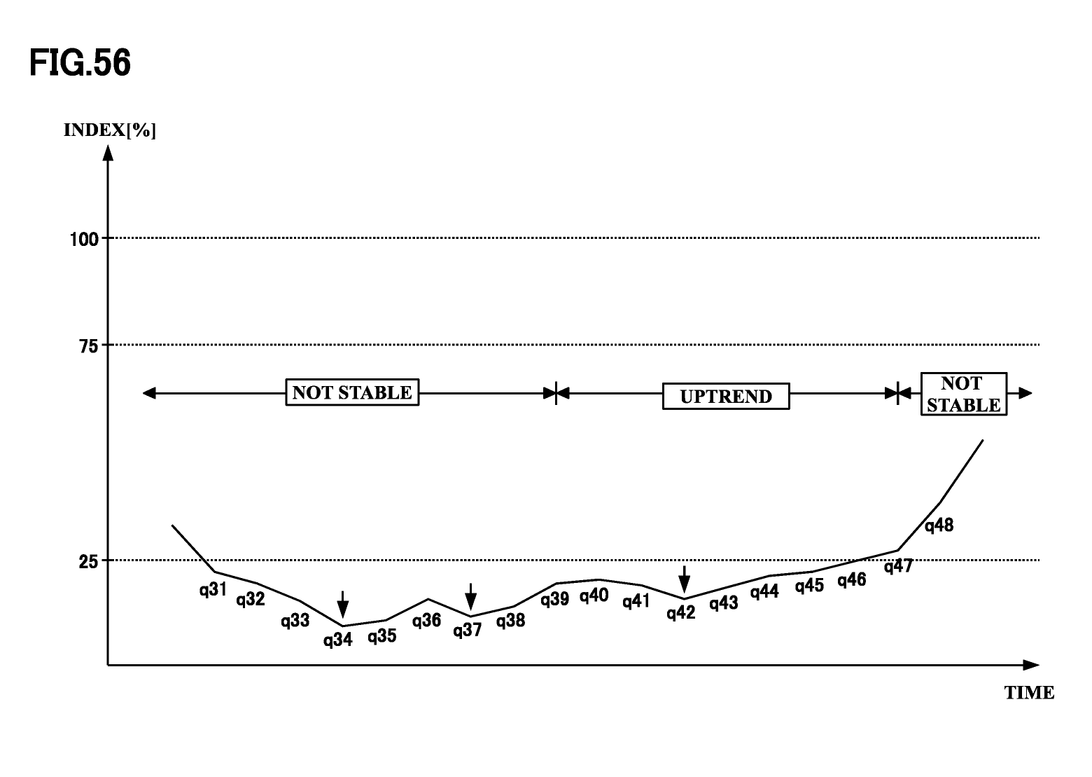

FIG. 56 is a drawing showing an example of the chart the technical index (RSI) shows the signs of uptrend of the market price.

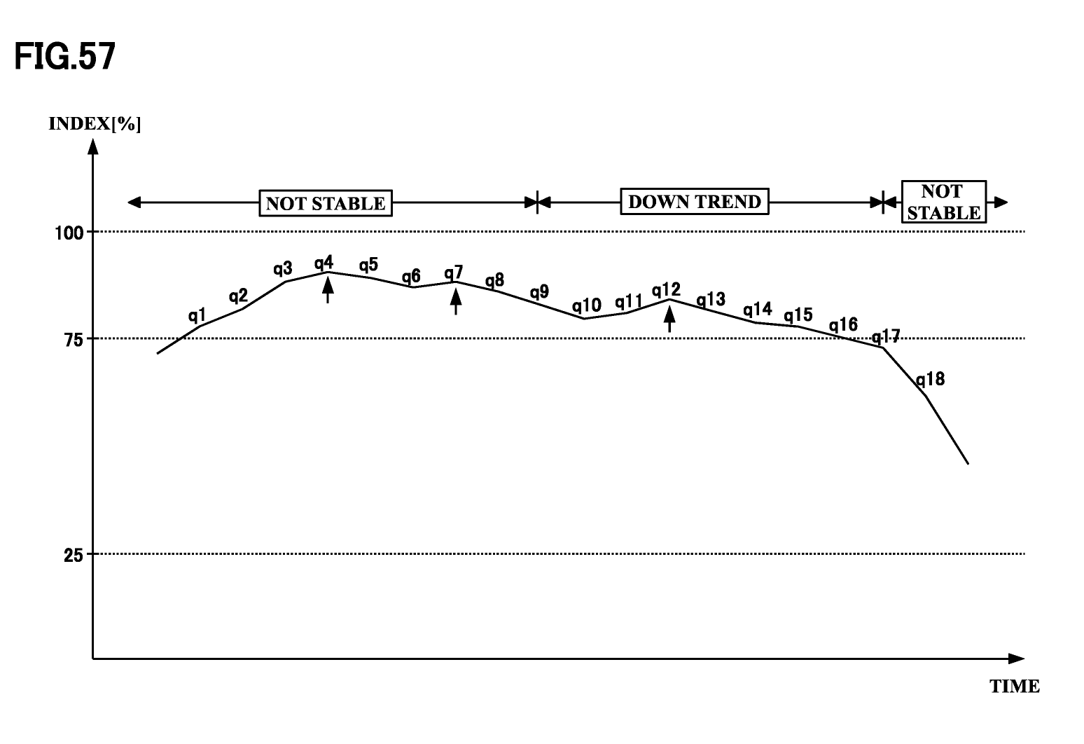

In the example of the FIG. 56, the technical index (RSI) in [p34], [p37] and [p42] are the point to start change towards upwards, and within the area of under 25% shows ‘oversold’. The second change point detecting unit 171 (FIG. 50) stores the technical index of the change point to the second change point storage 172. When the technical index rise a given value (or given percentage) to the change point of the second change point storage 172, the fixed second change point obtaining unit 173 stores the change point of the second change point storage 172 as a determined change point to the fixed second change point storage 174. In the example of FIG. 57, the change point of [p37] is determined when technical index of the [p39] is obtained. The determined change point [p37] is increased compare to the previous determined change point ([p34]). The second index judging unit 153 judges the market price is on uptrend based on the determined change point increase from [p34] to [p37].

Then, the change point of [p42] is determined, the change point of [p42] is increased compare to the previous change point ([p37]). Therefore, the second index judging unit 153 maintains the judgment that market price is uptrend based on the determined change point is increased from [p37] to [p42].

After that, the index of the [p47] exceeds 25%, the second trend judging unit judges that the market price is no trend state.

FIG. 57 is a drawing showing an example of the chart the technical index (RSI) shows the signs of downtrend of the market price.

In the example of the FIG. 57, the technical index (RSI) in [q4], [q7] and [q12] are the point to start change towards downwards, and within the area of over 75% shows ‘overbought’. The first change point detecting unit 161 (FIG. 49) stores the technical index of the change point to the first change point storage unit 162. The technical index decline a given value (or given percentage) to the change point of the first change point storage unit 162, the fixed first change point obtaining unit 163 stores the change point of the first change point storage unit 162 as a determined change point to the fixed first change point storage 164. In the example of FIG. 57, the change point of [q7] is determined when technical index of the [p9] is obtained. The determined change point [q7] is declined compare to the previous determined change point ([p4]). The first index judging unit 151 judges the market price is on downtrend based on the determined change point decline from [q4] to [q7].

Then, the change point of [q12] is determined, the change point of [q12] is declined compare to the previous change point ([q7]). Therefore, the first index judging unit 151 maintains the judgment that market price is downtrend based on the determined change point is declined from [q7] to [q12]. After that, the index of the [q17] exceeds 75%, the second trend judging unit judges that the market price is no trend state.

As it was mentioned above, according to the order server 1 relate to the present embodiment, the market trend is judged based on the time shift of the bottom and ceiling price of the market price as well as based on the transition of the technical index. The order server 1 outputs buy or sell orders when the result of the judgment of the trend based on the technical index is opposite to the result of judgment of the trend based on the bottom price and ceiling price in the market price (one is uptrend and the other is downtrend). From this, buying and selling are able to be executed at the proper timing of when the trend of the market price shifts upward to downward or downward to upward.

### The Eighth Embodiment

Next, the eighth embodiment will be explained.

The order server 1 relate to the aforementioned seventh embodiment, as shown in FIG. 52 and FIG. 53, when the result of judgment of second trend judging unit and first trend judging unit 103 are opposite, (at the timing of [q63] in FIG. 52 and [q84] in FIG. 53) the process of buy-sell orders is output. Therefore, sell order may output while the market price continues to update the highest price, alternatively, buy order may output while the market price continues to update the lowest price. Then, when the reversal of the trend does not occur, contrary to expectations, the losses might be increases.

Therefore, in the order server 1 relate to the eighth embodiment, the process of buy-sell orders is executed under the condition of the result of judgment from the second trend judging unit reverses the result of judgment from the first trend judging unit 103, and update process of highest and lowest price is stopped.

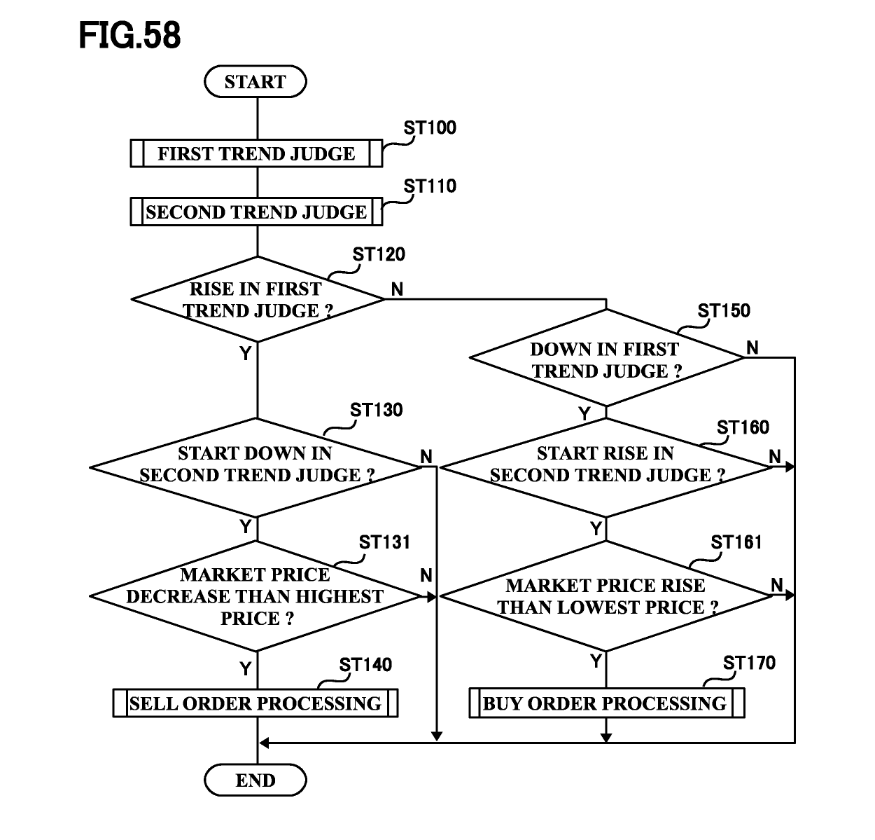

FIG. 58 is a flowchart to explain the movement to execute buy and sell orders in the order server 1 relate to the eighth embodiment.

Compare to the flowchart shown in FIG. 51 of the seventh embodiment, the flowchart shown in FIG. 58 is added step ST131 and ST161. Other operations of the order server 1 relate the eighth embodiment is the same as the seventh embodiment.

According to the flowchart in FIG. 58, when the market price is judged as uptrend in the uptrend judging unit 121 (FIG. 35) (ST120), in the second trend judging unit (FIG. 48) the market price is judged that downtrend has begun (ST130). Moreover, when the latest market price shown in the market price data (For example, the high price of the market price data) is judged by the highest price comparing unit 131 (FIG. 5) that is cheaper than the highest price of the highest price storage 130 (FIG. 5) (ST313), the order outputting unit 106A (FIG. 47) outputs the sell order (ST140:FIG. 43).

When the market price is judged as downtrend in the downtrend judging unit 123 (FIG. 35) (ST150), in the second trend judging unit (FIG. 48) the market price is judged that uptrend has begun (ST160). Moreover, the latest market price shown in the market price data (For example, the low price of the market price data) is judged by the lowest price comparing unit 141 (FIG. 6) that is higher than the lowest price of the lowest price storage 140 (FIG. 6) (ST161), the order outputting unit 106A (FIG. 47) outputs the buy order (ST170:FIG. 43).

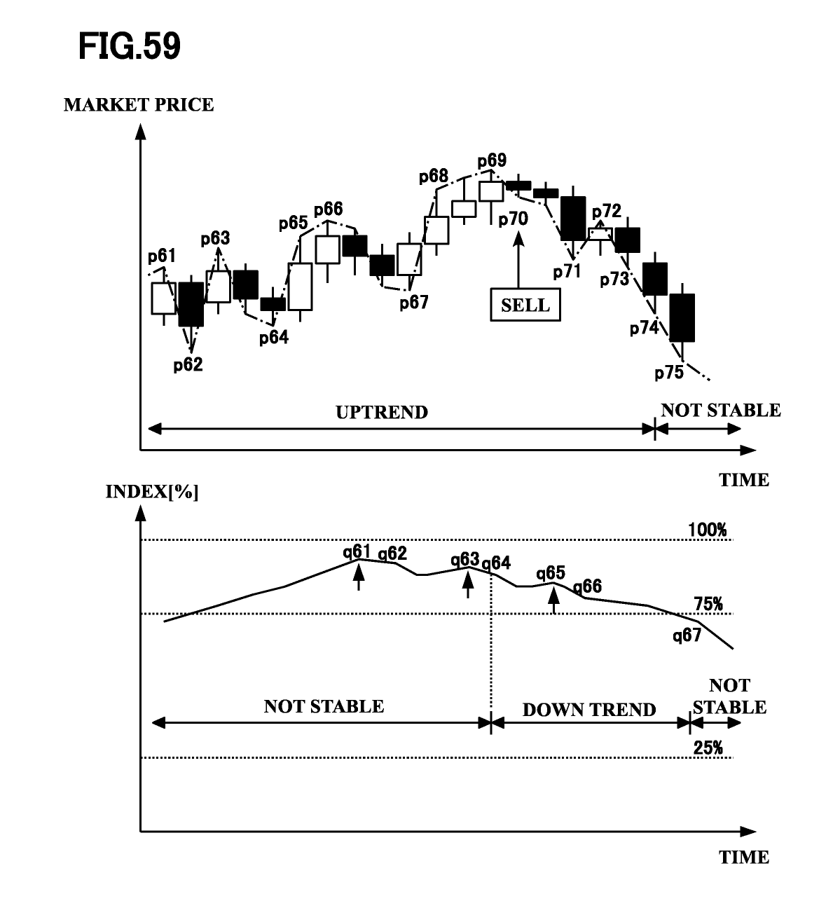

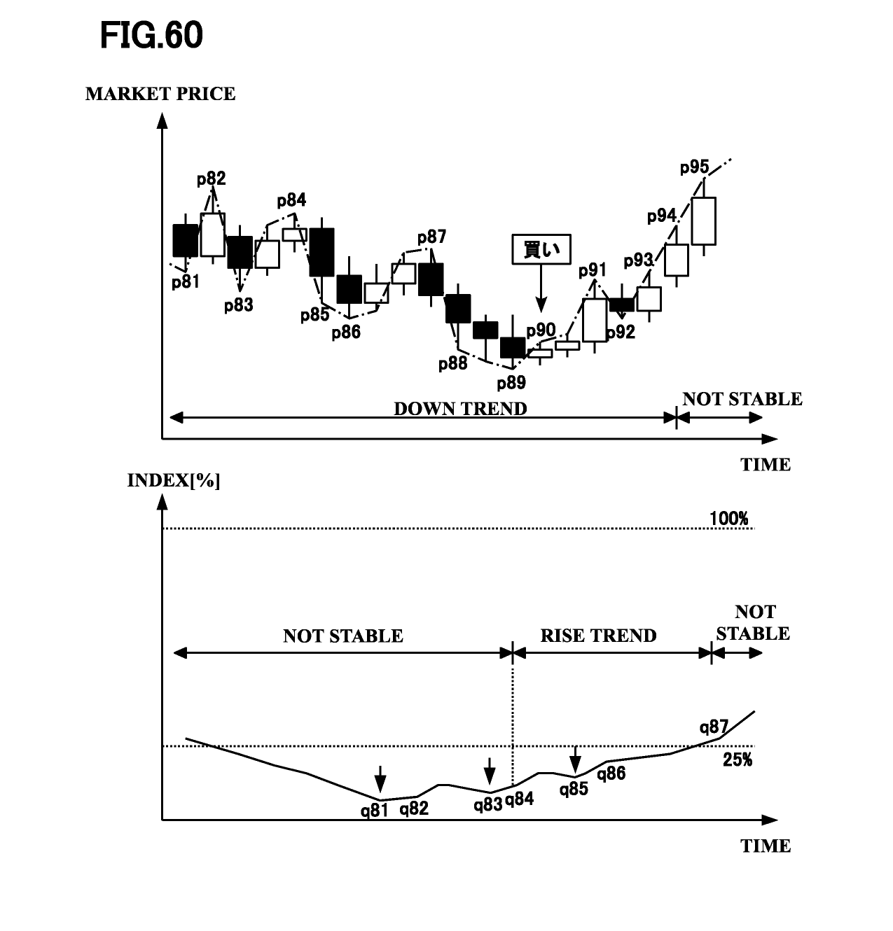

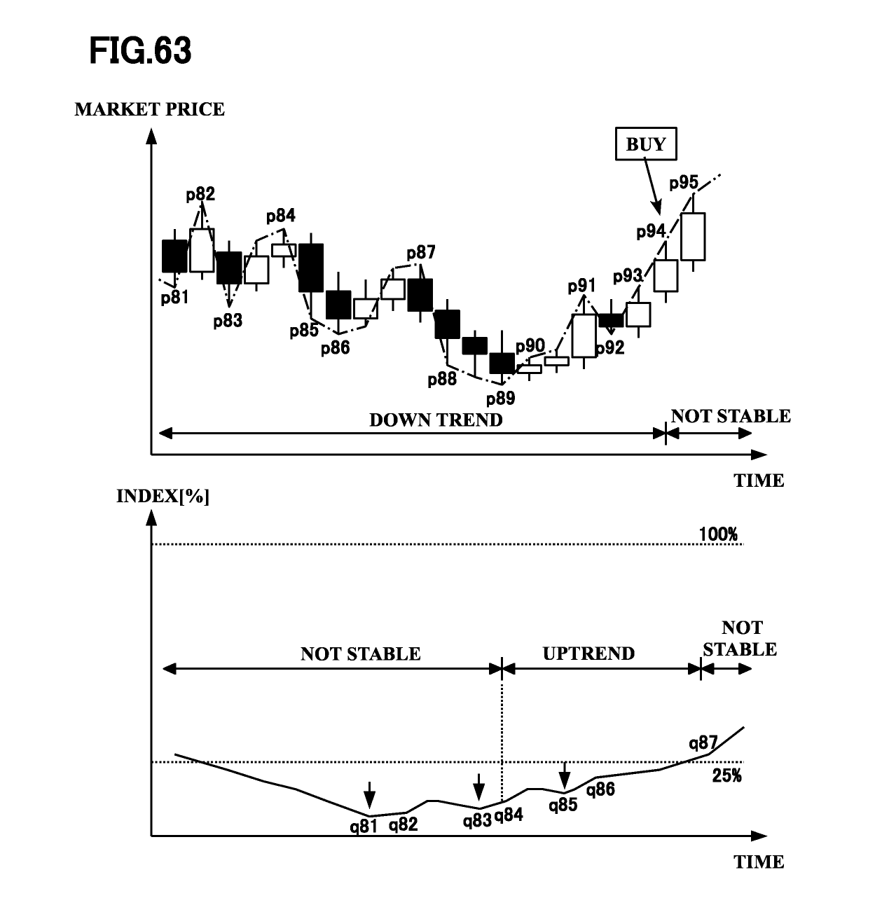

FIG. 59 and FIG. 60 are drawings to explain the timing of the order of buying and selling in the order server 1 relates to the eighth embodiment. FIG. 59 indicates the example of the chart when the selling order is output, and FIG. 63 indicates the example of the chart when the buying order instruction is output. In each drawing, the upper side indicates the candlestick chart and the underside indicates RSI chart.

The chart in FIG. 59 is the same as the charts in FIG. 52 mentioned above. In the seventh embodiment shown in the FIG. 52, sell order is executed at the timing of the result of judgment of first trend judging unit 103 become opposite to the result of judgment of second trend judging unit [p64]. In contrast, the eighth embodiment shown in the FIG. 59, sell order is executed at the timing of the result of judgment of first trend judging unit 103 become opposite to the result of judgment of second trend judging unit ([p64]), and at the timing of update of the highest price of the market price is stopped ([p70]).

The chart in FIG. 60 is the same as the charts in FIG. 53 mentioned above. In the seventh embodiment shown in the FIG. 53, buy order is executed at the timing of the result of judgment of first trend judging unit 103 is opposite to the result of judgment of second trend judging unit [q84]. In contrast, the eighth embodiment shown in the FIG. 59, buy order is executed at the timing of the result of judgment of first trend judging unit 103 is opposite to the result of judgment of second trend judging unit ([q84]), and at the timing of update of the lowest price of the market price is stopped ([q90]).

The order server 1 relate to the eighth embodiment, when the buy-sell order is executed based on the result of judgment of the trend by the first trend judging unit 103 and the second trend judging unit, under condition of stopping update of the highest price of the [sell] order, or stopping update of the lowest price of the [buy] order. Therefore, it prevents a case of updating the highest price of the market price continues after [buy] order and a case of updating the lowest price of the market price continues after [sell] order, thus able to reduce the risk of losses expansion immediately after the order. In addition, the stop order is set for loss cut, it can reduce the case of stop order executed by the market price moves to opposite direction as expected right after the order is contracted.

### The Ninth Embodiment

Next, the ninth embodiment will be explained.

The order server 1 relate to the aforementioned eighth embodiment, the processes of buy-sell orders take place under condition of terminating update of the highest price and lowest price. In contrast, the order server 1 relate to the ninth embodiment, the processes of buy-sell orders take place under condition of the end of uptrend of downtrend is determined in the first trend judging unit 103.

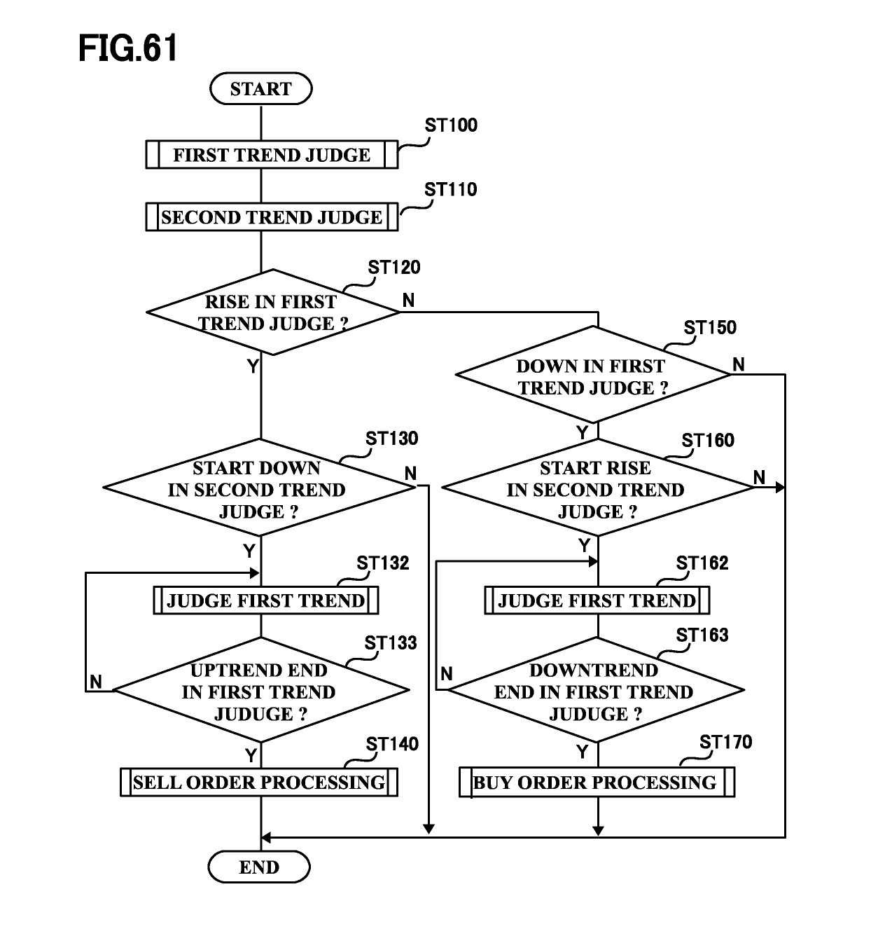

FIG. 61 is a flowchart to explain the movement to execute buy and sell orders in the order server 1 relate to the ninth embodiment.

Compare to the flowchart shown in FIG. 51 of the seventh embodiment, the flowchart shown in FIG. 61 is added step ST132, ST133, ST162 and ST163. Other operations of the order server 1 relate to the ninth embodiment is the same as the seventh embodiment.

According to the flowchart in FIG. 61, when the market price is judged as uptrend in the uptrend judging unit 121 (FIG. 35) (ST120), and the market price is judged that downtrend has begun by the second trend judging unit (FIG. 48) (ST130), then the result of the judgment of the uptrend judging unit 121 based on the market price data obtained after aforementioned process will be observed (ST132, ST133). When the result of the judgment obtained in the uptrend judging unit 121 says the uptrend of the market price has ended, the order outputting unit 106A (FIG. 47) outputs the sell order (ST140: FIG. 43).

In addition, when the market price is judged as downtrend in the downtrend judging unit 123 (FIG. 35) (ST150), and the market price is judged that uptrend has begun by the second trend judging unit (FIG. 48) (ST160), then the result of the judgment of the downtrend judging unit 123 based on the market price data obtained after aforementioned process will be observed (ST162, ST163). When the result of the judgment obtained in the downtrend judging unit 123 says the uptrend of the market price has ended, the order outputting unit 106A (FIG. 47) outputs the buy order (ST170: FIG. 43).

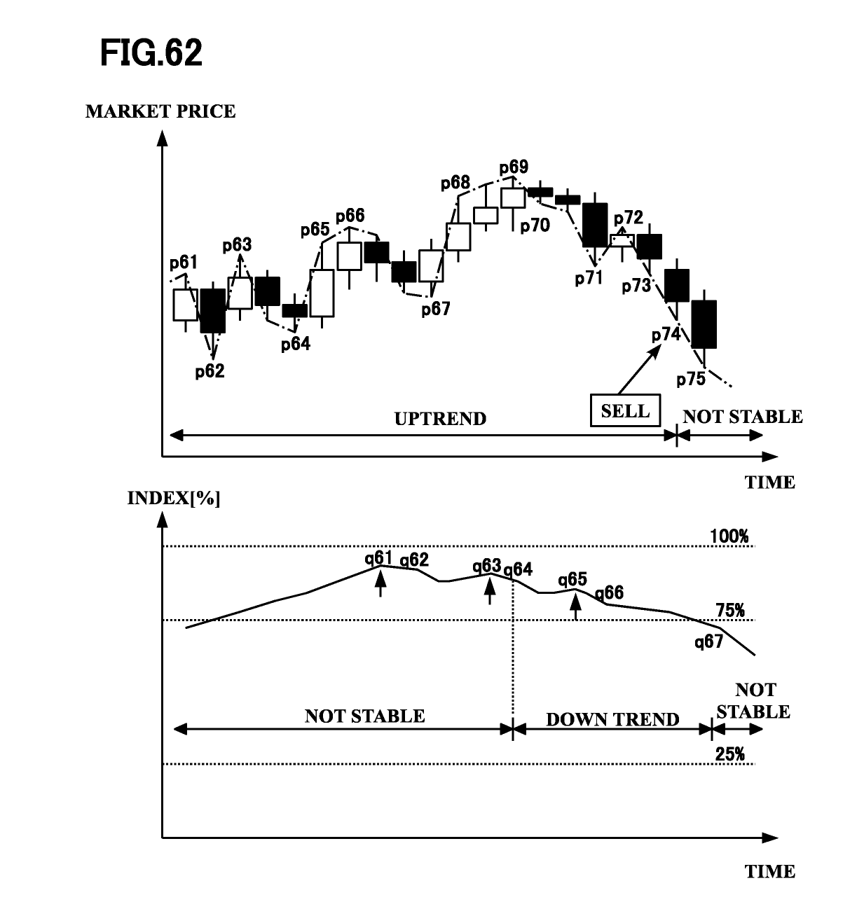

FIG. 62 and FIG. 63 are drawings to explain the timing of the order of buying and selling in the order server 1 relates to the ninth embodiment. FIG. 62 indicates the example of the chart when the selling order instruction is issued, and FIG. 63 indicates the example of the chart when the buying order instruction is issued. In each drawing, the upper side indicates the candlestick chart and the underside indicates RSI chart.

The chart in FIG. 62 is the same as the charts in FIG. 52 and FIG. 59 mentioned above. In a case of the eighth embodiment shown in FIG. 59, “selling” order executes at the timing “p70” of stopping update of the highest price in the market price data. On the other hand, in a case of the ninth embodiment shown in FIG. 62, “selling” order executes at the timing “p74” of the market price data is judged as the uptrend has finished.

In addition, the chart in FIG. 63 is the same as the charts in FIGS. 53 and 60 mentioned above. In a case of the eighth embodiment shown in FIG. 60, “buying” order executes at the timing “p90” of stopping update of the lowest price in the market price data. In contrast, in a case of the ninth embodiment shown in FIG. 63, “buying” order executes at the timing “p94” of the market price is judged that the downtrend has finished.

The order server 1 relate to the ninth embodiment, the sell order is output when the market trend is judged as uptrend has ended after the market price is judged as uptrend in the first trend judging unit 103 as well as downtrend in the second trend judging unit. The buy order is output when the market trend is judged as downtrend has ended after the market price is judged as downtrend in the first trend judging unit 103 as well as uptrend in the second trend judging unit. In other words, buy-sell order is output after reversal of the trend become much secure, therefore the risk of loss due to unexpected movement of the market movement can be reduced.

### The Tenth Embodiment

Next, the tenth embodiment will be explained.

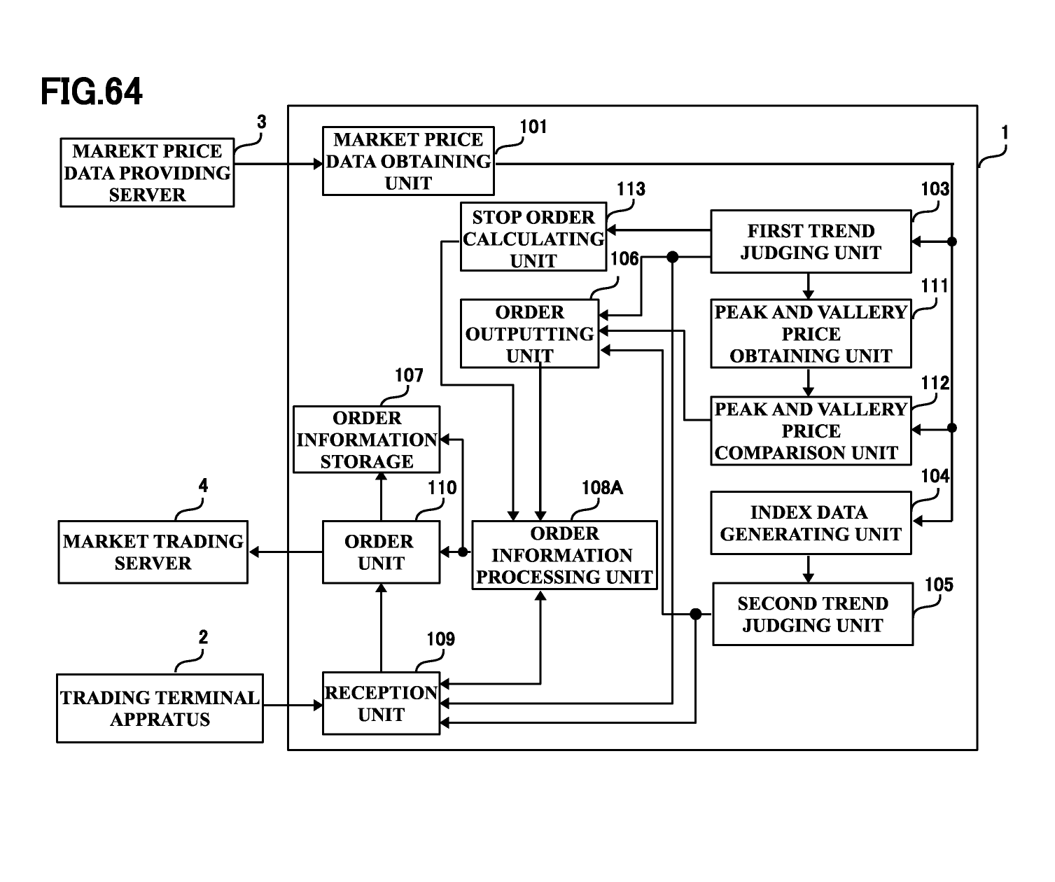

FIG. 64 is a drawing showing an example of the structure of the order server 1 relates to the tenth embodiment. The order server 1 shown in FIG. 64 has the same components to the order server 1 (FIG. 47) relates to the seventh embodiment, the peak and valley floor price obtaining unit 111 and the peak and valley floor price comparing unit 112.

The peak and valley floor price obtaining unit 111 obtains the highest price in the highest price storage 130 as a peak price before the period of temporary decline, every time the latest market price shown in the market price data is judged by the highest price comparing unit 131 as lower than the highest price of the highest price storage 130 (every time update process of the highest price ended and before the period of temporary decline starts). The peak and valley floor price obtaining unit 111 obtains the lowest price in the lowest price storage 140 as a valley floor price before the period of temporary rise, every time the latest market price shown in the market price data is judged by the lowest price comparing unit 141 as higher than the lowest price of the lowest price storage 140 (every time update process of the lowest price ended and before the period of temporary decline starts).

The peak and valley floor price comparing unit 112 compares the latest market price shown in the market price data and the one front just before the latest peak price obtained in the peak and valley floor price obtaining unit 111 in the temporary decline period during updating the highest price of the market price. The peak and valley floor price comparing unit 112 compares the latest market price shown in the market price data and the one front just before the latest valley floor price obtained in the peak and valley floor price obtaining unit 111 in the temporary rise period during updating the lowest price of the market price.

The order outputting unit 106A outputs buy-sell orders based on the result of comparison from the peak and valley floor price comparing unit 112 and the result of judgment from the first trend judging unit 103 and the second trend judging unit.

In other words, the order outputting unit 106A outputs the sell order under conditions stated hereafter. The market price is judged as uptrend by the uptrend judging unit 121, and the market price is judged that downtrend of the market price has begun by the second trend judging unit, and the latest market price is judged by the peak and valley floor price comparing unit 112 that lower than the one front just before the latest market price,

In other words, the order outputting unit 106A outputs the buy order under conditions stated hereafter. The market price is judged as downtrend by the uptrend judging unit 121, and the market price is judged that uptrend of the market price has begun by the second trend judging unit, and the latest market price is judged by the peak and valley floor price comparing unit 112 that higher than the one front just before the latest market price,

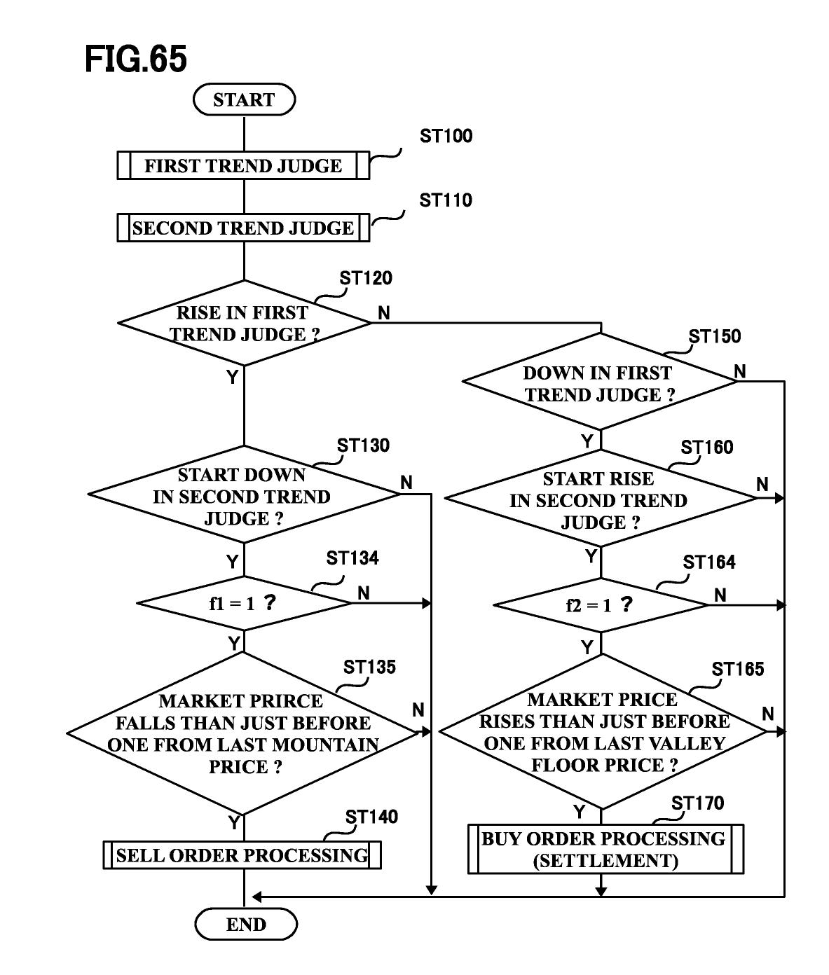

FIG. 65 is a flowchart to explain the movement to execute buy and sell orders in the order server 1 relate to the ninth embodiment.

Compare to the flowchart shown in FIG. 51 of the seventh embodiment, the flowchart shown in FIG. 65 is added step ST134, ST135, ST164 and ST165. Other operations of the order server 1 relate to the tenth embodiment is the same as the seventh embodiment.

According to the flowchart of FIG. 65, when the market price is judged as uptrend by the uptrend judging unit 121 (FIG. 35) (ST120) and the market price is judged that the downtrend has begun in the second trend judging unit (ST130), in the present embodiment, the result of the comparison between the value of flag f1 shows the temporary decline period by the peak and valley floor price comparing unit 112 is referenced. In other words, when flag f1 is set to [1] (ST134) and the result of comparison that the latest market price is lower than the one front just before the latest peak price (ST135) by the peak and valley floor price comparing unit 112, the order outputting unit 106A outputs the sell order (ST140: FIG. 43).

When the market price is judged as downtrend by the downtrend judging unit 123 (FIG. 35) (ST150) and the market price is judged that uptrend has begun in the second trend judging unit (ST160), in the present embodiment, the comparison between the value of flag f2 shows the period of temporary rise and the peak and valley floor price comparing unit 112 is referred. In other words, when flag f2 is set to [1] (ST164) and the result of comparison that the latest market price is higher than the one front just before the latest valley floor price (ST165) by the peak and valley floor price comparing unit 112, the order outputting unit 106A outputs the buy order (ST140:FIG. 43).

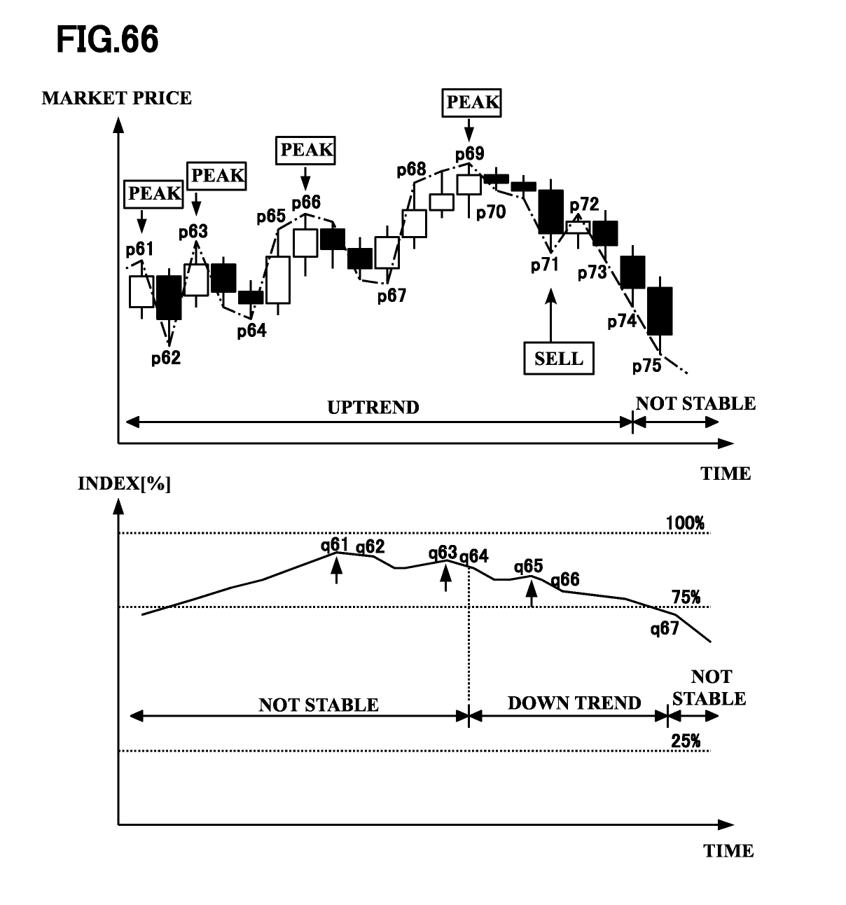

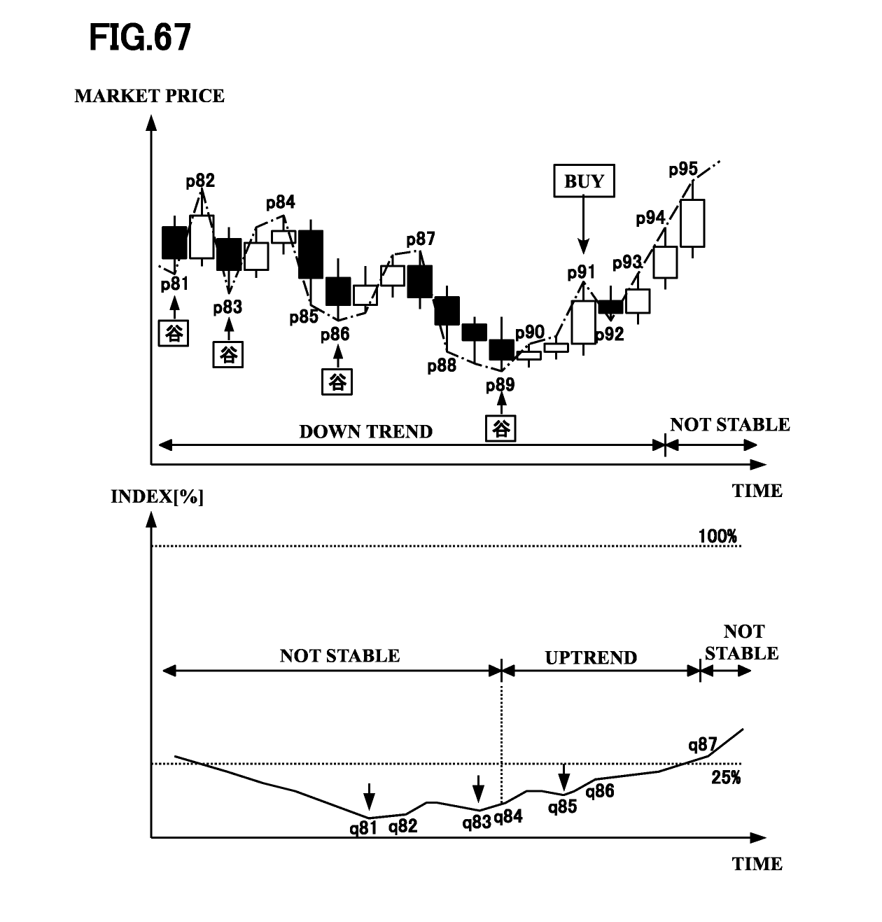

FIG. 66 and FIG. 67 are drawings to explain the timing of the order of buying and selling in the order server 1 relates to the tenth embodiment. FIG. 66 indicates the example of the chart when the selling order instruction is issued, and FIG. 67 indicates the example of the chart when the buying order instruction is issued. In each drawing, the upper side indicates the candlestick chart and the underside indicates RSI chart.

The chart in FIG. 66 is the same as aforementioned chart in FIG. 52, FIG. 59 and FIG. 62. The ninth embodiment shown in FIG. 62, the sell order is executed at the timing of [p74] in the market price data which is judged uptrend has ended in the first trend judging unit 103. In contrast, in the tenth embodiment shown in FIG. 66, the sell order is executed at the timing of [p71] in the market price data which is judged the market price in the temporary decline period (p69) become lower than one before the previous peak price (p66). In other words, when the market price become lower than the peak price recently exceeded (p66), the market trend is judged as downtrend is ensured, and the sell order is executed.

The chart in FIG. 67 is the same as aforementioned chart in FIG. 53, FIG. 60 and FIG. 63. The ninth embodiment shown in FIG. 63, the buy order is executed at the timing of p94 in the market price data which is judged downtrend has ended in the first trend judging unit 103. In contrast, in the tenth embodiment shown in FIG. 67, the buy order is executed at the timing of p91 in the market price data which is judged the market price in the temporary rise period become lower than one before the previous peal price. In other words, when the market price become lower than the valley floor price recently exceeded, the market trend is judged as uptrend is ensured, and the buy order is executed.

Thus, the order server 1 relates to the aforementioned seventh embodiment, the sell order is output in case where the market price become lower than the one front just before the latest peak price (the peak price recently exceeded) in the period of temporary decline when the market price is judged as uptrend by the first trend judging unit 103 and judged as downtrend by the second trend judging unit. In General, when the market trend is on uptrend, the peak price recently exceeded might become resistance line that prevents the decline in the market price. Therefore, when the market price become lower than the peak price recently exceeded as mentioned above, downtrend of the market become sure. Therefore, the sell order is output under condition of the surely downtrend, therefore a risk of rising the market price after the sell order output is reduced.

Thus, the order server 1 relates to the aforementioned tenth embodiment, the buy order is output in case where the market price become higher than the one front just before the latest valley floor price (the valley floor price recently exceeded) in the period of temporary rise when the market price is judged as downtrend by the first trend judging unit 103 and judged as uptrend by the second trend judging unit. In General, when the market trend is on downtrend, the valley floor price recently exceeded might become resistance line that prevents the rise in the market price. Therefore, when the market price become higher than the valley bottom price recently exceeded as mentioned above, uptrend of the market become sure. Therefore, the buy order is output under condition of the surely uptrend, therefore a risk of declining the market price after the buy order output is reduced.

### The Tenth Embodiment

Next, the eleventh embodiment will be explained.

The market trading system shown in FIG. 1, several terminal apparatus 2 are able to access to the order server 1 at the same time. However, when processes relates to the aforementioned embodiment is performed by each terminal apparatus 2, load of processing gets heavier in the order server 1 in proportion as number of the terminal apparatus 2 increases.

Especially, the processes of acquiring the bottom price and ceiling price of the market price need to observe the market price data and update the highest price and lowest price. Therefore, when a system used by multiple users is structured, CPU load gets heavier significantly and consumes massive storage space.

Thereupon, the order server 1 relate to the present embodiment, relieve processing load on the order server 1 by sharing the result of the process relate to the acquiring the bottom price and the ceiling price in the market price by several users.

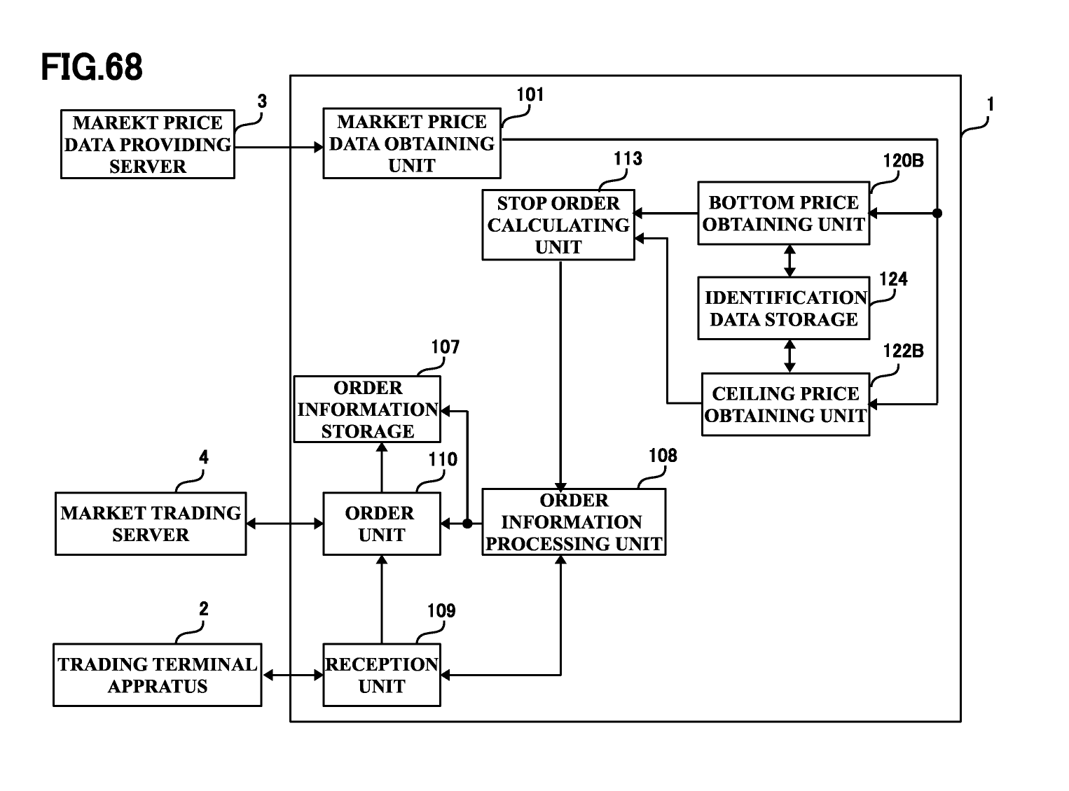

FIG. 68 is a drawing showing an example of the structure of the order server 1 relates to the eleventh embodiment.

The server shown in FIG. 68 has same elements as the server shown in FIG. 3, such as the market price data obtaining unit 101, the order information storage 107, the order information processing unit 108, the reception unit 109, the order unit 110 and the stop order calculating unit 113. Moreover, the order server 1 shown in FIG. 68 has the bottom price obtaining unit 120B, the ceiling price obtaining unit 122B and the identification data storage 124.

The highest and lowest price of the market price used for update process of the price of stop order may be different for each user. For instance, the initial value of the highest price determined on the basis of market price within a certain period of time prior to the starting point when service for users (update of the price of stop order) starts. In that case, if the market price continues to decline for long-term, the highest price used in the process of users with different beginning point necessarily differs since the highest price become higher as the beginning point of the service is earlier.

However, if the highest price and the lowest price in any state of market price movements are reserved for each user, the update processes of the highest price and the lowest price have to be done for each user constantly, therefore, the order server 1 takes a big load on a regular basis.

To reduce the load of processing, in the present embodiment, the highest price identification data to recognize the highest price and the lowest price identification data to recognize the lowest price are installed as well as the user identification data to identify each user.

Then, various data is associated with under a predetermined definition to enable to use common highest and lowest price in the process for multiple users.

In other words, in the present embodiment, several highest price stored in the bottom price obtaining unit 120B are recognized individually by the highest price identification data, and several lowest price stored in the ceiling price obtaining unit 122B are recognized individually by the lowest price identification data.

The provisional bottom price, stored while the market price temporary become lower than the highest price, is recognized by the highest price identification data same as the highest price. The provisional ceiling price, stored while the market price temporary become higher than the lowest price, is recognized by the lowest price identification data same as the ceiling price.

Furthermore, one user identification data for one user is related to one highest price identification data and one lowest price identification data.

According to the association between such data, one highest price identification data and one lowest price identification data are identified by one user identification data, and the provisional bottom price and the provisional ceiling price are identified by one highest price identification data and one lowest price identification data. When the user identification data relate to one user is specified, data (the provisional bottom price and the provisional ceiling price) required to process the user processing is identified by tracing the association between the data mentioned above. The association between the data allows the data need to be referred in the process of several users can be a common data. Consequently, enable to use common highest and lowest price in the process for multiple users.

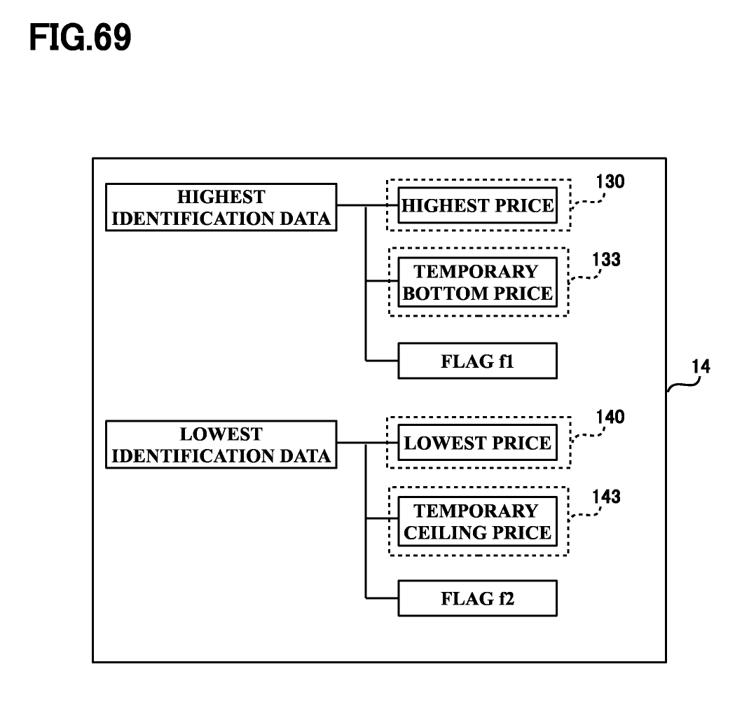

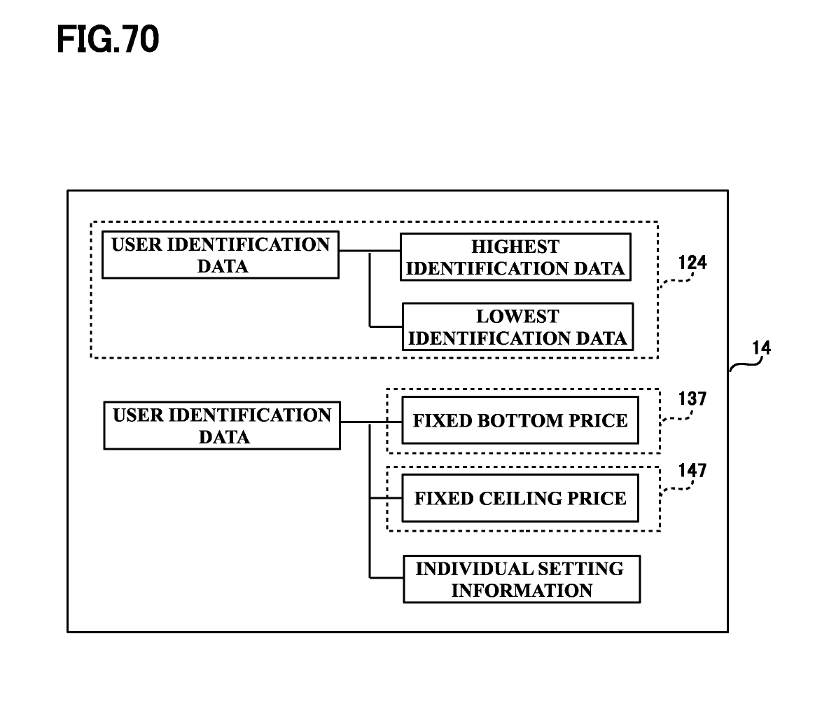

FIG. 69 and FIG. 70 are drawings showing examples of the data structure to obtain the bottom price and the ceiling price by each user based on the highest price and lowest price shared by multiple users.

In the example of the drawing, the highest price storage 130, the lowest price storage 140, the first bottom price storage 133, the first ceiling price storage 143, the second bottom price storage 137, the second ceiling price storage 147 and the identification data storage 124 show the particular storage area in the storage 14.

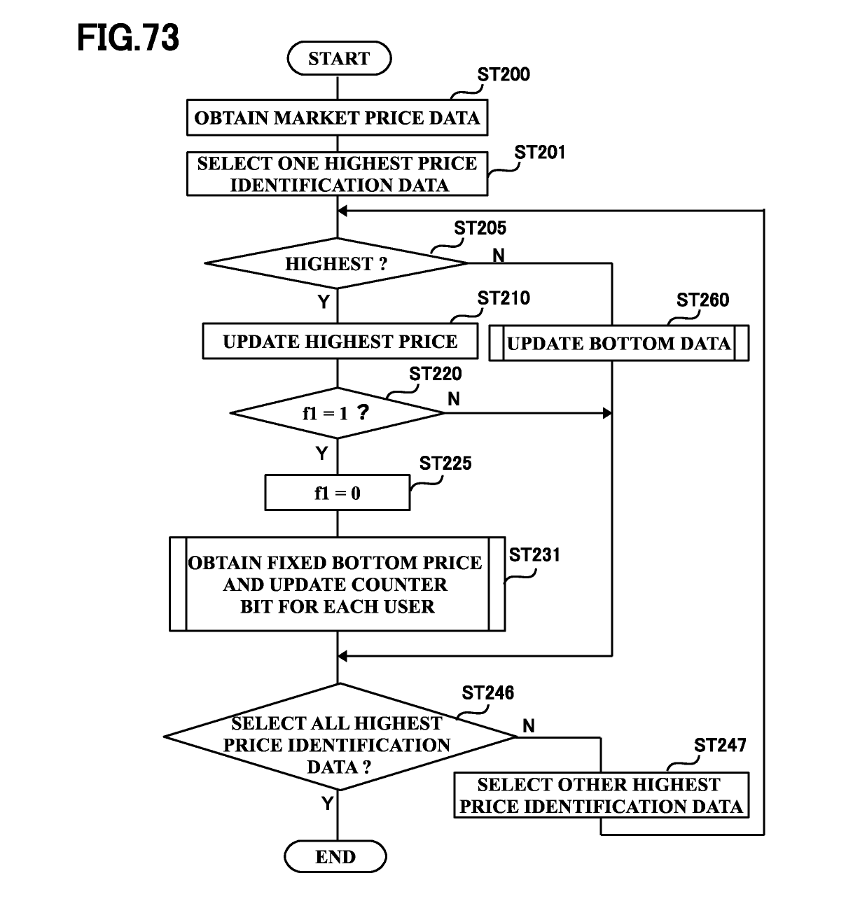

The highest price, the provisional bottom price in the period of the latest market price become lower than the highest price and flag f1 (FIG. 73) indicates whether the market price is lower than the highest price are associated with one highest price identification data. For example, the highest price identification data can be the data related to the stored location (address) of the highest price.

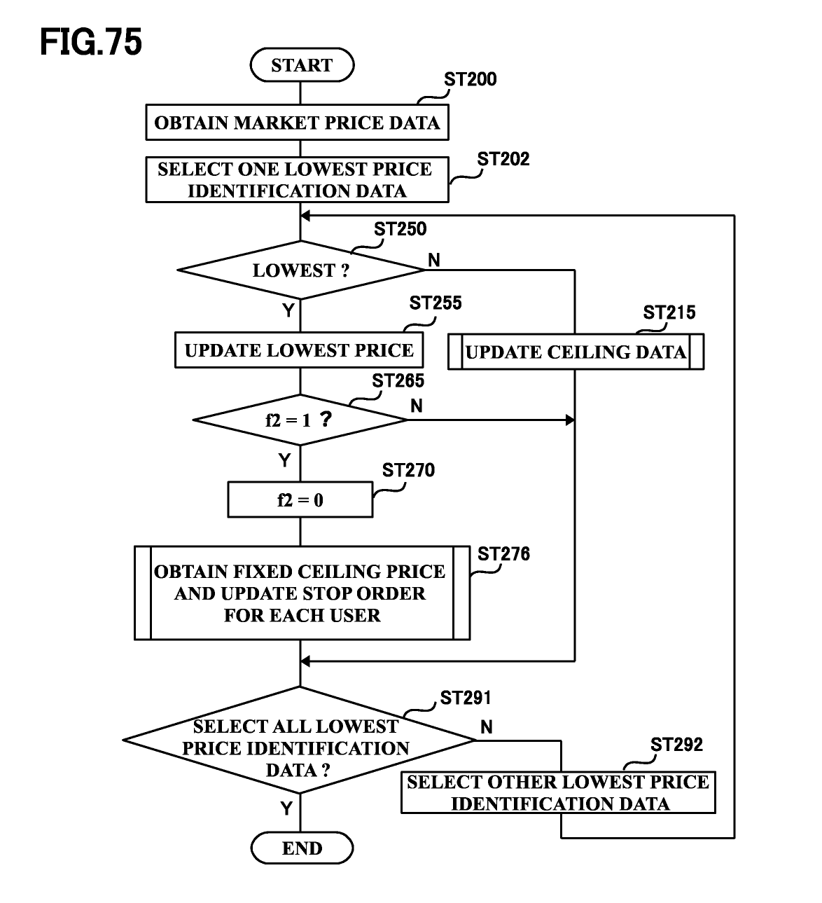

The lowest price, the provisional ceiling price in the period of the latest market price become higher than the lowest price and flag f2 (FIG. 75) indicates whether the market price is lower than the lowest price are associated with one lowest price identification data. For example, the lowest price identification data can be the data related to the stored location of the lowest price.

One user identification data associated with the one highest price identification data and one lowest price identification data. In contrast, one or more user identification data associated with one highest price identification data, and one or more user identification data associated with one lowest price identification data.

Moreover, one user identification data associated with the fixed bottom price in the temporary decline period, the fixed ceiling price in the temporary rise period and a variety of configuration information to be customized by each user relate to operation of a system.

Afterwards, the identification data storage 124, the bottom price obtaining unit 120B and the ceiling price obtaining unit 122B will be explained respectively.

[Identification Data Storage 124]

As shown in FIG. 70, the identification data storage 124 stores at least one user identification data related to the one highest price identification data and one lowest price identification data.

[Bottom Price Obtaining Unit 120B]

The bottom price obtaining unit 120B has the highest price storage 130, the highest price comparing unit 131, the highest price updating unit 132, the first bottom price storage 133, the bottom price comparing unit 134, the bottom price updating unit 135, the fixed bottom price obtaining unit 136 and the second bottom price storage 137 likewise the bottom price obtaining unit 120 shown in FIG. 5.

The highest price storage 130 stores in association with the highest price identification data at least one highest price of market price shown in the market price data obtained from the market price data obtaining unit 101 (FIG. 69). Each highest price is recognized by the highest price identification data.

The highest price comparing unit 131 compares at least one highest price stored in the highest price storage 130 and the latest market price shown in the market price obtained in the market price data obtaining unit 101. For instance, the highest price comparing unit 131 compares at least one highest price stored in the highest price storage 130 and the latest high price included in the market price data (FIG. 4).

Moreover, the highest price comparing unit 131 stores in association with the highest price identification data relate to the highest price the flag f1 indicates whether the market price is lower than the highest price (FIG. 69). The highest price comparing unit 131 set the flag f2 to [1] when the market price is lower than the lowest price related to the lowest price identification data, and the highest price comparing unit 131 reset the flag f2 to [0] when the market price is lower than the lowest price related to the lowest price identification data.

When the latest market price (for example, the high price of the market price (FIG. 4) is judged by the highest price comparing unit 131 that higher than the highest price associated with one highest identification data, the highest price updating unit 132 stores the latest market price as a new highest price associated with the aforementioned one highest price identification data to the highest price storage 130.

Moreover, when the latest market price shown in the market price data is judged by the highest price comparing unit 131 as higher than several highest price associated with several highest price identification data, the highest price updating unit 132 stores the latest market price to the highest price storage 130 as a new highest price to replace several highest price stored, and associates with one highest price identification data. In this case, all the user identification data associated with several highest price identification data in the identification data storage 124, instead of several highest price identification data, the highest price updating unit 132 associates with aforementioned one highest price identification data.

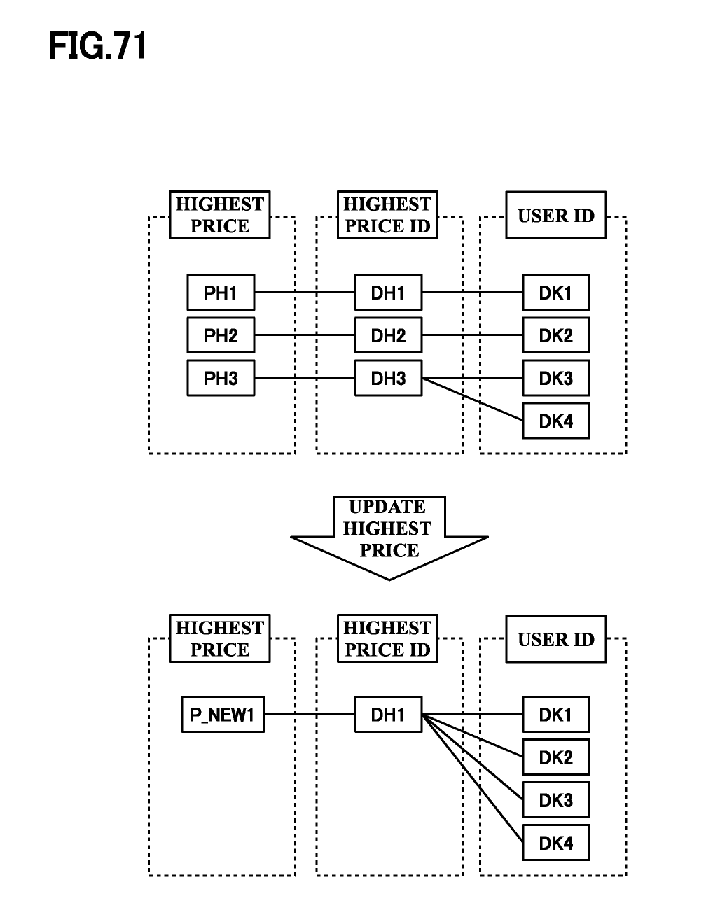

FIG. 71 is a drawing to explain a concrete example of update process of highest price when the latest market price is higher than multiple highest prices stored in the highest price storage 130.

The upper side of the FIG. 71 shows the highest price storage 130 and the identification data storage 124 before its update. In the highest price storage 130 before update, the highest price identification data DH1, DH2 and DH3 associated with the high price PH1, PH2 and PH3 are stored. In the identification data storage 124, the highest price identification data DH1 associated with the user identification data DK1, the highest price identification data DH2 associated with the user identification data DK2 and the highest price identification data DH3 associated with the user identification data DK3 and DK4.

At this point, the latest market price P_NEW1 is assumed higher than the highest price PH1, PH2 and PH3. In this case, the highest price updating unit 132 stores the latest market price P_NEW1 to the highest price storage 130 as a new highest price linked to new highest price identification data (DH1 in the example of FIG. 71). Also, the highest price updating unit 132 in the identification data storage 124 links again the user identification data DK1, DK2, DK3 and DK4 related to the highest price identification data DH1, DH2, DH3 to one highest price identification data.

Before the update process, the user identification data DK1, DK2, DK3 and DK4, four in total, are linked to the highest price PH1, PH2 and PH3 via the highest price identification data DH1, DH2, DH3. However after the update process the user identification data DK1, DK2, DK3 and DK4 are linked to one highest price P_NEW1 via one highest price identification data DH1. From this process, processing load on the order server 1 is relieved by decreasing two of the highest price stored in the highest price storage 130.

The first bottom price storage 133 stores the provisional bottom price in the period of the market price become lower than the highest price in association with the highest price identification data (FIG. 69).

The second bottom price storage 137 stores the bottom price determined in the end of the period of temporary decline of the market price in association with the user identification data (FIG. 70). In other words, the second bottom price storage 137 stores the fixed bottom price for each user.

The bottom price comparing unit 134 compares at least one bottom price (the provisional bottom price) stored in the first bottom price storage 133 and the latest market price, such as the lowest price of the market price (FIG. 4), shown in the market price data obtained in market price data obtaining unit 101.

The bottom price updating unit 135 stores the lowest price (bottom price) of all the market price data obtained in the market price data obtaining unit 101 to the first bottom price storage 133 between the update of the highest price by the highest price updating unit 132.

When the first market price compared after update of the one highest price associated with one highest price identification data (for instance, the low price in the market price (FIG. 4)) is judged by the highest price comparing unit 131 as lower than aforementioned one highest price, the lowest price updating unit 142 stores the first market price to the first bottom price storage 133 as a new provisional bottom price and associates with one aforementioned highest price identification data (In other words, the first market price in the temporary decline period is stored). Until the highest price associated to the aforementioned highest price identification data is updated in the highest price updating unit 132, when the latest market price shown in the market price data obtained in the market price data obtaining unit 101 is judged as lower than the provisional bottom price linked to aforementioned highest price identification data, the bottom price updating unit 135 stores to the bottom price storage the latest market price as a provisional bottom price and associates to the aforementioned highest price identification data.

The fixed bottom price obtaining unit 136 judges the change of the market price for the highest price based on the result of the highest price comparing unit 131. For instance, the fixed bottom price obtaining unit 136 judges whether the market price is shifted from the condition of lower than the highest price related to one highest price identification data to the condition of higher than the highest price based on flag 11 related to one highest price identification data. When the market price is judged to be shifted from the condition of lower than the highest price linked to one highest price identification data to the condition of higher than the aforementioned highest price linked to aforementioned one highest price identification data (Flag f1 is changed from [1] to [0]), the fixed bottom price obtaining unit 136 stores to the second bottom price storage 137 the provisional bottom price stored in the first bottom price storage 133 associated to the aforementioned one highest price identification data as a determined bottom price in the temporary decline period. In this case, the fixed bottom price obtaining unit 136 associates the provisional bottom price, stored in the first bottom price storage 133 and linked to the aforementioned one highest price identification data, and all of the user identification data stored in the identification data storage 124 and linked to aforementioned highest price identification data, and stores to the second bottom price storage 137.

[Ceiling Price Obtaining Unit 122]

The ceiling price obtaining unit 122, similar to the ceiling price obtaining unit 122 shown in FIG. 5, has the lowest price storage 140, the lowest price comparing unit 141, the lowest price updating unit 142, the first ceiling price storage 143, the ceiling price comparing unit 144, the ceiling price updating unit 145, the fixed ceiling price obtaining unit 146 and second ceiling price storage 147

The lowest price storage 140 stores in association with the lowest price identification data at least one lowest price of market price shown in the market price data obtained from the market price data obtaining unit 101 (FIG. 69).

Each lowest price is recognized by the lowest price identification data.

The lowest price comparing unit 141 compares at least one highest price stored in the lowest price storage 140 and the latest market price shown in the market price data obtained in the market price data obtaining unit 101. For example, the lowest price comparing unit 141 compares the bottom price of the latest market price included in the market price data (FIG. 4) and the bottom price in the lowest price storage 140.

The lowest price comparing unit 141 stores in association with the lowest price identification data relate to the lowest price the flag f2 indicates whether the market price is higher than the lowest price (FIG. 69). The lowest price comparing unit 141 set the flag f2 to [1] when the market price is lower than the lowest price related to the lowest price identification data, and the lowest price comparing unit 141 reset the flag f2 to [0] when the market price is lower than the lowest price related to the lowest price identification data.

When the latest market price (for instance, the low price in the market price (FIG. 4)) is judged by the lowest price comparing unit 141 as lower than the lowest price linked to one lowest price identification data, the lowest price updating unit 142 stores the latest market price to the lowest price storage 140 as a new lowest price linked to aforementioned lowest price identification data.

Moreover, when the latest market price shown in the market price data is judged by the lowest price comparing unit 141 as lower than several lowest price linked to several lowest price identification data, the lowest price updating unit 142 stores the latest market price to the lowest price storage 140 as a new lowest price to replace several lowest price linked to aforementioned lowest price identification data. In this case, the lowest price updating unit 142 associates the aforementioned lowest price identification data as a replacement of several lowest price identification data associate with all of the user identification data in the identification data storage 124.

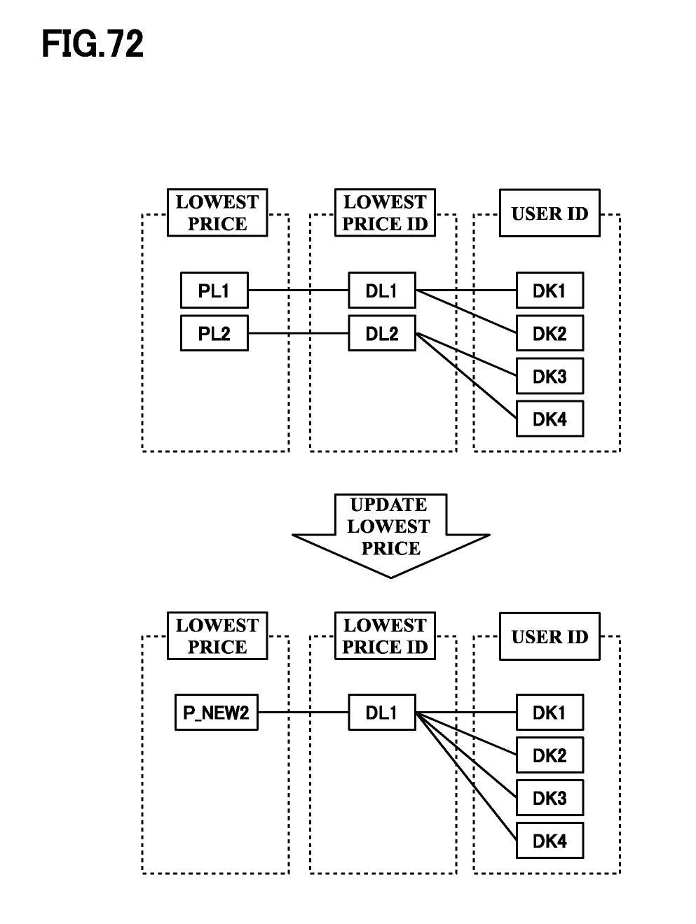

FIG. 72 is a drawing to explain a concrete example of the update process of the lowest price when the latest market price is lower than several lowest price stored in the lowest price storage 140.

Upper side of FIG. 72 shows the status of the lowest price storage 140 and identification data storage 124 before update. Before its update, the lowest price PL1 and PL2 linked to the lowest price identification data DL1 and DL2 are respectively stored in the lowest price storage 140. In the identification data storage 124, the user identification data DK1 and DK2 is linked to the lowest price identification data DL1, and the user identification data DK3 and DK4 is linked to the lowest price identification data DL2.

At this point, the latest market price P_NEW2 is assumed higher than the lowest price PL1, PL2 and PL3. In this case, the lowest price updating unit 142 stores the latest market price P_NEW2 to the lowest price storage 140 as a new lowest price linked to new lowest price identification data (DL1 in the example of FIG. 72). Also, the lowest price updating unit 142 relates again one lowest price identification data DL1 with the user identification data DK1, DK2, DK3 and DK4, four in total associated with the lowest price identification data DL1 and DL2 in the identification data storage 124.

Before the update process, the user identification data DK1, DK2, DK3 and DK4, four in total, are linked to the lowest price PL1, PL2 via the lowest price identification data DH1, DH2, DH3. However after the update process the user identification data DK1, DK2, DK3 and DK4 are linked to one lowest price P_NEW2 via one lowest price identification data DL1. From this process, processing load on the order server 1 is relieved by decreasing one of the lowest price stored in the lowest price storage 140.

The first ceiling price storage 143 stores the provisional ceiling price in the period of the market price become higher than the lowest price in association with the lowest price identification data (FIG. 69). The second ceiling price storage 147 stores the ceiling price determined in the end of the period of temporary decline of the market price in association with the user identification data (FIG. 70). In other words, the second ceiling price storage 147 stores the fixed ceiling price for each user.

The ceiling price comparing unit 144 compares at least one ceiling price (the provisional ceiling price) stored in the first ceiling price storage 143 and the latest market price, such as the highest price of the market price (FIG. 4), shown in the market price data obtained in market price data obtaining unit 101.

The ceiling price updating unit 145 stores the highest price (ceiling price) of all the market price data obtained in the market price data obtaining unit 101 to the first ceiling price storage 143 between the update of the highest price by the lowest price updating unit 142.

When the first market price compared after update of the one lowest price associated with one lowest price identification data (for instance, the low price in the market price (FIG. 4)) is judged by the lowest price comparing unit 141 as higher than aforementioned one lowest price, the ceiling price updating unit 145 stores the first market price to the first ceiling price storage 143 as a new provisional ceiling price and associates with one aforementioned lowest price identification data (In other words, the first market price in the temporary rise period is stored). Until the lowest price associated to the aforementioned highest price identification data is updated in the lowest price updating unit 142, when the latest market price shown in the market price data obtained in the market price data obtaining unit 101 is judged as higher than the ceiling price linked to aforementioned lowest price identification data, the ceiling price updating unit 145 stores to the first ceiling price storage 143 the latest market price as a provisional ceiling price and associates to the aforementioned lowest price identification data.

The fixed ceiling price obtaining unit 146 judges the change of the market price for the lowest price based on the result of comparison of the lowest price comparing unit 141. For instance, the fixed ceiling price obtaining unit 146 judges whether the market price is shifted from the condition of higher than the lowest price associated with one lowest price identification data to the condition of lower than the lowest price based on the flag f2 related to one lowest price identification data.

When the market price is judged to be shifted from the condition of higher than the lowest price linked to one lowest price identification data to the condition of lower than the lowest price linked to aforementioned one lowest price identification data (Flag f2 is changed from [1] to [0]), the fixed ceiling price obtaining unit 146 stores to the fixed ceiling price obtaining unit 146 the provisional ceiling price stored in the first ceiling price storage 143 associated to aforementioned one lowest price identification data as a determined ceiling price in the temporary rise period. In this case, the fixed ceiling price obtaining unit 146 associates the provisional ceiling price, stored in the first ceiling price storage 143 and linked to the aforementioned one lowest price identification data, and all of the user identification data (FIG. 70), stored in the identification data storage 124 and linked to aforementioned lowest price identification data, and stores to the second ceiling price storage 147.

Next, movement for determining the price of the stop order in the order server 1 with aforementioned structure will be described. Loss cut mode of short position and loss cut mode of long position will be mentioned separately.

(Loss Cut Mode of Long Position)

FIG. 73 is a flowchart to explain update of the price of sell order of the stop order in the order server relates to the eleventh embodiment.

When the market price data is obtained in the market price data obtaining unit 101 (ST200), the highest price comparing unit 131 selects the highest price identification data stored in the highest price storage 130 in predetermined order (ST201) and compares the highest price stored in the highest price storage 130 associated with the selected highest price identification data and the latest market price shown in the market price data (ST205). When the latest market price is higher than the aforementioned highest price, the highest price updating unit 132 stores the latest price as a new highest price associated with the selected highest price identification data (ST201) to the highest price storage 130 (ST210).

On the other hand, in case where the latest market price is lower than the highest price, the process of updating the bottom price stored in the first bottom price storage 133 (ST260: See FIG. 8) is executed due to the period of temporary decline in the market price.

In the process of updating, when flag f1 related to the selected use identification data (ST201) is set to [0], the bottom price updating unit 135 set the flag f1 to [1] and stores the latest market price to the first bottom price storage 133 as an initial value of provisional bottom price and associates with the selected use identification data (ST201).

On the other hand, in case where flag f1 related to the selected highest price identification data (ST201) is set to [1], the bottom price comparing unit 134 compares the bottom price related to the selected highest price identification data (ST2-1) stored in the first bottom price storage 133 and the latest market price.

In the result of comparison, when the latest market price is lower than the provisional bottom price, the bottom price updating unit 135 stores the latest market price to the first bottom price storage 133 as an initial value of provisional bottom price and associates with the selected use identification data (ST201).

When the new highest price is stored to the highest price storage 130 by the highest price updating unit 132, the fixed bottom price obtaining unit 136 refers to the flag f1 related to the selected highest price identification data (ST201) (ST220). In case where the Flag f1 is set to [1], in the comparison of the highest price relate to the selected highest price identification data, the market price is deemed to be shifted from the condition of lower than the highest price to the condition of higher than the highest price (the period of temporary decline has ended). In this case, the fixed bottom price obtaining unit 136 resets the flag f1 to [0] (ST225), performs the update process of the sell order price of stop order for all users related to the selected highest price identification data (ST201).

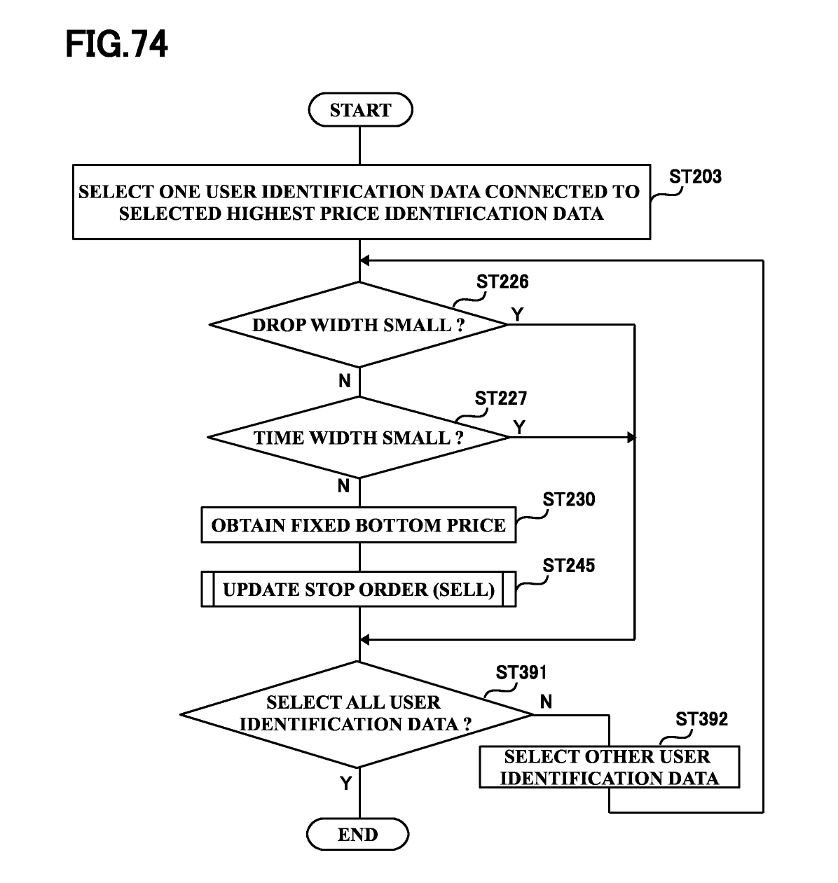

FIG. 74 is a flowchart to explain the process (ST231:FIG. 73) of updating the sell order price of stop order of the highest price selected for each user.

The fixed bottom price obtaining unit 136 selects the user identification data in predetermined order (ST203) related to the highest price identification data currently selected in the identification data storage 124 (ST201).

The fixed bottom price obtaining unit 136 calculates the differences between the bottom price stored in the first bottom price storage 133 and associated with the selected highest price identification data (ST201) and the previous highest price (the highest price just before update in ST210) associated with the selected highest price identification data (ST201)

For example, the highest price updating unit 132 stores the highest price before update to another storage area in the storage 14 associated with the highest price identification data when updates the highest price in the highest price storage 130. The fixed bottom price obtaining unit 136 reads the highest price before updating related to the highest price identification data from storage area, and calculates range of drop by subtracting the bottom price of the first bottom price storage 133 from the read highest price.

The fixed bottom price obtaining unit 136 judges whether the calculated range of drop is smaller than the predetermined threshold value. When the calculated range of drop is smaller than the predetermined threshold value, the fixed bottom price obtaining unit 136 cancels to store the bottom price of the first bottom price storage 133 as a determined bottom price to the second bottom price storage 137 (ST226). From this, the sell order price of stop order stored in the order information storage 107 related to the user of the selected user identification data (ST203) is unchanged and maintained.

Furthermore, the threshold value, compared with the range of drop at this point, may be common value for all the users, or may be custom values of user (individual setting information (FIG. 70) stored in the storage 14 associated with the user identification data.

In addition, in regard to the selected highest price identification data (ST201), the fixed bottom price obtaining unit 136 calculates elapsed time between the time previous highest price is touched and the time highest price in this time is touched (length of the temporary decline period) based on the time information of the market price data.

For example, the highest price updating unit 132 stores the highest price before update and the time information to another storage area in the storage 14 when updates the highest price in the highest price storage 130. The fixed bottom price obtaining unit 136 reads the time information of the highest price from storage area before update, and calculates the length of the temporary decline period based on the read time information of the highest price and the time information of the highest price in the highest price storage 130.

The fixed bottom price obtaining unit 136 judges whether the calculated length of the temporary decline period is shorter than the standard time. When the calculated length of the temporary decline period is shorter than the standard time, the fixed bottom price obtaining unit 136 cancels to store the bottom price of the first bottom price storage 133 as a determined bottom price to the second bottom price storage 137. From this, the sell order price of stop order stored in the order information storage 107 related to the user of the selected user identification data (ST201) is unchanged and maintained.

Furthermore, the standard time, compared with the length of the temporary decline period at this point, may be common value for all the users, or may be custom values of user stored in the storage 14 associated with the user identification data.

In case where the range of drop is judged as larger than the threshold value in the step ST226, and the length in the temporary decline period is judged as shorter than the predetermined time in step ST277, the fixed ceiling price obtaining unit 146 stores the bottom price stored in the first bottom price storage 133 in association with the selected highest price identification data (ST201) as a determined bottom price in the temporary decline period linked to the selected user identification data (ST203) to the second bottom price storage 137 (ST230).

When the bottom price associated with one user identification data is obtained in the fixed bottom price obtaining unit 136, the stop order calculating unit 113 calculates sell order price of stop order based on the obtained bottom price. The order information processing unit 108 updates the price of stop order calculated by stop order calculating unit 113 from the price stored in the order information storage 107. (ST245: See FIG. 9)

The fixed bottom price obtaining unit 136 performs the processes of steps ST226-ST245 concerning the identification data of users associated with the selected highest price identification data (ST391, ST392).

Return to FIG. 73. When the process of ST205-ST231 concerning the highest price identification data has finished, the other highest price identification data is selected by the highest price comparing unit 131 and the process of ST205-ST231 is repeated. From this, the process of ST205-ST231 related to all of the highest price identification data is performed.

(Loss Cut Mode of Short Position)

FIG. 75 is a flowchart to explain updating the buy order price of stop order at the order server 1 relate to the eleventh embodiment.

When the market price data is obtained in the market price data obtaining unit 101 (ST200), the lowest price comparing unit 141 selects the lowest price identification data stored in the lowest price storage 140 in predetermined order (ST202) and compares the lowest price stored in the lowest price storage 140 associated with the selected lowest price identification data and the latest market price shown in the market price data (ST250). When the latest market price is lower than the aforementioned lowest price, the highest price updating unit 132 stores the latest market price as a new lowest price and associates with the selected lowest price identification data (ST202) to the lowest price storage 140 (ST255).

On the other hand, when the latest market price is cheaper than the aforementioned lowest price, as the market price is in the temporary rise period, therefore update process of the ceiling price stored in the first ceiling price storage 143 is performed (ST215: see FIG. 13).

In the update process, when flag f2 associated with the selected lowest price identification data (ST202) is set to [0], the ceiling price updating unit 145 sets flag f2 to [1], and stores the market price as an initial provisional ceiling price associated with the lowest price identification data (ST202) to the first ceiling price storage 143.

On the other hand, the flag f1 associated with the selected lowest price identification data (ST202) is set to [1], the ceiling price comparing unit 144 compares the provisional bottom price stored in the first ceiling price storage 143 associated with the selected lowest price identification data (ST202) and the latest price. The latest market price is higher than the provisional ceiling price in the result of comparison, the ceiling price updating unit 145 stores the latest market price as a new provisional ceiling price and associates with the selected lowest price identification data (ST202) to the first ceiling price storage 143.

In case where the new lowest price is stored in the lowest price storage 140 by the lowest price updating unit 142 (ST255), the fixed ceiling price obtaining unit 146 refers the Flag f2 linked to the selected bottom price identification data (ST265). In case where the flag f2 is set to [1], the market price is deemed to be shifted from the condition of higher than the lowest price to the condition of lower than the lowest price (the period of temporary rise has ended). In this case, the fixed ceiling price obtaining unit 146 resets the flag f2 to [0] (ST270), and performs update process of the buy order of stop order for the all user relates to the selected the bottom price identification data (ST202).

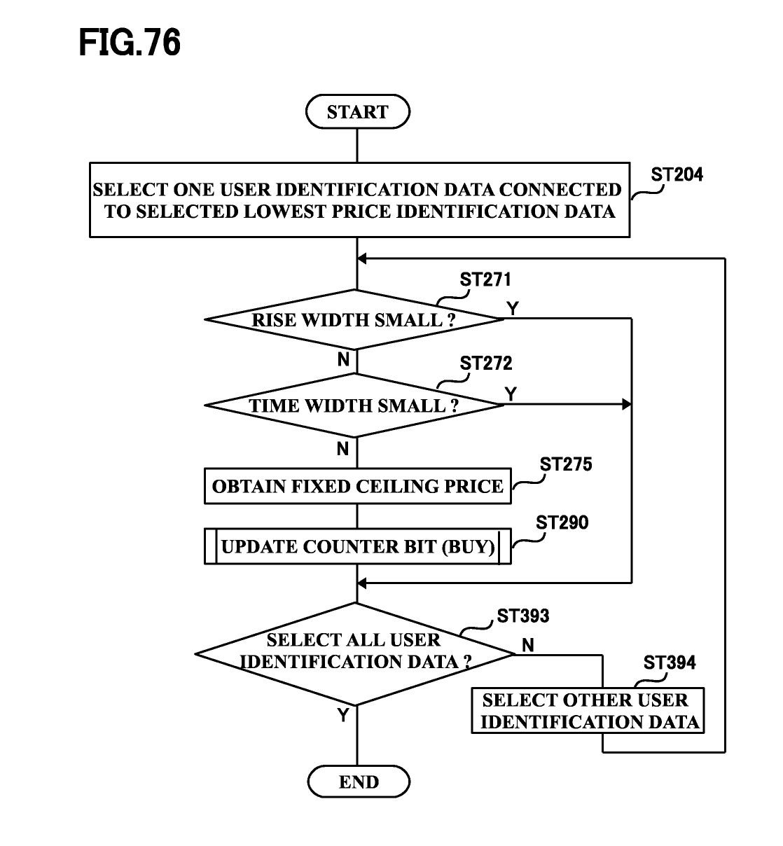

FIG. 76 is a flowchart to explain the update process of the buy order price of stop order for each user of one highest price selected (ST276: FIG. 75).

The fixed ceiling price obtaining unit 146 selects the user identification data linked to the selected lowest price identification data (ST202) in the identification data storage 124 with predetermined order (ST204).

The fixed ceiling price obtaining unit 146 calculates the differences between the ceiling price stored in the first ceiling price storage 143 associated with the lowest price identification data selected (ST202) and the previous lowest price (the lowest price just before update in ST255) associated with the lowest price identification data selected (ST202). For example, the lowest price updating unit 142 stores the lowest price before the update to another storage area in the storage 14 and linked with the lowest price identification data when updates the lowest price in the lowest price storage 140. The fixed ceiling price obtaining unit 146 read the lowest price before update relate to the lowest price identification data from aforementioned storage area, and calculates range of rises by subtracting the ceiling price in the first ceiling price storage 143 from the lowest price read.

The fixed ceiling price obtaining unit 146 reads the bottom price before update linked to the lowest price identification data from storage area, and calculates the range of rises by subtracting the read lowest price from the ceiling price of the first ceiling price storage 143.

The fixed ceiling price obtaining unit 146 judges whether the calculated range of rises is smaller than the predetermined threshold value. When the calculated range of rises is shorter than the predetermined threshold value, the fixed ceiling price obtaining unit 146 cancels to store the ceiling price of the first ceiling price storage 143 as a determined ceiling price to the second ceiling price storage 147 (ST271). From this, the buy order price of stop order stored in the order information storage 107 related to the user of the selected user identification data (ST204) is unchanged and maintained.

Furthermore, the threshold value, compared with the range of rises at this point, may be common value for all the users, or may be custom values of user (individual setting information (FIG. 70)) stored in the storage 14 associated with the user identification data.

In addition, in regard to the selected lowest price identification data (ST202), the fixed bottom price obtaining unit 136 calculates elapsed time between the time previous lowest price is touched and the time lowest price in this time is touched (length of the temporary rise period) based on the time information of the market price data.

For example, the lowest price updating unit 142 stores the lowest price before update and the time information to another storage area in the storage 14 when updates the lowest price in the lowest price storage 140. The fixed ceiling price obtaining unit 146 reads the time information of the lowest price from storage area before update, and calculates the length of the temporary rise period based on the read time information of the lowest price and the time information of the lowest price in the lowest price storage 140.

The fixed ceiling price obtaining unit 146 judges whether the calculated length of the temporary rise period is shorter than the standard time. When the calculated length of the temporary rise period is shorter than the standard time, the fixed ceiling price obtaining unit 146 cancels to store the ceiling price of the first ceiling price storage 143 as a determined ceiling price to the second ceiling price storage 147 (ST272). From this, the buy order price of stop order stored in the order information storage 107 related to the user of the selected user identification data (ST204) is unchanged and maintained.

Furthermore, the standard time, compared with the length of the temporary rise period at this point, may be common value for all the users, or may be custom values (individual setting information (FIG. 70) of user stored in the storage 14 associated with the user identification data.

In case where the range of rise is judged as larger than the threshold value in the step ST271, and the length in the temporary rise period is judged as longer than the predetermined time in step ST272, the fixed ceiling price obtaining unit 146 stores the ceiling price stored in the first ceiling price storage 143 in association with the selected lowest price identification data (ST202) as a determined bottom price in the temporary rise period linked to the selected user identification data (ST204) to the second ceiling price storage 147 (ST275).

When the ceiling price associated with one user identification data is obtained in the fixed ceiling price obtaining unit 146, the stop order calculating unit 113 calculates buy order price of stop order based on the obtained ceiling price. The order information processing unit 108 updates the price of stop order calculated by stop order calculating unit 113 from the price stored in the order information storage 107. (ST290: See FIG. 14)

The fixed ceiling price obtaining unit 146 performs the processes of steps ST271-ST290 concerning the user identification data associated with the selected lowest price identification data (ST393, ST394).

Return to FIG. 75. When the process of steps ST250-ST276 concerning one lowest price identification data has finished, the other lowest price identification data is selected in the (141, the process of steps ST250-ST276 are repeated. From this, the processes of steps ST250-ST276 concerning the lowest price related to all the lowest price identification data are performed.

As explained above, according to the order server 1 related to the present embodiment, the result of the process such as updating the highest price and lowest price to judge the market trend can be used by multiple users by using the identification data to recognize the highest price and lowest price, and the identification data to recognize each user, therefore the load on processes and usage of storage area can be reduced.

### The Twelfth Embodiment

Next, the twelfth embodiment of the present embodiment will be explained. The order server 1 related to the present embodiment applies the process of deciding the trend of the market price in the order server 1 relate to the fifth-tenth embodiment to the process of acquiring the bottom price and the ceiling price in the order server 1 relate to the eleventh embodiment.

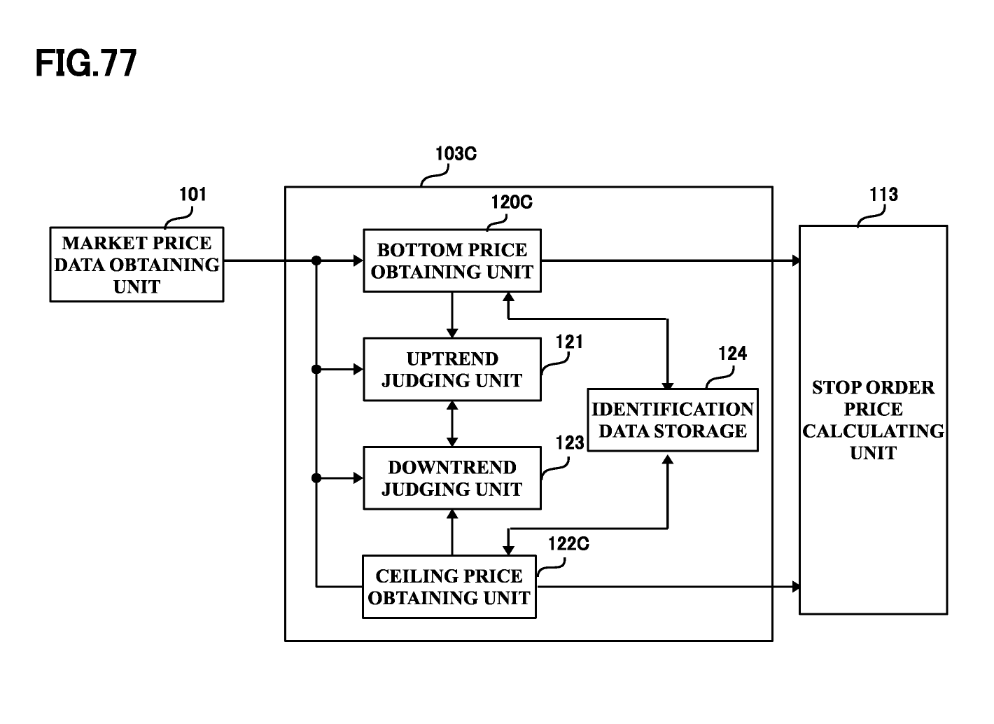

FIG. 77 is a drawing showing an example of the (103C) in the order server 1 related to the twelfth embodiment.

The trend judging unit 103C shown in FIG. 77 has the same components of the trend judging unit 103 (the uptrend judging unit 121 and the downtrend judging unit 123) shown in FIG. 35, as well as the bottom price obtaining unit 120C, the ceiling price obtaining unit 122C and the identification data storage 124.

For instance, the trend judging unit 103C is applicable to the trend judging unit 103 in FIG. 34, the first trend judging unit 103A and the second trend judging unit 103B in FIG. 40, the first trend judging unit 103 in FIG. 47 and FIG. 64.

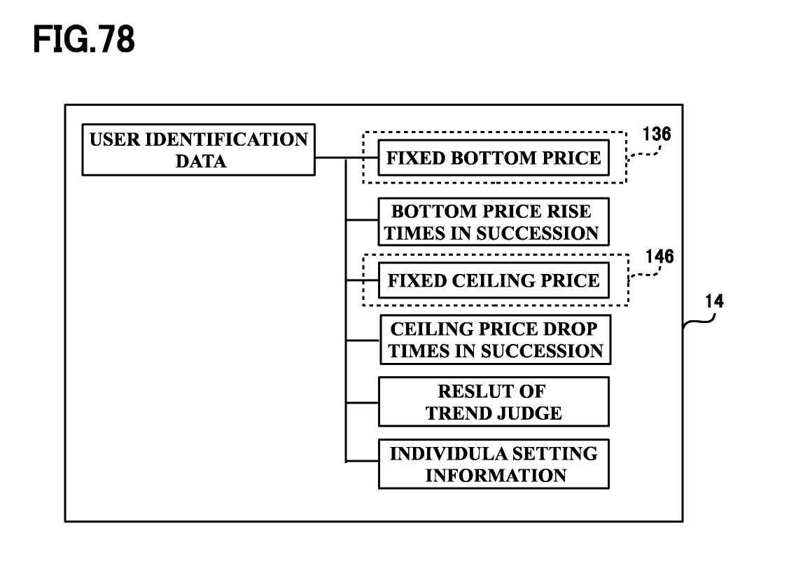

FIG. 78 is a drawing showing an example of the data linked to the user identification data in the order server 1 relate to the present embodiment.

One user identification data is associated with the fixed bottom price in the temporary decline period in the market price, the fixed ceiling price in the temporary rise period in the market price, and various configuration information customized by each user. In addition, the times of increase in succession of the bottom price used to judgment of the uptrend judging unit 121 and the times of decrease in succession of the ceiling price used to judgment of the downtrend judging unit 123, and the result of judgment of the current trends (Uptrend, downtrend and no trend state) are related to one user identification data.

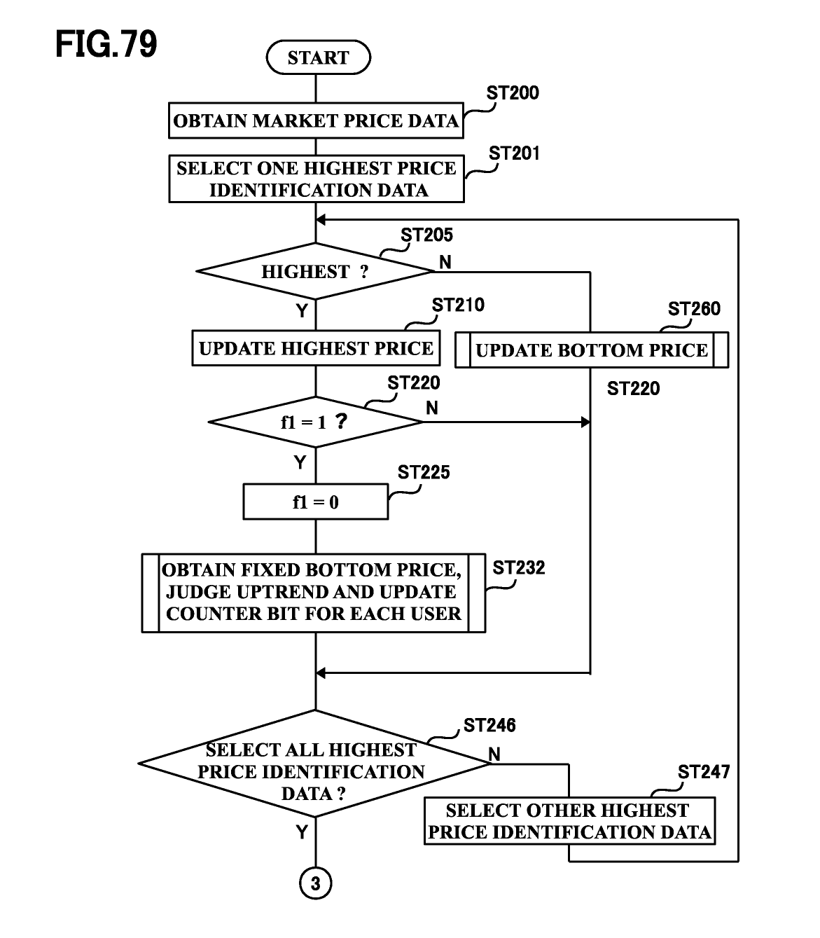

In the order server 1 has the structure stated above, the process of judging the market trend and deciding the price of stop order for several users will be explained using flowcharts in FIG. 79-FIG. 83.

FIG. 79-FIG. 81 are flowcharts to explain the process of deciding the trend of the market price and the update process of the price of stop order in the order processing server relating to the twelfth embodiment.

When the market price data is obtained at the market price data obtaining unit 101 (ST200), the order server 1 perform the processes of step ST201-ST247 for all the highest price identification data.

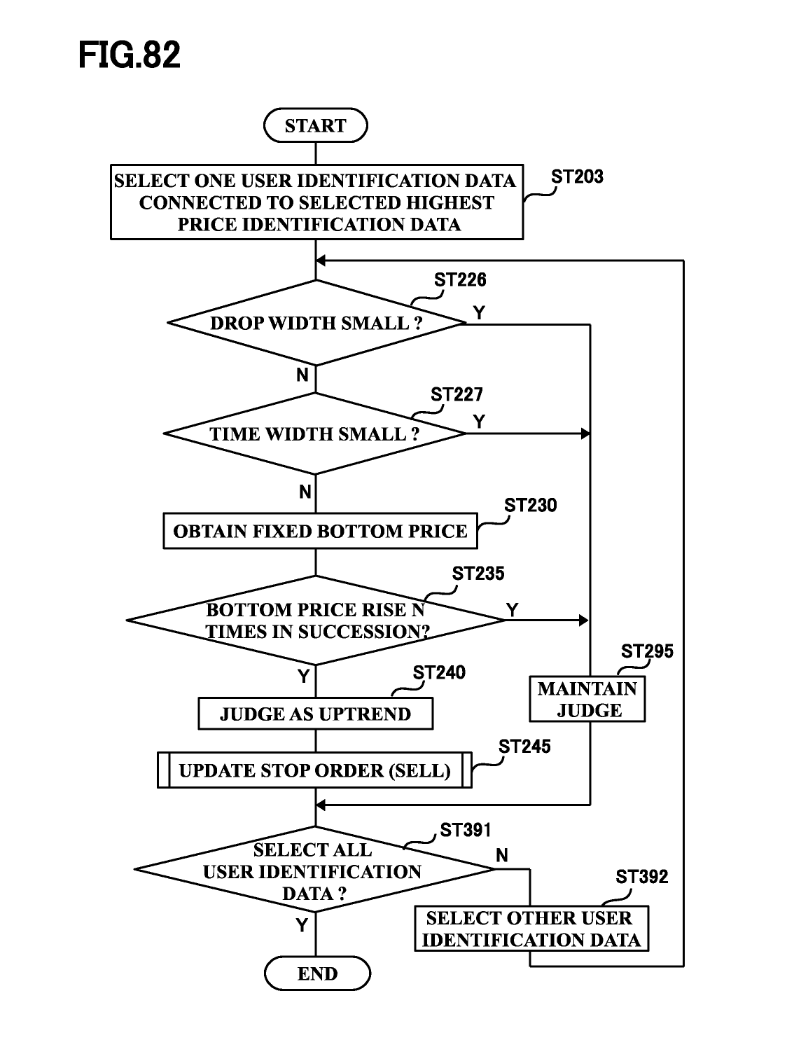

The processes of step ST201-247 shown in FIG. 79 are replaced the processes of step ST231 (FIG. 74) in ST201-ST274 in flowchart in FIG. 73 with the processes of the following step ST232 (FIG. 82).

FIG. 82 is a flowchart to explain the process (ST232:FIG. 79) of judging uptrend of market price and updating the sell order price of stop order for the highest price selected for each user.

In comparison with the flowchart of FIG. 82 and FIG. 74, step ST235, ST240 and ST295 by the uptrend judging unit 121 were added to FIG. 82.

In other words, when the fixed bottom price in the temporary decline period is obtained by the fixed bottom price obtaining unit 136 (ST230), the uptrend judging unit 121 compares the recent fixed bottom price and the previous fixed bottom price. When the latest fixed bottom price is higher than the previous fixed bottom price, the uptrend judging unit 121 adds 1 to the number of increase times of bottom price in succession (FIG. 78) stored in the storage 14 associated with the selected user identification data (ST203). The uptrend judging unit 121 judges whether the number of increase time in succession after this add calculation reaches the predetermined number of times (n times) (ST240), when it reaches to the predetermined number of times, the market price is judged as uptrend (ST240). The uptrend judging unit 121 stores the result of the judgment of the trend (uptrend) associated with the selected user identification data (ST203) to the predetermined storage area in the storage 14 (FIG. 78).

The uptrend judging unit 121 maintains the current result of judgment (ST295) when the range of drop is judged as smaller than the predetermined range in the temporary decline period in the step ST225, or when the duration is judged as shorter than the predetermined duration in the temporary decline period in the step ST227, or when the times of increase in succession of the bottom price is judged as not reached to the predetermined times in the step ST235 (ST295).

The order server 1 performs the processes of steps ST226-ST295 shown in FIG. 82 concerning the identification data of users associated with the selected highest price identification data (ST201:FIG. 79).

Hereinbefore, description of the Step ST232 (FIG. 82) is stated.

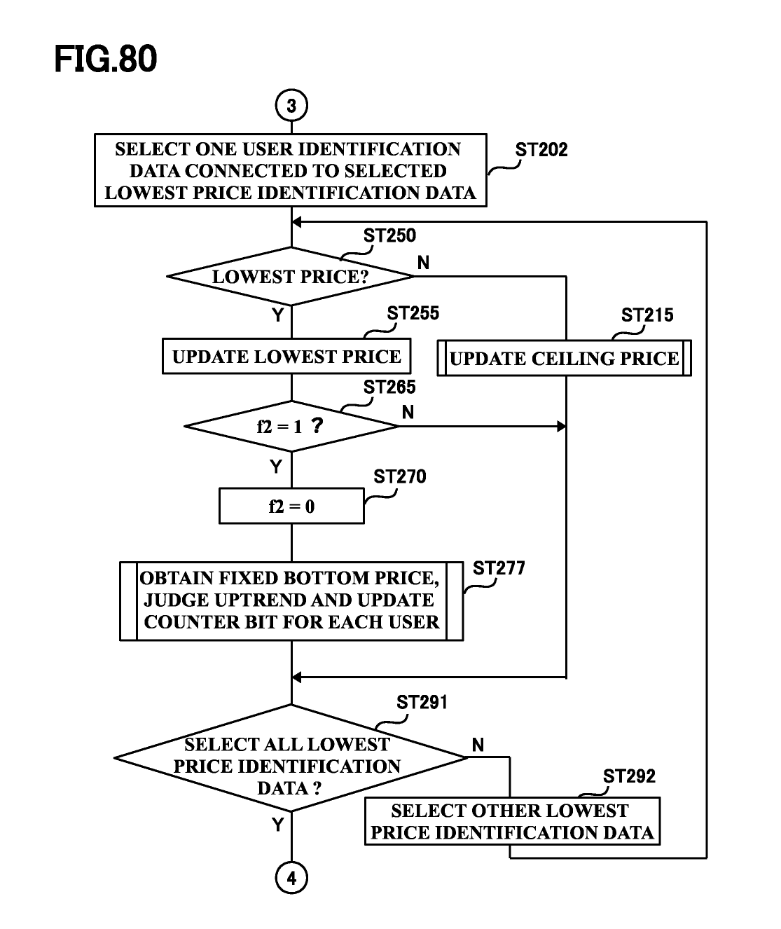

Return to FIG. 79. When the processes of step ST205-ST260 for all of the highest price identification data, the order server 1 executes the process of step ST202-ST292 shown in a flowchart of FIG. 80.

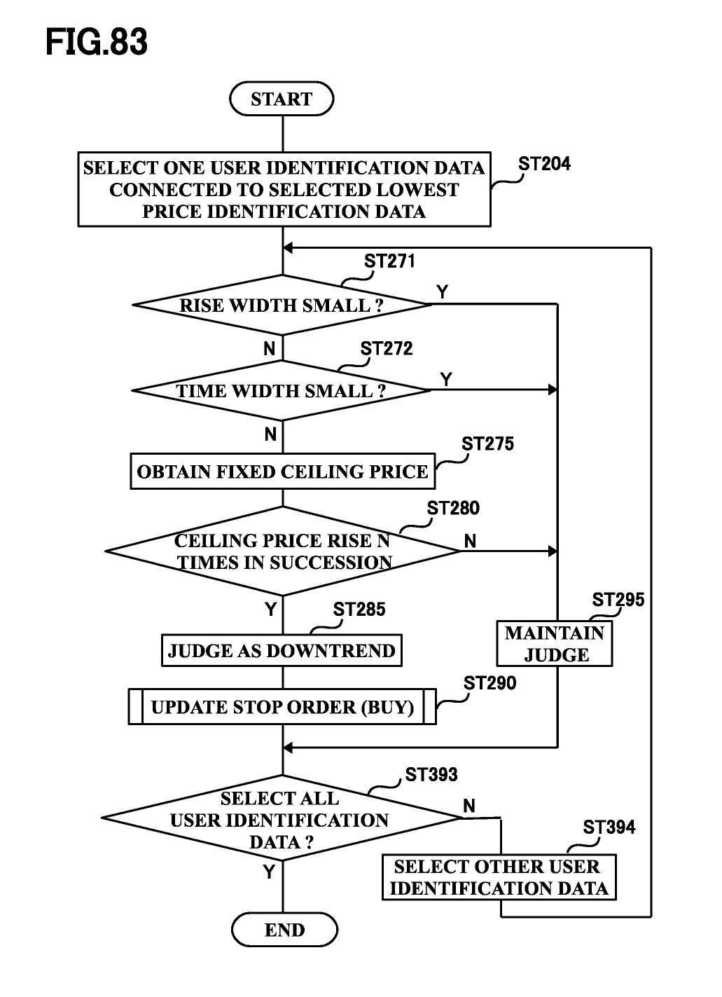

The processes of ST202-ST292 shown in flowchart in FIG. 80, are replaced the processes of step ST276 (FIG. 76) in ST202-ST292 in flowchart in FIG. 75 with the processes of the following step ST277 (FIG. 83).

FIG. 83 is a flowchart to explain the process (ST277:FIG. 80) of judging downtrend of market price and updating the buy order price of stop order of the lowest price selected for each user.

In comparison with the flowchart of FIG. 83 and FIG. 76, step ST280, ST285 and ST295 by the downtrend judging unit 123 were added to FIG. 83.

In other words, when the fixed ceiling price in the temporary rise period is obtained by the fixed ceiling price obtaining unit 146 (ST275), the downtrend judging unit 123 compares the recent fixed ceiling price and the previous fixed ceiling price. When the latest fixed ceiling price is lower than the previous fixed ceiling price, the downtrend judging unit 123 add 1 to the times of decrease of the ceiling price in successin (FIG. 78) stored in the storage 14 associated with the selected user identification data (ST204). The downtrend judging unit 123 judges whether the times of increase in succession after add operation reaches the predetermined number of times (n times) (ST280), when it reaches to the predetermined number of times, the market price is judged as downtrend (ST285). The downtrend judging unit 123 stores the result of the judgment of the trend (downtrend) associated with the selected user identification data to the predetermined storage area in the storage 14 (FIG. 78).

The downtrend judging unit 123 maintains the current result of judgment (ST295) when the range of rise is judged as smaller than the predetermined range in the temporary rise period in the step ST272, or when the duration is judged as shorter than the predetermined duration in the temporary rise period in the step ST272, or when the times of increase in succession of the ceiling price is judged as not reached to the predetermined times in the step ST295.

The order server 1 performs the processes of steps ST271-ST295 shown in FIG. 83 concerning the identification data of users associated with the selected lowest price identification data (ST202:FIG. 80).

Hereinbefore, description of the Step ST277 (FIG. 83) is stated.

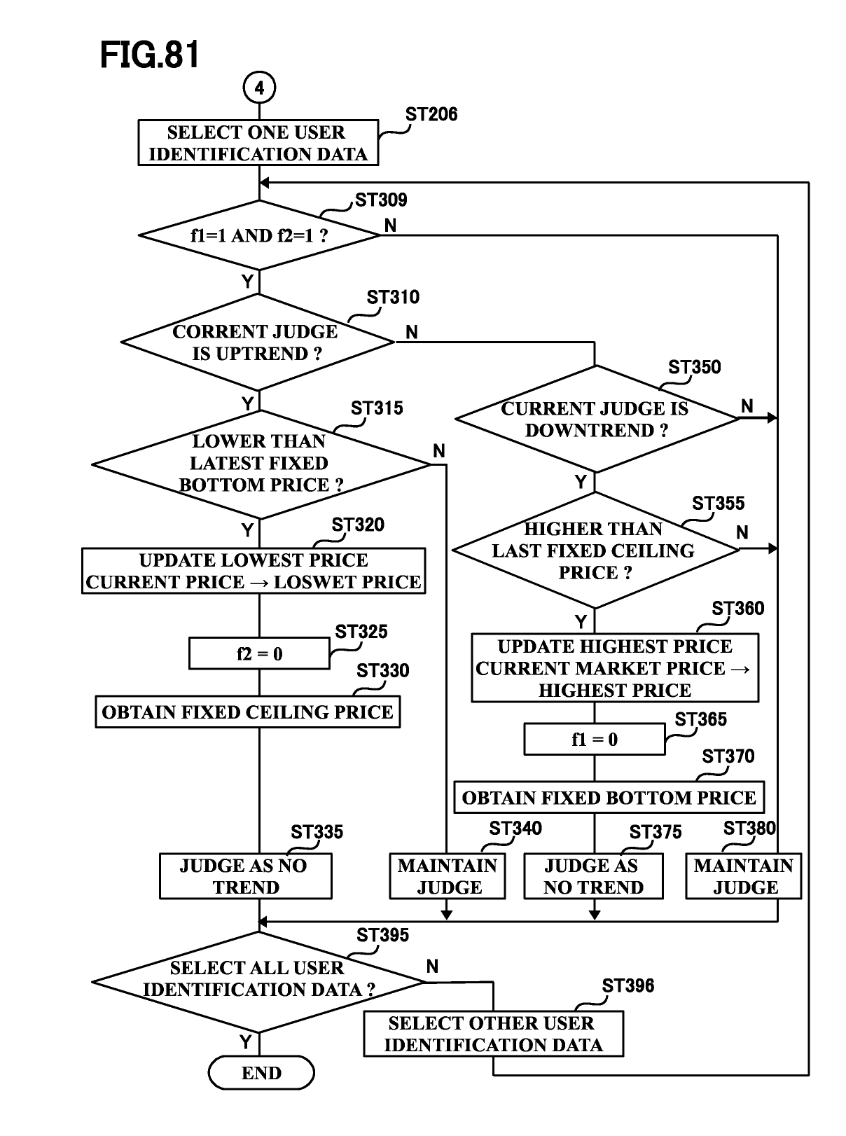

Return to FIG. 80. After processes of step ST250-ST277 concerning the all the lowest price identification data, the order server 1 performs processes of step ST206-ST396 shown in flowchart of FIG. 81.

The trend judging unit 103 selects in order in a predetermined order from at least one user identification data registered in predetermined storage area in the storage 14.

When the trend judging unit 103 selects one user identification data, and references the highest price identification data and the lowest price identification data associated with the selected user identification data and the identification data storage 124 (FIG. 70). Moreover, the trend judging unit 103 references flag f1 associated with the highest price identification data and flag f2 associated with the lowest price identification data (ST309).

When flag f1 referenced indicates [1] (the market price is lower than the highest price), and flag f2 referenced indicates [1] (the market price is higher than the lowest price), the trend judging unit 103 perform the processes after step ST310. On the other hand, either flag f1 or f2 referenced indicates [0] (the market price is higher than the highest price, or the market price is lower than the lowest price), the trend judging unit 103 maintains the current judgment (ST380).

When flag f1 referenced indicates [1] and flag f2 referenced indicates [1] (the market price is lower than the highest price and higher than the lowest price), the trend judging unit 103 reads out the result of current trend judgment associated with the selected user identification data (ST) from the predetermined memory area of the storage 14 (FIG. 70).

When the result of current trend judgment read from the storage 14 indicates uptrend (ST310), the trend judging unit 103 judges whether uptrend of the market price has ended.

In other words, the uptrend judging unit 121 reads out the latest determined bottom price associated with the selected user identification data (ST206) from the second bottom price storage 137, when the latest market price is lower than the latest determined bottom price (ST315), the uptrend judging unit 121 judges that uptrend of the market price has ended and the market price become no trend state (Not uptrend or downtrend) (ST335).

When the uptrend of the market price is judged as ended (ST335) by the uptrend judging unit 121, the lowest price updating unit 142 stores the latest market price shown in the market price data, obtained in the market price data obtaining unit 101 to judge whether uptrend has ended, as a new lowest price, and associated with new lowest price identification data. In addition, the lowest price updating unit 142 updates the memory information of the identification data storage 124 (ST320) the currently selected user identification data (ST206) to be associated with new lowest price identification data.

Thus, the latest market price considered as an initial value of the lowest price, obtaining the ceiling price by the (122C) and judging the downtrend by the downtrend judging unit 123 become possible.

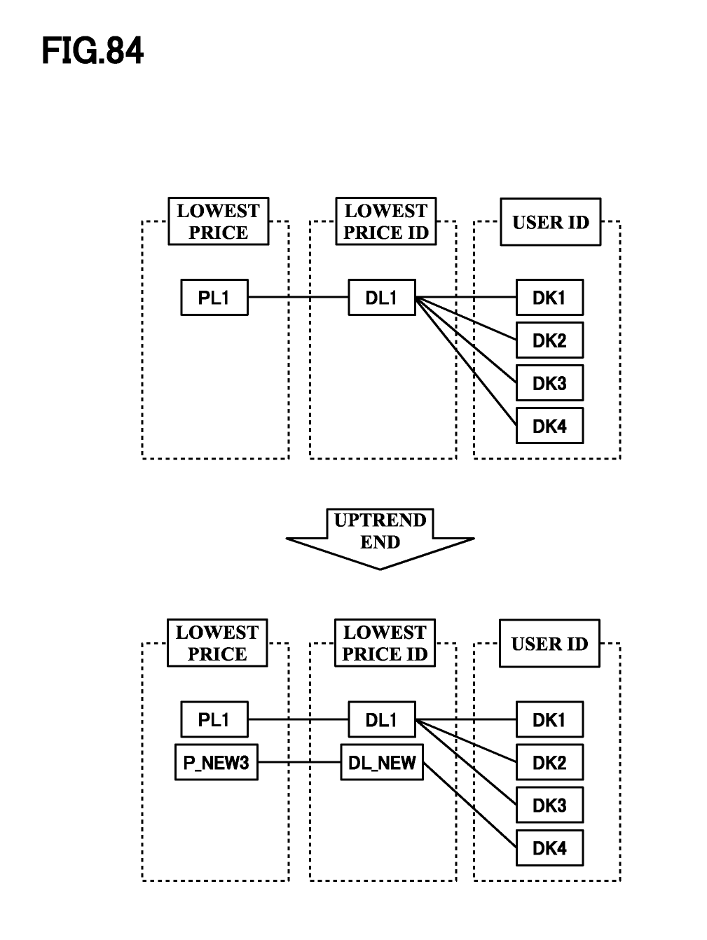

FIG. 84 is a drawing to explain an example of the process storing the latest market price as a new lowest price when uptrend of the market price is judged as ended.

Upper side of FIG. 84 shows the condition of the lowest price storage 140 and identification data storage 124 just before the market price of uptrend is judged as ended. The lowest price PL1 associated with the lowest price identification data DL1 is stored to the lowest price storage 140. The lowest price identification data DL1 is associated with user identification data DK1, DK2, DK3 and DK4 in the identification data storage 124.

Here, the end of the uptrend of the market price is determined when the selected user identification data (ST206) is DK4. The lowest price updating unit 142 stores the latest market price P_NEW shown in the market price data, obtained in the market price data obtaining unit 101 to judge whether uptrend has ended, as a new lowest price, and associated with new lowest price identification data. In addition, the lowest price updating unit 142 updates the memory information of the identification data storage 124 (ST320) the currently selected user identification data DK4 to be associated with new lowest price identification data DL_NEW.

When the uptrend is judged that ended, the lowest price comparing unit 141 resets the flag f2 relates to the selected user identification data (ST206) to [0] to end the temporary decline period from the previous lowest price. Moreover, the fixed ceiling price obtaining unit 146 stores to the second ceiling price storage 147 the provisional ceiling price of the first ceiling price storage 143 associated with the selected user identification data (ST206) through the lowest price identification data as a new determined ceiling price, and associated with the selected user identification data (ST206). The ceiling price determined at this point corresponds to the highest price in the uptrend period that ended.

When latest market price is higher than the latest fixed bottom price (ST315), the trend judging unit 103 maintains uptrend on the judgment related to the selected user identification data (ST206) (ST340).

On the other hand, the result of current trend judgment read from the storage 14 indicates downtrend (ST350), the trend judging unit 103 judges whether downtrend of the market price has ended.

In other words, the downtrend judging unit 123 reads out the latest determined ceiling price related to the selected user identification data (ST206) from the second ceiling price storage 147. When the latest market price is higher than the determined ceiling price (ST355), the downtrend judging unit 123 judges that downtrend of the market price has ended and the market price become no trend state (ST375).

In other words, the uptrend judging unit 121 reads out the latest determined bottom price associated with the selected user identification data (ST206) from the second bottom price storage 137, when the latest market price is lower than the latest determined bottom price (ST315), the uptrend judging unit 121 judges that uptrend of the market price has ended and the market price become no trend state (Not uptrend or downtrend) (ST335).

When the downtrend of the market price is judged as ended (ST375) by the downtrend judging unit 123, the highest price updating unit 132 stores the latest market price shown in the market price data, obtained in the market price data obtaining unit 101 to judge whether downtrend has ended, as a new highest price, and associated with new highest price identification data. In addition, the downtrend judging unit 123 updates the memory information of the identification data storage 124 (ST360) the currently selected user identification data (ST206) to be associated with new highest price identification data.

Thus, the latest market price considered as an initial value of the highest price, obtaining the bottom price by the (120C) and judging the uptrend by the uptrend judging unit 121 become possible.

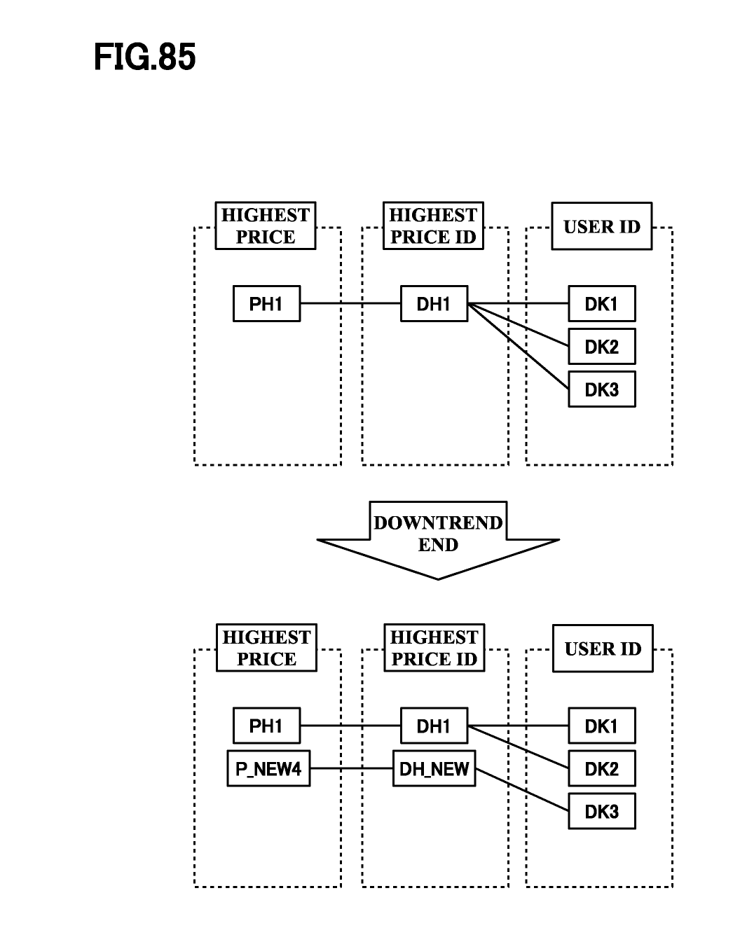

FIG. 85 is a drawing to explain an example of the process storing the latest market price as a new highest price when downtrend of the market price is judged as ended.

Upper side of FIG. 85 shows the condition of the highest price storage 130 and identification data storage 124 just before the market price of downtrend is judged as ended. The highest price PH1 associated with the highest price identification data HL1 is stored to the highest price storage 130. The highest price identification data DH1 is associated with user identification data DK1, DK2, DK3 and DK4 in the identification data storage 124.

Here, the end of the downtrend of the market price is determined when the selected user identification data (ST206) is DK3. The highest price updating unit 132 stores the latest market price P_NEW4 shown in the market price data, obtained in the market price data obtaining unit 101 to judge whether downtrend has ended, as a new highest price, and associated with new highest price identification data DH_NEW. In addition, the highest price updating unit 132 updates the memory information of the identification data storage 124 (ST360) the currently selected user identification data DK3 to be associated with new highest price identification data DH_NEW.

When the downtrend is judged that ended, the highest price comparing unit 131 resets the flag f1 relates to the selected user identification data (ST206) to [0] to end the temporary rise period from the previous highest price. Moreover, the fixed bottom price obtaining unit 136 stores to the second bottom price storage 137 the provisional bottom price of the first bottom price storage 133 associated with the selected user identification data (ST206) through the highest price identification data as a new determined bottom price, and associated with the selected user identification data (ST206)(ST370). The bottom price determined at this point corresponds to the lowest price in the downtrend period that ended.

When the latest market price is lower than the latest fixed ceiling price (ST355), the trend judging unit 103 maintains the downtrend on the judgment related to the selected user identification data (ST206) (ST380).

The order server 1 performs processes of aforementioned steps ST309˜ST380 to all the user identification data stored in the predetermined territory of the storage 14 (FIG. 78) (ST395, ST396).

As stated above, according to the order server 1 relate to the present embodiment, the result of the process such as updating the highest price and lowest price to judge the market trend can be used by multiple users. Therefore the load on processes and usage of storage area can be reduced.

<Example of the Setting Screen of Terms and Conditions>

Next, at the order server 1 related to the foregoing each embodiment, an example of the setting screen of terms and conditions set by the users will be explained.

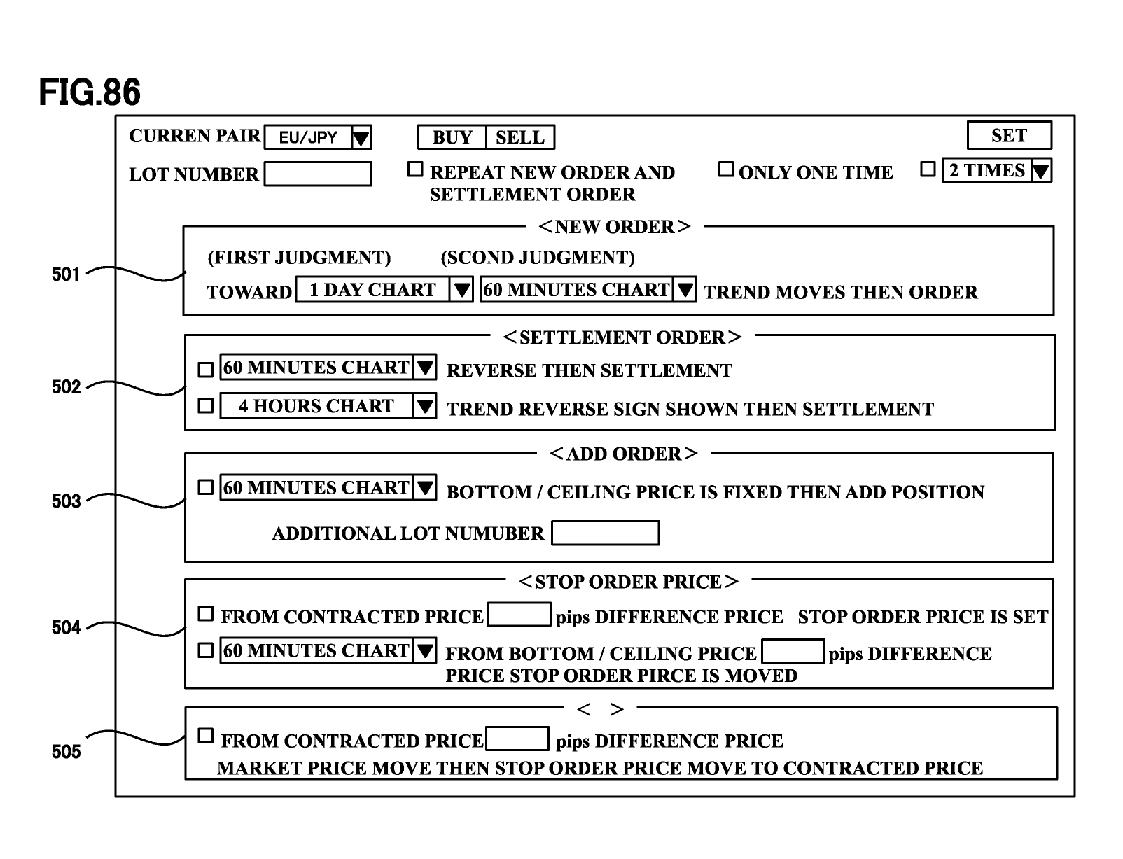

FIG. 86 is a drawing showing an example of the setting screen of terms and conditions at the order server 1 (FIG. 40) related to the sixth embodiment. The information of the screen sent to the terminal apparatus 2 as web page data generated at the reception unit 109 (FIG. 3), for instance.

The example of the screen in FIG. 86 shows the setting screen of the terms and conditions relate to the foreign exchange margin transactions. At the top of the screen, there are the buttons to select “sell” or “buy”, the list boxes to enter by choosing trading target of currency pair from the list, and the boxes to enter the number of lots (amount) of the currency to trade. Moreover, the column 501 about new order, the column 502 about settlement order, the column 503 about additional order, the column 504 about stop order (loss cut) and the column 505 for other special order are provided lower than the top of the screen.

The column for new order 501 possesses listbox to set the time scale to the market price data D1 and D2 used to judge the two trend judging units (103A, 103B). To make the time scale of the market price data D2 shorter than the market price data D1, once the time scale is set to list box on the left (the market price data D1), the time scale to enter to list box on the right (the market price data D2) is limited. The market price data obtaining unit 101 generates the market price data used to judge the each trend judging unit (103A, 103B) according to the setting of the time scale entered in the list boxes.

The column 502 for settlement order has checkboxes to select the condition of two ways of settlement condition. Furthermore, on the right side of each checkboxes, there are listbox to set the time scale of the market price data used to judge each settlement condition. The time scale able to enter the listbox, for example, limited to be shorter than the market price data D1.

When the checkbox on the top of the column 502 is selected, the order outputting unit 106 compares the result of judgment of the trend based on the time scale set in the listbox on the right side and the result of judgment of the trend in the first trend judging unit 103A (First judgment) settlement order will output both result become opposite (one is uptrend and the other is downtrend).

When the checkbox on the second of the column 502 is selected, the result of judgment of the trend based on the time scale set in the listbox on the right side become [no trend state], the order outputting unit 106 outputs the settlement order.

Furthermore, in this case, the order server 1 has the trend judging unit to judge additional settlement condition with similar structure of the second trend judging unit 103B. The market price data obtaining unit 101 generates the market price data used to judge the trend judging unit according to the settings of the time scale entered in the list box. The order outputting unit 106 outputs the settlement order according to the result of judgment in the trend judging unit.

Three radio buttons on top of the screen are placed to set whether repeats the new order in the aforementioned column 501 and the settlement order in the column 502.

In other words, the radio button on the left for “repeat new order and settlement order” is pressed, the order outputting unit 106 continuously executes new order and settlement order set in the column 501 and the column 502. The radio button in the middle for [one-time-only] is pressed, the order outputting unit 106 executes new order and settlement order only once. The radio button on the right is pressed, the order outputting unit 106 repeats new order and settlement order for number of times entered in the list box.

The column 503 for additional order possesses checkboxes to verify automatic additional order after new order. Moreover, on the right side of the checkbox, the listbox is provided to set the time scale of the market price data used to judge additional order. The time scale able to be entered to the list box, for example, is limited to be shorter than the market price data D1. There is a box near center of the column 503 to enter the number of the lot (amount of money) of currency for additional order.

When the checkbox for additional order is valid, the order outputting unit 106 adds more position to buy or sell when the column 501 is not settled yet and the bottom price or ceiling price of the market price is determined. In other words, when both of the results of judgment of the trend of two trend judging unit (103A, 103B) indicate uptrend, the order outputting unit 106 add buy position according to the determination of the bottom price (See FIG. 30 and FIG. 31). When both of the results of judgment of the trend of two trend judging unit (103A, 103B) indicate downtrend, the order outputting unit 106 add sell position according to the determination of the ceiling price (See FIG. 32 and FIG. 33).

The order server 1 has the trend judgment unit with the same structure as second trend judging unit 103B for judging the additional order condition. The market price data obtaining unit 101 generates the market price data used to judge the trend judgment unit according to the settings of the time scale entered in the list box. The order outputting unit 106 outputs the settlement order according to the result of judgment in the trend judgment unit.

Two check boxes are provided in order to enable automatic setting of stop order in the column 504 about stop order (loss cut).

When the checkbox on the top of the column 504 is valid, the stop order calculating unit 113 calculates a given amount away from the contracted price as stop order price when new order of sell or buy is contracted. For instance, the stop order calculating unit 113 calculates selling order price a given price lower than the buying price when the buy order is contracted (FIG. 24-FIG. 26). The stop order calculating unit 113 calculates buying order price a given price higher than the selling price when the sell order is contracted (See FIG. 27-FIG. 29). When the price of stop order is calculated by the stop order calculating unit 113, the order information processing unit 108 stores the order information of stop order calculated to the order information storage 107. From this, certain amount apart from the contracted price order of stop order become valid. On the right side of the first checkbox, the box for setting an amount equivalent to differences between the contracted price and the price of stop order by pip unit (smallest currency unit) is provided.

When the checkbox on the second of the column 504 is valid, the stop order calculating unit 113 calculates a given amount away from the bottom price or ceiling price as stop order price each time the bottom price or ceiling price in the market is determined with the new order of the column 501 is not yet settled (See FIG. 7-FIG. 16). For example, the stop order calculating unit 113 calculates the price a given price lower than the bottom price of the market price of the short time scale as the sell price of stop order, when the results of the judgement of two trend judging units (103A, 105B) indicates uptrend, the stop order calculating unit 113 calculates the price a given price higher than the ceiling price of the market price of short time scales as the buy price of stop order. When the price of stop order is calculated by the stop order calculating unit 113, the order information processing unit 108 changes the determined price of stop order stored in the order information storage 107 to the calculated price. From this, the price of stop order is sequentially modified to the price a given price away from the bottom price or the ceiling price of the market price. On the right of the second checkbox, there is a list box to set the time scale of the market price data used to obtain the bottom price and the ceiling price of the market price. The time scale enterable to the list box is limited to the time shorter than the market price data D1. On the right side of the list box, the box for setting an amount equivalent to differences between the bottom price or the ceiling price and the price of stop order by pip unit is provided.

Furthermore, in this case, the order server 1 has the trend judging unit to calculate stop order with similar structure of the second trend judging unit 103B. The market price data obtaining unit 101 generates the market price data used to judge the judgment unit according to the settings of the time scale entered in the listbox. The stop order calculating unit 113 calculates the price of stop order based on the bottom price obtained in the bottom price obtaining unit 120A of the judgment unit (FIG. 35) and the ceiling price obtained in the ceiling price obtaining unit 122A (FIG. 35). The order outputting unit 106 outputs the settlement order according to the result of judgment in the trend judging unit.

In the column 505 about special order, there is a checkbox to enable the special order relate to the automatic correction of stop order after new order is contracted.

When the checkbox is enabled and the latest market price shown in the market price data reaches a given amount away from the contracted price, the stop order calculating unit 113 calculates the contracted price as a price of stop order.

For instance, as for the latest market price reaches a given price higher than the contracted price of buy order, the stop order calculating unit 113 calculates the contracted price of buy order as a sell order price of stop order. On the other hand, as for the latest market price reaches a given price lower than the contracted price of sell order, the stop order calculating unit 113 calculates the contracted price of sell order as a buy order price of stop order. When the price of stop order is calculated in the stop order calculating unit 113, the order information processing unit 108 changes the determined price of stop order stored in the order information storage 107 to the calculated price. Thus, the price of stop order is modified to the contracted price, the transaction is carried out at the same price as the contracted price even if the stop order is executed, and therefore the loss will not occur. On the right side of the checkbox, the box for setting an amount equivalent to differences between the price to execute the special order and the contracted price by pip unit is provided.

The setting button on top of the screen is a button for set the items entered into the each column to the order server 1. When the [Setting] bottom is pressed, the setting information of the screen is sent from the terminal apparatus 2 to the order server 1, and the conditions become valid.

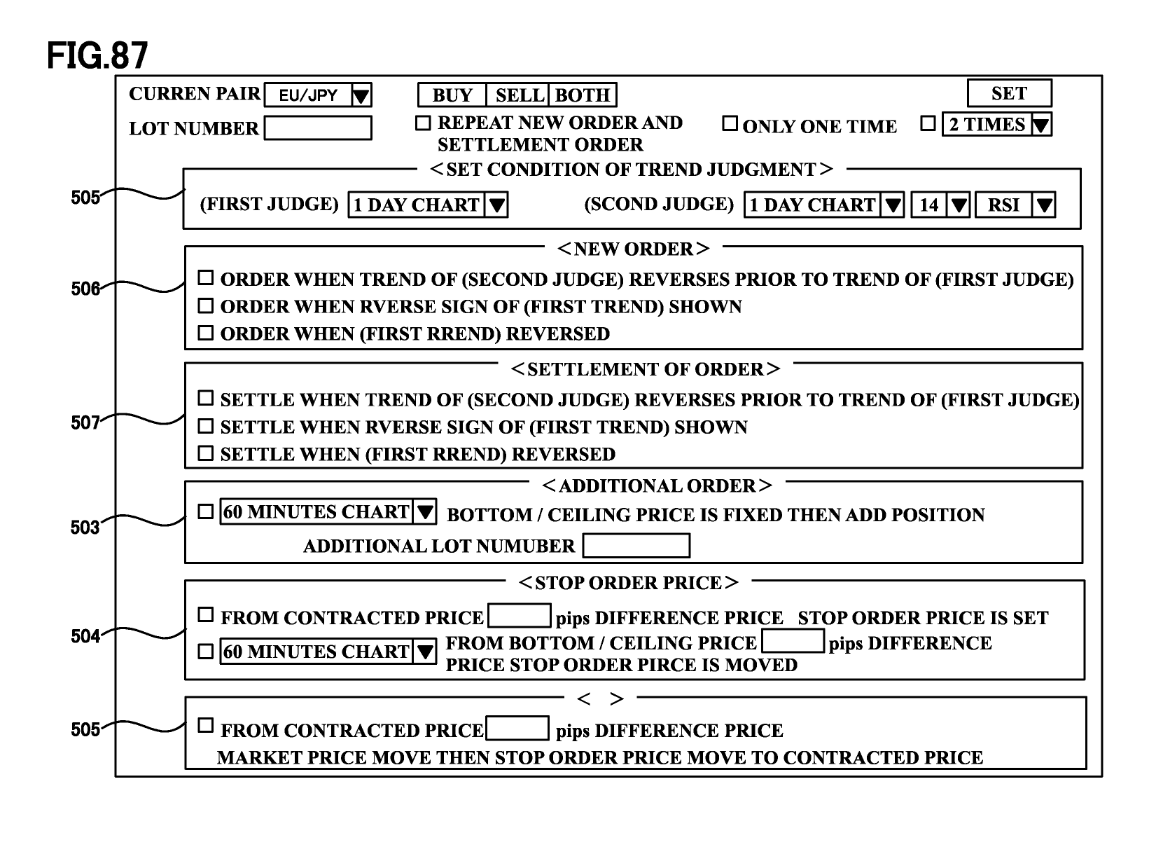

FIG. 87 is a drawing showing an example of the setting screen of terms and conditions in the order server (FIG. 47 and FIG. 64) relate to the seventh-tenth embodiments.

The example of the screen in FIG. 87, likewise FIG. 86, outputs the setting screen of terms and conditions relate to the foreign exchange margin transactions. The column 501 and the column 502 in the example of the screen in FIG. 86 are replaced to the column 505, the column 506, and the column 507 in the example of the screen in FIG. 87. The other elements in FIG. 87 are the same as the example of the screen in FIG. 86.

In the column 505 for other special order for setting of judgment condition of trend, list boxes are provided to judge of the first trend judging unit 103 (FIG. 47 and FIG. 64) and to set the timescale of the market price data used to generate the technical index data in the index data generating unit 104. In addition, the list boxes are provided to set types of technical index generated in the index data generating unit 104 and the parameter relates to the technical index (for instance, number of the market price data used to generate index).

The (506) for new orders has checkboxes to select the condition of three ways of new order.

When the column 506 of the checkbox on the top of is valid, the order outputting unit 106 outputs the buy-sell orders when conditions stated in the seventh embodiment are fulfilled. In other words, the order outputting unit 106 outputs the buy-sell order when the opposite direction of the result of judgment from the first trend judging unit 103 is obtained in the second trend judging unit (FIG. 52, FIG. 53).

Under the condition of the checkbox on the second of the column 506 is valid, the order outputting unit 106 outputs the buy-sell orders when the conditions stated in the eighth or tenth are fulfilled. In other words, the order outputting unit 106 outputs the buy-sell orders in case where after the result of judgment is obtained from the second trend judging unit 105 in the opposite direction of the first trend judging unit 103, the market price has fluctuated to the opposite direction to the result of first trend judging unit 103, or the market price has fluctuated to the opposite direction of first trend judging unit 103 and to the exceeded peak price and the exceeded valley floor price (FIG. 66 and FIG. 67).

Under the condition of the checkbox on the third of the column 506 is valid, the order outputting unit 106 outputs the buy-sell orders when the conditions stated in the ninth are fulfilled. In other words, the order outputting unit 106 outputs the buy-sell order when the result of judgment in the first trend judging unit 103 shifts to no trend state (FIG. 62, FIG. 63), after the opposite direction of the result of judgment from the first trend judging unit 103 is obtained in the second trend judging unit.

The (507) for settlement order has checkboxes to select the condition of three ways of settlement order same as the new order.

Under the condition of the checkbox on the top is valid, the order outputting unit 106 outputs settlement order when the conditions stated in the seventh embodiment are fulfilled.

Under the condition of the checkbox on the second is valid, the order outputting unit 106 outputs settlement order when the conditions stated in the eighth or tenth embodiment are fulfilled.

Under the conditions of the checkbox on the third is valid, the order outputting unit 106 outputs settlement order when the condition stated in the ninth embodiment are fulfilled.

It is to be understood that the invention is not limited to the foregoing embodiments, since the invention includes various ways.

In the aforementioned sixth embodiment, the buy-sell orders are output based on the result of the judgment of two trend judging unit (103A, 103B) judges each market trend based on the market price data with different time scale, however the present invention is not limited thereto. In the other embodiment of the present embodiment, the buy-sell orders may output based on the result of the judgment of more than three trend judging units judge each market trend based on the market price data with different time scale. In this case, the order unit may outputs buy order when the market price is judged as uptrend by all trend judging unit, and may outputs sell order when the market price is judged as downtrend by all trend judging unit.

For example, in case where one state in which some of the trend judging units output different judgment results changes to another state in which all of the trend judging units output same judgment results, the order outputting unit outputs the new buy-sell orders. In other words, in case where one state in which some of the trend judging units output the judgment results denying the uptrend of the market changes to another state in which all of the trend judging units output the judgment results affirming the uptrend of the market, the order outputting unit outputs new buy order. In case where one state in which some of the trend judging units output the judgment results denying the downtrend of the market changes to another state in which all of the trend judging units output the judgment results affirming the downtrend of the market, the order outputting unit outputs new sell order.

Moreover, for example, in case where one state in which all of the trend judging units output same judgment results changes to another state in which some of the trend judging units output different judgment results, the order outputting unit order to settle the contracted order (positions). In other words, in case where one state in which all of the trend judging units output the judgment results affirming the uptrend of the market changes to another state in which some of the trend judging units output the judgment results denying the uptrend of the market, the order outputting unit outputs new sell order to settle short position. In case where one state in which all of the trend judging units output the judgment results affirming the downtrend of the market changes to another state in which some of the trend judging units output the judgment results denying the downtrend of the market, the order outputting unit outputs new buy order to settle long position.

In the aforementioned embodiment, the example of indicating the appropriate timing of the order automatically based on the result of judgment of the trend, however the present invention is not limited thereto. In the other embodiment of the present embodiment, when user outputs order directly, the order may be judged automatically whether it is appropriate based on the result of judgment of the trend. When it is determined as inappropriate, confirmation of the content of the order to ask users may send.

For example, the reception unit 109 (FIG. 3) sends the notification asking confirmation of the order to the terminal apparatus 2, when the contents of order request data received from the terminal apparatus 2 does not fit to the result of judgment of the first trend judging unit 103A based on the market price data with comparative long time scale. In other words, the reception unit 109 (FIG. 3) sends the notification asking confirmation of the order to the terminal apparatus 2 when the buy order request data is sent from the terminal apparatus 2 of the user in case where the market price is judged as downtrend by the downtrend judging unit 123 (FIG. 35) of the first trend judging unit 103A, and when the sell order request data is sent from the terminal apparatus 2 of the user in case where the market price is judged as uptrend by the uptrend judging unit 123 (FIG. 35) of the first trend judging unit 103A. The notification displays messages such as [Would you like to place sell orders even in the situation of on uptrend?], [Would you like to place buy orders even in the situation of downtrend?] on the display screen of the terminal apparatus 2 to point out that the order is not adapted to the result of judgement of the second trend judging unit 103B. To call users attention, the voluntary pictures may shown on the display of the terminal apparatus 2, and sounds by the speaker or vibrations by the motor vibrations may generate. The reception unit 109 receives from the terminal apparatus 2 the response of acceptance or cancellation of the order against the notification.

The order information processing unit 108 generates the order information according to a request ad stores to the order information storage 107, when despite the notification of confirmation, response from terminal apparatus 2 requesting acceptance of the order is received in the reception unit 109. In contrast, when the response to request cancellation of the order is received, the order information processing unit 108 does not store the order information to the order information storage 107.

The order from the users (buying or selling) does not fit to the trend of market price judged based on the market price data with comparative long time scale, the wrong order of buying and selling by users can be effectively prevent by seeking confirmation of the order to users.

In addition, in this case, in another present embodiment, the result of judgment of the trend of the first trend judging unit 103 may be sent at any time to the terminal apparatus 2 from the reception unit 109. When order instruction does not fit to the result of judgment of the trend is entered in the terminal apparatus 2, the notification mentioned above may be shown on a display of the terminal apparatus 2 to evoke the user's attention.

In aforementioned the seventh-tenth embodiments, the RSI is cited as an example of technical index generated in the index data generating unit 104, however the present invention is not limited to thereto. For example, technical indexes such as stochastic oscillator, RCI (rank correlation index) and ROC (rate of change) may be used in the other embodiment of the present embodiment.

Furthermore, in aforementioned seventh embodiment to tenth embodiment, when the change point of technical index shifts in succession towards the direction indicates downtrend of the market price, the market price is judged that downtrend has begun (ST595: See FIG. 55), however the present invention is not limited thereto. In the other embodiment of the present embodiment, after one technical index of the change point is obtained in the first change point obtaining unit 150 (FIG. 48), when the technical index of another change point shift towards the direction indicates downtrend of the market than the technical index of one change point is obtained once or several times in succession, the first index judging unit 151 (FIG. 48) may judge that the downtrend on the market price has begun.

Furthermore, in aforementioned seventh embodiment to tenth embodiment, when the change point of technical index shifts in succession towards the direction indicates uptrend of the market price, the market price is judged that uptrend has begun (ST545: See FIG. 54), however the present invention is not limited thereto. In the other embodiment of the present embodiment, after one technical index of the change point is obtained in the second change point obtaining unit 152 (FIG. 48), when the technical index of another change point shift towards the direction indicates uptrend of the market than the technical index of one change point is obtained once or several times in succession, the second index judging unit 153 (FIG. 48) may judge that the uptrend on the market price has begun.

In addition, the aforementioned each embodiments cite examples of acquiring the bottom price and the ceiling price of the market price based on the highest price and the lowest price in data aggregate (the opening price, the closing price, the highest price and the lowest price) shown in FIG. 4, however this invention is not limited to thereto. The other embodiments in the present invention may obtain the bottom price and the ceiling price by referencing only the specific price (i.e. the closing price).

In addition, the aforementioned each embodiments cite examples of confirming user to execute the buy-sell orders, however order can be executed without asking confirmation to the user in the other embodiments of the present invention. Alternatively, user may be able to arbitrarily set whether or not asking for confirmation.

Moreover, the process of judging the market trend and generating order information in the embodiments presented herein, the present invention is not limited thereto. The part of the process executed in the order server 1 may be executed in the terminal apparatus 2 in the other embodiments of the present embodiment. In this case, for example, program responsible for a part of the process described above may be downloaded from the order server 1 to the terminal apparatus 2, and part of the process may be executed in the terminal apparatus 2.

Although, the embodiments of the present invention includes; embodiments replaced from a part of the elements included aforementioned each elements to other equivalent, embodiments combined a part of the aforementioned each elements, and embodiments that the order of processing is changed in aforementioned embodiment.

The following Additional claims A1 to A22 and B1 t B18 will be disclosed relating to each embodiment (especially first to fourth embodiment) of the present invention.

[Additional A1]

A market trade supporting apparatus supporting for determining a price of a stop order, comprising

a data obtaining unit obtaining market data indicating market price of a trade target changing every moment in a market one by one;

a bottom price obtaining unit obtaining a bottom price of the market in the temporary decline period during the market price updates a highest price;

a ceiling price obtaining unit obtaining a ceiling price of the market in the temporary rise period during the market price updates a lowest price; and

a calculating unit calculating a sell price of the stop order based on the obtained bottom price when the bottom price is obtained by the bottom price obtaining unit and calculating a buy price of the stop order based on the obtained ceiling price when the ceiling price is obtained by the ceiling price obtaining unit.

[Additional A2]

A market trade supporting apparatus as set forth in Additional claim A1, wherein

the bottom price obtaining unit comprises:

a highest price processing unit comparing the highest price of the market stored in advance and the latest market price indicated by the market price data and storing the latest market price as a latest highest price when the latest market price is higher than the stored highest price; and

a bottom price processing unit storing a first market price as a temporary bottom price when the highest price processing unit judges a first market price compared with a newly stored highest price is lower than the highest price newly stored, comparing a latest market price indicated by the market data obtained by the data obtaining unit and the temporary bottom price until a latest highest price is stored in the highest price processing unit next time, storing the latest market price as a temporary bottom prices when the latest market price is lower than the temporary bottom price, and obtaining the temporary bottom price as a fixed bottom price of the temporary decline period when judging that the market price changes from a state in which the market price is lower than the highest price to a state in which the market price is higher than the highest price based on a comparison result of the highest price processing unit,

the ceiling price obtaining unit comprises,

a lowest price processing unit comparing the lowest price of the market stored in advance and the latest market price indicated by the market price data, and storing the latest market price as a latest lowest price when the latest market price is lower than the stored lowest price; and

a ceiling price processing unit storing a first market price as a temporary ceiling price when the lowest price processing unit judges a first market price compared with a newly stored lowest price is higher than the lowest price newly stored, comparing a latest market price indicated by the market data obtained by the data obtaining unit and the temporary ceiling price until a latest lowest price is stored in the lowest price processing unit next time, storing the latest market price as a temporary ceiling prices when the latest market price is lower than the temporary ceiling price, and obtaining the temporary ceiling price as a fixed bottom price of the temporary decline period when judging that the market price changes from a state in which the market price is higher than the lowest price to a state in which the market price is lower than the lowest price based on a comparison result of the lowest price processing unit.

[Additional A3]

A market trade supporting apparatus as set forth in Additional claim A1, wherein

the bottom price obtaining unit comprises:

a highest price storage storing the highest price of the market,

a highest price comparing unit comparing the latest market price indicated by the market price data obtained by the data obtaining unit and the highest price of the highest price storage,

a highest price updating unit storing the latest market price as a latest highest price into the highest price storage when the highest price comparing unit judges that the latest market price is higher than the highest price of the highest price storage,

a bottom price storage storing a temporary bottom price,

a bottom price comparing unit comparing a latest market price indicated by the market price data obtained by the data obtaining unit and the temporary bottom price of the bottom price storage,

a bottom price updating unit storing the latest market price as the temporary bottom price into the bottom price storage when the highest price comparing unit judges that a first market price compared after updating the highest price by the highest price updating unit is lower the highest price, storing the latest market price as a latest temporary bottom price into the bottom price storage when the bottom price comparing unit judges that a latest market price indicated by the market price data obtained by the data obtaining unit is lower than the temporary bottom price of the bottom price storage until the highest price is updated by the bottom price updating unit next,

a fixed bottom price obtaining unit obtains the temporary bottom price stored in the bottom price storage as a fixed bottom price of the temporary decline period when judging that the market price has changed from a state in which the market price is lower than the highest price to a state in which the market price is higher than the highest price based on a comparison result of the highest price comparing unit,

the ceiling price obtaining unit comprises:

a lowest price storage storing the lowest price of the market,

a lowest price comparing unit comparing the latest market price indicated by the market price data obtained by the data obtaining unit and the lowest price of the lowest price storage,

a lowest price updating unit storing the latest market price as a latest lowest price into the lowest price storage when the lowest price comparing unit judges that the latest market price is lower than the lowest price of the lowest price storage,

a ceiling price storage storing a temporary ceiling price,

a ceiling price comparing unit comparing a latest market price indicated by the market price data obtained by the data obtaining unit and the temporary ceiling price of the ceiling price storage,

a ceiling price updating unit storing the latest market price as the temporary ceiling price into the ceiling price storage when the lowest price comparing unit judges that a first market price compared after updating the lowest price by the lowest price updating unit is higher the lowest price, storing the latest market price as a latest temporary ceiling price into the ceiling price storage when the ceiling price comparing unit judges that a latest market price indicated by the market price data obtained by the data obtaining unit is higher than the temporary ceiling price of the ceiling price storage until the lowest price is updated by the ceiling price updating unit next,

a fixed ceiling price obtaining unit obtains the temporary ceiling price stored in the ceiling price storage as a fixed ceiling price of the temporary decline period when judging that the market price has changed from a state in which the market price is higher than the lowest price to a state in which the market price is lower than the lowest price based on a comparison result of the lowest price comparing unit.

[Additional A4]

A market trade supporting apparatus as set forth in Additional claim A1, wherein

the data obtaining unit obtains the market price data indicating a high price and a low price in a predetermined time whenever the predetermined time passes,

the highest price comparing unit compares the high price of the latest market price indicated by the market price data obtained the data obtaining unit and the highest price of the highest price storage,

the highest price updating unit stores the high price of the latest market price as a new highest price when the highest price comparing unit judges that the high price of the latest market price is higher than the highest price of the highest price storage,

the bottom price comparing unit compares the low price of the latest market price indicated by the market price data obtained the data obtaining unit and the temporary bottom price of the bottom price storage,

the bottom price updating unit stores the low price of the latest market price as the temporary bottom price into the bottom price storage when the highest price comparing unit judges that a high price of a first market price compared after updating the highest price by the highest price updating unit is lower than the highest price of the highest price storage, storing the low price of the latest market price as a latest temporary bottom price into the bottom price storage when the bottom price comparing unit judges that a low price of the latest market price indicated by the market price data obtained by the data obtaining unit is lower than the temporary bottom price of the bottom price storage until the highest price is updated by the bottom price updating unit next,

the lowest price comparing unit compares the low price of the latest market price indicated by the market price data obtained the data obtaining unit and the lowest price of the lowest price storage,

the lowest price updating unit stores the low price of the latest market price as a new lowest price when the lowest price comparing unit judges that the low price of the latest market price is lower than the lowest price of the lowest price storage,

the ceiling price comparing unit compares the high price of the latest market price indicated by the market price data obtained the data obtaining unit and the temporary ceiling price of the ceiling price storage, and

the ceiling price updating unit stores the high price of the latest market price as the temporary ceiling price into the ceiling price storage when the lowest price comparing unit judges that a low price of a first market price compared after updating the lowest price by the lowest price updating unit is higher than the lowest price of the lowest price storage, storing the high price of the latest market price as a latest temporary ceiling price into the ceiling price storage when the ceiling price comparing unit judges that a high price of the latest market price indicated by the market price data obtained by the data obtaining unit is higher than the temporary ceiling price of the ceiling price storage until the lowest price is updated by the ceiling price updating unit next,

[Additional A5]

A market trade supporting apparatus as set forth in Additional claim A1, wherein

the bottom price obtaining unit calculates a width of the drop in a period of temporary decline and stops obtaining the bottom price of the period of temporary decline when the width of the drop calculated is smaller than a predetermined value, and

the ceiling price obtaining unit calculates a width of the rising in a period of temporary rising and stops obtaining the ceiling price of the period of temporary rising when the width of the rising calculated is smaller than a predetermined value.

[Additional A6]

A market trade supporting apparatus as set forth in claim Additional A2, wherein

the bottom price processing unit calculates a width of decline of the market price in the temporary decline period in accordance with a difference or a ratio between a highest of the market price before updating and the temporary bottom price when the highest of the market price stored in the highest price processing unit is updated, and stops obtaining the fixed bottom price in the temporary decline period when the width of decline calculated is smaller than a predetermined price, and

the ceiling price processing unit calculates a width of rise of the market price in the temporary rise period in accordance with a difference or a ratio between a lowest of the market price before updating and the temporary ceiling price when the lowest of the market price stored in the lowest price processing unit is updated, and stops obtaining the fixed ceiling price in the temporary rise period when the width of rise calculated is smaller than a predetermined price.

[Additional A7]

A market trade supporting apparatus as set forth in claim Additional A6, wherein

the fixed bottom price obtaining unit calculates a width of decline of the market price in the temporary decline period in accordance with a difference or a ratio between a highest of the market price before updating and the temporary bottom price of the bottom price storage when the highest of the market price stored in the highest price processing unit is updated, and stops obtaining the fixed bottom price in the temporary decline period when the width of drop calculated is smaller than a predetermined price, and

the fixed ceiling price obtaining unit calculates a width of rise of the market price in the temporary rise period in accordance with a difference or a ratio between a lowest of the market price before updating and the temporary ceiling price of the ceiling price storage when the lowest of the market price stored in the lowest price processing unit is updated, and stops obtaining the fixed ceiling price in the temporary rise period when the width of rise calculated is smaller than a predetermined price.

[Additional A8]

A market trade supporting apparatus as set forth in Additional claim A1, wherein

the calculating unit

calculates a width of the drop in a period of temporary decline and stops calculating the sell price of the stop order based on the bottom price of the temporary decline period for which the decline width is calculated or generating a signal indicating that a sell price of the of the stop order calculated based on the bottom price of the temporary decline period for which the width of the drop is calculated is invalid, and

calculates a width of the rise in a period of temporary rise and stops calculating the sell price of the stop order based on the ceiling price of the temporary rise period for which the rise width is calculated or generating a signal indicating that a sell price of the of the stop order calculated based on the ceiling price of the temporary rise period for which the width of the rise is calculated is invalid.

[Additional A9]

A market trade supporting apparatus as set forth in claim Additional A2, wherein

the calculating unit

calculates a width of decline of the market price in the temporary decline period in accordance with a difference or a ratio between a highest price of the market price before updating and the temporary bottom price when the highest price of the market price stored in the highest price processing unit is updated,

performs stop process for stopping calculation of the sell price of the stop order based on the bottom price in temporary decline period for which the width of the drop is calculated or generation process of a signal indicating the sell price of the stop order calculated based on the bottom price of the temporary decline period for which the width of the drop is calculated when the width of the drop calculated is smaller than a predetermined price, and

calculates a width of rise of the market price in the temporary rise period in accordance with a difference or a ratio between a lowest price of the market price before updating and the temporary ceiling price when the lowest price of the market price stored in the lowest price processing unit is updated,

performs stop process for stopping calculation of the sell price of the stop order based on the ceiling price in temporary rise period for which the width of the rise is calculated or generation process of a signal indicating the sell price of the stop order calculated based on the ceiling price of the temporary rise period for which the width of the rise is calculated when the width of the rise calculated is smaller than a predetermined price.

[Additional A10]

A market trade supporting apparatus as set forth in claim Additional A3, wherein

the calculating unit

calculates a width of decline of the market price in the temporary decline period in accordance with a difference or a ratio between a highest of the market price before updating and the temporary bottom price when the highest price of the market price is updated by the highest price updating unit,

performs stop process for stopping calculation of the sell price of the stop order based on the bottom price in temporary decline period for which the width of the drop is calculated or generation process of a signal indicating the sell price of the stop order calculated based on the bottom price of the temporary decline period for which the width of the drop is calculated when the width of the drop calculated is smaller than a predetermined price,

calculates a width of rise of the market price in the temporary rise period in accordance with a difference or a ratio between a lowest of the market price before updating and the temporary ceiling price when the lowest price of the market price is updated by the lowest price updating unit,

performs stop process for stopping calculation of the sell price of the stop order based on the ceiling price in temporary rise period for which the width of the rise is calculated or generation process of a signal indicating the sell price of the stop order calculated based on the ceiling price of the temporary rise period for which the width of the rise is calculated when the width of the rise calculated is smaller than a predetermined price.

[Additional A11]

A market trade supporting apparatus as set forth in Additional claim A1, wherein

the market price data includes a time information of the market,

the bottom price obtaining unit calculates time of the temporary decline period based on the time information and stop obtaining the bottom price in the temporary decline period when the calculated time is shorter than a predetermined time, and

the ceiling price obtaining unit calculates time of the temporary rise period based on the time information and stop obtaining the ceiling price in the temporary rise period when the calculated time is shorter than a predetermined time.

[Additional claim A12]

A market trade supporting apparatus as set forth in claim Additional A2, wherein

the market price data includes a time information of the market,

the highest price processing unit stores the time information of the market connecting to the highest price of the market price,

the lowest price processing unit stores the time information of the market connecting to the lowest price of the market price,

the bottom price processing unit calculates an elapsed time from the time of the highest of the market price before updating to the time of the highest price of the market price after updating based on the time information when the highest price of the market price stored in the highest price processing unit is updated, and stops obtaining the fixed bottom price in the temporary decline period when the elapsed time calculated is shorter than a predetermined time, and

the ceiling price processing unit calculates an elapsed time from the time of the lowest of the market price before updating to the time of the lowest price of the market price after updating based on the time information when the lowest price of the market price stored in the lowest price processing unit is updated, and stops obtaining the fixed ceiling price in the temporary rise period when the elapsed time calculated is shorter than a predetermined time.

[Additional A13]

A market trade supporting apparatus as set forth in claim Additional A3, wherein

the market price data includes a time information of the market,

the highest price storage stores the time information of the market connecting to the highest of the market price,

the lowest price storage stores the time information of the market connecting to the lowest of the market price,

the fixed bottom price obtaining unit calculates an elapsed time from the time of the highest price of the market price before updating to the time of the highest price of the market price after updating based on the time information when the highest price of the market price is updated by the highest price updating unit, and stops obtaining the fixed bottom price in the temporary decline period when the elapsed time calculated is shorter than a predetermined time, and

the fixed ceiling price obtaining unit calculates an elapsed time from the time of the lowest price of the market price before updating to the time of the lowest price of the market price after updating based on the time information when the lowest price of the market price is updated by the lowest price updating unit, and stops obtaining the fixed ceiling price in the temporary decline period when the elapsed time calculated is shorter than a predetermined time.

[Additional A14]

A market trade supporting apparatus as set forth in Additional claim A1, wherein

the market price data includes a time information of the market,

the calculating unit calculates a width of the drop in a period of temporary decline, stops calculating the sell price of the stop order based on the bottom price of the temporary decline period for which the decline width is calculated or generates signal indicating that a sell price of the of the stop order calculated based on the bottom price of the temporary decline period for which the width of the drop is calculated is invalid, and

the calculating unit calculates a width of the rise in a period of temporary rise, stops calculating the buy price of the stop order based on the ceiling price of the temporary rise period for which the rise width is calculated or generates signal indicating that a buy price of the of the stop order calculated based on the ceiling price of the temporary rise period for which the width of the rise is calculated is invalid.

[Additional A15]

A market trade supporting apparatus as set forth in claim Additional A2, wherein

the market price data includes a time information of the market,

the highest price processing unit stores the time information of the market connecting to the highest price of the market price,

the lowest price processing unit stores the time information of the market connecting to the lowest price of the market price,

the calculating unit

calculates an elapsed time from the time of the highest price of the market price before updating to the time of the highest price of the market price after updating based on the time information when the highest price of the market price stored in the highest price processing unit is updated,

performs stop process for stopping calculation of the sell price of the stop order based on the bottom price in temporary decline period for which the elapsed time is calculated or generation process of a signal indicating the sell price of the stop order calculated based on the bottom price of the temporary decline period for which the elapsed time is calculated when the elapsed time calculated is smaller than a predetermined time,

calculates an elapsed time from the time of the lowest price of the market price before updating to the time of the lowest price of the market price after updating based on the time information when the lowest price of the market price stored in the lowest price processing unit is updated,

performs stop process for stopping calculation of the buy price of the stop order based on the ceiling price in temporary rise period for which the elapsed time is calculated or generation process of a signal indicating the buy price of the stop order calculated based on the ceiling price of the temporary rise period for which the elapsed time is calculated when the elapsed time calculated is smaller than a predetermined time.

[Additional A16]

A market trade supporting apparatus as set forth in claim Additional A3, wherein

the market price data includes a time information of the market,

the highest price processing unit stores the time information of the market connecting to the highest price of the market price,

the lowest price processing unit stores the time information of the market connecting to the lowest price of the market price,

the calculating unit

calculates an elapsed time from the time of the highest price of the market price before updating to the time of the highest price of the market price after updating based on the time information when the highest price of the market price is updated by the highest price updating unit,

performs stop process for stopping calculation of the sell price of the stop order based on the bottom price in temporary decline period for which the elapsed time is calculated or generation process of a signal indicating the sell price of the stop order calculated based on the bottom price of the temporary decline period for which the elapsed time is calculated when the elapsed time calculated is smaller than a predetermined time,

calculates an elapsed time from the time of the lowest price of the market price before updating to the time of the lowest price of the market price after updating based on the time information when the lowest price of the market price is updated by the lowest price updating unit, and

performs stop process for stopping calculation of the buy price of the stop order based on the ceiling price in temporary rise period for which the elapsed time is calculated or generation process of a signal indicating the buy price of the stop order calculated based on the ceiling price of the temporary rise period for which the elapsed time is calculated when the elapsed time calculated is smaller than a predetermined time.

[Additional A17]

A market trade supporting apparatus as set forth in any one of additional claims A1 to A16 further comprising:

an order information storage storing information relating to the stop order for which a reception is established;

an ordering unit generating an order data for buy and sell of the stop order and transmitting the order data to a predetermined server for managing market trade when the latest market price reaches a price of the stop order which is indicated by information stored in the order information storage; and

an order information processing unit for updating a price of the stop order of information stored in the order information storage when a price of the stop order is calculated in the calculating unit.

[Additional A18]

A market trade supporting apparatus as set forth in additional claim A17 wherein

the order information processing unit

stops updating the sell price of the information stored in the order information storage with a sell price of the stop order calculated by the calculating unit when the calculated sell price is lower than the sell price of the information stored in the order information storage, and

stops updating the buy price of the information stored in the order information storage with a buy price of the stop order calculated by the calculating unit when the calculated buy price is higher than the buy price of the information stored in the order information storage.

[Additional A19]

A market trade supporting apparatus as set forth in additional claim A17 or A18 wherein

the order information storage stores information of sell contracted price and buy contracted price, and

further comprising a contracted price comparing unit comparing the latest market price indicated by the market price data obtained in the data obtaining unit and the sell contracted price and buy contracted price of the information stored in the order information storage,

the calculating unit

updates the sell price of the stop order with the same price with the buy contracted price or price which is higher than the buy contracted price and lower than the latest market price when the contracted price comparing unit judges that the latest market price is higher than the buy contracted price and the sell price of the stop order stored in the order information storage is lower than the buy contracted price, and

updates the buy price of the stop order with the same price with the sell contracted price or price which is lower than the sell contracted price and higher than the latest market price when the contracted price comparing unit judges that the latest market price is lower than the sell contracted price and the buy price of the stop order stored in the order information storage is higher than the sell contracted price.

[Additional A20]

A market trade supporting apparatus as set forth in additional A19, wherein

the contracted price comparing unit judges whether or not the latest market price increases by more than a predetermined width compared with buy contracted price and whether or not the latest market price decreases by more than a predetermined width compared with sell contracted price,

the calculating unit

updates the buy price of the stop order with the same price with the sell contracted price or price which is higher than the buy contracted price and lower than the latest market price when the contracted price comparing unit judges that the latest market price increases more than the buy contracted price and the sell price of the stop order stored in the order information storage is lower than the buy contracted price, and

updates the sell price of the stop order with the same price with the buy contracted price or price which is lower than the sell contracted price and higher than the latest market price when the contracted price comparing unit judges that the latest market price decreases more than the sell contracted price and the buy price of the stop order stored in the order information storage is higher than the sell contracted price.

[Additional A21]

A market trade supporting apparatus as set forth in any one of additional claims 17 to 20 wherein

the order information processing unit

generates a first order information indicating new buy order, updates sell price of the stop order which is fixed in the information stored in the order information storage by the calculated price and increases an amount of sell order of the stop order which is fixed in the information by an amount of the buy order of the first order information, and

generates a second order information indicating new sell order, updates buy price of the stop order which is fixed in the information stored in the order information storage by the calculated price and increases an amount of buy order of the stop order which is fixed in the information by an amount of the sell order of the first order information.

[Additional A22]

A market trade supporting apparatus as set forth in any one of additional claims A1 to A19, wherein

the calculating unit

calculates a price which is lower than a bottom price obtained by the bottom price obtaining unit by a predetermined price or a price which is lower than a bottom price obtained by the bottom price obtaining unit by a predetermined rate as the sell price of the stop order,

calculates a price which is higher than a ceiling price obtained by the ceiling price obtaining unit by a predetermined price or a price which is higher than a ceiling price obtained by the bottom price obtaining unit by a predetermined rate as the buy price of the stop order.

[Additional claim B1]

A market trade supporting method supporting for determining a price of a stop order, comprising:

obtaining market data indicating market price of a trade target changing every moment in a market one by one;

obtaining a bottom price of the market in the temporary decline period during the market price updates a highest price;

obtaining a ceiling price of the market in the temporary rise period during the market price updates a lowest price; and

calculating a sell price of the stop order based on the obtained bottom price when the bottom price is obtained; and calculating a buy price of the stop order based on the obtained ceiling price when the ceiling price is obtained.

[Additional claim B2]

A market trade supporting method as set forth in additional claim B1, wherein

the step of obtaining the bottom price comprises:

comparing the highest price of the market stored in advance and the latest market price indicated by the market price data;

storing the latest market price as a latest highest price when the latest market price is higher than the stored highest price;

storing a first market price as a temporary bottom price when the highest price processing unit judges a first market price compared with a newly stored highest price is lower than the highest price newly stored;

comparing a latest market price indicated by the market data obtained by the data obtaining unit and the temporary bottom price until a latest highest price is stored next time;

storing the latest market price as a temporary bottom prices when the latest market price is lower than the temporary bottom price; and

obtaining the temporary bottom price as a fixed bottom price of the temporary decline period when judging that the market price changes from a state in which the market price is lower than the highest price to a state in which the market price is higher than the highest price based on a comparison result of the comparing,

the step of obtaining the ceiling price comprises:

comparing the lowest price of the market stored in advance and the latest market price indicated by the market price data;

storing the latest market price as a latest lowest price when the latest market price is lower than the stored lowest price;

storing a first market price as a temporary ceiling price when the lowest price processing unit judges a first market price compared with a newly stored lowest price is higher than the lowest price newly stored;

comparing a latest market price indicated by the market data obtained by the data obtaining unit and the temporary ceiling price until a latest lowest price is stored next time;

storing the latest market price as a temporary ceiling prices when the latest market price is lower than the temporary ceiling price; and

obtaining the temporary ceiling price as a fixed bottom price of the temporary decline period when judging that the market price changes from a state in which the market price is higher than the lowest price to a state in which the market price is lower than the lowest price based on a comparison result of the comparing.

[Additional claim B3]

A market trade supporting method as set forth in additional claim B1, wherein

the step of obtaining the market price data one by one comprises a step obtaining the market price data indicating a high price and a low price in a predetermined time whenever the predetermined time passes,

the step of obtaining the bottom price comprises: comparing the high price of the highest price of the market stored in a storage of the computer in advance and the high price of a new market price indicated by the market price data obtained one by one;

storing the high price of the latest market price to the storage as a new highest price when judging the high price of the new market price is higher than a highest price stored in the storage in the step of comparing the highest price and the market price;

storing the low price of the latest market price to the storage as a temporary bottom price when judging the high price of a first market price compared with a highest price newly stored in the storage is lower than a highest price newly stored in the step of comparing the highest price and the market price;

comparing the low price of the latest market price indicated by the market price data obtained one by one and the temporary bottom price stored in the storage until next new highest price is stored in the storage in the step of storing the highest price to the storage;

storing the low price of the latest market price as a new temporary bottom price to the storage when judging the low price of the latest market price is lower than the temporary bottom price of the storage in the step of comparing the temporary bottom price and the market price;

judging whether or not the high price of the market price changes from the state in which the high price of the market price is lower than the highest price to the state in which the high price of the market price is higher than the highest price; and

obtaining the temporary bottom price stored in the storage as a fixed bottom price of the temporary decline period when it is judged that the high price of the market price changes from the state in which the high price of the market price is lower than the highest price to the state in which the high price of the market price is higher than the highest price in the step of judging the change of the market price,

the step of obtaining the ceiling price comprises:

comparing the low price of the lowest price of the market stored in a storage of the computer in advance and the low price of a new market price indicated by the market price data obtained one by one;

storing the low price of the latest market price to the storage as a new lowest price when judging the low price of the new market price is lower than a lowest price stored in the storage in the step of comparing the lowest price and the market price;

storing the high price of the latest market price to the storage as a temporary ceiling price when judging the low price of a first market price compared with a lowest price newly stored in the storage is higher than a lowest price newly stored in the step of comparing the lowest price and the market price;

comparing the high price of the latest market price indicated by the market price data obtained one by one and the temporary ceiling price stored in the storage until next new lowest price is stored in the storage in the step of storing the lowest price to the storage;

storing the high price of the latest market price as a new temporary ceiling price to the storage when judging the high price of the latest market price is higher than the temporary ceiling price of the storage in the step of comparing the temporary ceiling price and the market price;

judging whether or not the low price of the market price changes from the state in which the low price of the market price is higher than the lowest price to the state in which the low price of the market price is lower than the lowest price; and

obtaining the temporary ceiling price stored in the storage as a fixed ceiling price of the temporary rise period when it is judged that the low price of the market price changes from the state in which the low price of the market price is higher than the lowest price to the state in which the low price of the market price is lower than the lowest price in the step of judging the change of the market price.

[Additional claim B4]

A market trade supporting method as set forth in additional claim B1, wherein

the step of obtaining the bottom price, comprises:

calculating a width of the drop in a period of temporary decline; and

stopping obtaining the bottom price of the period of temporary decline when the width of the drop calculated is smaller than a predetermined value,

the step of obtaining the ceiling price, comprises:

calculating a width of the rising in a period of temporary rising; and

stopping obtaining the ceiling price of the period of temporary rising when the width of the rising calculated is smaller than a predetermined value.

[Additional B5]

A market trade supporting method as set forth in additional claims B2 or B3, wherein

the step of obtaining fixed bottom price comprises:

calculating a width of decline of the market price in the temporary decline period in accordance with a difference or a ratio between a highest of the market price before updating and the temporary bottom price when the highest of the market price stored is updated; and

stopping obtaining the fixed bottom price in the temporary decline period when the width of decline calculated is smaller than a predetermined price;

the step of obtaining fixed ceiling price comprises:

calculating a width of rise of the market price in the temporary rise period in accordance with a difference or a ratio between a lowest of the market price before updating and the temporary ceiling price when the lowest of the market price stored is updated; and

stopping obtaining the fixed ceiling price in the temporary rise period when the width of rise calculated is smaller than a predetermined price,

[Additional claim B6]

A market trade supporting method as set forth in additional claim B1, wherein

the step of calculating a sell price of the stop order comprises the steps of: calculating a width of the drop in a period of temporary decline based on the market price data; and

stopping calculating the sell price of the stop order based on the bottom price of the temporary decline period for which the decline width is calculated or generating a signal indicating that a sell price of the of the stop order calculated based on the bottom price of the temporary decline period for which the width of the drop is calculated is invalid when the decline width calculated is smaller than a predetermined price,

the step of calculating a buy price of the stop order comprises:

calculating a width of the rise in a period of temporary rise and stops calculating the sell price of the stop order based on the ceiling price of the temporary rise period for which the rise width is calculated; and

generating a signal indicating that a sell price of the of the stop order calculated based on the ceiling price of the temporary rise period for which the width of the rise is calculated is invalid when the rise width calculated is smaller than a predetermined price.

[Additional claim B7]

A market trade supporting method as set forth in additional claims B2 or B3, wherein

the step of calculating a sell price of the stop order comprises:

calculating a width of the drop in a period of temporary decline based on a difference or a ratio between a highest price before updating and the temporary bottom price stored in the storage when the highest price is updated in the step of storing a new highest price in the storage; and

stopping calculating the sell price of the stop order based on the bottom price of the temporary decline period for which the decline width is calculated or generating a signal indicating that a sell price of the of the stop order calculated based on the bottom price of the temporary decline period for which the width of the drop is calculated is invalid when the decline width calculated is smaller than a predetermined price,

the step of calculating a buy price of the stop order comprises:

calculating a width of the rise in a period of temporary rise based on a difference or a ratio between a lowest price before updating and the temporary ceiling price stored in the storage when the lowest price is updated in the step of storing a new lowest price in the storage; and

stopping calculating the buy price of the stop order based on the ceiling price of the temporary rise period for which the rise width is calculated or generating a signal indicating that a buy price of the of the stop order calculated based on the ceiling price of the temporary rise period for which the width of the rise is calculated is invalid when the rise width calculated is smaller than a predetermined price.

[Additional claim B8]

A market trade supporting method as set forth in additional claim B1 wherein

the market price data includes a time information of the market,

the step of obtaining the bottom price comprises the steps of: calculating time of the temporary decline period based on the time information; and

stopping obtaining the bottom price in the temporary decline period when the calculated time is shorter than a predetermined time,

the step of obtaining the ceiling price comprises the steps of:

calculating time of the temporary rise period based on the time information; and

stopping obtaining the ceiling price in the temporary rise period when the calculated time is shorter than a predetermined time.

[Additional claim B9]

A market trade supporting method as set forth in additional claims B2 or B3, wherein

the market price data includes a time information of the market,

the step of storing the highest price to the storage comprises storing the time information of the market connecting to the highest price of the market price, and

the step of storing the highest price to the storage comprises storing the time information of the market connecting to the lowest price of the market price,

the step of obtaining the fixed bottom price comprises:

calculating an elapsed time from the time of the highest of the market price before updating to the time of the highest price of the market price after updating based on the time information when the highest price of the market price stored is updated; and

stopping obtaining the fixed bottom price in the temporary decline period when the elapsed time calculated is shorter than a predetermined time,

the step of obtaining the fixed ceiling price comprises:

calculating an elapsed time from the time of the lowest of the market price before updating to the time of the lowest price of the market price after updating based on the time information when the lowest price of the market price stored is updated; and

stopping obtaining the fixed ceiling price in the temporary rise period when the elapsed time calculated is shorter than a predetermined time.

[Additional B10]

A market trade supporting method as set forth in additional claim B1, wherein

the market price data includes a time information of the market,

the step of calculating sell price of the stop order comprises:

calculating time of the temporary decline period based on the time information: and

stopping calculating the sell order based on the bottom price of the temporary decline period obtained in the step of obtaining the bottom price or generating a signal indicating the sell price calculated based on the bottom price of the temporary decline period is invalid,

the step of calculating buy price of the stop order comprises:

calculating time of the temporary rise period based on the time information: and

stopping calculating the buy order based on the ceiling price of the temporary rise period obtained in the step of obtaining the ceiling price or generating a signal indicating the buy price calculated based on the ceiling price of the temporary rise period is invalid.

[Additional claim B11]

A market trade supporting method as set forth in additional claims B2 or B3, wherein

the market price data includes a time information of the market,

the step of storing the highest price to the storage comprises storing the time information of the market connecting to the highest price of the market price,

the step of storing the highest price to the storage comprises storing the time information of the market connecting to the lowest price of the market price,

the step of calculating the sell price of the stop order comprises:

calculating an elapsed time from the time of the highest of the market price before updating to the time of the highest price of the market price after updating based on the time information when the highest price of the market price stored is updated; and

stopping calculating the sell price based on the fixed bottom price of the temporary decline period obtained in the step of obtaining the fixed bottom price or generating a signal indicating the sell price calculated based on the fixed bottom price of the temporary decline period is invalid,

the step of calculating the buy price of the stop order comprises:

calculating an elapsed time from the time of the lowest of the market price before updating to the time of the lowest price of the market price after updating based on the time information when the lowest price of the market price stored is updated; and

stopping calculating the buy price based on the fixed ceiling price of the temporary rise period obtained in the step of obtaining the fixed ceiling price or generating a signal indicating the buy price calculated based on the fixed ceiling price of the temporary rise period is invalid.

[Additional claim B12]

A market trade supporting method as set forth in additional claims B1 to B11 wherein

the storage of the computer stores information of a stop order for which a reception is established,

further comprising:

changing the sell price of the fixed stop order in the information stored in the storage with the calculated sell price when the sell price is calculated in the step of calculating the sell price of the stop order;

changing the buy price of the fixed stop order in the information stored in the storage with the calculated buy price when the buy price is calculated in the step of calculating the buy price of the stop order;

generating a sell order data when the latest market price indicated by the market price data is lower than the sell price of the stop order indicated by the information stored in the storage; and

generating a buy order data when the latest market price indicated by the market price data is higher than the buy price of the stop order indicated by the information stored in the storage.

[Additional claim B13]

A market trade supporting method as set forth in additional claim B12 wherein

the step of changing the sell price of the stop order comprises stopping the changing from the sell price of the stored information to the calculated sell price when the sell order price calculated in the step of calculating the sell price of the stop order is lower than the sell price of the stored information of the storage, and

the step of changing the sell price of the stop order comprises stopping the changing from the buy price of the stored information to the calculated buy price when the buy order price calculated in the step of calculating the buy price of the stop order is higher than the buy price of the stored information of the storage.

[Additional claim B14]

A market trade supporting method as set forth in additional claims B12 or B13 wherein

the storage of the computer stored information of sell contracted price and buy contracted price,

further comprising comparing the latest market price indicated by the market price data obtained one by one and the sell contracted price and buy contracted price of the information stored in the storage,

the step of calculating the sell price of the stop order comprises changing the sell price of the stop order to the same price with the buy contracted price or price which is higher than the buy contracted price and lower than the latest market price when judging the latest market price is higher than the buy contracted price and the sell price of the stop order stored in the storage is lower than the buy contracted price, and

the step of calculating the buy price of the stop order comprises changing the buy price of the stop order to the same price with the sell contracted price or price which is lower than the sell contracted price and higher than the latest market price when judging the latest market price is lower than the sell contracted price and the buy price of the stop order stored in the storage is higher than the sell contracted price.

[Additional claim B15]

A market trade supporting method as set forth in additional claim B14 wherein

the step of comparing the buy contracted price and the market price comprises judging whether or not the latest market price increases by more than a predetermined price width compared with the buy contracted price,

the step of comparing the sell contracted price and the market price comprises judging whether or not the latest market price decreases by more than a predetermined price width compared with the sell contracted price,

the step of calculating the sell price of the stop order comprises changing the sell price of the stop order to the same price with the buy contracted price or price which is higher than the buy contracted price and lower than the latest market price when judging the latest market price increases by a predetermined width compared with the buy contracted price and the sell price of the stop order stored in the storage is lower than the buy contracted price, and

the step of calculating the buy price of the stop order comprises changing the buy price of the stop order to the same price with the sell contracted price or price which is lower than the sell contracted price and higher than the latest market price when judging the latest market price decreases by a predetermined width compared with the sell contracted price and the buy price of the stop order stored in the storage is higher than the sell contracted price.

[Additional claim B16]

A market trade supporting method as set forth in additional claims B12 to B15 wherein

when the sell price of the stop order is calculated in the step of calculating the sell price of the stop order,

the step of changing the sell price of the stop order comprises:

generating a first order information indicating new buy order;

updating the sell price of the stop order which is fixed in the information stored in the storage to the calculated sell price; and

increasing amount of sell of the fixed stop order of the stored information by amount of buy of the first order information,

when the buy price of the stop order is calculated in the step of calculating the buy price of the stop order,

the step of changing the buy price of the stop order comprises:

generating a second order information indicating new sell order;

updating the buy price of the stop order which is fixed in the information stored in the storage to the calculated buy price; and

increasing amount of buy of the fixed stop order of the stored information by amount of sell of the second order information.

[Additional claim B17]

A market trade supporting method as set forth in additional claims B1 to B16 wherein

the step of calculating the sell price of the stop order comprises calculating the price which is lower than the obtained bottom price by a predetermined price or the price which is lower than the obtained bottom price by a predetermined rate as sell price of the stop order, and

the step of calculating the buy price of the stop order comprises calculating the price which is higher than the obtained ceiling price by a predetermined price or the price which is higher than the obtained ceiling price by a predetermined rate as buy price of the stop order.

[Additional claim B18]

A program for supporting decision of the price of stop order comprises description of the processing executed by a computer,

wherein the processing comprise a step which is described in any one of additional claims B1 to B17.

The following Additional claims C1 to C18 and D1 to D17 will be disclosed relating to each embodiment (especially sixth embodiment) of the present invention.

[Additional claim C1]

A market trade supporting apparatus comprising:

a ceiling price obtaining unit obtaining a plurality of market price data which is market information of trading target which changes every moment in a market and includes information having different time scale one by one;

a plurality of trend judging units which correspond to a plurality of the market price data one to one and judge whether the market price is uptrend or downtrend based on the market price data for which the market price are corresponded; and

a order unit outputting a buy order when the market price is uptrend in all of the trend judging units and outputting a sell order when the market price is downtrend in all of the trend judging units.

[Additional claim C2]

A market trade supporting apparatus as set forth in additional claim C1 wherein

the order unit outputs a new buy order when a state has changed from a state

in which at least one of the trend judging unit judges the market price is not uptrend to a state in which all of the trend judging units judges the market price is uptrend, and outputs a new sell order when a state has changed from a state in which at least one of the trend judging unit judges the market price is not downtrend to a state in which all of the trend judging units judges the market price is downtrend.

[Additional claim C3]

A market trade supporting apparatus as set forth in additional claim C2 wherein

the order unit outputs a new buy order for settling a short position when a state has changed from a state in which all of the trend judging units judges the market price is uptrend to a state in which at least one of the trend judging unit judges the market price is not uptrend, and

outputs a new sell order for settling a long position when a state has changed from a state in which all of the trend judging units judges the market price is downtrend to a state in which at least one of the trend judging unit judges the market price is not downtrend.

[Additional claim C4]

A market trade supporting apparatus as set forth in additional claim C2 or C3 wherein

the trend judging unit comprises:

the bottom price obtaining unit obtaining the bottom price in the temporary decline period in which a highest of the market price is updated based on the market price corresponded;

a uptrend judging unit judging the market price is uptrend when the bottom price obtained by the bottom price obtaining unit increases one time or a plurality of times in succession, and judging the uptrend of the market price ends when the latest market price indicated by the market price data falls than the latest bottom price obtained by the bottom price obtaining unit after judging the market price is uptrend;

a ceiling price obtaining unit obtaining a ceiling price in the temporary rise period in which a lowest of the market price is updated based on the market price corresponded;

a downtrend judging unit judging the market price is downtrend when the ceiling price obtained by the bottom price obtaining unit falls one time or a plurality of times in succession, and judging the downtrend of the market price ends when the latest market price indicated by the market price data rises than the latest ceiling price obtained by the bottom price obtaining unit after judging the market price is downtrend.

[Additional claim C5]

A market trade supporting apparatus as set forth in additional claim C2 wherein

the bottom price obtaining unit obtains the following bottom price while using the latest market price indicated by the market price data obtained by the data obtaining unit at the timing the downtrend judging unit judges the downtrend of the market price ends as the highest price of the market price, and

the ceiling price obtaining unit obtains the following ceiling price while using the latest market price indicated by the market price data obtained by the data obtaining unit at the timing the uptrend judging unit judges the uptrend of the market price ends as the lowest price of the market price.

[Additional claim C6]

A market trade supporting apparatus as set forth in additional claims C4 or C5 wherein

the bottom price obtaining unit includes the highest price processing unit and the bottom price processing unit described in the [Additional claim 2] respectively,

the uptrend judging unit compares a latest fixed bottom price and the last fixed bottom price whenever the fixed bottom price is obtained in the bottom price processing unit, judges the market price is uptrend when the result of comparison in which the latest fixed bottom price is higher than the last fixed bottom price is obtained one time or a plurality of times in succession, and judges the uptrend of the market price ends when a result of the comparison in which the latest market price indicated by the market price data is lower than the latest fixed bottom price after judging the market price is uptrend,

the ceiling price obtaining unit includes the lowest price processing unit and the ceiling price processing unit described in additional claim 2 respectively,

the downtrend judging unit compares a latest fixed ceiling price and the last fixed ceiling price whenever the fixed ceiling price is obtained in the ceiling price processing unit, judges the market price is downtrend when the result of comparison in which the latest fixed ceiling price is lower than the last fixed ceiling price is obtained one time or a plurality of times in succession, and judges the uptrend of the market price ends when a result of the comparison in which the latest market price indicated by the market price data is higher than the latest fixed ceiling price after judging the market price is downtrend.

[Additional claim C7]

A market trade supporting apparatus as set forth in additional claims C4 or C5 wherein

the bottom price obtaining unit comprises the highest price storage, the highest price comparing unit, the highest price updating unit, the bottom price storage, the bottom price comparing unit, the bottom price updating unit and the fixed bottom price obtaining unit described in additional claim A3,

the uptrend judging unit compares a latest fixed bottom price and the last fixed bottom price whenever the fixed bottom price is obtained in the fixed bottom price processing unit, judges the market price is uptrend when the result of comparison in which the latest fixed bottom price is higher than the last fixed bottom price is obtained one time or a plurality of times in succession, and judges the uptrend of the market price ends when a result of the comparison in which the latest market price indicated by the market price data is lower than the latest fixed bottom price after judging the market price is uptrend,

the ceiling price obtaining unit comprises the lowest price storage, the lowest price comparing unit, the lowest price updating unit, the ceiling price storage, the ceiling price comparing unit, the ceiling price updating unit and the fixed ceiling price obtaining unit described in additional claim A3, and

the downtrend judging unit compares a latest fixed ceiling price and the last fixed ceiling price whenever the fixed ceiling price is obtained in the fixed ceiling price processing unit, judges the market price is downtrend when the result of comparison in which the latest fixed ceiling price is lower than the last fixed ceiling price is obtained one time or a plurality of times in succession, and judges the uptrend of the market price ends when a result of the comparison in which the latest market price indicated by the market price data is higher than the latest fixed ceiling price after judging the market price is downtrend.

[Additional claim C8]

A market trade supporting apparatus as set forth in additional claim C7 wherein

the highest price updating unit stores the latest market price indicated by the market price data obtained by the data obtaining unit at the timing when the downtrend judging unit judges the downtrend ends as a new highest of the market price to the highest price storage, and

the lowest price updating unit stores the latest market price indicated by the market price data obtained by the data obtaining unit at the timing when the uptrend judging unit judges the uptrend ends as a new lowest of the market price to the lowest price storage.

[Additional claim C9]

A market trade supporting apparatus as set forth in additional claim C7 or C8 wherein

the data obtaining unit obtains the plurality of market price data including information of high and low price in a predetermined time which is different in accordance with the time scale whenever the predetermined time passes, and the highest price comparing unit, the highest price updating unit, the bottom price comparing unit, the bottom price updating unit, the lowest price comparing unit, the lowest price updating unit, the ceiling price comparing unit and the ceiling price updating unit perform the processing described in the additional claim A4.

[Additional claim C10]

A market trade supporting apparatus as set forth in additional claims C4 or C9 wherein

the bottom price obtaining unit and the ceiling price obtaining unit perform the processing described in additional claim A5.

[Additional claim C11]

A market trade supporting apparatus as set forth in additional claims C4 or C9 wherein

the bottom price processing unit and the ceiling price processing unit performs the processing described in additional claim A6.

[Additional claim C12]

A market trade supporting apparatus as set forth in additional claims C7 to C9 wherein

the fixed bottom price obtainer and the fixed ceiling price obtainer performs the processing described in additional claim A7.

[Additional claim C13]

A market trade supporting apparatus as set forth in additional claims C4 to C12 wherein

the market price data includes time information of the market price,

the bottom price obtaining unit and the ceiling price obtaining unit perform the processing described in additional claim A11.

[Additional C14]

A market trade supporting apparatus as set forth in additional claim C6 and C11, wherein

the market price data includes a time information of the market,

the highest price processing unit stores the time information of the market connecting to the highest of the market price,

the lowest price processing unit stores the time information of the market connecting to the lowest of the market price, and

the bottom price processing unit and the ceiling price processing unit perform processing described in the [Additional claim A12].

[Additional C15]

A market trade supporting apparatus as set forth in additional claims C7 to C9, and C12, wherein

the market price data includes a time information of the market,

the highest price storage stores the time information of the market connecting to the highest of the market price,

the lowest price storage stores the time information of the market connecting to the lowest of the market price, and
the fixed bottom price obtainer and the fixed ceiling price obtainer perform processing described in additional claim A13.

[Additional C16]

A market trade supporting apparatus as set forth in additional claims C4 to C15 comprising:

an order information storage storing an order information relating to buy and sell order which are already accepted;

an order information processing unit for generating the order information indicating a new buy order and/or the order information indicating a buy order for settling a long position indicated by the order information stored in the order information storage when the order unit outputs buy order, generating the order information indicating a new sell order and/or the order information indicating a sell order for settling a short position indicated by the order information stored in the order information storage when the order unit outputs sell order and storing the order information generated in the order information storage;

an order information processing units storing the order information generated in the order information storage; and

an order unit for generating an order data for sell and buy based on the order information stored in the order information storage and transmitting the order data generated to a predetermined server managing sell and buy in market.

[Additional C17]

A market trade supporting apparatus as set forth in additional claims C16 further comprising

a reception unit transmitting a notice relating to contents of order indicated by the order information generated to a terminal apparatus of origin of the order and receiving response indicating permission or not permission of the order relating to the notice from the terminal apparatus of origin of the order, and

the order information processing unit stores the order information generated to the order information storage when the reception unit receives the response indicating the order relating the order information generated is permitted.

[Additional C18]

A market trade supporting apparatus as set forth in additional claims C16 or C17 further comprising a reception unit transmitting a notice for conforming the contents of the order to the terminal apparatus of the origin of the order and receiving response demanding reception or cancellation of the order with respect to the notice when receiving a command data of buy order from a terminal apparatus of the order person at the period the market price is judged as downtrend by the downtrend judging unit corresponding to the market data of which the time scale is longest or when receiving a command data of sell order from a terminal apparatus of the order person at the period the market price is judged as uptrend by the uptrend judging unit corresponding to the market data of which the time scale is longest, and

the order information processing unit generating the order information according to the command data from the terminal apparatus of the order person when the reception unit receives the response demanding reception of the order from the terminal apparatus.

[Additional C19]

A market trade supporting apparatus as set forth in additional claims C16 to C18 further comprising:

a calculating unit calculating sell price of the stop order based on the bottom price obtained when the bottom price is obtained in the bottom price obtaining unit of the trend judging unit which the time scale thereof is shortest and calculating buy price of the stop order based on the bottom price obtained when the ceiling price is obtained in the ceiling price obtaining unit of the trend judging unit which the time scale thereof is shortest,

the order information storage stores information relating the stop order which reception thereof is fixed,

the order information processing unit updates the sell price of the fixed stop order in information stored in the order information storage with the calculated price when the sell price of the stop order is calculated by the calculating unit and updates the buy price of the fixed stop order in information stored in the order information storage with the calculated price when the buy price of the stop order is calculated by the calculating unit, and

the order unit generates an order data for sell or buy using the stop order and transmits the order data to a predetermined server when the latest market price reaches to price of the stop order indicated by information stored in the order information storage.

[Additional claim D1] A market trade supporting method comprising:

obtaining one by one a plurality of market price data including market information which are market information of a trading target changing every moment in a market and have different time scale;

judging trend of the market price in a plurality of time scales indicated by the plurality of market data are uptrend or downtrend based on the plurality of market price;

outputting a buy order when it is judged the market price of all of the time scale are uptrend in step of the judging trend of the market price; and

outputting a sell order when it is judged the market price of all of the time scale are downtrend in step of the judging trend of the market price,

wherein the each step is executed by a processing circuit of a computer.

[Additional claim D2]

A market trade supporting method as set forth in additional claim D1 wherein

the step of outputting the sell order includes outputting a new buy order when a state changes from a state in which the market price of at least one of the time scale is judged as not uptrend in the step of judging trend of the market price to a state in which the market price of all of the time scales are judged as uptrend, and

the step of outputting the buy order includes outputting a new sell order when a state changes from a state in which the market price of at least one of the time scale is judged as not downtrend in the step of judging trend of the market price to a state in which the market price of all of the time scales are judged as downtrend.

[Additional claim D3]

A market trade supporting method as set forth in additional claim D1 further comprising:

outputting a new sell order for settling a short position when a state changes from a state in which the market price of all of the time scales are judged as uptrend in the step of judging trend of the market price to a state in which the market price of at least one of the time scale is judged as not uptrend, and

outputting a new sell order for settling a long position when a state changes from a state in which the market price of all of the time scales are judged as downtrend in the step of judging trend of the market price to a state in which the market price of at least one of the time scale is judged as not downtrend.

[Additional claim D4]

A market trade supporting method as set forth in additional claims D1 to D3 wherein

the step of the judging trend of the market price based on the market price data of one of the time scale comprising:

obtaining the bottom price of the market in the temporary decline period in which a highest of the market price is updated based on the market price of the one time scale;

judging the market price is uptrend when the bottom price obtained by the step of the obtaining the bottom price increase one time or a plurality of times in succession;

judging the uptrend of the market price ends when the latest market price indicated by the market price data falls than the latest bottom price obtained in the step of the obtaining the bottom price after judging the market price is uptrend in the step of judging the uptrend of the market price;

obtaining the ceiling price of the market in the temporary rise period in which a lowest of the market price is updated based on the market price of the one time scale;

judging the market price is downtrend when the ceiling price obtained by the step of the obtaining the ceiling price decrease one time or a plurality of times in succession; and

judging the downtrend of the market price ends when the latest market price indicated by the market price data rises than the latest ceiling price obtained in the step of the obtaining the ceiling price after judging the market price is downtrend in the step of judging the downtrend of the market price.

[Additional claim D5]

A market trade supporting method as set forth in additional claims D4 wherein

the step of obtaining the bottom price includes obtaining the following bottom price while using the latest market price indicated by the market price data obtained at the timing when it is judged that the downtrend of the market price ends in the step of judging the end of the downtrend of the market price as the lowest price of the market price, and

the step of obtaining the ceiling price includes obtaining the following ceiling price while using the latest market price indicated by the market price data obtained at the timing when it is judged that the uptrend of the market price ends in the step of judging the end of the uptrend of the market price as the lowest price of the market price.

[Additional claim D6]

A market trade supporting method as set forth in additional claims D4 or D5 wherein

the step of obtaining the bottom price includes the same step of the obtaining the bottom price described in additional claim B2, and

the step of obtaining the ceiling price includes the same step of the obtaining the ceiling price described in additional claim B2.

[Additional claim D7]

A market trade supporting method as set forth in additional claims D4 or D5 wherein

the step of obtaining the market price data one by one includes a step of obtaining the plurality of market price data indicating a high price and a low price in a predetermined time which are different based on the time scale whenever the predetermined time passes,

the step of obtaining the bottom price includes the same step with the step of obtaining the bottom price described in additional claim B3, and

the step of obtaining the ceiling price includes the same step with the step of obtaining the ceiling price described in additional claim B3.

[Additional claim D8]

A market trade supporting method as set forth in additional claims D6 or D7 wherein

the step of storing a new highest price to the storage in the step of obtaining the bottom price includes storing the latest market price indicated by the market price data obtained at the timing when it is judged that a downtrend of the market price ends in the step of judging the end of the downtrend of the market price into the storage,

the step of storing a new lowest price to the storage in the step of obtaining the ceiling price includes storing the latest market price indicated by the market price data obtained at the timing when it is judged that a uptrend of the market price ends in the step of judging the end of the uptrend of the market price into the storage.

[Additional claim D9]

A market trade supporting method as set forth in additional claims D4 to D8 wherein

the step of obtaining the bottom price includes the same step with the step of obtaining the bottom price described in additional claim B4, and

the step of obtaining the ceiling price includes the same step with the step of obtaining the ceiling price described in additional claim B4.

[Additional claim D10]

A market trade supporting method as set forth in additional claims D6 to D8 wherein

the step of obtaining the fixed bottom price includes the same step with the step of obtaining the fixed bottom price described in additional claim B5, and

the step of obtaining the fixed ceiling price includes the same step with the step of obtaining the fixed ceiling price described in additional claim B5.

[Additional claim D11]

A market trade supporting method as set forth in additional claims D4 to D10 wherein

the market price data includes time information of the market price,

the step of obtaining the bottom price includes the same step with the step of obtaining the bottom price described in additional claim B8, and

the step of obtaining the ceiling price includes the same step with the step of obtaining the ceiling price described in additional claim B8.

[Additional A12]

A market trade supporting method as set forth in additional claims D6 to D8,

wherein

the market price data includes a time information of the market,

the step of storing the highest price into the storage includes storing the time information into the storage connecting to the highest of the market price, and

the step of storing the lowest price into the storage includes storing the time information into the storage connecting to the lowest of the market price,

the step of obtaining the fixed bottom price includes the same step with the step of obtaining the fixed bottom price described in additional claim B9, and

the step of obtaining the fixed ceiling price includes the same step with the step of obtaining the fixed ceiling price described in additional claim B9.

[Additional D13]

A market trade supporting method as set forth in additional claims D4 to D12

wherein

the storage of the computer stores an order information relating to buy and sell order which is already received,

further comprising:

generating the order information indicating a new buy order and/or the order information indicating a buy order for settling a long position indicated by the order information stored in the storage when the buy order is output in the step of outputting the buy order;

generating the order information indicating a new sell order and/or the order information indicating a sell order for settling a short position indicated by the order information stored in the storage when the sell order is output in the step of outputting the sell order;

storing the order information generated;

generating an order data for sell and buy based on the order information stored in the storage; and

transmitting the order data generated to a predetermined server managing trading of market.

[Additional D14]

A market trade supporting method as set forth in additional claims D13 further comprising:

transmitting a notice relating to contents of order indicated by the order information generated to a terminal apparatus of origin of the order, and

receiving response indicating permission or not permission of the order relating to the notice from the terminal apparatus of origin of the order,

the step of storing the order information to the storage includes a step of storing the order information generated to the storage when receiving the response indicating the order relating the order information generated is permitted.

[Additional D15]

A market trade supporting method as set forth in additional claims C13 or C14 further comprising:

transmitting a notice for conforming the contents of the order to the terminal apparatus of the origin of the order when receiving a command data of buy order from the terminal apparatus of the order person in the period in which the market price is judged as downtrend in the step of judging the downtrend of the market based on the market price data of which the time scale is longest or when receiving a command data of sell order from the terminal apparatus of the order person in the period in which the market price is judged as uptrend in the step of judging the uptrend of the market based on the market price data of which the time scale is longest, and

receiving response demanding reception or cancellation of the order with respect to the notice,

the step of generating the order information generates the order information according to the command data from the terminal apparatus of the order person when receiving the response demanding the reception of the order in the step of receiving the response from the terminal apparatus.

[Additional D16]

A market trade supporting method as set forth in additional claims D4 to D15 wherein

the storage of the computer stores information relating the stop order which reception thereof is fixed,

further comprising:

calculating sell price of the stop order based on the bottom price obtained when the bottom price is obtained in the step of obtaining the bottom price based on the market data which the time scale thereof is shortest;

calculating buy price of the stop order based on the ceiling price obtained when the ceiling price is obtained in the step of obtaining the ceiling price based on the market data which the time scale thereof is shortest;

updating the sell price of the fixed stop order in the information stored in the storage with the sell price calculated when the sell price is calculated in the step of calculating the sell price of the stop order;

updating the buy price of the fixed stop order in the information stored in the storage with the buy price calculated when the buy price is calculated in the step of calculating the buy price of the stop order;

generating the sell order when the latest market price indicated by the market price is lower than the sell price of the stop order indicated by the information stored in the storage;

generating the buy order when the latest market price indicated by the market price is higher than the buy price of the stop order indicated by the information stored in the storage; and

transmitting the order data generated to a predetermined server managing trading of market.

[Additional claim D17]

A program for supporting market trading comprises description of the processing executed by a computer,

wherein the processing comprise a step which is described in any one of additional claims D1 to D16.

Additional claims E1 to E20 and Additional claims F1 to F19 described below is disclosed relating to each embodiment of the preset invention (especially seventh to tenth embodiments).

[Additional claims E1]

A market trade supporting apparatus comprising

a data obtaining unit obtaining market data indicating trading target of market changing every moment in a market one by one;

a first trend judging unit judging that the market is a uptrend or downtrend based on changing pattern of the market price indicated by the market price data obtained by the data obtaining unit;

An index data generating unit generating a predetermined technical index data indicating a trend of the market price one by one based on the market price data obtained by the data obtaining unit;

a second trend judging unit judging that the market is a uptrend or downtrend based on the technical index data generated by the index data generating unit; and

a order unit outputting buy order when the second trend judging unit judges the downtrend of the market price starts in the state in which it is judged the market price is a uptrend in the first trend judging unit and outputting sell order when the second trend judging unit judges the uptrend of the market price starts in the state in which it is judged the market price is a downtrend in the first trend judging unit.

[Additional claims E2]

A market trade supporting apparatus as set forth in additional claim E1 wherein

the first trend judging unit comprises:

the bottom price obtaining unit obtaining the bottom price in the temporary decline period in which a highest of the market price is updated based on the market price corresponded;

a uptrend judging unit judging the market price is uptrend when the bottom price obtained increases one time or a plurality of times in succession, and judging the uptrend of the market price ends when the latest market price indicated by the market price data declines lower than the latest bottom price obtained by the bottom price obtaining unit after judging the market price is uptrend;

the ceiling price obtaining unit obtaining the ceiling price in the temporary rise period in which a lowest of the market price is updated based on the market price corresponded; and

a downtrend judging unit judging the market price is downtrend when the ceiling price obtained decreases one time or a plurality of times in succession, and judging the downtrend of the market price ends when the latest market price indicated by the market price data rises higher than the latest ceiling bottom price obtained by the bottom price obtaining unit after judging the market price is downtrend.

[Additional claims E3]

A market trade supporting apparatus as set forth in Additional claim E2 wherein

the bottom price obtaining unit and the ceiling price obtaining unit performs the processing described in additional claim 5.

[Additional claims E4]

A market trade supporting apparatus as set forth in additional claims E2 or E3] wherein

the bottom price obtaining unit includes the highest price processing unit and the bottom price processing unit described in additional claim A2,

the ceiling price obtaining unit includes the lowest price processing unit and the ceiling price processing unit described in additional claim A2, and

the uptrend judging unit and the downtrend judging unit performs the processing described in additional claim C6.

[Additional claims E5]

A market trade supporting apparatus as set forth in additional claims E2 or E3 wherein

the bottom price obtaining unit comprises the highest price storage, the highest price comparing unit, the highest price updating unit, the bottom price storage, the bottom price comparing unit, the bottom price updating unit and the fixed bottom price obtaining unit described in additional claim A3,

the ceiling price obtaining unit comprises the lowest price storage, the lowest price comparing unit, the lowest price updating unit, the ceiling price storage, the ceiling price comparing unit, the ceiling price updating unit and the fixed ceiling price obtaining unit described in additional claim A3, and

the uptrend judging unit and the downtrend judging unit performs the processing described in additional claim C7.

[Additional claims E6]

A market trade supporting apparatus as set forth in additional claim E5 wherein

the highest price updating unit and the lowest price updating unit performs the processing described in additional claim C8.

[Additional claim E7]

A market trade supporting apparatus as set forth in additional claims E5 or E6 wherein

the data obtaining unit, the highest price comparing unit, the highest price updating unit, the bottom price comparing unit, the bottom price updating unit, the lowest price comparing unit, the lowest price updating unit, the ceiling price comparing unit and the ceiling price updating unit performs the processing described in additional claim A4.

[Additional claims E8]

A market trade supporting apparatus as set forth in Additional claims E5 to E7 wherein

the order unit outputting buy order

when the second trend judging unit judges the downtrend of the market price starts in the state in which it is judged the market price is a uptrend in the uptrend judging unit, and it is judged the latest market price indicated by the market price data is lower than the highest price stored in the highest price storage, or the uptrend judging unit judges the uptrend of the market price ends,

the order unit outputting sell order

when the second trend judging unit judges the uptrend of the market price starts in the state in which it is judged the market price is a downtrend in the downtrend judging unit, and it is judged the latest market price indicated by the market price data is higher than the lowest price stored in the lowest price storage, or the downtrend judging unit judges the downtrend of the market price ends.

[Additional claims E9]

A market trade supporting apparatus as set forth in additional claims E5 to E7 further comprising:

a peak price obtaining unit obtaining the highest price of the highest price storage as the latest peak price of the temporary decline period whenever the highest price comparing unit judges the latest market price indicated by the market price data is lower than the highest price of the highest price storage;

a valley floor price obtaining unit obtaining the lowest price of the lowest price storage as the latest valley floor price of the temporary rise period whenever the lowest price comparing unit judges the latest market price indicated by the market price data is higher than the lowest price of the lowest price storage;

a peak price comparing unit comparing the latest market price indicated by the market price data and the peak price which is obtained one front just before the last peak price obtained by the peak price obtaining unit in the temporary decline period;

a valley floor price comparing unit comparing the latest market price indicated by the market price data and the valley floor which is obtained one front just before the last valley floor price obtained by the valley floor price obtaining unit in the temporary rise period,

wherein

the order unit outputs sell order

when the second trend judging unit judges the downtrend of the market price starts in the state in which it is judged the market price is a uptrend in the uptrend judging unit, and the valley floor price comparing unit judges the latest market price is lower than the peak price which is obtained one front just before the last peak price, and

the order unit outputs buy order

when the second trend judging unit judges the uptrend of the market price starts in the state in which it is judged the market price is a downtrend in the rise decline judging unit, and the valley floor price comparing unit judges the latest market price is higher than the valley floor price which is obtained one front just before the last valley floor price.

[Additional claim E10]

A market trade supporting apparatus as set forth in additional claims E2 to E9 wherein

the bottom price obtaining unit and the ceiling price obtaining unit perform the processing described in additional claim A5.

[Additional claim E11]

A market trade supporting apparatus as set forth in additional claim E4 wherein

the bottom price processing unit and the ceiling price processing unit perform the processing described in additional claim A6.

[Additional claim E12]

A market trade supporting apparatus as set forth in additional claims E5 to E9 wherein

the fixed bottom price obtainer and the fixed ceiling price obtainer perform the processing described in additional claim A7.

[Additional E13]

A market trade supporting apparatus as set forth in additional claims E2 to E12, wherein

the market price data includes a time information of the market,

the fixed bottom price obtainer and the fixed ceiling price obtainer perform the processing described in Additional claim A11.

[Additional E14]

A market trade supporting apparatus as set forth in additional claims E4 and E11, wherein

the market price data includes a time information of the market,

the highest price processing unit stores the time information of the market connecting to the highest of the market price,

the lowest price processing unit stores the time information of the market connecting to the lowest of the market price, and
the bottom price processing unit and the ceiling price processing unit perform the processing described in additional claim A12.

[Additional E15]

A market trade supporting apparatus as set forth in additional claims E5 to E9 and E12, wherein

the market price data includes a time information of the market,

the highest price processing unit stores the time information of the market connecting to the highest of the market price,

the lowest price processing unit stores the time information of the market connecting to the lowest of the market price, and

the fixed bottom price obtainer and the fixed ceiling price obtainer perform the processing described in additional claim A13.

[Additional E16]

A market trade supporting apparatus as set forth in additional claims E1 to E15, wherein

the technical index indicated by the technical index data indicates whether the market price is the uptrend or the downtrend according to a direction of price change,

the second trend judging unit comprises:

a first change point obtainer obtaining the technical price of a change point from which the change starts when the technical index changes to a direction indicating the downtrend of the market price;

a first index judging unit judging the downtrend of the market price starts when the technical index of the change point obtained by the first change point obtainer changes to a decline direction of the market one time or a plurality of times in succession, or a technical index of the other changing point which is changed to the direction indicating the downtrend of the market price more than the technical index of one changing point after the technical index of the one changing point is obtained by the first change point obtainer is obtained one time or a plurality of times in succession;

a second change point obtainer obtaining the technical price of a change point from which the change starts when the technical index changes to a direction indicating the uptrend of the market price; and

a second index judging unit judging the uptrend of the market price starts when the technical index of the change point obtained by the second change point obtainer changes to a rise direction of the market one time or a plurality of times in succession, or a technical index of the other changing point which is changed to the direction indicating the uptrend of the market price more than the technical index of one changing point after the technical index of the one changing point is obtained by the second change point obtainer is obtained one time or a plurality of times in succession.

[Additional E17]

A market trade supporting apparatus as set forth in additional claim E16, wherein

the first change point obtainer obtains the technical index of the start point of the change as the change point when the technical index changes toward the direction indicating the downtrend of the market price by a predetermined price or a predetermined ratio, and

the second change point obtainer obtains the technical index of the start point of the change as the change point when the technical index changes toward the direction indicating the uptrend of the market price by a predetermined price or a predetermined ratio.

[Additional E18]

A market trade supporting apparatus as set forth in additional claims E1 to E17 further comprising

the order information storage, the order information processing unit and the ordering unit described in additional claim C16.

[Additional E19] A market trade supporting apparatus as set forth in Additional claims E18 further comprising

a reception unit described in the [Additional claim C17],

wherein the order information processing unit performs processing described in the Additional claim C17.

[Additional E20]

A market trade supporting apparatus as set forth in additional claims E18 or E19 further comprising a calculating unit calculating sell price of the stop order based on the bottom price obtained when the bottom price is obtained in the bottom price obtaining unit, and calculating buy price of the stop order based on the ceiling price obtained when the ceiling price is obtained in the ceiling price obtaining unit,

wherein the order information storage stores information relating the stop order which reception thereof is fixed,

the order information processing unit updates the fixed sell price of the stop order in the information stored in the order information storage with the calculated price when the calculating unit calculates the sell price of the stop order, and updates the fixed buy price of the stop order in the information stored in the order information storage with the calculated price when the calculating unit calculates the buy price of the stop order, and

an ordering unit generates an order data for buy and sell of the stop order and transmits the order data to the predetermined server when the latest market price reaches a price of the stop order which is indicated by information stored in the order information storage.

[Additional claim F1]

A market trade supporting method comprising:

obtaining market data indicating market price of trading target changing every moment in a market one by one;

judging that the market is a uptrend or downtrend based on changing pattern of the market price indicated by the market price data obtained;

generating a predetermined technical index data indicating a trend of the market price one by one based on the market price data obtained;

judging that the market is a uptrend or downtrend based on the technical index data generated;

outputting sell order when the downtrend of the market price starts in the step of judging the trend of the market price based on the technical use data in the state in which it is judged the market price is a uptrend in the step of judging the trend of the market price based on the changing pattern of the market; and

outputting buy order when the uptrend of the market price starts in the step of judging the trend of the market price based on the technical use data in the state in which it is judged the market price is a downtrend in the step of judging the trend of the market price based on the changing pattern of the market.

[Additional claims F2]

A market trade supporting method as set forth in additional claim F1 wherein

the step of judging the trend of the market price based on the changing pattern of the market comprises:

obtaining the bottom price in the temporary decline period in which a highest of the market price is updated based on the market price corresponded;

judging the market price is uptrend when the bottom price obtained increases one time or a plurality of times in succession;

judging the uptrend of the market price ends when the latest market price indicated by the market price data declines lower than the latest bottom price obtained in the step of obtaining the bottom price after judging the market price is uptrend in the step of judging the uptrend of the market;

obtaining the ceiling price in the temporary rise period in which a lowest of the market price is updated based on the market price corresponded;

judging the market price is downtrend when the ceiling price obtained decreases one time or a plurality of times in succession; and

judging the downtrend of the market price ends when the latest market price indicated by the market price data rises higher than the latest ceiling price obtained in the step of obtaining the ceiling price after judging the market price is downtrend in the step of judging the downtrend of the market.

[Additional claims F3]

A market trade supporting method as set forth in additional claim F2 wherein

the step of obtaining the bottom price and the step of obtaining the ceiling price perform the processing described in additional claim D5.

[Additional claims F4]

A market trade supporting method as set forth in additional claims F2 or F3 wherein

the step of obtaining the bottom price includes the same step with the step of obtaining the bottom price described in the [Additional claim B2], and

the step of obtaining the ceiling price includes the same step with the step of obtaining the ceiling price described in additional claim B2.

[Additional claims F5]

A market trade supporting method as set forth in additional claims F2 or F3 wherein

the step of obtaining the market price data comprises obtaining the market price data indicating a high price and a low price in a predetermined time whenever the predetermined time passes,

the step of obtaining the bottom price includes the same step with the step of obtaining the bottom price described in additional claim B3, and

the step of obtaining the ceiling price includes the same step with the step of obtaining the ceiling price described in additional claim B3.

[Additional claim F6]

A market trade supporting method as set forth in additional claims F4 or F5 wherein

the step of storing the new highest price to the storage in the step of obtaining the bottom price includes a step described in the [Additional claim D8], and

the step of storing the new lowest price to the storage in the step of obtaining the ceiling price includes a step described in additional claim D8.

[Additional claim F7]

A market trade supporting method as set forth in additional claims F4 to F6 wherein

the step of outputting the sell order comprises outputting the sell order when it is judged the downtrend of the market price starts based on the technical use data in the step of judging the trend of the market price in the state in which it is judged the market price is a uptrend in the step of judging the uptrend of the market, and it is judged the latest market price indicated by the market price data is lower than the highest price stored in the highest price storage or it is judged the uptrend of the market ends in the step of judging the uptrend of the market price, and

the step of outputting the buy order comprises outputting the buy order when it is judged the uptrend of the market price starts based on the technical use data in the step of judging the trend of the market price in the state in which it is judged the market price is a downtrend in the step of judging the downtrend of the market, and it is judged the latest market price indicated by the market price data is higher than the lowest price stored in the lowest price storage or it is judged the downtrend of the market ends in the step of judging the downtrend of the market price.

[Additional claim F7]

A market trade supporting method as set forth in additional claims F4 to F6 further comprising:

obtaining the highest price of the storage as the latest peak price of the temporary decline period whenever it is judged the latest market price indicated by the market price data is lower than the highest price store in the storage in the step of comparing the market price and the highest price;

obtaining the lowest price of the storage as the latest valley floor price of the temporary rise period whenever it is judged the latest market price indicated by the market price data is higher than the lowest price store in the storage in the step of comparing the market price and the lowest price;

comparing t the peak price which is obtained one front just before the latest peak price obtained in the step of obtaining the peak price and the latest market price indicated by the market price data in the temporary decline period; and

comparing the valley floor price which is obtained one front just before the latest valley floor price obtained in the step of obtaining the valley floor price and the latest market price indicated by the market price data in the temporary rise period;

the step of outputting sell order comprises outputting the sell order when it is judged that the downtrend of the market price starts in the step of judging the trend of the market based on the technical use data in the state in which it is judged the market price is a uptrend in the step of judging the uptrend, and it is judged the latest market price is lower than the valley floor price before one the latest valley floor price in the step of comparing the market price and the peak price, and

the step of outputting buy order comprises outputting the buy order when it is judged that the uptrend of the market price starts in the step of judging the trend of the market based on the technical use data in the state in which it is judged the market price is a downtrend in the step of judging the downtrend, and it is judged the latest market price is higher than the valley floor price before one the latest valley floor price in the step of comparing the market price and the valley floor price.

[Additional claim F9] A market trade supporting method as set forth in additional claims F2 to F8 wherein

the step of obtaining the bottom price includes the same step of the obtaining the bottom price described in additional claim B4, and

the step of obtaining the ceiling price includes the same step of the obtaining the ceiling price described in additional claim B4.

[Additional claim F10] A market trade supporting method as set forth in additional claims F4 to F8 wherein

the step of obtaining the fixed bottom price includes the same step with the step of obtaining the fixed bottom price described in additional claim B5, and

the step of obtaining the fixed ceiling price includes the same step with the step of obtaining the fixed ceiling price described in additional claim B5.

[Additional claim F11]

A market trade supporting method as set forth in additional claims F2 to F10 wherein

the market price data includes time information of the market price,

the step of obtaining the bottom price includes the same step with the step of obtaining the bottom price described in additional claim B8, and

the step of obtaining the ceiling price includes the same step with the step of obtaining the ceiling price described in additional claim B8.

[Additional F12]

A market trade supporting method as set forth in additional claims F4 to F8 and F10, wherein

the market price data includes a time information of the market,

the step of storing the highest price into the storage includes a step of storing the time information into the storage connecting to the highest of the market price, and

the step of storing the lowest price into the storage includes a step of storing the time information into the storage connecting to the lowest of the market price,

the step of obtaining the fixed bottom price includes the same step with the step of obtaining the fixed bottom price described in additional claim B9, and

the step of obtaining the fixed ceiling price includes the same step with the step of obtaining the fixed ceiling price described in additional claim B9.

[Additional F13]

A market trade supporting method as set forth in additional claims F1 to F12, wherein

the technical index indicated by the technical index data indicates whether the market price is the uptrend or the downtrend according to a direction of price change,

the step of judging the trend of the market price based on the technical use data comprises:

obtaining the technical price of a change point from which the change starts when the technical index changes to a direction indicating the downtrend of the market price;

judging whether or not the downtrend of the market price starts when the technical index obtained in the step of obtaining the technical point of the of the change point toward the decline direction of the market price changes to a decline direction of the market one time or a plurality of times in succession;

obtaining the technical price of a change point from which the change starts when the technical index changes to a rise direction indicating the uptrend of the market price; and

judging whether or not the uptrend of the market price starts when the technical index obtained in the step of obtaining the technical point of the of the change point toward the rise direction of the market price changes to a rise direction of the market one time or a plurality of times in succession.

[Additional F14]

A market trade supporting method as set forth in additional claims F1 to F12, wherein

the technical index indicated by the technical index data indicates whether the market price is the uptrend or the downtrend according to a direction of price change,

the step of judging the trend of the market price based on the technical use data comprises:

obtaining the technical price of a change point from which the change starts when the technical index changes to a direction indicating the downtrend of the market price;

judging the downtrend of the market price starts when a technical index of the other changing point which is changed to the direction indicating the downtrend of the market price more than the technical index of the one changing point obtained one time or a plurality of times in succession after the technical index of the one changing point is obtained in the step of obtaining the technical index of the changing pint toward the decline direction of the market price;

obtaining the technical price of a change point from which the change starts when the technical index changes to a direction indicating the uptrend of the market price; and

judging the uptrend of the market price starts when a technical index of the other changing point which is changed to the direction indicating the uptrend of the market price more than the technical index of the one changing point obtained one time or a plurality of times in succession after the technical index of the one changing point is obtained in the step of obtaining the technical index of the changing pint toward the rise direction of the market price.

[Additional F15]

A market trade supporting method as set forth in additional claims F13 or F14, wherein

the step of obtaining the technical index of the changing point toward the decline direction of the market price comprises obtaining the technical index of the start point of the change when the technical index changes toward the direction indicating the downtrend of the market price by a predetermined price or a predetermined ratio, and

the step of obtaining the technical index of the changing point toward the rise direction of the market price comprises obtaining the technical index of the start point of the change when the technical index changes toward the direction indicating the uptrend of the market price by a predetermined price or a predetermined ratio.

[Additional F16]

A market trade supporting method as set forth in additional claims F1 to F15 wherein

the storage of the computer stores an order information relating to buy and sell order which is already received,

and further comprising the step of generating the order information of the buy order, the step of generating the order information of the sell order, the step of storing the order information to the storage, and the generating the order data and the step of transmitting the order data to the predetermined server described in additional claim D13 respectively.

[Additional F17]

A market trade supporting method as set forth in additional claims F1 to F16 further comprising the step of transmitting the notice to the terminal apparatus and the step of receiving the response from the terminal apparatus,

wherein the step of storing the order information to the storage comprises

the step described in additional claim D14.

[Additional D18]

A market trade supporting method as set forth in additional claims F2 to F17 wherein

the storage of the computer stores information relating the stop order which reception thereof is fixed,

further comprising:

calculating the sell price of the stop order based on the bottom price obtained when the bottom price is obtained in the step of obtaining the bottom price,

calculating the buy price of the stop order based on the ceiling price obtained when the ceiling price is obtained in the step of obtaining the ceiling price;

updating the sell price of the fixed stop order in the information stored in the storage with the sell price calculated when the sell price is calculated in the step of calculating the sell price of the stop order;

updating the buy price of the fixed stop order in the information stored in the storage with the buy price calculated when the buy price is calculated in the step of calculating the buy price of the stop order;

generating the sell order when the latest market price indicated by the market price is lower than the sell price of the stop order indicated by the information stored in the storage;

generating the buy order when the latest market price indicated by the market price is higher than the buy price of the stop order indicated by the information stored in the storage; and

transmitting the order data generated to a predetermined server managing trading of the market.

[Additional claim F19]

A program for supporting trading of the market,

including description of the processing executed by a computer,

wherein the processing comprise a step which is described in any one of additional claims F1 to F18.

Additional claim G1 to G12 and Additional claims H1 to H10 described below is disclosed relating to each embodiment of the preset invention (especially fifth embodiment).

[Additional claims G1]

A market trade supporting apparatus judging trend market price of trading target comprising:

a data obtaining unit obtaining market data indicating market price of the trading target changing every moment in a market one by one;

a bottom price obtaining unit obtaining a bottom price in the temporary decline period in which a highest of the market price is updated based on the market price; and

a ceiling price obtaining unit obtaining the ceiling price in the temporary rise period in which a lowest of the market price is updated based on the market price;

a uptrend judging unit judging the market price is uptrend when the bottom price obtained increases one time or a plurality of times in succession and judging the uptrend of the market price ends when the bottom price obtained in a temporary decline period declines less than the bottom price obtained latest after judging the market price is uptrend; and

a downtrend judging unit judging the market price is downtrend when the ceiling price obtained decreases one time or a plurality of times in succession and judging the downtrend of the market price ends when the ceiling price obtained in a temporary rise period rises higher than the ceiling price obtained latest after judging the market price is downtrend.

[Additional claim G2]

A market trade supporting apparatus as set forth in additional claim G1 wherein

the bottom price obtaining unit and the ceiling price obtaining unit perform the processing described in additional claim C5.

[Additional claim G3]

A market trade supporting apparatus as set forth in additional claims G1 or G2 wherein

the bottom price obtaining unit and the ceiling price obtaining unit comprises the highest price processing unit and the bottom price processing unit described in additional claim A2 respectively, and

the uptrend judging unit and the downtrend judging unit perform the processing described in additional claim C6.

[Additional claims G4]

A market trade supporting apparatus as set forth in additional claims G1 or G2 wherein

the bottom price obtaining unit comprises the highest price storage, the highest price comparing unit, the highest price updating unit, the bottom price storage, the bottom price comparing unit, the bottom price updating unit and the fixed bottom price obtaining unit described in additional claim A3,

the uptrend judging unit performs the processing described in additional claims C7,

the ceiling price obtaining unit comprises the lowest price storage, the lowest price comparing unit, the lowest price updating unit, the ceiling price storage, the ceiling price comparing unit, the ceiling price updating unit and the fixed ceiling price obtaining unit, and

the downtrend judging unit performs the processing described in additional claim C7.

[Additional claim G5]

A market trade supporting apparatus as set forth in additional claim G4 wherein

the highest price updating unit and the lowest price updating unit perform the processing described in additional claim C8.

[Additional claim G6]

A market trade supporting apparatus as set forth in additional claims G4 or G5 wherein

the data obtaining unit, the highest price comparing unit, the highest price updating unit, the bottom price comparing unit, the bottom price updating unit, the lowest price comparing unit, the lowest price updating unit, the ceiling price comparing unit, and the ceiling price updating unit perform the processing described in additional claim A4.

[Additional claim G7]

A market trade supporting apparatus as set forth in additional claims g1 to G6 wherein

the bottom price obtaining unit and the ceiling price obtaining unit perform the processing described in additional claim A5.

[Additional claim G8]

A market trade supporting apparatus as set forth in additional claim G3 wherein

the bottom price processing unit and the ceiling price processing unit perform the processing described in additional claim A6.

[Additional claim G9]

A market trade supporting apparatus as set forth in additional claims G4 to G6 wherein

the fixed bottom price obtainer and the fixed ceiling price obtainer perform the processing described in additional claim A7.

[Additional claim G10]

A market trade supporting apparatus as set forth in additional claims C1 to G9] wherein

the market price data includes time information of the market price,

the bottom price obtaining unit and the ceiling price obtaining unit perform the processing described in additional claim A11.

[Additional G11]

A market trade supporting apparatus as set forth in additional claim G3 and G8, wherein

the market price data includes a time information of the market,

the highest price processing unit stores the time information of the market connecting to the highest of the market price,

the lowest price processing unit stores the time information of the market connecting to the lowest of the market price, and

the bottom price processing unit and the ceiling price processing unit perform processing described in additional claim A12.

[Additional G12]

A market trade supporting apparatus as set forth in additional claims G4 to G6 and G9, wherein

the market price data includes a time information of the market,

the highest price storage stores the time information of the market connecting to the highest of the market price,

the lowest price storage stores the time information of the market connecting to the lowest of the market price, and

the fixed bottom price obtainer and the fixed ceiling price obtainer perform processing described in additional claim A13.

[Additional claims H1]

A market trade supporting method comprising:

obtaining market data indicating market price of the trading target changing every moment in a market one by one;

obtaining a bottom price in the temporary decline period in which a highest of the market price is updated based on the market price;

obtaining a ceiling price in the temporary rise period in which a lowest of the market price is updated based on the market price;

judging the market price is uptrend when the bottom price obtained increases one time or a plurality of times in succession;

judging the uptrend of the market price ends when the bottom price obtained in a temporary decline period declines less than the bottom price obtained latest after judging the market price is uptrend;

judging the market price is downtrend when the ceiling price obtained decreases one time or a plurality of times in succession; and

judging the downtrend of the market price ends when the ceiling price obtained in a temporary rise period rises more than the ceiling price obtained latest after judging the market price is downtrend.

[Additional claim H2]

A market trade supporting method as set forth in additional claim wherein

the step of obtaining the bottom price and the step of obtaining the ceiling price perform the processing described in additional claim D5.

[Additional claim H3]

A market trade supporting method as set forth in additional claims H1 or H2 wherein

the step of obtaining the bottom price includes the same step of obtaining the bottom price described in additional claim B2, and

the step of obtaining the ceiling price includes the same step of obtaining the ceiling price described in additional claim B2.

[Additional claim H4]

A market trade supporting method as set forth in additional claims H2 or H3 wherein

the step of obtaining the market price data one by one includes a step of obtaining the market price data indicating a high price and a low price in a predetermined time whenever the predetermined time passes,

the step of obtaining the bottom price includes the same step with the step of obtaining the bottom price described in additional claim B3, and

the step of obtaining the ceiling price includes the same step with the step of obtaining the ceiling price described in additional claim B3.

[Additional claim H5]

A market trade supporting method as set forth in additional claims H3 or H4 wherein

the step of storing the latest highest price to the storage in the step of obtaining the bottom price includes a step described in additional claim D8, and

the step of storing the latest lowest price to the storage in the step of obtaining the ceiling price includes a step described in additional claim D8.

[Additional claim H6]

A market trade supporting method as set forth in additional claims H1 to H5 wherein

the step of obtaining the bottom price includes the same step of the obtaining the bottom price described in additional claim B4, and

the step of obtaining the ceiling price includes the same step of the obtaining the ceiling price described in additional claim B4.

[Additional claim H7]

A market trade supporting method as set forth in additional claims H3 to H5 wherein

the step of obtaining the fixed bottom price includes the same step with the step of obtaining the fixed bottom price described in additional claim B5, and

the step of obtaining the fixed ceiling price includes the same step with the step of obtaining the fixed ceiling price described in additional claim B5.

[Additional claim H8]

A market trade supporting method as set forth in additional claims H1 to H7 wherein

the market price data includes time information of the market price,

the step of obtaining the bottom price includes the same step with the step of obtaining the bottom price described in additional claim B8, and

the step of obtaining the ceiling price includes the same step with the step of obtaining the ceiling price described in additional claim B8.

[Additional H9]

A market trade supporting method as set forth in additional claims H3 to H5 and H7, wherein

the market price data includes a time information of the market,

the step of storing the highest price into the storage includes a step of storing the time information into the storage connecting to the highest of the market price,

the step of storing the lowest price into the storage includes a step of storing the time information into the storage connecting to the lowest of the market price,

the step of obtaining the fixed bottom price includes the same step with the step of obtaining the fixed bottom price described in additional claim B9, and

the step of obtaining the fixed ceiling price includes the same step with the step of obtaining the fixed ceiling price described in additional claim B9.

[Additional claim H10]

A program for supporting market trading,

including description of the processing executed by a computer,

wherein the processing comprise a step which is described in any one of additional claims H1 to H9.

Additional claims J1 to J3 and Additional claims K1 to K3 described below are disclosed relating to each embodiment of the preset invention (especially 11th to 12th embodiments).

[Additional claims J1]

A market trade supporting apparatus as set forth in any one of additional claims A1 to A22, C4 to C19, E2 to E20 or G1 to G12 wherein

the bottom price obtaining unit comprises the highest price storage, the highest price comparing unit, the highest price updating unit, the bottom price storage, the bottom price comparing unit, the bottom price updating unit and the fixed bottom price obtaining unit described in additional claim A3,

the ceiling price obtaining unit comprises the lowest price storage, the lowest price comparing unit, the lowest price updating unit, the ceiling price storage, the ceiling price comparing unit, the ceiling price updating unit and the fixed ceiling price obtaining unit described in additional claim A3,

the highest price storage stores at least one highest price connecting to a highest price identification data for identifying the highest price, and

the lowest price storage stores at least one lowest price connecting to a lowest price identification data for identifying the lowest price,

the market trade supporting apparatus further comprises

a identification data storage storing at least one user identification data in which one highest price identification data and one lowest price identification data,

a fixed bottom price storage storing the fixed bottom price obtained by the fixed bottom price obtaining unit; and

a fixed ceiling price storage storing the fixed ceiling price obtained by the fixed ceiling price obtaining unit;

the highest price comparing unit compares at least one high price stored in the highest price storage and the latest market price indicated by the market price data,

the highest price updating unit stores the latest market price to the highest market price storage as a new highest price connecting to the one highest price identification data when the highest price comparing unit judges that the high price of the latest market price is higher than the highest price which is connected to the one highest price identification data,

the bottom price comparing unit compares at least one temporary high price stored in the bottom price storage and the latest market price indicated by the market price data,

the highest price updating unit stores the first compared market price to the bottom price storage as the temporary bottom price connecting to the one highest identification data when the highest price comparing unit judges the first market price compared after updating one highest price connected with one highest identification data is lower than the one highest price,

stores the latest market price to the bottom price storage as a new temporary bottom price connecting to the one highest identification data when the bottom price comparing unit judges that a latest market price indicated by the market price data obtained by a data obtaining unit is lower than the temporary bottom price connected to the one highest identification data in the period the highest price updating unit updates the highest price connected to the one highest price identification data next,

the fixed bottom price obtainer stores the temporary bottom price stored in the bottom price storage connected to the one highest price identification data to the fixed bottom price storage as the fixed bottom price connecting to the one highest price identification data when judging the market price changes from a state in which the market price is lower than the highest price connected to the one highest price identification data to a state in which the market price is higher than the highest price connected to the one highest price identification data,

the lowest price comparing unit compares at least one low price stored in the lowest price storage and the latest market price indicated by the market price data,

the lowest price updating unit stores the latest market price to the lowest market price storage as a new lowest price connecting to the one lowest price identification data when the lowest price comparing unit judges that the low price of the latest market price is lower than the lowest price which is connected to the one lowest price identification data,

the ceiling price comparing unit compares at least one temporary low price stored in the ceiling price storage and the latest market price indicated by the market price data,

the lowest price updating unit stores the first compared market price to the ceiling price storage as the temporary ceiling price connecting to the one lowest identification data when the lowest price comparing unit judges the first market price compared after updating one lowest price connected with one lowest identification data is higher than the one lowest price,

stores the latest market price to the ceiling price storage as a new temporary ceiling price connecting to the one lowest identification data when the ceiling price comparing unit judges that a new market price indicated by the market price data obtained by a data obtaining unit is higher than the temporary ceiling price connected to the one lowest identification data in the period the lowest price updating unit updates the lowest price connected to the one lowest price identification data next, and

the fixed ceiling price obtainer stores the temporary ceiling price stored in the ceiling price storage connected to the one lowest price identification data to the fixed ceiling price storage as the fixed ceiling price connecting to the one lowest price identification data when judging the market price changes from a state in which the market price is higher than the lowest price connected to the one lowest price identification data to a state in which the market price is lower than the lowest price connected to the one lowest price identification data.

[Additional claims J2]

A market trade supporting apparatus as forth in additional claim J1 wherein

the highest price updating unit stores the latest market price to the highest price storage as a new one highest price by which the plurality of highest price are replaced connecting to the one highest price identification data and connects all of the user identification data connected with the plurality of the highest price identification data in the identification data storage to the one highest identification data in place of the plurality of highest identification data, and

the lowest price updating unit stores the latest market price to the lowest price storage as a new one lowest price by which the plurality of lowest price are replaced connecting to the one lowest price identification data and connects all of the user identification data connected with the plurality of the lowest price identification data in the identification data storage to the one lowest identification data in place of the plurality of lowest identification data.

[Additional claims J3]

A market trade supporting apparatus as forth in additional claim J1 or J2 further comprising the uptrend judging unit and the downtrend judging unit,

wherein

the highest price updating unit stores the latest market price indicated by the market price data obtained by the data obtaining unit at the timing it is judged the downtrend ends as the latest highest price connecting to a new highest identification data and connects the one user identification data to the new highest price identification data in the identification data storage when the downtrend judging unit judges the downtrend of the market price ends based on the fixed bottom price connected to one user identification data, and

the lowest price updating unit stores the latest market price indicated by the market price data obtained by the data obtaining unit at the timing it is judged the uptrend ends as the latest lowest price connecting to a new lowest identification data and connects the one user identification data to the new lowest price identification data in the identification data storage when the uptrend judging unit judges the uptrend of the market price ends based on the fixed ceiling price connected to one user identification data.

[Additional claim K1]

A market trade supporting method as set forth in any one of additional claims B1 to B18, D4 to D17, F2 to F19, H1 to H10 wherein

the storage of the computer stores

at least one highest price connecting to a highest price identification data for identifying the highest price,

at least one lowest price connecting to a lowest price identification data for identifying the lowest price,

at least one user identification data in which one highest price identification data and one lowest price identification,

a fixed bottom price of the temporary decline period and

a fixed ceiling price of the temporary rise period,

the step of obtaining the bottom price comprises:

comparing at least one high price stored in the storage of the computer in advance and the latest market price indicated by the market price data obtained one by one;

storing the latest market price to the highest market price to the storage as a new highest price connecting to the one highest price identification data when it is judged that the high price of the latest market price is higher than the highest price which is stored in the storage connecting to the one highest price identification data in the step of comparing the highest price and the market price;

storing the first compared market price to the storage as the temporary bottom price connecting to the one highest identification data when it is judged that the first market price compared after updating one highest price connected with one highest identification data is lower than the one highest price newly stored;

comparing at least one temporary high price stored in the storage and the latest market price indicated by the market price data one by one;

storing the latest market price to the storage as a new temporary bottom price connecting to the one highest identification data when it is judged that the latest market price is lower than the temporary bottom price stored in the storage connecting to the one highest identification data in the step of comparing the temporary bottom price and the market price in the period a new highest price connecting to one highest price identification data is stored in the storage next in the step of storing the highest price; and

judging change of the market price based on a result of the comparison in the step of comparing the highest price and the market price;

storing the temporary bottom price stored in the storage connected to the one highest price identification data to the storage as the fixed bottom price connecting to all of the user identification data stored in the storage connecting to the one highest price identification data when judging the market price changes from a state in which the market price is lower than the highest price connected to the one highest price identification data to a state in which the market price is higher than the highest price connected to the one highest price identification data in the step of judging the change of the market price based on the comparison with the highest price,

the step of obtaining the ceiling price comprises:

comparing at least one low price stored in the storage of the computer in advance and the latest market price indicated by the market price data obtained one by one;

storing the latest market price to the lowest market price to the storage as a new lowest price connecting to the one lowest price identification data when it is judged that the low price of the latest market price is lower than the lowest price which is stored in the storage connecting to the one lowest price identification data in the step of comparing the lowest price and the market price;

storing the first compared market price to the storage as the temporary ceiling price connecting to the one lowest identification data when it is judged that the first market price compared after updating one lowest price connected with one lowest identification data is higher than the one lowest price newly stored;

comparing at least one temporary low price stored in the storage and the latest market price indicated by the market price data one by one;

storing the latest market price to the storage as a new temporary ceiling price connecting to the one lowest identification data when it is judged that the latest market price is higher than the temporary ceiling price stored in the storage connecting to the one lowest identification data in the step of comparing the temporary ceiling price and the market price in the period a new lowest price connecting to one lowest price identification data is stored in the storage next in the step of storing the lowest price;

judging change of the market price based on a result of the comparison in the step of comparing the lowest price and the market price; and

storing the temporary ceiling price stored in the storage connected to the one lowest price identification data to the storage as the fixed ceiling price connecting to all of the user identification data stored in the storage connecting to the one lowest price identification data when judging the market price changes from a state in which the market price is higher than the lowest price connected to the one lowest price identification data to a state in which the market price is lower than the lowest price connected to the one lowest price identification data in the step of judging the change of the market price based on the comparison with the lowest price.

[Additional claim K 2]

A market trade supporting method as forth in additional claim K1 wherein

when it is judged that the latest market price is higher than a plurality of highest price connected with the plurality of highest price identification data in the step of comparing the market price and the highest price,

the step of storing the highest price to the storage comprises:

storing the latest market price to the storage as a new one highest price by which the plurality of highest price are replaced; and

connecting all of the user identification data connected with the plurality of the highest price identification data in the storage to the one highest identification data in place of the plurality of highest identification data,

when it is judged that the latest market price is lower than a plurality of lowest price connected with the plurality of lowest price identification data in the step of comparing the market price and the lowest price,

the step of storing the lowest price to the storage comprises:

storing the latest market price to the storage as a new one lowest price by which the plurality of lowest price are replaced; and

connecting all of the user identification data connected with the plurality of the lowest price identification data in the storage to the one lowest identification data in place of the plurality of lowest identification data.

[Additional claim K3]

A market trade supporting method as forth in additional claim K2 further comprising:

judging the market price is uptrend when the fixed bottom price obtained in the step of obtaining the bottom price rises one or a plurality times in succession;

judging the uptrend of the market price ends when the latest market price indicated by the market price data drops than the fixed latest bottom price obtained in the step of obtaining the bottom price after judging the market price is uptrend in the judging the uptrend of the market price;

judging the market price is downtrend when the fixed ceiling price obtained in the step of obtaining the ceiling price declines one or a plurality times in succession;

judging the downtrend of the market price ends when the latest market price indicated by the market price data rises than the fixed latest ceiling price obtained in the step of obtaining the ceiling price after judging the market price is downtrend in the judging the downtrend of the market price;

when it is judged that the downtrend of the market price ends based on the fixed bottom price connected to one user identification data in the step of judging end of the downtrend of the market price,

the step of storing the highest price to the storage comprises:

storing the latest market price indicated by the market price data obtained in the step of obtaining the market price data at the timing of judging of the end of the downtrend to the storage as a new highest price connecting to a new highest identification data; and

connecting the one user identification data stored in the storage to the new highest price identification data,

when it is judged that the uptrend of the market price ends based on the fixed ceiling price connected to one user identification data in the step of judging end of the uptrend of the market price,

the step of storing the lowest price to the storage comprises:

storing the latest market price indicated by the market price data obtained in the step of obtaining the market price data at the timing of judging of the end of the uptrend to the storage as a new lowest price connecting to a new lowest identification data; and

connecting the one user identification data stored in the storage to the new lowest price identification data.

[Additional claim K4]

A program for supporting market trading comprises description of the processing executed by a computer,

wherein the processing comprise a step which is described in any one of additional claims K1 to K4.

The programs descried in additional claims B18, D17, F19, H10, K4 are realized on the storage media which is readable by computer and stored in not temporary state for example.

### EXPLANATION OF REFERENCES

1 order server
2 terminal apparatus
3 market data providing server
4 market trading server
9 communication network
13 display
14 storage
15 processing circuit
101 Market price data obtaining unit
103 trend judging unit 103 (first trend judging unit)
103A first trend judging unit
103B second trend judging unit
104 index data generating unit
105 second trend judging unit
106 order outputting unit
107 order information storage
108 order information processing unit
109 reception unit
110 order unit
111 peak and valley floor price obtaining unit
112 peak and valley floor price comparing unit
113 stop order calculating unit
120 bottom price obtaining unit
121 uptrend judging unit
122 ceiling price obtaining unit
123 downtrend judging unit
124 identification data storage
130 highest price storage
131 highest price comparing unit
132 highest price updating unit
133 first bottom price
134 bottom price comparing unit
135 bottom price updating unit
136 fixed bottom price obtaining unit
137 second bottom price storage
140 lowest price storage
141 lowest price comparing unit
142 lowest price updating unit
143 first ceiling price storage
144 ceiling price comparing unit
145 ceiling price updating unit
146 fixed ceiling price
147 second ceiling price storage
150 first change point obtaining unit
151 first index judging unit
152 second change point obtaining unit
153 second index judging unit
160 index data storage
161 first change point detecting unit
162 first change point storage unit
163 fixed first change point obtaining unit
164 fixed first change point storage
170 index data storage
171 second change point detecting unit
172 second change point storage
173 fixed second change point obtaining unit
174 fixed second change point storage

1-13. (canceled)

14. A market trade supporting apparatus supporting for determining a price of a stop order, comprising:
a data obtaining unit obtaining market data indicating market price of a trade target changing every moment in a market one by one;
a bottom price obtaining unit obtaining a bottom price of the market in the temporary decline period during the market price updates a highest price;
a ceiling price obtaining unit obtaining a ceiling price of the market in the temporary rise period during the market price updates a lowest price; and
a calculating unit calculating a sell price of the stop order based on the obtained bottom price when the bottom price is obtained by the bottom price obtaining unit and calculating a buy price of the stop order based on the obtained ceiling price when the ceiling price is obtained by the ceiling price obtaining unit.

15. A market trade supporting apparatus as set forth in claim 14, wherein
the bottom price obtaining unit comprises:
a highest price processing unit comparing the highest price of the market stored in advance and the latest market price indicated by the market price data
and storing the latest market price as a latest highest price when the latest market price is higher than the stored highest price; and
a bottom price processing unit storing a first market price as a temporary bottom price when the highest price processing unit judges a first market price compared with a newly stored highest price is lower than the highest price newly stored, comparing a latest market price indicated by the market data obtained by the data obtaining unit and the temporary bottom price until a latest highest price is stored in the highest price processing unit next time, storing the latest market price as a temporary bottom prices when the latest market price is lower than the temporary bottom price, and obtaining the temporary bottom price as a fixed bottom price of the temporary decline period when judging that the market price changes from a state in which the market price is lower than the highest price to a state in which the market price is higher than the highest price based on a comparison result of the highest price processing unit,
the ceiling price obtaining unit comprises,
a lowest price processing unit comparing the lowest price of the market stored in advance and the latest market price indicated by the market price data,
and storing the latest market price as a latest lowest price when the latest market price is lower than the stored lowest price; and
a ceiling price processing unit storing a first market price as a temporary ceiling price when the lowest price processing unit judges a first market price compared with a newly stored lowest price is higher than the lowest price newly stored, comparing a latest market price indicated by the market data obtained by the data obtaining unit and the temporary ceiling price until a latest lowest price is stored in the lowest price processing unit next time, storing the latest market price as a temporary ceiling prices when the latest market price is lower than the temporary ceiling price, and obtaining the temporary ceiling price as a fixed bottom price of the temporary decline period when judging that the market price changes from a state in which the market price is higher than the lowest price to a state in which the market price is lower than the lowest price based on a comparison result of the lowest price processing unit.

16. Market trade supporting apparatus as set forth in claim 14, wherein
the bottom price obtaining unit comprises:
a highest price storage storing the highest price of the market,
a highest price comparing unit comparing the latest market price indicated by the market price data obtained by the data obtaining unit and the highest price of the highest price storage,
a highest price updating unit storing the latest market price as a latest highest price into the highest price storage when the highest price comparing unit judges that the latest market price is higher than the highest price of the highest price storage,
a bottom price storage storing a temporary bottom price,
a bottom price comparing unit comparing a latest market price indicated by the market price data obtained by the data obtaining unit and the temporary bottom price of the bottom price storage,
a bottom price updating unit storing the latest market price as the temporary bottom price into the bottom price storage when the highest price comparing unit judges that a first market price compared after updating the highest price by the highest price updating unit is lower the highest price, storing the latest market price as a latest temporary bottom price into the bottom price storage when the bottom price comparing unit judges that a latest market price indicated by the market price data obtained by the data obtaining unit is lower than the temporary bottom price of the bottom price storage until the highest price is updated by the bottom price updating unit next,
a fixed bottom price obtaining unit obtains the temporary bottom price stored in the bottom price storage as a fixed bottom price of the temporary decline period when judging that the market price has changed from a state in which the market price is lower than the highest price to a state in which the market price is higher than the highest price based on a comparison result of the highest price comparing unit,
the ceiling price obtaining unit comprises:
a lowest price storage storing the lowest price of the market,
a lowest price comparing unit comparing the latest market price indicated by the market price data obtained by the data obtaining unit and the lowest price of the lowest price storage,
a lowest price updating unit storing the latest market price as a latest lowest price into the lowest price storage when the lowest price comparing unit judges that the latest market price is lower than the lowest price of the lowest price storage,
a ceiling price storage storing a temporary ceiling price,
a ceiling price comparing unit comparing a latest market price indicated by the market price data obtained by the data obtaining unit and the temporary ceiling price of the ceiling price storage,
a ceiling price updating unit storing the latest market price as the temporary ceiling price into the ceiling price storage when the lowest price comparing unit judges that a first market price compared after updating the lowest price by the lowest price updating unit is higher the lowest price, storing the latest market price as a latest temporary ceiling price into the ceiling price storage when the ceiling price comparing unit judges that a latest market price indicated by the market price data obtained by the data obtaining unit is higher than the temporary ceiling price of the ceiling price storage until the lowest price is updated by the ceiling price updating unit next,
a fixed ceiling price obtaining unit obtains the temporary ceiling price stored in the ceiling price storage as a fixed ceiling price of the temporary decline period when judging that the market price has changed from a state in which the market price is higher than the lowest price to a state in which the market price is lower than the lowest price based on a comparison result of the lowest price comparing unit.

17. A market trade supporting apparatus as set forth in claim 16, wherein
the data obtaining unit obtains the market price data indicating a high price and a low price in a predetermined time whenever the predetermined time passes,
the highest price comparing unit compares the high price of the latest market price indicated by the market price data obtained the data obtaining unit and the highest price of the highest price storage,
the highest price updating unit stores the high price of the latest market price as a new highest price when the highest price comparing unit judges that the high price of the latest market price is higher than the highest price of the highest price storage,
the bottom price comparing unit compares the low price of the latest market price indicated by the market price data obtained the data obtaining unit and the temporary bottom price of the bottom price storage,
the bottom price updating unit stores the low price of the latest market price as the temporary bottom price into the bottom price storage when the highest price comparing unit judges that a high price of a first market price compared after updating the highest price by the highest price updating unit is lower than the highest price of the highest price storage, storing the low price of the latest market price as a latest temporary bottom price into the bottom price storage when the bottom price comparing unit judges that a low price of the latest market price indicated by the market price data obtained by the data obtaining unit is lower than the temporary bottom price of the bottom price storage until the highest price is updated by the bottom price updating unit next,
the lowest price comparing unit compares the low price of the latest market price indicated by the market price data obtained the data obtaining unit and the lowest price of the lowest price storage,
the lowest price updating unit stores the low price of the latest market price as a new lowest price when the lowest price comparing unit judges that the low price of the latest market price is lower than the lowest price of the lowest price storage,
the ceiling price comparing unit compares the high price of the latest market price indicated by the market price data obtained the data obtaining unit and the temporary ceiling price of the ceiling price storage, and
the ceiling price updating unit stores the high price of the latest market price as the temporary ceiling price into the ceiling price storage when the lowest price comparing unit judges that a low price of a first market price compared after updating the lowest price by the lowest price updating unit is higher than the lowest price of the lowest price storage, storing the high price of the latest market price as a latest temporary ceiling price into the ceiling price storage when the ceiling price comparing unit judges that a high price of the latest market price indicated by the market price data obtained by the data obtaining unit is higher than the temporary ceiling price of the ceiling price storage until the lowest price is updated by the ceiling price updating unit next.

18. A market trade supporting method supporting for determining a price of a stop order, comprising:
obtaining market data indicating market price of a trade target changing every moment in a market one by one;
obtaining a bottom price of the market in the temporary decline period during the market price updates a highest price;
obtaining a ceiling price of the market in the temporary rise period during the market price updates a lowest price; and
calculating a sell price of the stop order based on the obtained bottom price when the bottom price is obtained; and calculating a buy price of the stop order based on the obtained ceiling price when the ceiling price is obtained.

19. A market trade supporting method as set forth in claim 18, wherein
the step of obtaining the bottom price comprises:
comparing the highest price of the market stored in advance and the latest market price indicated by the market price data;
storing the latest market price as a latest highest price when the latest market price is higher than the stored highest price;
storing a first market price as a temporary bottom price when the highest price processing unit judges a first market price compared with a newly stored highest price is lower than the highest price newly stored;
comparing a latest market price indicated by the market data obtained by the data obtaining unit and the temporary bottom price until a latest highest price is stored next time;
storing the latest market price as a temporary bottom prices when the latest market price is lower than the temporary bottom price; and
obtaining the temporary bottom price as a fixed bottom price of the temporary decline period when judging that the market price changes from a state in which the market price is lower than the highest price to a state in which the market price is higher than the highest price based on a comparison result of the comparing,
the step of obtaining the ceiling price comprises:
comparing the lowest price of the market stored in advance and the latest market price indicated by the market price data;
storing the latest market price as a latest lowest price when the latest market price is lower than the stored lowest price;
storing a first market price as a temporary ceiling price when the lowest price processing unit judges a first market price compared with a newly stored lowest price is higher than the lowest price newly stored;
comparing a latest market price indicated by the market data obtained by the data obtaining unit and the temporary ceiling price until a latest lowest price is stored next time;
storing the latest market price as a temporary ceiling prices when the latest market price is lower than the temporary ceiling price; and
obtaining the temporary ceiling price as a fixed bottom price of the temporary decline period when judging that the market price changes from a state in which the market price is higher than the lowest price to a state in which the market price is lower than the lowest price based on a comparison result of the comparing.

20. A market trade supporting method as set forth in claim 18, wherein
the step of obtaining the market price data one by one comprises a step obtaining the market price data indicating a high price and a low price in a predetermined time whenever the predetermined time passes,
the step of obtaining the bottom price comprises:
comparing the high price of the highest price of the market stored in a storage of the computer in advance and the high price of a new market price indicated by the market price data obtained one by one;
storing the high price of the latest market price to the storage as a new highest price when judging the high price of the new market price is higher than a highest price stored in the storage in the step of comparing the highest price and the market price;
storing the low price of the latest market price to the storage as a temporary bottom price when judging the high price of a first market price compared with a highest price newly stored in the storage is lower than a highest price newly stored in the step of comparing the highest price and the market price;
comparing the low price of the latest market price indicated by the market price data obtained one by one and the temporary bottom price stored in the storage until next new highest price is stored in the storage in the step of storing the highest price to the storage;
storing the low price of the latest market price as a new temporary bottom price to the storage when judging the low price of the latest market price is lower than the temporary bottom price of the storage in the step of comparing the temporary bottom price and the market price;
judging whether or not the high price of the market price changes from the state in which the high price of the market price is lower than the highest price to the state in which the high price of the market price is higher than the highest price; and
obtaining the temporary bottom price stored in the storage as a fixed bottom price of the temporary decline period when it is judged that the high price of the market price changes from the state in which the high price of the market price is lower than the highest price to the state in which the high price of the market price is higher than the highest price in the step of judging the change of the market price,
the step of obtaining the ceiling price comprises:
comparing the low price of the lowest price of the market stored in a storage of the computer in advance and the low price of a new market price indicated by the market price data obtained one by one;
storing the low price of the latest market price to the storage as a new lowest price when judging the low price of the new market price is lower than a lowest price stored in the storage in the step of comparing the lowest price and the market price;
storing the high price of the latest market price to the storage as a temporary ceiling price when judging the low price of a first market price compared with a lowest price newly stored in the storage is higher than a lowest price newly stored in the step of comparing the lowest price and the market price;
comparing the high price of the latest market price indicated by the market price data obtained one by one and the temporary ceiling price stored in the storage until next new lowest price is stored in the storage in the step of storing the lowest price to the storage;
storing the high price of the latest market price as a new temporary ceiling price to the storage when judging the high price of the latest market price is higher than the temporary ceiling price of the storage in the step of comparing the temporary ceiling price and the market price;
judging whether or not the low price of the market price changes from the state in which the low price of the market price is higher than the lowest price to the state in which the low price of the market price is lower than the lowest price; and
obtaining the temporary ceiling price stored in the storage as a fixed ceiling price of the temporary rise period when it is judged that the low price of the market price changes from the state in which the low price of the market price is higher than the lowest price to the state in which the low price of the market price is lower than the lowest price in the step of judging the change of the market price.

21. A market trade supporting method as set forth in claim 18, wherein
the step of obtaining the bottom price, comprises:
calculating a width of the drop in a period of temporary decline; and
stopping obtaining the bottom price of the period of temporary decline when the width of the drop calculated is smaller than a predetermined value,
the step of obtaining the ceiling price, comprises:
calculating a width of the rising in a period of temporary rising; and
stopping obtaining the ceiling price of the period of temporary rising when the width of the rising calculated is smaller than a predetermined value.

22. A market trade supporting method as set forth in claim 19, wherein
the step of obtaining fixed bottom price comprises:
calculating a width of decline of the market price in the temporary decline period in accordance with a difference or a ratio between a highest of the market price before updating and the temporary bottom price when the highest of the market price stored is updated; and
stopping obtaining the fixed bottom price in the temporary decline period when the width of decline calculated is smaller than a predetermined price;
the step of obtaining fixed ceiling price comprises:
calculating a width of rise of the market price in the temporary rise period in accordance with a difference or a ratio between a lowest of the market price before updating and the temporary ceiling price when the lowest of the market price stored is updated; and
stopping obtaining the fixed ceiling price in the temporary rise period when the width of rise calculated is smaller than a predetermined price,

23. A market trade supporting method as set forth in claim 18, wherein
the step of calculating a sell price of the stop order comprises the steps of:
calculating a width of the drop in a period of temporary decline based on the market price data; and
stopping calculating the sell price of the stop order based on the bottom price of the temporary decline period for which the decline width is calculated or generating a signal indicating that a sell price of the of the stop order calculated based on the bottom price of the temporary decline period for which the width of the drop is calculated is invalid when the decline width calculated is smaller than a predetermined price,
the step of calculating a buy price of the stop order comprises:
calculating a width of the rise in a period of temporary rise and stops calculating the sell price of the stop order based on the ceiling price of the temporary rise period for which the rise width is calculated; and
generating a signal indicating that a sell price of the of the stop order calculated based on the ceiling price of the temporary rise period for which the width of the rise is calculated is invalid when the rise width calculated is smaller than a predetermined price.

24. A market trade supporting method as set forth in claim 15, wherein
the step of calculating a sell price of the stop order comprises:
calculating a width of the drop in a period of temporary decline based on a difference or a ratio between a highest price before updating and the temporary bottom price stored in the storage when the highest price is updated in the step of storing a new highest price in the storage; and
stopping calculating the sell price of the stop order based on the bottom price of the temporary decline period for which the decline width is calculated or generating a signal indicating that a sell price of the of the stop order calculated based on the bottom price of the temporary decline period for which the width of the drop is calculated is invalid when the decline width calculated is smaller than a predetermined price,
the step of calculating a buy price of the stop order comprises:
calculating a width of the rise in a period of temporary rise based on a difference or a ratio between a lowest price before updating and the temporary ceiling price stored in the storage when the lowest price is updated in the step of storing a new lowest price in the storage; and
stopping calculating the buy price of the stop order based on the ceiling price of the temporary rise period for which the rise width is calculated or generating a signal indicating that a buy price of the of the stop order calculated based on the ceiling price of the temporary rise period for which the width of the rise is calculated is invalid when the rise width calculated is smaller than a predetermined price.

25. A market trade supporting method as set forth in claim 18, wherein
the market price data includes a time information of the market,
the step of obtaining the bottom price comprises the steps of:
calculating time of the temporary decline period based on the time information; and
stopping obtaining the bottom price in the temporary decline period when the calculated time is shorter than a predetermined time,
the step of obtaining the ceiling price comprises the steps of
calculating time of the temporary rise period based on the time information; and
stopping obtaining the ceiling price in the temporary rise period when the calculated time is shorter than a predetermined time.

26. A market trade supporting method as set forth in claim 19, wherein
the market price data includes a time information of the market,
the step of storing the highest price to the storage comprises storing the time information of the market connecting to the highest price of the market price, and
the step of storing the highest price to the storage comprises storing the time information of the market connecting to the lowest price of the market price,
the step of obtaining the fixed bottom price comprises:
calculating an elapsed time from the time of the highest of the market price before updating to the time of the highest price of the market price after updating based on the time information when the highest price of the market price stored is updated; and
stopping obtaining the fixed bottom price in the temporary decline period when the elapsed time calculated is shorter than a predetermined time,
the step of obtaining the fixed ceiling price comprises:
calculating an elapsed time from the time of the lowest of the market price before updating to the time of the lowest price of the market price after updating based on the time information when the lowest price of the market price stored is updated; and
stopping obtaining the fixed ceiling price in the temporary rise period when the elapsed time calculated is shorter than a predetermined time.

27. A market trade supporting method as set forth in claim 18, wherein
the market price data includes a time information of the market,
the step of calculating sell price of the stop order comprises:
calculating time of the temporary decline period based on the time information: and
stopping calculating the sell order based on the bottom price of the temporary decline period obtained in the step of obtaining the bottom price or generating a signal indicating the sell price calculated based on the bottom price of the temporary decline period is invalid,
the step of calculating buy price of the stop order comprises:
calculating time of the temporary rise period based on the time information: and
stopping calculating the buy order based on the ceiling price of the temporary rise period obtained in the step of obtaining the ceiling price or generating a signal indicating the buy price calculated based on the ceiling price of the temporary rise period is invalid.

28. A market trade supporting method as set forth in claim 19, wherein
the market price data includes a time information of the market,
the step of storing the highest price to the storage comprises storing the time information of the market connecting to the highest price of the market price,
the step of storing the highest price to the storage comprises storing the time information of the market connecting to the lowest price of the market price,
the step of calculating the sell price of the stop order comprises:
calculating an elapsed time from the time of the highest of the market price before updating to the time of the highest price of the market price after updating based on the time information when the highest price of the market price stored is updated; and
stopping calculating the sell price based on the fixed bottom price of the temporary decline period obtained in the step of obtaining the fixed bottom price or generating a signal indicating the sell price calculated based on the fixed bottom price of the temporary decline period is invalid,
the step of calculating the buy price of the stop order comprises:
calculating an elapsed time from the time of the lowest of the market price before updating to the time of the lowest price of the market price after updating based on the time information when the lowest price of the market price stored is updated; and
stopping calculating the buy price based on the fixed ceiling price of the temporary rise period obtained in the step of obtaining the fixed ceiling price or generating a signal indicating the buy price calculated based on the fixed ceiling price of the temporary rise period is invalid.

29. A market trade supporting method as set forth in claim 18, wherein
the storage of the computer stores information of a stop order for which a reception is established,
further comprising:
changing the sell price of the fixed stop order in the information stored in the storage with the calculated sell price when the sell price is calculated in the step of calculating the sell price of the stop order;
changing the buy price of the fixed stop order in the information stored in the storage with the calculated buy price when the buy price is calculated in the step of calculating the buy price of the stop order;
generating a sell order data when the latest market price indicated by the market price data is lower than the sell price of the stop order indicated by the information stored in the storage; and
generating a buy order data when the latest market price indicated by the market price data is higher than the buy price of the stop order indicated by the information stored in the storage.

30. A market trade supporting method as set forth in claim 29, wherein
the step of changing the sell price of the stop order comprises stopping the changing from the sell price of the stored information to the calculated sell price when the sell order price calculated in the step of calculating the sell price of the stop order is lower than the sell price of the stored information of the storage, and
the step of changing the sell price of the stop order comprises stopping the changing from the buy price of the stored information to the calculated buy price when the buy order price calculated in the step of calculating the buy price of the stop order is higher than the buy price of the stored information of the storage.

31. A market trade supporting method as set forth in claim 29, wherein
the storage of the computer stored information of sell contracted price and buy contracted price,
further comprising comparing the latest market price indicated by the market price data obtained one by one and the sell contracted price and buy contracted price of the information stored in the storage,
the step of calculating the sell price of the stop order comprises changing the sell price of the stop order to the same price with the buy contracted price or price which is higher than the buy contracted price and lower than the latest market price when judging the latest market price is higher than the buy contracted price and the sell price of the stop order stored in the storage is lower than the buy contracted price, and
the step of calculating the buy price of the stop order comprises changing the buy price of the stop order to the same price with the sell contracted price or price which is lower than the sell contracted price and higher than the latest market price when judging the latest market price is lower than the sell contracted price and the buy price of the stop order stored in the storage is higher than the sell contracted price.

32. A market trade supporting method as set forth in claim 31, wherein
the step of comparing the buy contracted price and the market price comprises judging whether or not the latest market price increases by more than a predetermined price width compared with the buy contracted price,
the step of comparing the sell contracted price and the market price comprises judging whether or not the latest market price decreases by more than a predetermined price width compared with the sell contracted price,
the step of calculating the sell price of the stop order comprises changing the sell price of the stop order to the same price with the buy contracted price or price which is higher than the buy contracted price and lower than the latest market price when judging the latest market price increases by a predetermined width compared with the buy contracted price and the sell price of the stop order stored in the storage is lower than the buy contracted price, and
the step of calculating the buy price of the stop order comprises changing the buy price of the stop order to the same price with the sell contracted price or price which is lower than the sell contracted price and higher than the latest market price when judging the latest market price decreases by a predetermined width compared with the sell contracted price and the buy price of the stop order stored in the storage is higher than the sell contracted price.

33. A market trade supporting method as set forth in claim 29, wherein
when the sell price of the stop order is calculated in the step of calculating the sell price of the stop order,
the step of changing the sell price of the stop order comprises:
generating a first order information indicating new buy order;
updating the sell price of the stop order which is fixed in the information stored in the storage to the calculated sell price; and
increasing amount of sell of the fixed stop order of the stored information by amount of buy of the first order information,
when the buy price of the stop order is calculated in the step of calculating the buy price of the stop order,
the step of changing the buy price of the stop order comprises:
generating a second order information indicating new sell order;
updating the buy price of the stop order which is fixed in the information stored in the storage to the calculated buy price; and
increasing amount of buy of the fixed stop order of the stored information by amount of sell of the second order information.

34. A market trade supporting method as set forth in claim 18, wherein
the step of calculating the sell price of the stop order comprises calculating the price which is lower than the obtained bottom price by a predetermined price or the price which is lower than the obtained bottom price by a predetermined rate as sell price of the stop order, and
the step of calculating the buy price of the stop order comprises calculating the price which is higher than the obtained ceiling price by a predetermined price or the price which is higher than the obtained ceiling price by a predetermined rate as buy price of the stop order.

35. A program for supporting decision of the price of stop order comprises description of the processing executed by a computer,
wherein the processing comprise a step which is described in claim 18;
updating the buy price of the fixed stop order in the information stored in the storage with the buy price calculated when the buy price is calculated in the step of calculating the buy price of the stop order;
generating the sell order when the latest market price indicated by the market price is lower than the sell price of the stop order indicated by the information stored in the storage;
generating the buy order when the latest market price indicated by the market price is higher than the buy price of the stop order indicated by the information stored in the storage; and
transmitting the order data generated to a predetermined server managing trading of the market.
